(19) United States
(12) Patent Application Publication
(10) Pub. No.: US 2025/0321801 A1
(43) Pub. Date: Oct. 16, 2025

(54) DATABASE SYSTEM PERFORMANCE OF A STORAGE REBALANCING PROCESS

(71) Applicant: Ocient Holdings LLC, Chicago, IL (US)

(72) Inventors: Finley Jordan Lau, Chicago, IL (US); George Kondiles, Chicago, IL (US); Richard George Wendel, III, Cincinnati, OH (US); Andrew Michael Bass, Carmel, IN (US); Pieter Charles Jas Svenson, Seattle, WA (US); Greg R. Dhuse, Chicago, IL (US); Hassan Farahani, Evanston, IL (US); Johannes Altmanninger, Linz (AT); Owen Pang, Austin, TX (US)

(73) Assignee: Ocient Holdings LLC, Chicago, IL (US)

(21) Appl. No.: 18/632,629

(22) Filed: Apr. 11, 2024

(51) Int. Cl. G06F 9/50

(52) U.S. Cl. CPC G06F 9/5044; G06F 9/5016; G06F 9/5033

(57) ABSTRACT

A database system is operable to generating current storage distribution data indicating storage utilization for a plurality of storage buckets of a database system. A first subset of the plurality of storage buckets are identified a plurality of source buckets based on each of the first subset of the plurality of storage buckets having corresponding storage utilization meeting source bucket criteria. A second subset of the plurality of storage buckets are identified as a plurality of target buckets based on each of the first subset of the plurality of storage buckets having corresponding storage utilization meeting target bucket criteria. Each of a plurality of data transfers are performed based on transferring storage of data included in one of plurality of source buckets to one of the plurality of target buckets.

### CROSS-REFERENCE TO RELATED APPLICATIONS

None

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with various embodiments;

FIG. 1A is a schematic block diagram of an embodiment of a database system in accordance with various embodiments;

FIG. 2 is a schematic block diagram of an embodiment of an administrative sub-system in accordance with various embodiments:

FIG. 3 is a schematic block diagram of an embodiment of a configuration sub-system in accordance with various embodiments:

FIG. 4 is a schematic block diagram of an embodiment of a parallelized data input sub-system in accordance with various embodiments:

FIG. 5 is a schematic block diagram of an embodiment of a parallelized query and response (Q&R) sub-system in accordance with various embodiments:

FIG. 6 is a schematic block diagram of an embodiment of a parallelized data store, retrieve, and/or process (IO& P) sub-system in accordance with various embodiments:

FIG. 7 is a schematic block diagram of an embodiment of a computing device in accordance with various embodiments;

FIG. 8 is a schematic block diagram of another embodiment of a computing device in accordance with various embodiments:

FIG. 9 is a schematic block diagram of another embodiment of a computing device in accordance with various embodiments:

FIG. 10 is a schematic block diagram of an embodiment of a node of a computing device in accordance with various embodiments:

FIG. 11 is a schematic block diagram of an embodiment of a node of a computing device in accordance with various embodiments:

FIG. 12 is a schematic block diagram of an embodiment of a node of a computing device in accordance with various embodiments:

FIG. 13 is a schematic block diagram of an embodiment of a node of a computing device in accordance with various embodiments:

FIG. 14 is a schematic block diagram of an embodiment of operating systems of a computing device in accordance with various embodiments;

FIGS. 15-23 are schematic block diagrams of an example of processing a table or data set for storage in the database system in accordance with various embodiments:

FIG. 24A is a schematic block diagram of a query execution plan implemented via a plurality of nodes in accordance with various embodiments:

FIGS. 24B-24D are schematic block diagrams of embodiments of a node that implements a query processing module in accordance with various embodiments;

FIG. 24E is an embodiment is schematic block diagrams illustrating a plurality of nodes that communicate via shuffle networks in accordance with various embodiments:

FIG. 24F is a schematic block diagram of a database system communicating with an external requesting entity in accordance with various embodiments:

FIG. 24G is a schematic block diagram of a query processing system in accordance with various embodiments;

FIG. 24H is a schematic block diagram of a query operator execution flow in accordance with various embodiments:

FIG. 24I is a schematic block diagram of a plurality of nodes that utilize query operator execution flows in accordance with various embodiments:

FIG. 24J is a schematic block diagram of a query execution module that executes a query operator execution flow via a plurality of corresponding operator execution modules in accordance with various embodiments;

FIG. 24K illustrates an example embodiment of a plurality of database tables stored in database storage in accordance with various embodiments:

FIG. 24L illustrates an example embodiment of a dataset stored in database storage that includes at least one array field in accordance with various embodiments;

FIG. 24M is a schematic block diagram of a query execution module that implements a plurality of column data streams in accordance with various embodiments:

FIG. 24N illustrates example data blocks of a column data stream in accordance with various embodiments:

FIG. 24O is a schematic block diagram of a query execution module illustrating writing and processing of data blocks by operator execution modules in accordance with various embodiments;

FIG. 24P is a schematic block diagram of a database system that implements a segment generator that generates segments from a plurality of records in accordance with various embodiments:

FIG. 24Q is a schematic block diagram of a segment generator that implements a cluster key-based grouping module, a columnar rotation module, and a metadata generator module in accordance with various embodiments;

FIG. 24R is a schematic block diagram of a query processing system that generates and executes a plurality of IO pipelines to generate filtered records sets from a plurality of segments in conjunction with executing a query in accordance with various embodiments:

FIG. 24S is a schematic block diagram of a query processing system that generates an IO pipeline for accessing a corresponding segment based on predicates of a query in accordance with various embodiments:

FIG. 24T is a schematic block diagram of a database system that includes a plurality of storage clusters that each mediate cluster state data via a plurality of nodes in accordance with a consensus protocol in accordance with various embodiments:

FIG. 24U is a schematic block diagram of a database system that implements a compressed column filter conversion module based on accessing a dictionary structure in accordance with various embodiments:

FIG. 24V is a schematic block diagram of a query execution module that implements a Global Dictionary Compression join via access to a dictionary structure in accordance with various embodiments:

FIGS. 25A-25B are schematic block diagrams of embodiments of a database system that includes a record processing and storage system in accordance with various embodiments;

FIG. 25C is a is a schematic block diagram of an embodiment of a page generator in accordance with various embodiments:

FIG. 25D is a schematic block diagram of an embodiment of a page storage system of a record processing and storage system in accordance with various embodiments;

FIG. 25E is a schematic block diagram of a node that implements a query processing module that reads records from segment storage and page storage in accordance with various embodiments:

FIG. 26A is a schematic block diagram of a record processing and storage system that implements a selected metadata loading module to load metadata rows to at least one persistent system table stored via database storage in accordance with various embodiments;

FIG. 26B is a schematic block diagram of a plurality of nodes of a record processing and storage system that send metadata rows to a selected metadata loading module in accordance with various embodiments:

FIG. 26C is a schematic block diagram of a system metadata generator module that processes column extractor input to generate a data block in accordance with various embodiments;

FIG. 26D is a logic diagram illustrating a method for execution in accordance with various embodiments;

FIG. 27A is a schematic block diagram of a record processing and storage system that implements a page drain initiation module to determine to perform a page drain on pages of a page storage system based on page drain condition data in accordance with various embodiments:

FIG. 27B is a schematic block diagram of a database system that implements a plurality of loading modules each implementing a page drain module based on communication with a storage cluster in accordance with various embodiments;

FIG. 27C is a logic diagram illustrating a method for execution in accordance with various embodiments:

FIG. 28A illustrates transition of a database system from one database system state to another database system state via a segment group transfer process in accordance with various embodiments:

FIG. 28B illustrates performance of a query execution process during a database system from one database system state to another database system state in accordance with various embodiments;

FIG. 28C illustrates performance of steps of a segment group transfer process via communication between a transfer segment group task processing module and a first storage cluster and a second storage cluster in accordance with various embodiments;

FIGS. 28D-28I illustrate examples of executing a query execution process during execution of a segment group transfer process in accordance with various embodiments;

FIG. 28J illustrates a flow of an embodiment of segment group transfer process that includes a plurality of probe polling steps in accordance with various embodiments:

FIG. 28K illustrates a flow of an embodiment of a probe polling step in accordance with various embodiments:

FIG. 28L illustrates an example of executing a query execution process during execution of a segment group transfer process that includes a probe polling step in accordance with various embodiments:

FIG. 28M is a logic diagram illustrating a method for execution in accordance with various embodiments:

FIG. 29A is a schematic block diagram of a storage rebalancing module that performs a storage rebalancing process via a source and target selection module and a data transfer module in accordance with various embodiments:

FIG. 29B illustrates example transition between storage distribution states in accordance with various embodiments:

FIG. 29C is a schematic block diagram of a storage rebalancing module that implements a source and target criteria generator module and a source and target candidate selection module in accordance with various embodiments:

FIG. 29D illustrates an example storage distribution state that includes example source buckets and example target buckets in accordance with various embodiments:

FIG. 29E illustrates example transition between storage distribution states via execution of a storage rebalancing process in accordance with various embodiments:

FIG. 29F is a schematic block diagram of a storage rebalancing module that performs a storage rebalancing process to implement inter-cluster rebalancing and intra-cluster rebalancing via a plurality of storage rebalancing subprocesses in accordance with various embodiments;

FIG. 29G is a schematic block diagram of a storage rebalancing module that performs a storage rebalancing process to implement an inter-cluster data transfer process based on applying inter-cluster-based rebalancing configuration data in accordance with various embodiments;

FIG. 29H is a schematic block diagram of a storage rebalancing module that performs a storage rebalancing process to implement an intra-cluster data transfer process based on applying intra-cluster-based rebalancing configuration data in accordance with various embodiments:

FIG. 29I is a logic diagram illustrating a method for execution in accordance with various embodiments;

FIG. 30A is a schematic block diagram of a segment generator that performs a segment activation-based time bucket lookup map update process to update a time bucket lookup map in conjunction with generating a segment for storage in accordance with various embodiments:

FIG. 30B is a schematic block diagram of a query processing module that implements a segment identification module based on performing a time-based query filtering-based segment pre-filtering process to access a time bucket lookup map in conjunction with executing a query in accordance with various embodiments:

FIG. 30C is a schematic block diagram of a database storage of a database system storing a database table that includes a time column in accordance with various embodiments;

FIG. 30D illustrates an embodiment of a time bucket lookup map that includes a plurality of time buckets each mapped to a segment set indicating at least one segment identifier mapped to segments in an activated segment set in accordance with various embodiments:

FIG. 30E illustrates an example embodiment of segment data in accordance with various embodiments:

FIG. 30F illustrates an example logic flow of a segment activation-based time bucket lookup map update process in accordance with various embodiments;

FIG. 30G illustrates an example logic flow of a time-based query filtering-based segment pre-filtering process in accordance with various embodiments:

FIG. 30H is a logic diagram illustrating a method for execution in accordance with various embodiments;

FIG. 31A is a schematic block diagram of a segment generator that performs a multi-dimensional index structure update process to update a multi-dimensional index structure in conjunction with generating a segment for storage in accordance with various embodiments:

FIG. 31B is a schematic block diagram of a query processing module that implements a segment identification module based on performing a segment pre-filtering process to access a multi-dimensional index structure in conjunction with executing a query in accordance with various embodiments;

FIG. 31C illustrates example multi-dimensional segment bounding boxes generated for range value sets for example segments via a segment bounding box determination module:

FIG. 31D illustrates an example multi-dimensional index structure implemented as an R-tree structure that includes a plurality of tree nodes corresponding to example multi-dimensional bounding boxes in accordance with various embodiments; and

FIG. 31E is a logic diagram illustrating a method for execution in accordance with various embodiments.

### DETAILED DESCRIPTION OF THE INVENTION

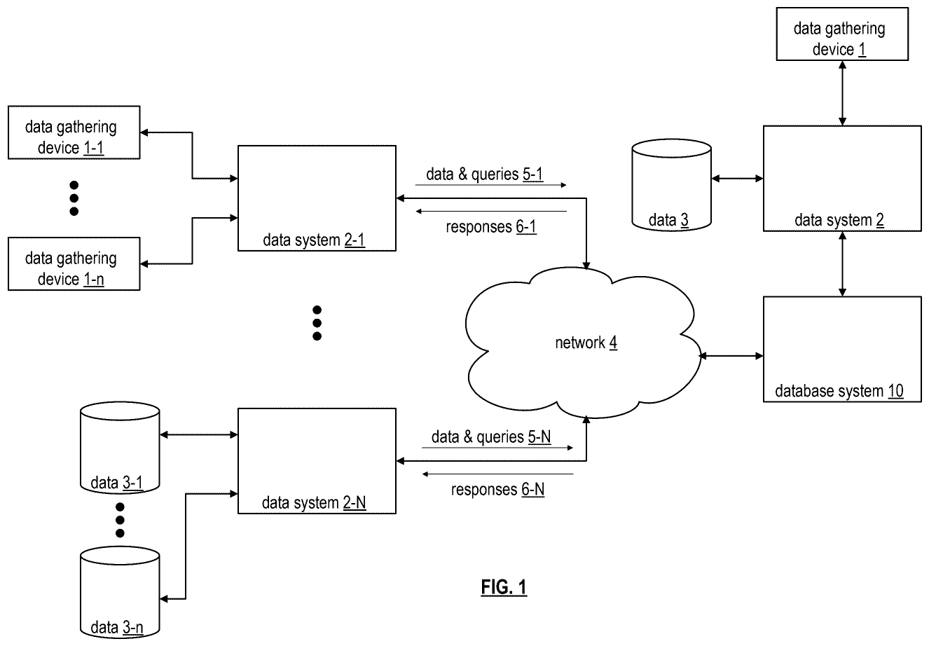

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of: wide area network (WAN) connections, local area network (LAN) connections, wireless connections, wireline connections, etc. to couple the sub-systems 11, 12, 13, 15, and 16 together.

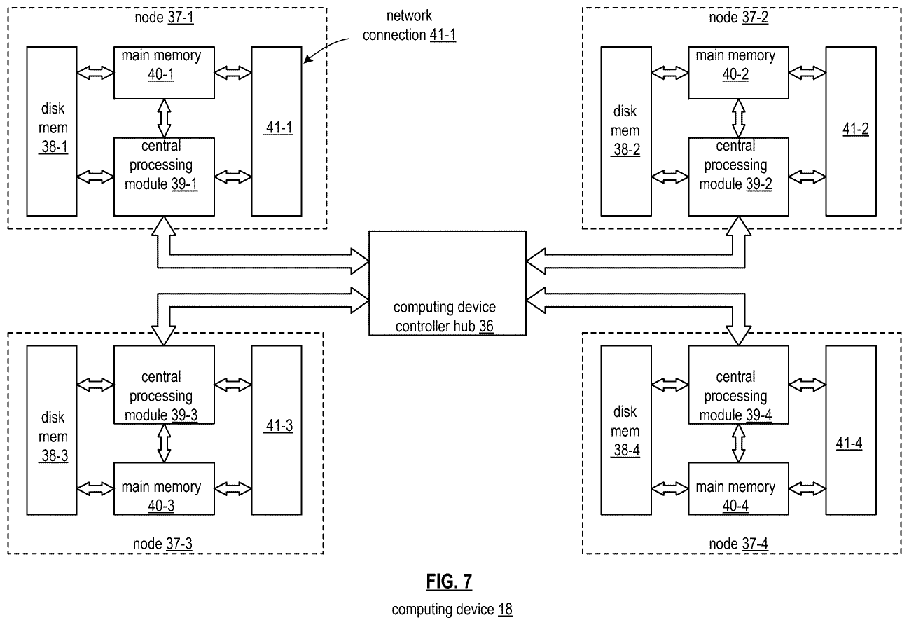

Each of the sub-systems 11, 12, 13, 15, and 16 include a plurality of computing devices: an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

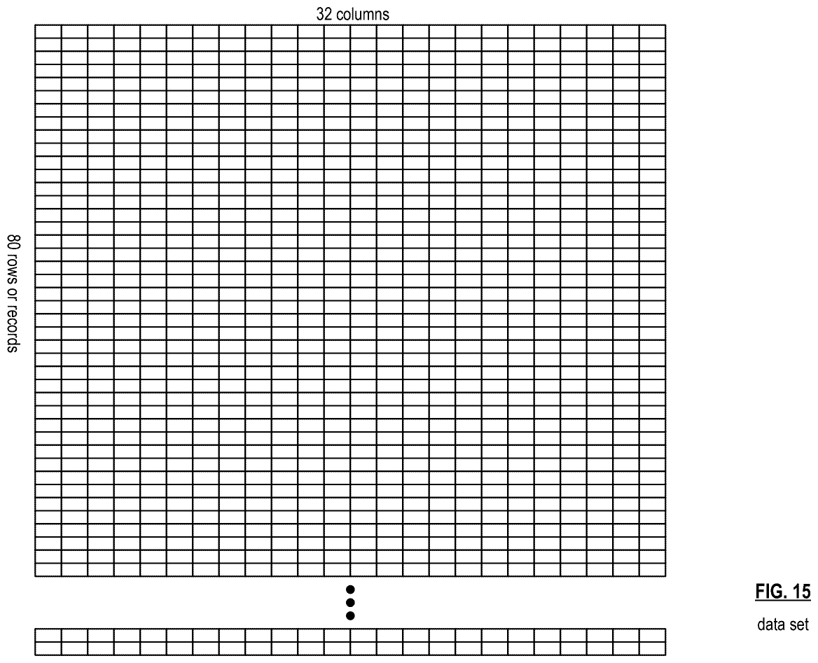

As is further discussed with reference to FIG. 15, the data source organizes its records of the data set into a table that includes rows and columns. The columns represent data fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

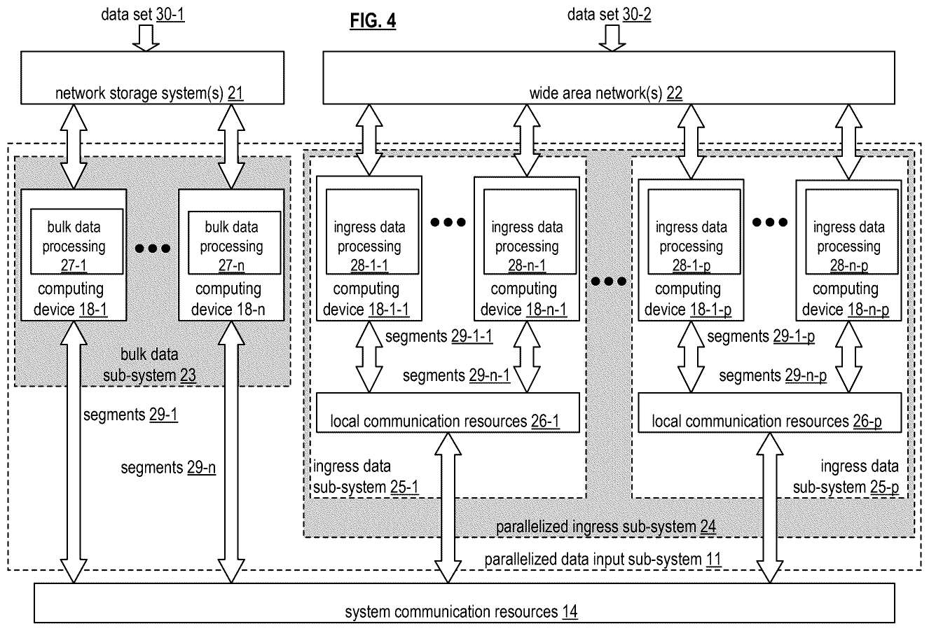

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

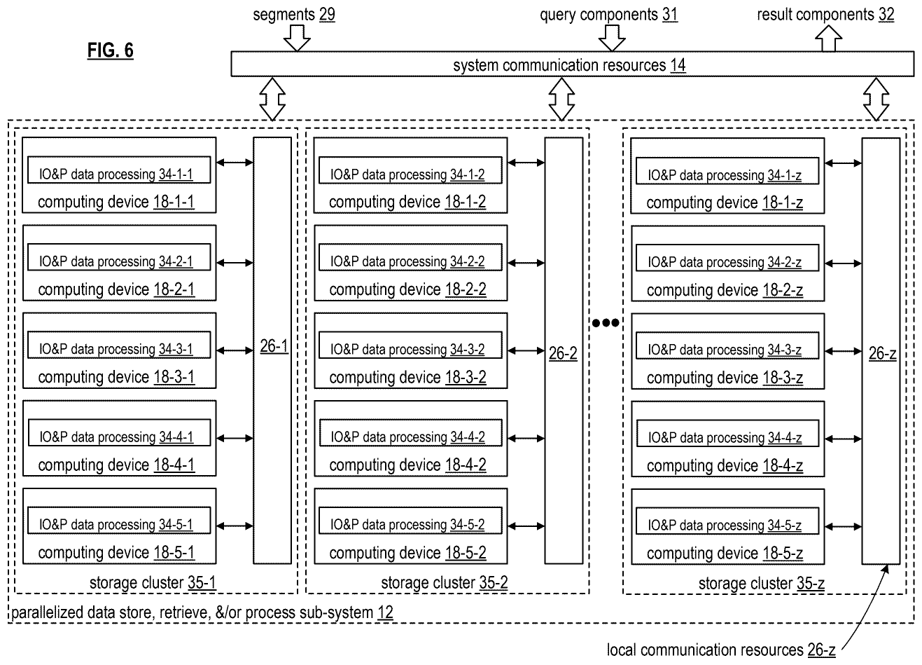

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

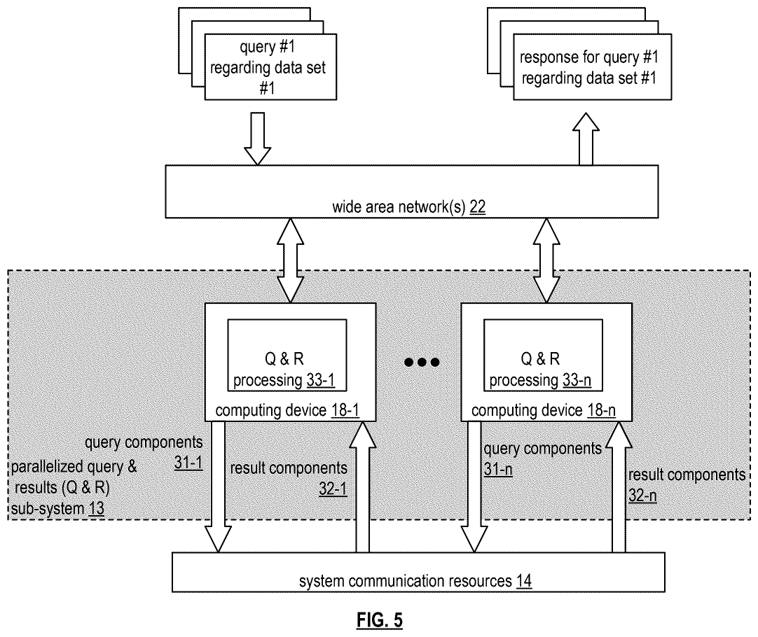

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

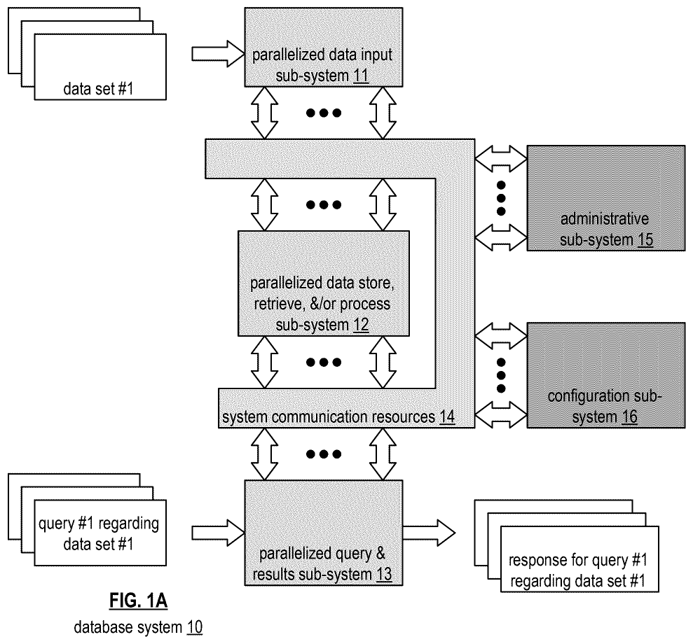

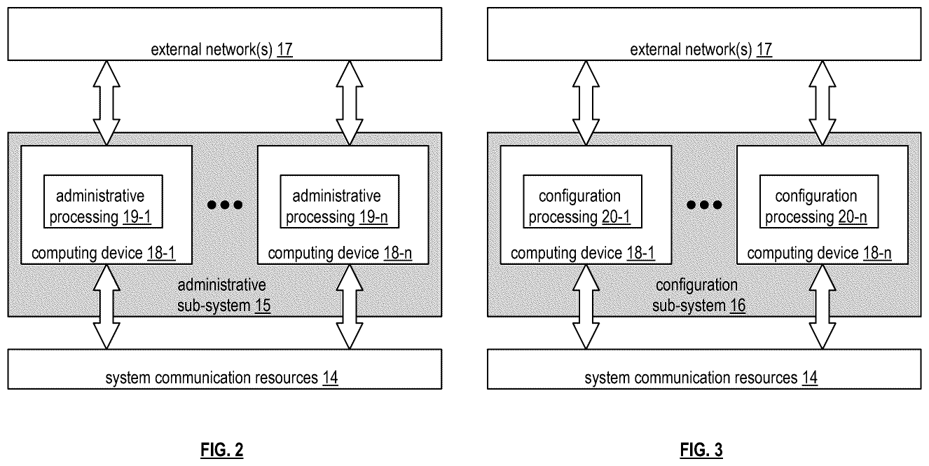

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

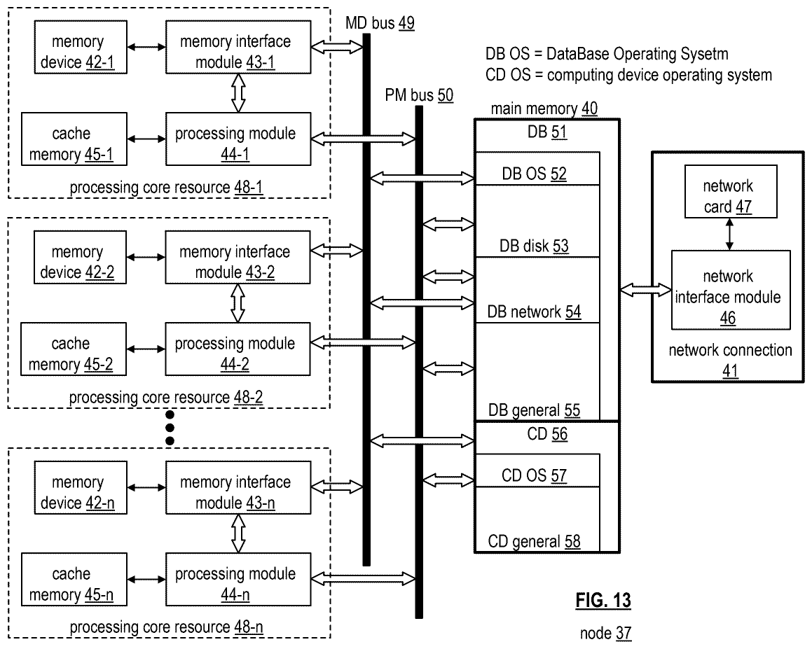

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

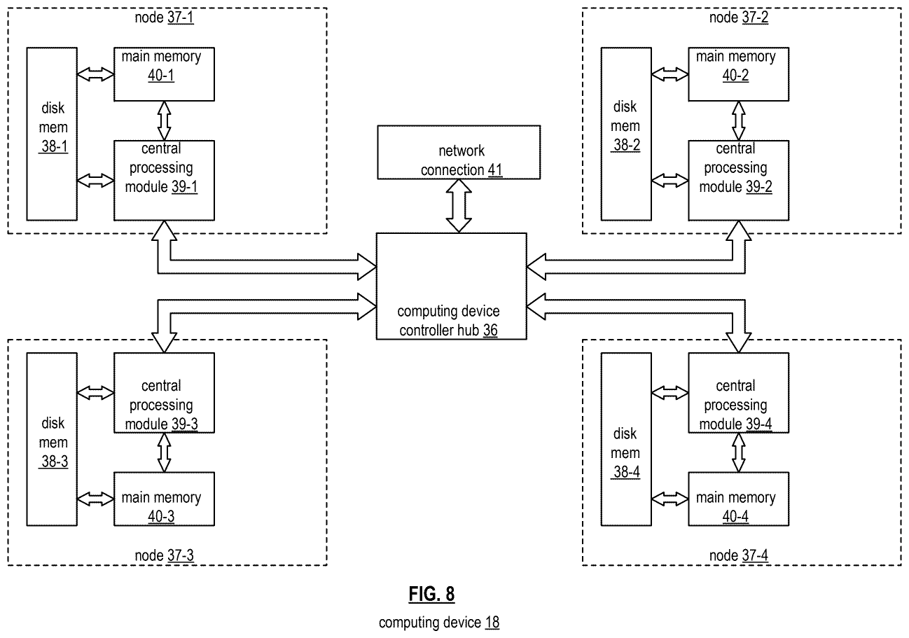

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

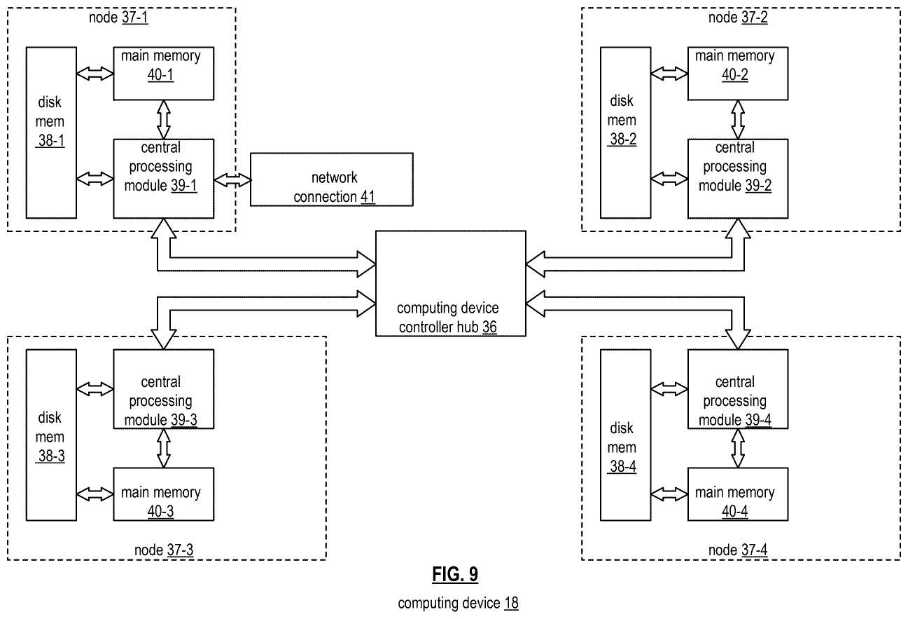

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

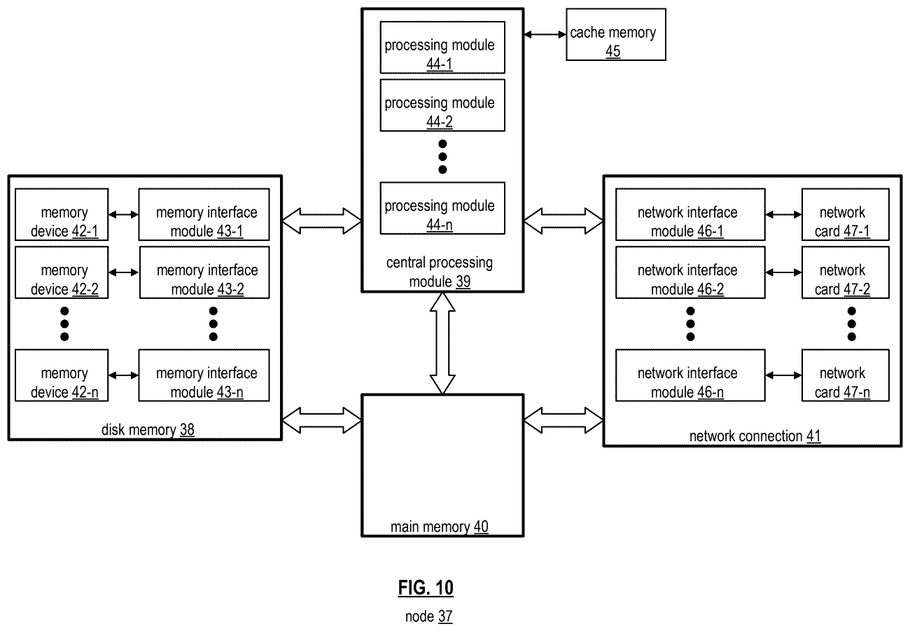

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

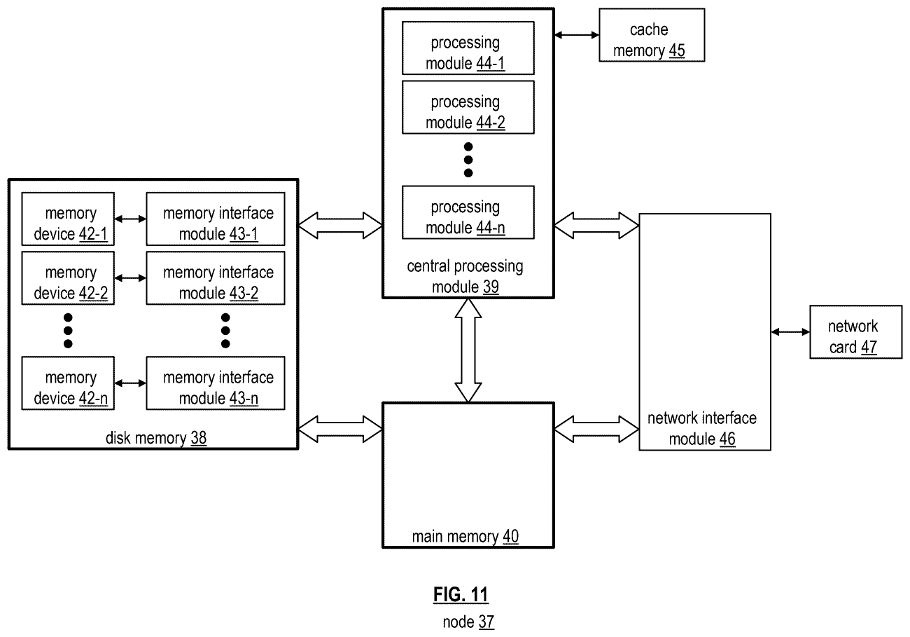

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

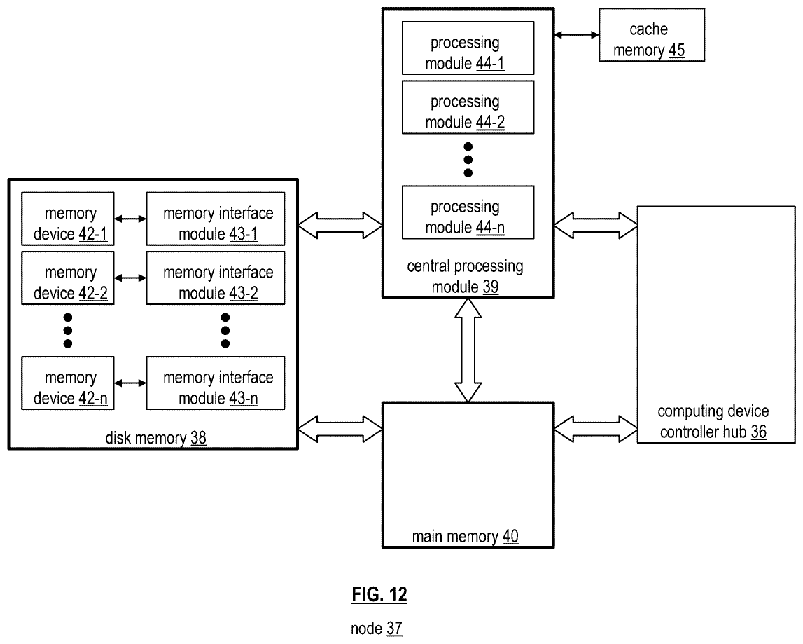

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

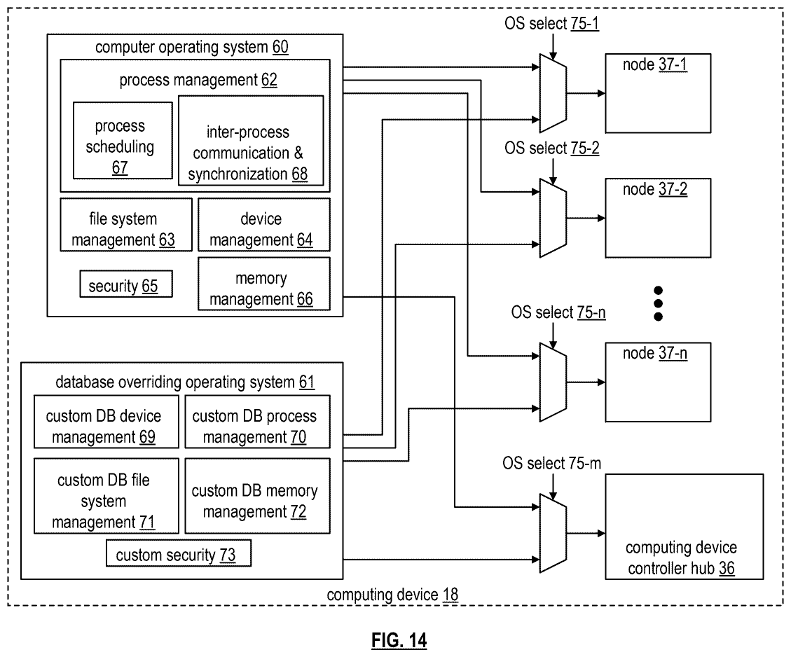

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

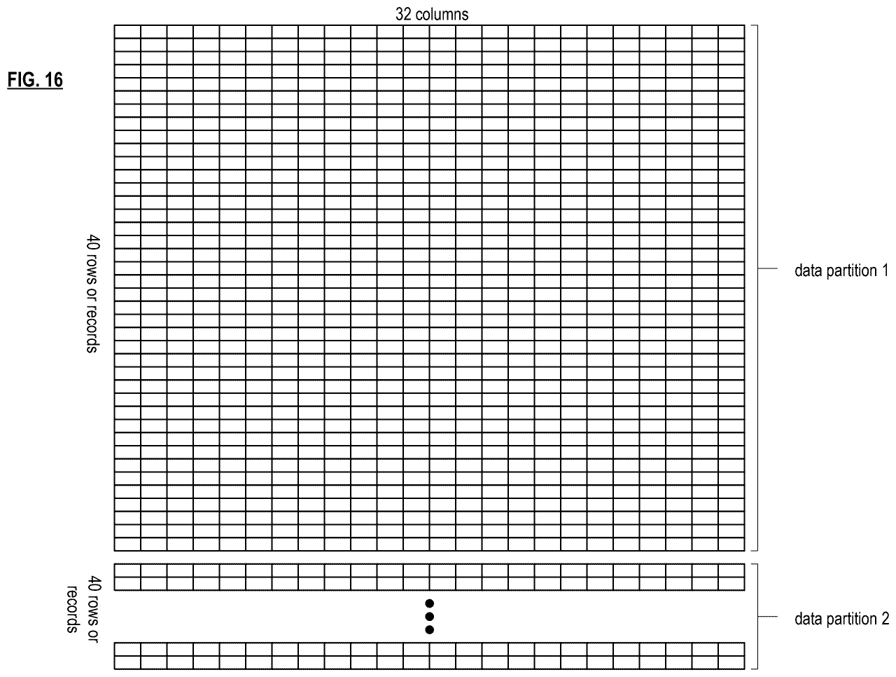

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

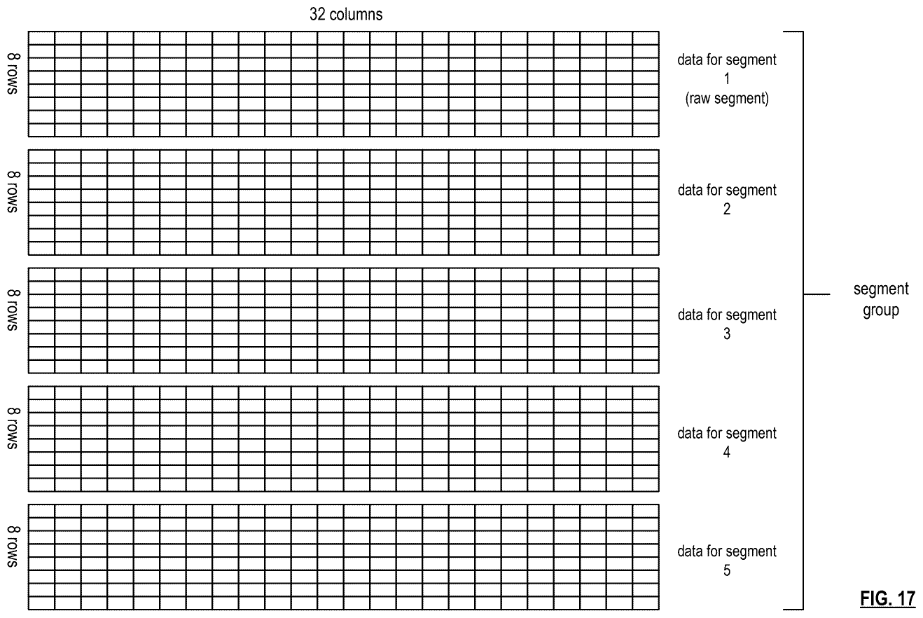

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces: thus, eight segments are created.

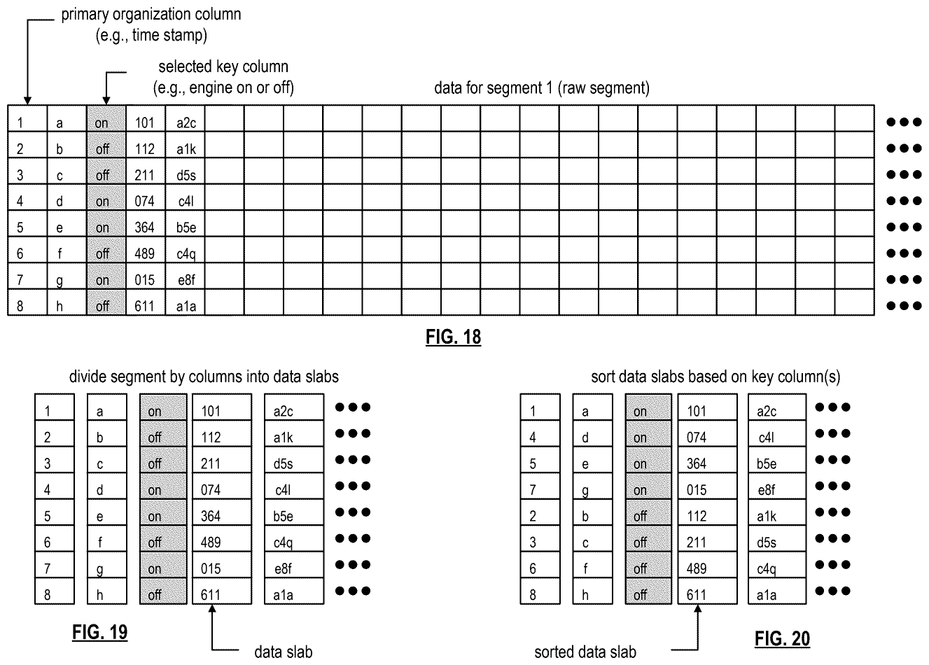

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

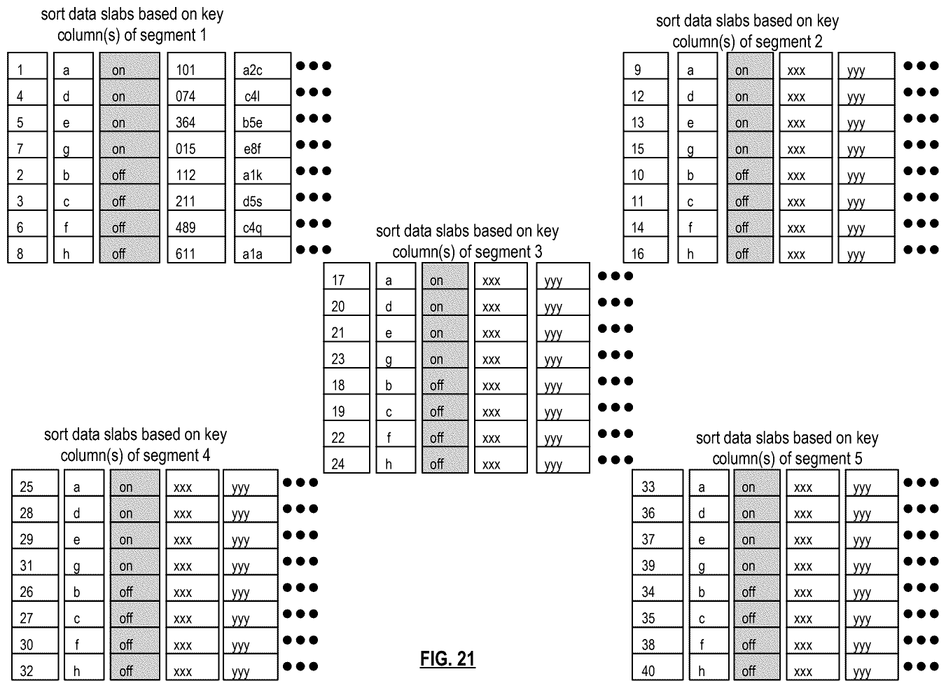

FIG. 21 illustrates an example of each segment of the segment group sorted into sorted data slabs. The similarity of data from segment to segment is for the convenience of illustration. Note that each segment has its own data, which may or may not be similar to the data in the other sections.

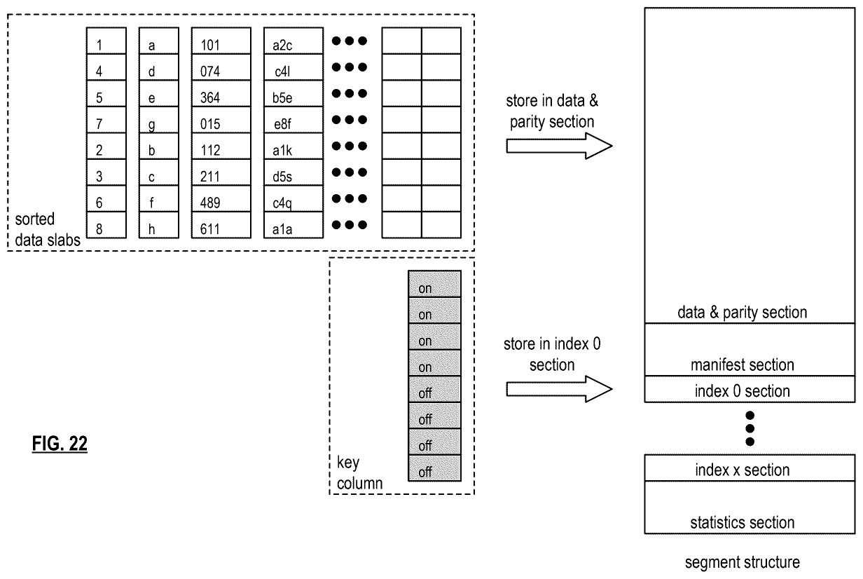

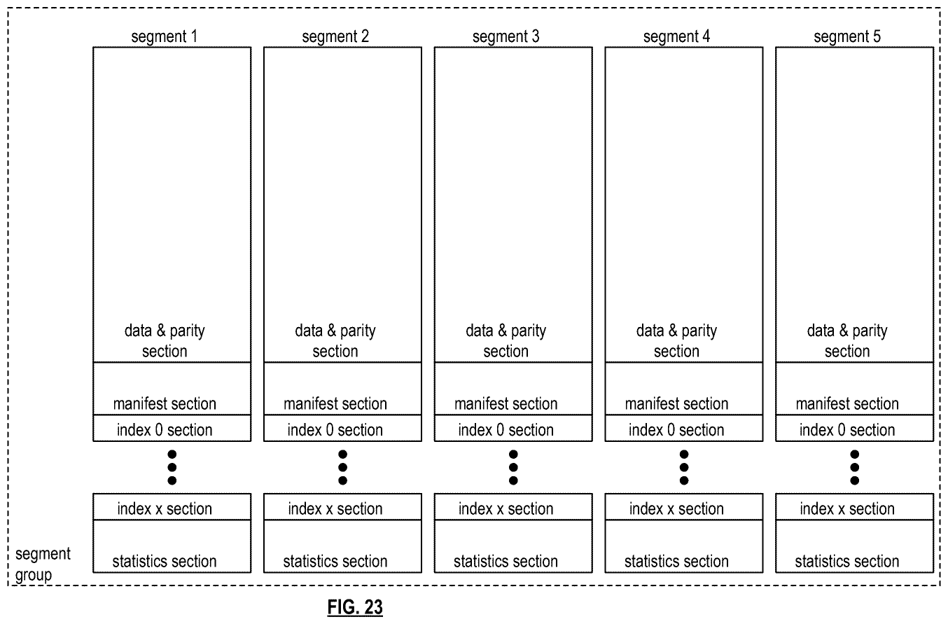

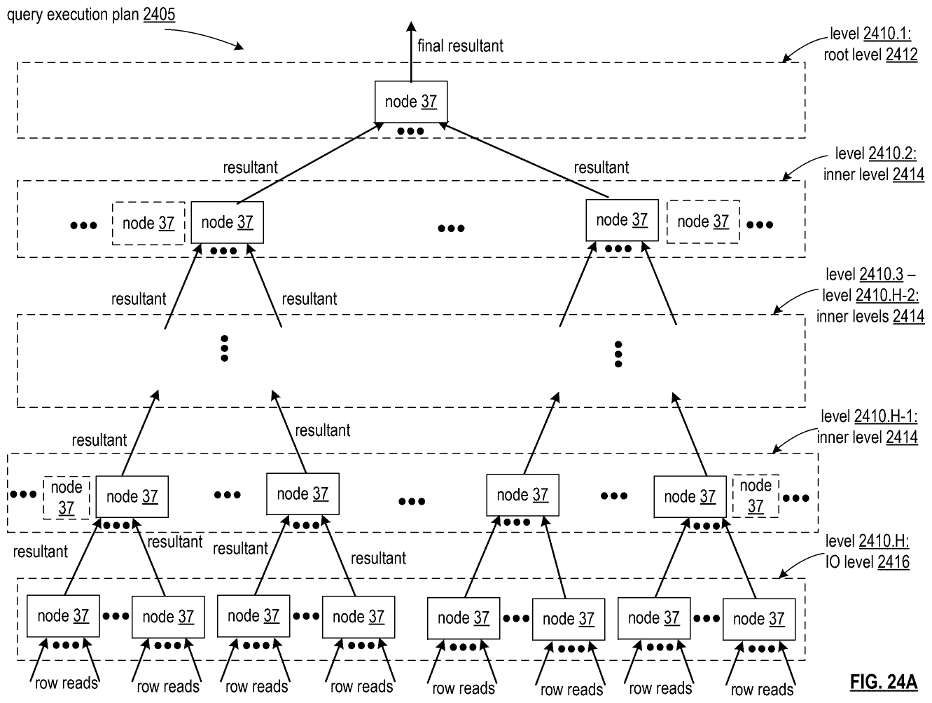

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

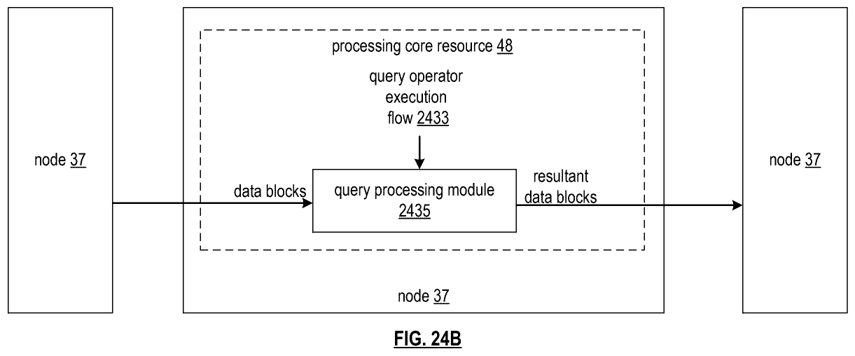

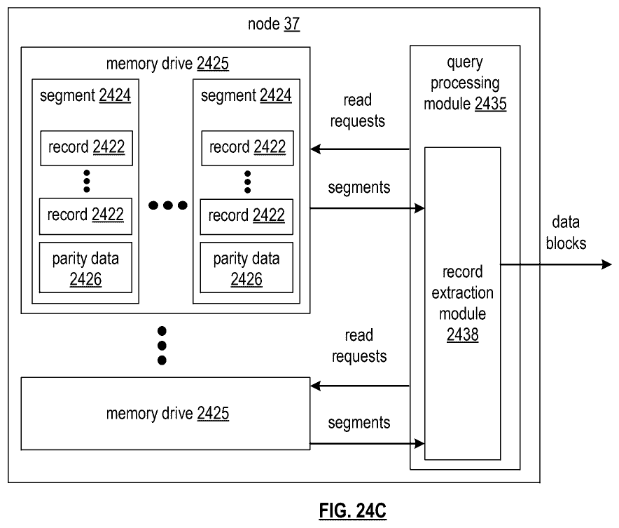

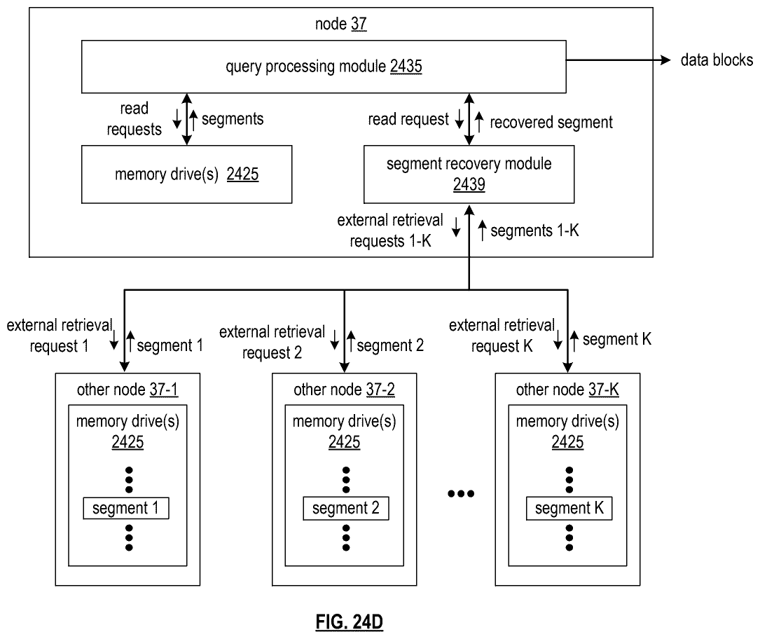

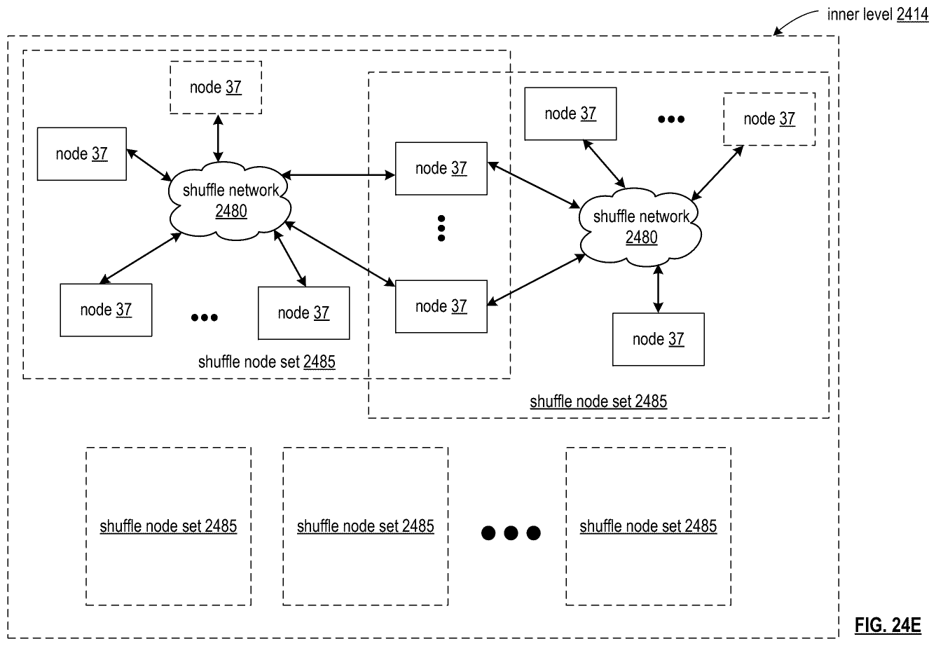

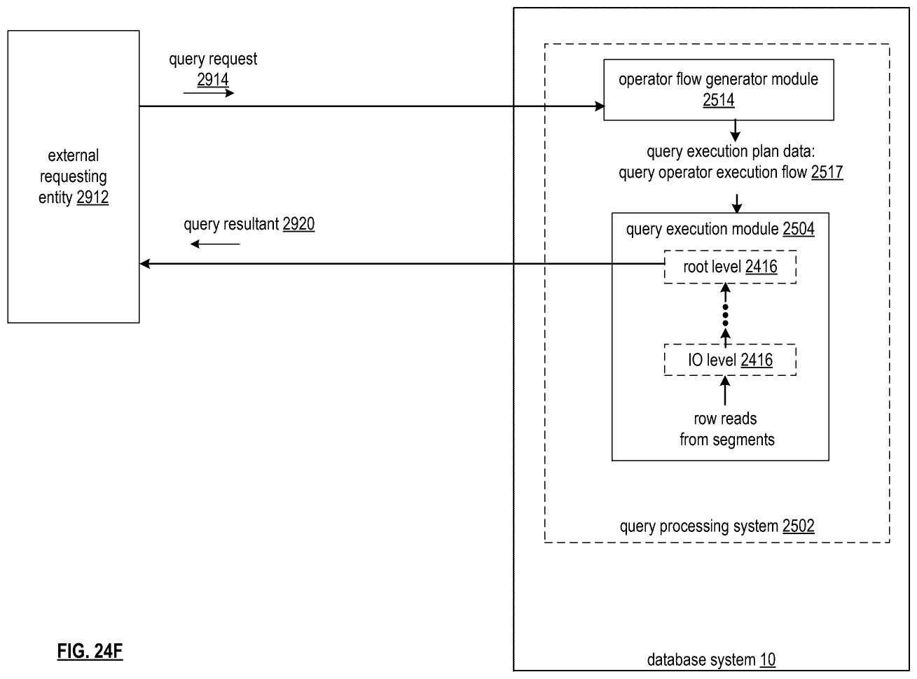

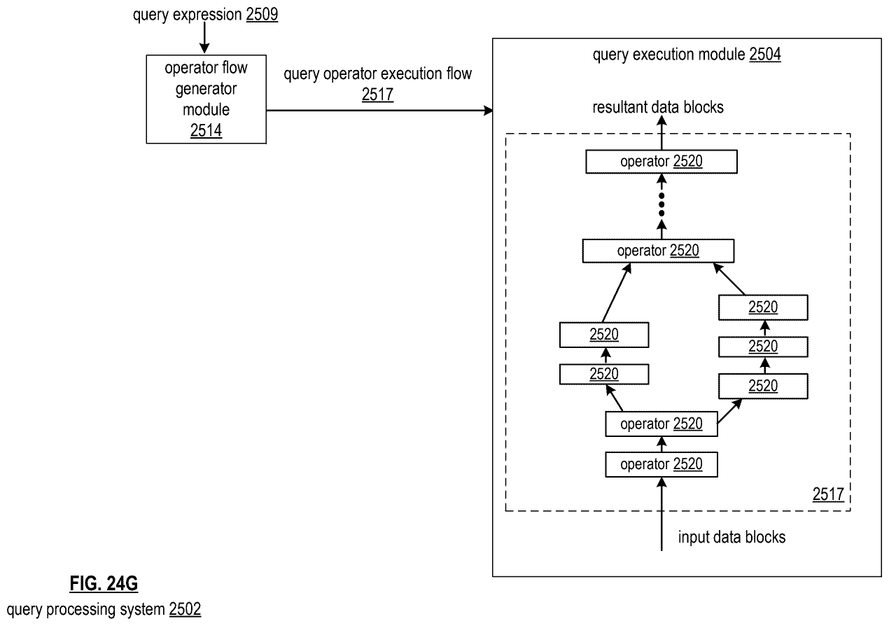

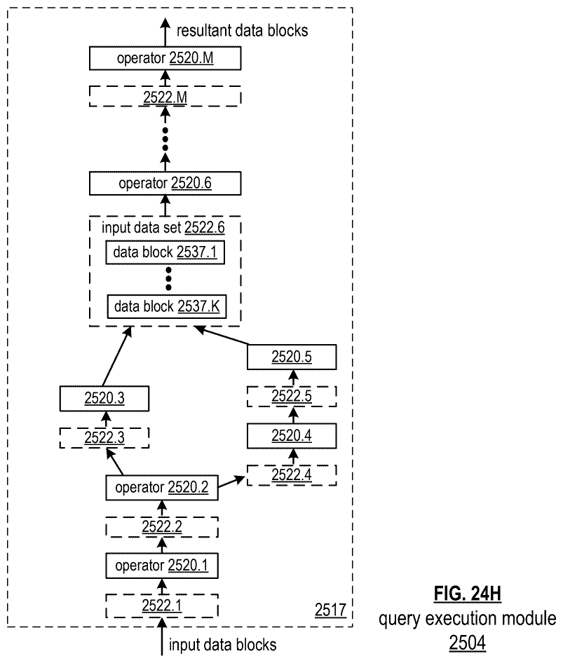

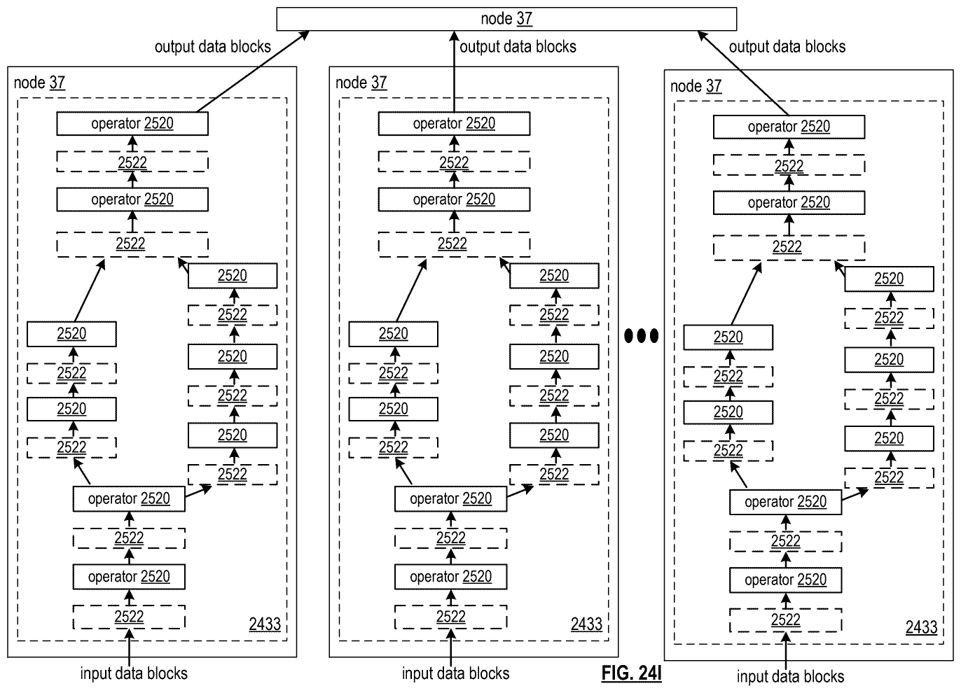

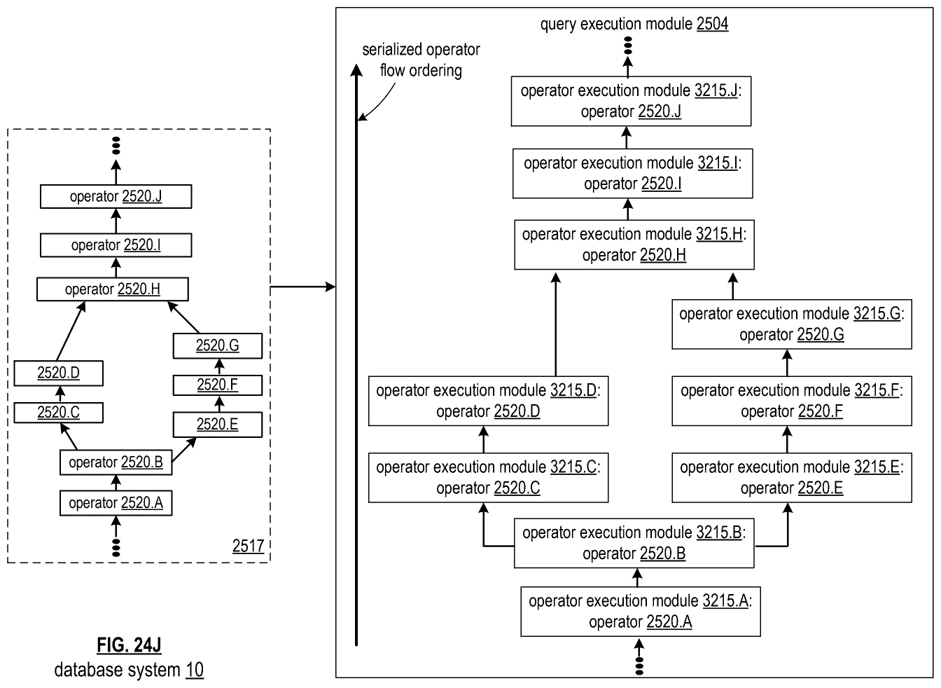

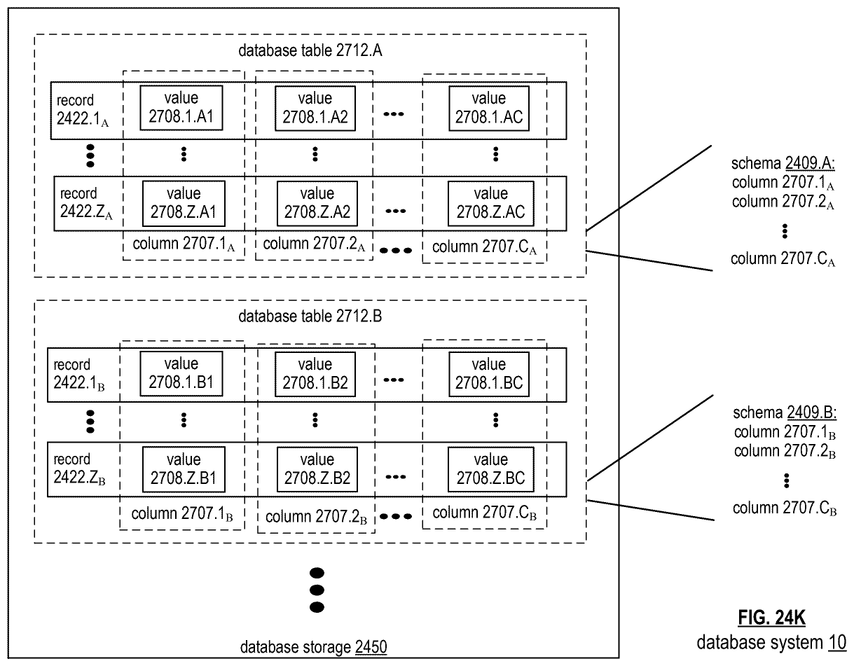

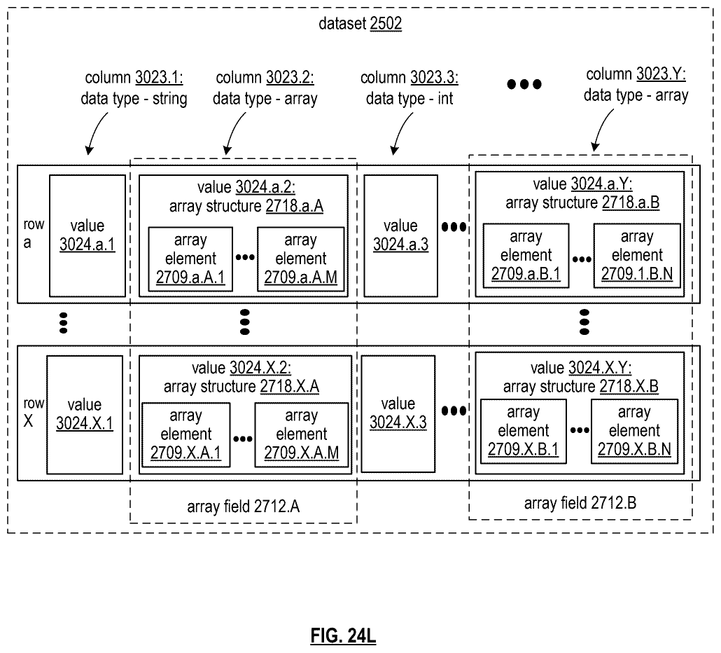

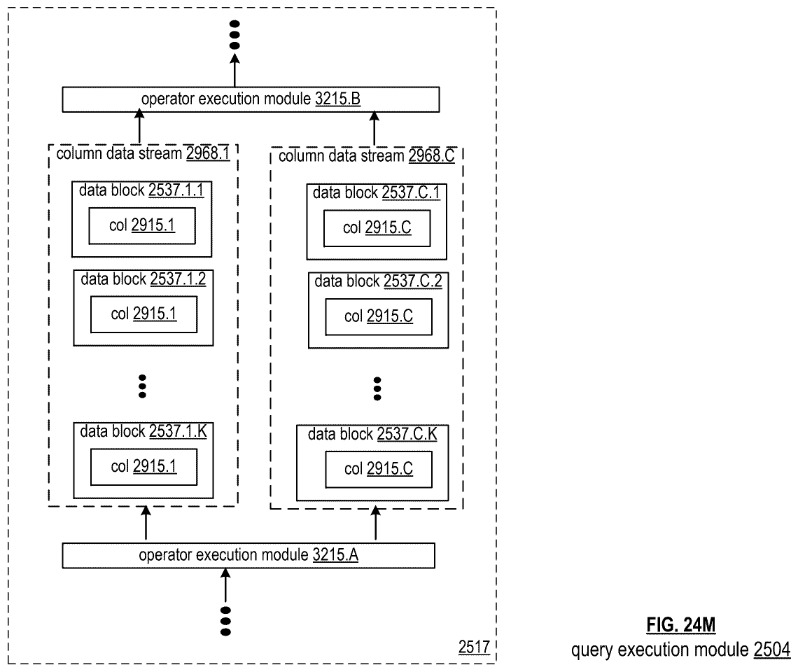

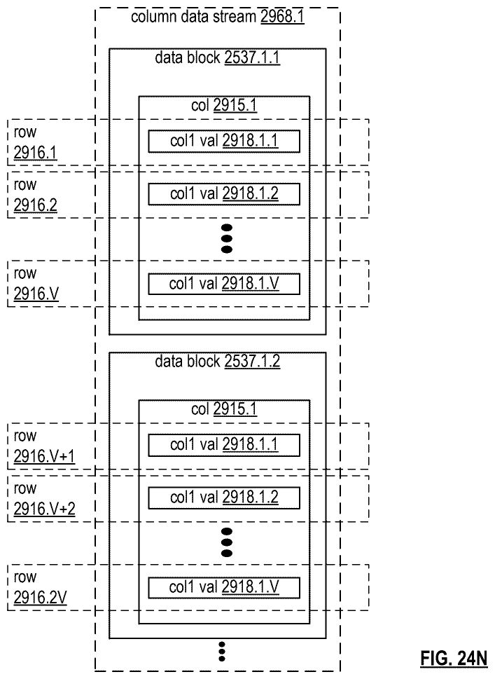

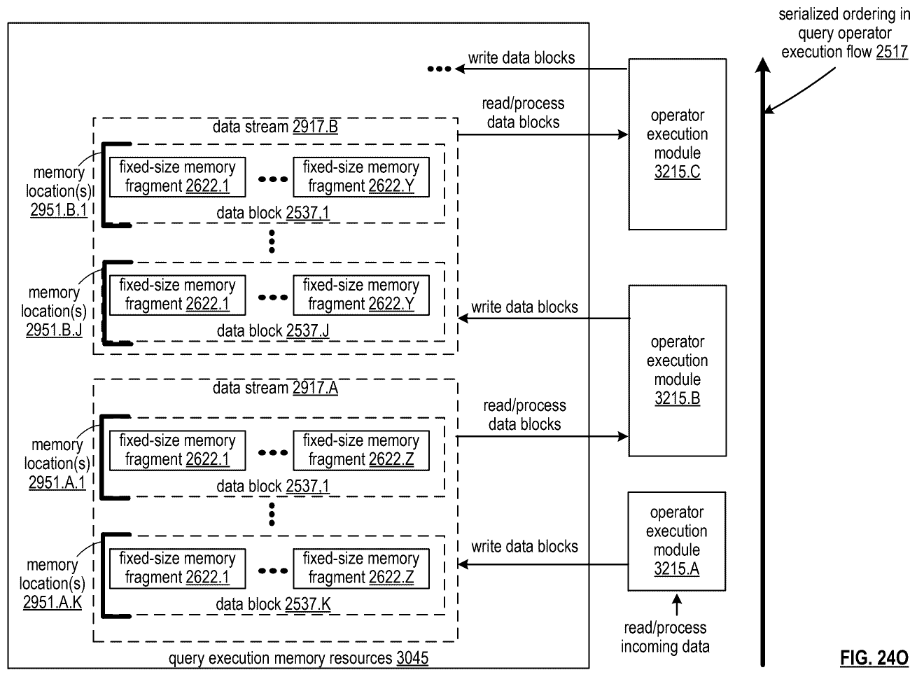

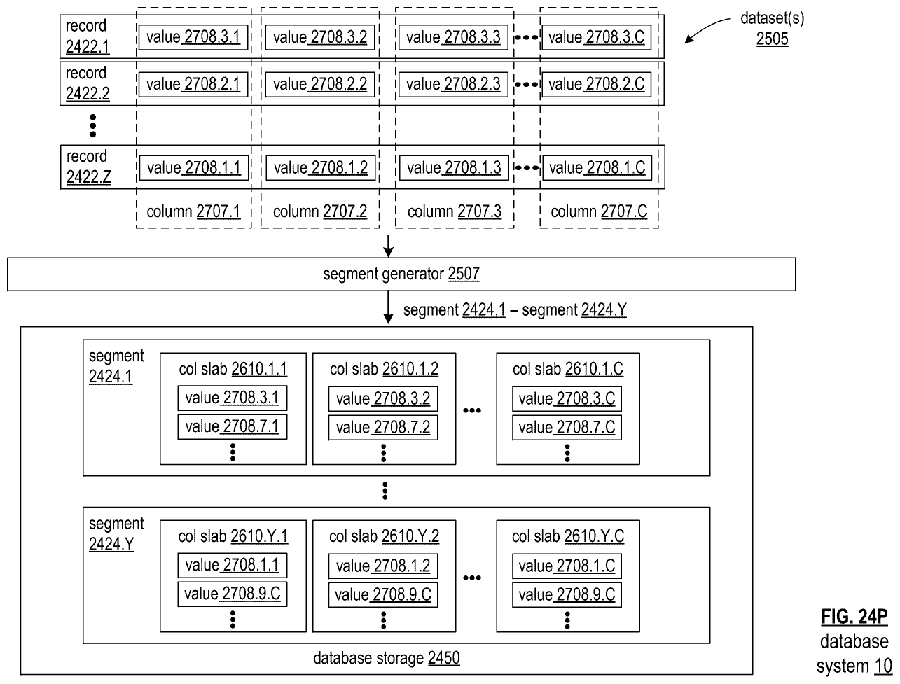

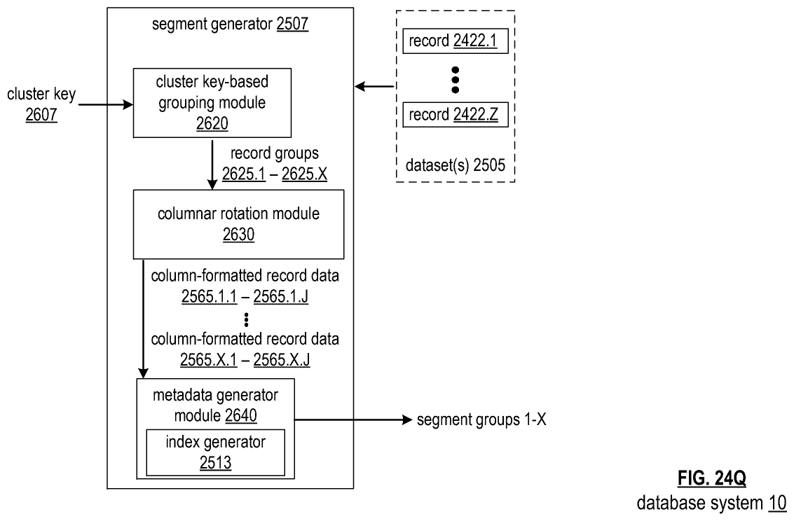

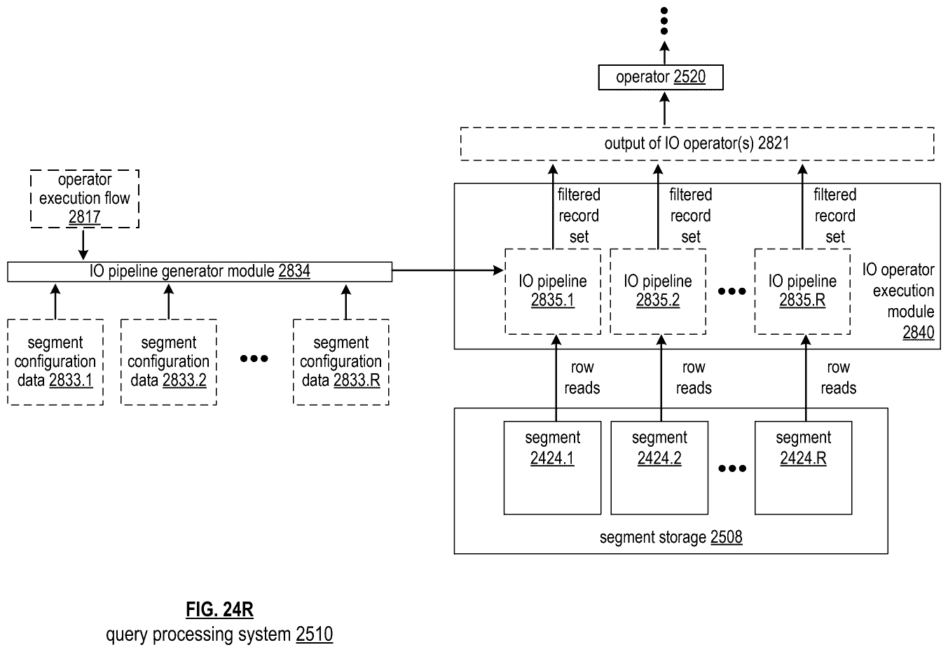

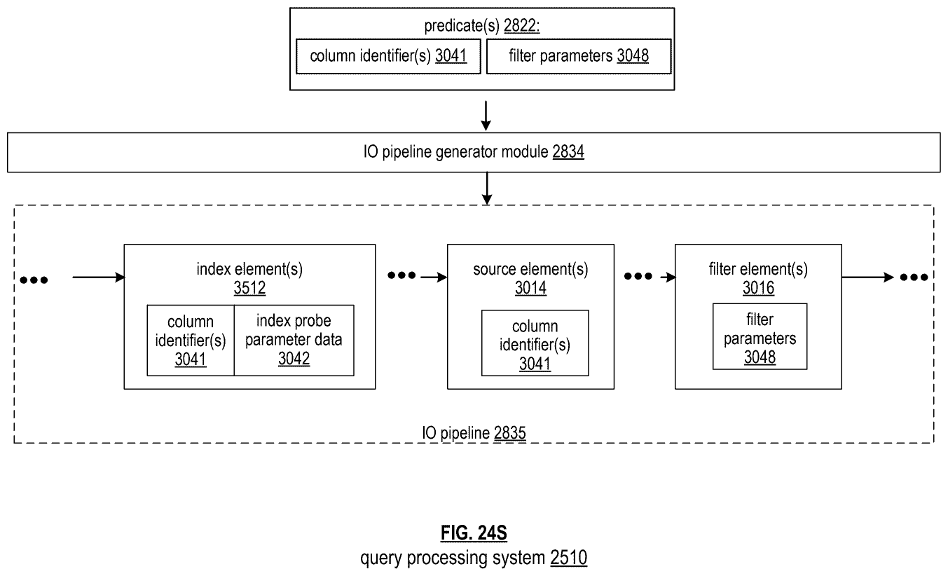

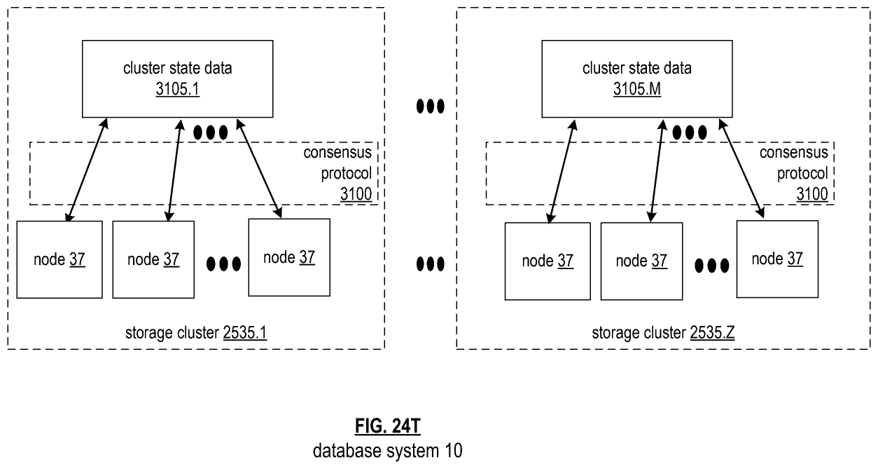

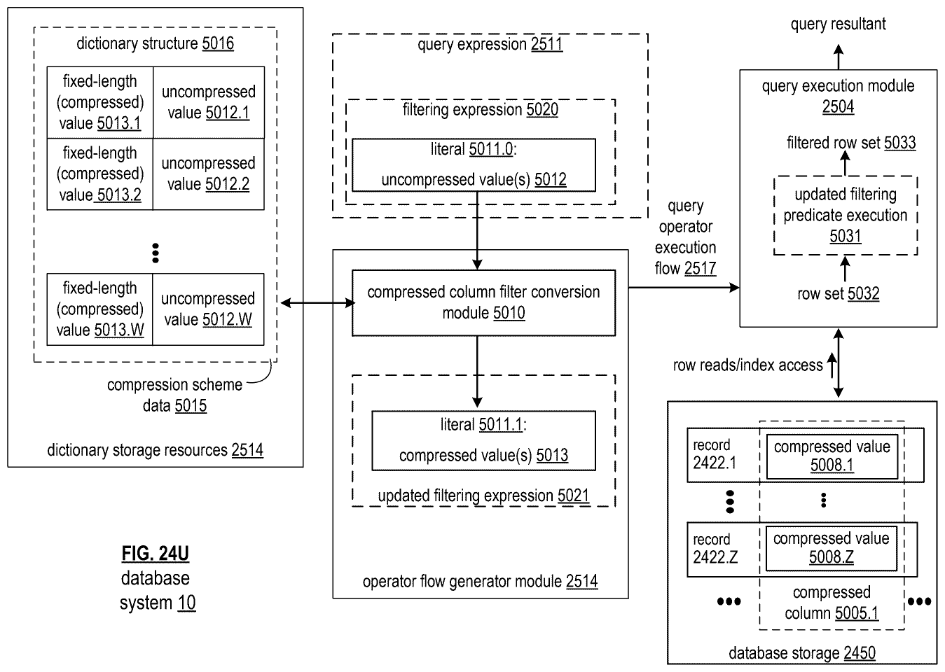

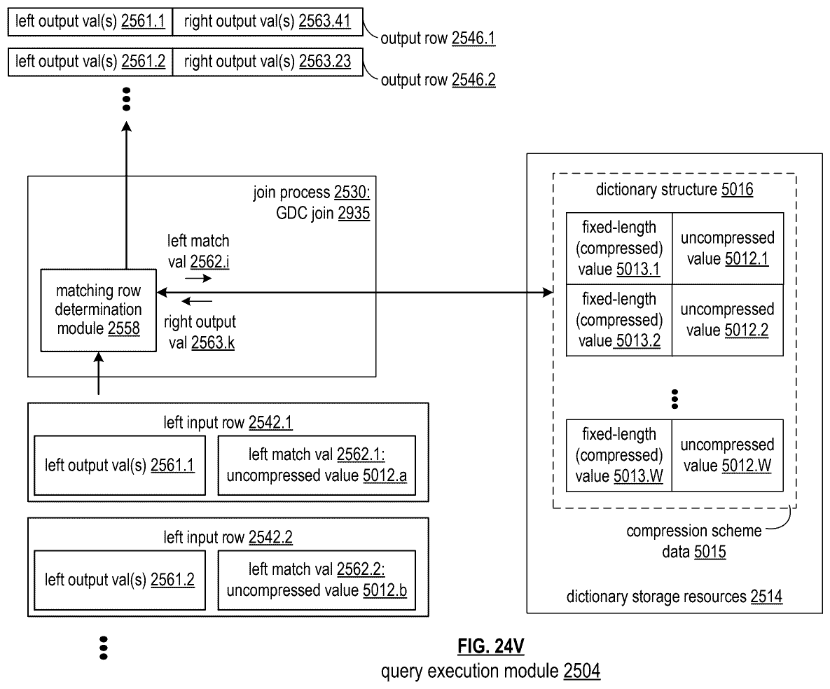

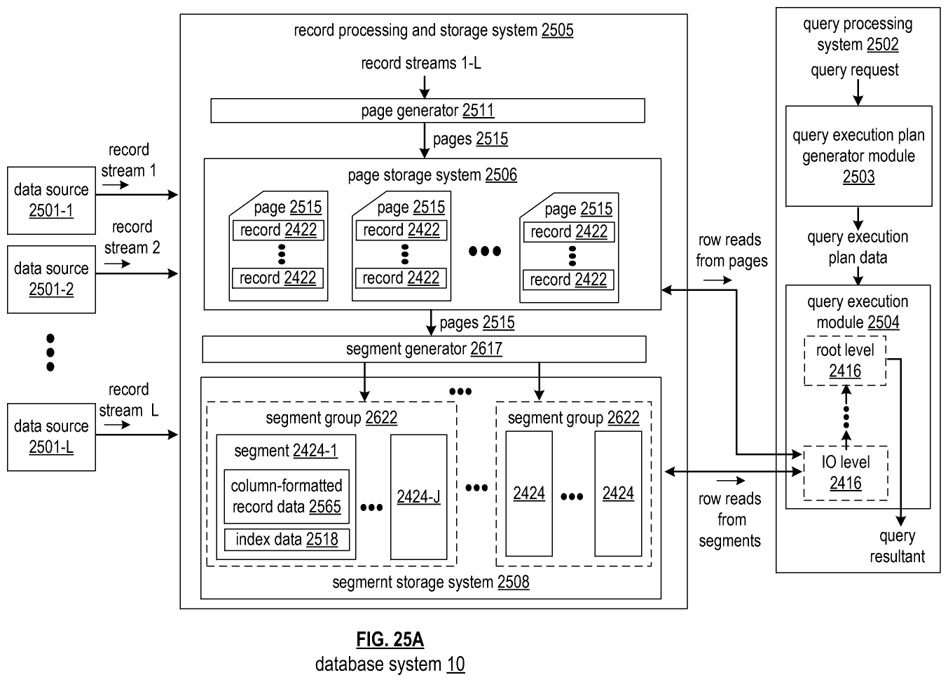

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412: a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H-1, and there are no other inner levels 2410.3-2410.H-2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H-1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H-1 includes at least one node from the IO level 2416 in the possible set of nodes. In such cases, while each selected node in level 2410.H-1 is depicted to process resultants sent from other nodes 37 in FIG. 24A, each selected node in level 2410.H-1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata applied across a plurality of nodes 37, for example, where at least one node 37 participates in some or all features and/or functionality of FIG. 24A based on receiving and storing the system metadata in local memory of the at least one node 37 as configuration data and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of a node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433. In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

Some or all features and/or functionality of FIG. 24B can be performed via a corresponding node 37 in conjunction with system metadata applied across a plurality of nodes 37 that includes the given node, for example, where the given node 37 participates in some or all features and/or functionality of FIG. 24B based on receiving and storing the system metadata in local memory of given node 37 as configuration data and/or based on further accessing and/or executing this configuration data to process data blocks via a query processing module as part of its database functionality accordingly. Performance of some or all features and/or functionality of FIG. 24B can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

Some or all features and/or functionality of FIG. 24C can be performed via a corresponding node 37 in conjunction with system metadata applied across a plurality of nodes 37 that includes the given node, for example, where the given node 37 participates in some or all features and/or functionality of FIG. 24C based on receiving and storing the system metadata in local memory of given node 37 as configuration data and/or based on further accessing and/or executing this configuration data to read segments and/or extract rows from segments via a query processing module as part of its database functionality accordingly. Performance of some or all features and/or functionality of FIG. 24C can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

Some or all features and/or functionality of FIG. 24D can be performed via a corresponding node 37 in conjunction with system metadata applied across a plurality of nodes 37 that includes the given node, for example, where the given node 37 participates in some or all features and/or functionality of FIG. 24D based on receiving and storing the system metadata in local memory of given node 37 as configuration data and/or based on further accessing and/or executing this configuration data to recover segments via external retrieval requests and performing a rebuilding process upon corresponding segments as part of its database functionality accordingly. Performance of some or all features and/or functionality of FIG. 24D can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level, but are not participating in a query at that given time, as denoted with dashed outlines and as discussed in conjunction with FIG. 24A.

For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were access in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node, and can be nodes participating in the query execution plan of the given query and/or can be nodes that are not participating in the query execution plan of the given query.

Some or all features and/or functionality of FIG. 24E can be performed via at least one node 37 in conjunction with system metadata applied across a plurality of nodes 37, for example, where at least one node 37 participates in some or all features and/or functionality of FIG. 24E based on receiving and storing the system metadata in local memory of the at least one node 37 as configuration data and/or based on further accessing and/or executing this configuration data to participate in one or more shuffle node sets of FIG. 24E as part of its database functionality accordingly. Performance of some or all features and/or functionality of FIG. 24E can optionally change and/or be updated over time, and/or a set of nodes participating in executing some or all features and/or functionality of FIG. 24E can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2914. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2914 for execution via the database system 10, where the corresponding query resultant 2920 is transmitted back to the computing device, for example, for storage by the computing device and/or for display to the corresponding user via a display device.

As another example, a query is automatically generated for execution via processing resources via a computing device and/or via communication with an external requesting entity implemented via at least one computing device. For example, the query is automatically generated and/or modified from a request generated via user input and/or received from a requesting entity in conjunction with implementing a query generator system, a query optimizer, generative artificial intelligence (AI), and/or other artificial intelligence and/or machine learning techniques. The computing device generates and transmits a corresponding query request 2914 for execution via the database system 10, where the corresponding query resultant 2920 is transmitted back to the computing device, for example, for storage by the computing device, transmission to another system, and/or for display to at least one corresponding user via a display device.

Some or all features and/or functionality of FIG. 24F can be performed via at least one node 37 in conjunction with system metadata applied across a plurality of nodes 37, for example, where at least one node 37 participates in some or all features and/or functionality of FIG. 24F based on receiving and storing the system metadata in local memory of the at least one node 37 as configuration data, and/or based on further accessing and/or executing this configuration data to generate query execution plan data from query requests by implementing some or all of the operator flow generator module 2514 as part of its database functionality accordingly, and/or to participate in one or more query execution plans of a query execution module 2504 as part of its database functionality accordingly. Performance of some or all features and/or functionality of FIG. 24F can optionally change and/or be updated over time, and/or a set of nodes participating in executing some or all features and/or functionality of FIG. 24F can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24G illustrates an embodiment of a query processing system 2502 that generates a query operator execution flow 2517 from a query expression 2509 for execution via a query execution module 2504. The query processing system 2502 can be implemented utilizing, for example, the parallelized query and/or response sub-system 13 and/or the parallelized data store, retrieve, and/or process subsystem 12. The query processing system 2502 can be implemented by utilizing at least one computing device 18, for example, by utilizing at least one central processing module 39 of at least one node 37 utilized to implement the query processing system 2502. The query processing system 2502 can be implemented utilizing any processing module and/or memory of the database system 10, for example, communicating with the database system 10 via system communication resources 14.

As illustrated in FIG. 24G, an operator flow generator module 2514 of the query processing system 2502 can be utilized to generate a query operator execution flow 2517 for the query indicated in a query expression 2509. This can be generated based on a plurality of query operators indicated in the query expression and their respective sequential, parallelized, and/or nested ordering in the query expression, and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by perform a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2502 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output data blocks. The query execution module 2504 can be utilized to implement the parallelized query and results sub-system 13 and/or the parallelized data store, receive and/or process sub-system 12.

Some or all features and/or functionality of FIG. 24G can be performed via at least one node 37 in conjunction with system metadata applied across a plurality of nodes 37, for example, where at least one node 37 participates in some or all features and/or functionality of FIG. 24G based on receiving and storing the system metadata in local memory of the at least one node 37 as configuration data and/or based on further accessing and/or executing this configuration data to generate query execution plan data from query requests by executing some or all operators of a query operator flow 2517 as part of its database functionality accordingly. Performance of some or all features and/or functionality of FIG. 24G can optionally change and/or be updated over time, and/or a set of nodes participating in executing some or all features and/or functionality of FIG. 24G can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMUM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

Some or all features and/or functionality of FIG. 24H can be performed via at least one node 37 in conjunction with system metadata applied across a plurality of nodes 37, for example, where at least one node 37 participates in some or all features and/or functionality of FIG. 24H based on receiving and storing the system metadata in local memory of the at least one node 37 as configuration data and/or based on further accessing and/or executing this configuration data execute some or all operators of a query operator flow 2517 as part of its database functionality accordingly. Performance of some or all features and/or functionality of FIG. 24H can optionally change and/or be updated over time, and/or a set of nodes participating in executing some or all features and/or functionality of FIG. 24H can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

Some or all features and/or functionality of FIG. 24I can be performed via at least one node 37 in conjunction with system metadata applied across a plurality of nodes 37, for example, where at least one node 37 participates in some or all features and/or functionality of FIG. 24I based on receiving and storing the system metadata in local memory of the at least one node 37 as configuration data and/or based on further accessing and/or executing this configuration data to execute some or all operators of a query operator flow 2517 in parallel with other nodes, send data blocks to a parent node, and/or process data blocks from child nodes as part of its database functionality accordingly. Performance of some or all features and/or functionality of FIG. 24I can optionally change and/or be updated over time, and/or a set of nodes participating in executing some or all features and/or functionality of FIG. 24I can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 24J can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1_{A}-2707.C_{A} of schema 2709.A for database table 2712.A can have a different number of columns than and/or can have different datatypes for some or all columns of the set of columns 2707.1_{B}-2707.C_{B} of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIG. 24L illustrates an embodiment of a dataset 2502 having one or more columns 3023 implemented as array fields 2712. Some or all features and/or functionality of the dataset 2502 of FIG. 24L can be utilized to implement one or more of the database tables 2712 of FIG. 24K and/or any embodiment of any database table and/or dataset received, stored, and processed via the database system 10 as described herein.

Columns 3023 implemented as array fields 2712 can include array structures 2718 as values 3024 for some or all rows. A given array structure 2718 can have a set of elements 2709.1-2709.M. The value of M can be fixed for a given array field 2712, or can be different for different array structures 2718 of a given array field 2712. In embodiments where the number of elements is fixed, different array fields 2712 can have different fixed numbers of array elements 2709, for example, where a first array field 2712.A has array structures having M elements, and where a second array field 2712.B has array structures having N elements.

Note that a given array structure 2718 of a given array field can optionally have zero elements, where such array structures are considered as empty arrays satisfying the empty array condition. An empty array structure 2718 is distinct from a null value 3852, as it is a defined structure as an array 2718, despite not being populated with any values. For example, consider an example where an array field for rows corresponding to people is implemented to note a list of spouse names for all marriages of each person. An empty array for this array field for a first given row denotes a first corresponding person was never married, while a null value for this array field for a second given row denotes that it is unknown as to whether the second corresponding person was ever married, or who they were married to.

Array elements 2709 of a given array structure can have the same or different data type. In some embodiments, data types of array elements 2709 can be fixed for a given array field (e.g. all array elements 2709 of all array structures 2718 of array field 2712.A are string values, and all array elements 2709 of all array structures 2718 of array field 2712.B are integer values). In other embodiments, data types of array elements 2709 can be different for a given array field and/or a given array structure.

Some array structures 2718 that are non-empty can have one or more array elements having the null value 3852, where the corresponding value 3024 thus meets the null-inclusive array condition. This is distinct from the null value condition 3842, as the value 3024 itself is not null, but is instead an array structure 2718 having some or all of its array elements 2709 with values of null. Continuing example where an array field for rows corresponding to people is implemented to note a list of spouse names for all marriages of each person, a null value for this array field for the second given row denotes that it is unknown as to whether the second corresponding person was ever married or who they were married to, while a null value within an array structure for a third given row denotes that the name of the spouse for a corresponding one of a set of marriages of the person is unknown.

Some array structures 2718 that are non-empty can have all non-null values for its array elements 2709, where all corresponding array elements 2709 were populated and/or defined. Some array structures 2718 that are non-empty can have values for some of its array elements 2709 that are null, and values for others of its array elements 2709 that are non-null values.

Some array structures 2718 that are non-empty can have values for all of its array elements 2709 that are null. This is still distinct from the case where the value 3024 denotes a value of null with no array structure 2718. Continuing example where an array field for rows corresponding to people is implemented to note a list of spouse names for all marriages of each person, a null value for this array field for the second given row denotes that it is unknown as to whether the second corresponding person was ever married, how many times they were married or who they were married to, while the array structure for the third given row denotes a set of three null values and non-null values, denoting that the person was married three times, but the names of the spouses for all three marriages are unknown.

FIGS. 24M-24N illustrates an example embodiment of a query execution module 2504 of a database system 10 that executes queries via generation, storage, and/or communication of a plurality of column data streams 2968 corresponding to a plurality of columns. Some or all features and/or functionality of query execution module 2504 of FIGS. 24M-24N can implement any embodiment of query execution module 2504 described herein and/or any performance of query execution described herein. Some or all features and/or functionality of column data streams 2968 of FIGS. 24M-24N can implement any embodiment of data blocks 2537 and/or other communication of data between operators 2520 of a query operator execution flow 2517 when executed by a query execution module 2504, for example, via a corresponding plurality of operator execution modules 3215.

As illustrated in FIG. 24M, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24N, each data block 2537 of a given column data stream 2968 can include values 2918 for the respective column for one or more corresponding rows 2916. In the example of FIG. 24N, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding IO operators. Alternatively or in addition, a given column 2915 can be implemented as a column 2707 having new and/or modified values generated during query execution, for example, via execution of an extend expression and/or other operation. Alternatively or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows across for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

In other embodiments, rather than emitting data blocks with values 2918 for different columns in different column streams, values 2918 for a set of multiple columns can be emitted in a same multi-column data stream.

FIG. 24O illustrates an example of operator execution modules 3215.C that each write their output memory blocks to one or more memory fragments 2622 of query execution memory resources 3045 and/or that each read/process input data blocks based on accessing the one or more memory fragments 2622 Some or all features and/or functionality of the operator execution modules 3215 of FIG. 24O can implement the operator execution modules of FIG. 24J and/or can implement any query execution described herein. The data blocks 2537 can implement the data blocks of column streams of FIGS. 24M and/or 24N, and/or any operator 2520's input data blocks and/or output data blocks described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2917.A to contiguous or non-contiguous memory fragments 2622 at one or more corresponding memory locations 2951 of query execution memory resources 3045.

Operator execution module 3215.A can generate these data blocks 2537.1-2537.K of data stream 2917.A in conjunction with execution of the respective operator on incoming data. This incoming data can correspond to one or more other streams of data blocks 2537 of another data stream 2917 accessed in memory resources 3045 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2917.B based on execution of the respective operator upon data blocks 2537.1-2537.K of data stream 2917.A. Executing the operator can include reading the values from and/or performing operations toy filter, aggregate, manipulate, generate new column values from, and/or otherwise determine values that are written to data blocks 2537.1-2537.J.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to access and read the values from forwarded streams.

In the case where operator execution module 3215.A has multiple parents, the data blocks 2537.1-2537.K of data stream 2917.A can be read, forwarded, and/or otherwise processed by each parent operator execution module 3215 independently in a same or similar fashion. Alternatively or in addition, in the case where operator execution module 3215.B has multiple children, each child's emitted set of data blocks 2537 of a respective data stream 2917 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2917.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2917.A and/or the operator execution module 3215.B writes data blocks 2537.1-2537.J of data stream 2917.B. As another example, the operator execution module 3215.C reads data blocks 2537.1-2537.K of data stream 2917.A, or data blocks of another descendent, based on having been forwarded, where corresponding memory reference information denoting the location of these data blocks is read and processed from the received data blocks data blocks 2537.1-2537.J of data stream 2917.B enable accessing the values from data blocks 2537.1-2537.K of data stream 2917.A. As another example, the operator execution module 3215.B does not read the values from these data blocks, and instead forwards these data blocks, for example, where data blocks 2537.1-2537.J include memory reference data for the data blocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

For example, rather than accessing this large data for some or all potential records prior to filtering in a query execution, for example, via IO level 2416 of a corresponding query execution plan 2405 as illustrated in FIGS. 24A and 24C, and/or rather than passing this large data to other nodes 37 for processing, for example, from IO level nodes 37 to inner level nodes 37 and/or between any nodes 37 as illustrated in FIGS. 24A, 24B, and 24C, this large data is not accessed until a final stage of a query. As a particular example, this large data of the projected field is simply joined at the end of the query for the corresponding outputted rows that meet query predicates of the query. This ensures that, rather than accessing and/or passing the large data of these fields for some or all possible records that may be projected in the resultant, only the large data of these fields for final, filtered set of records that meet the query predicates are accessed and projected.

FIG. 24P illustrates an embodiment of a database system 10 that implements a segment generator 2507 to generate segments 2424. Some or all features and/or functionality of the database system 10 of FIG. 24P can implement any embodiment of the database system 10 described herein. Some or all features and/or functionality of segments 2424 of FIG. 24P can implement any embodiment of segment 2424 described herein.

A plurality of records 2422.1-2422.Z of one or more datasets 2505 to be converted into segments can be processed to generate a corresponding plurality of segments 2424.1-2424. Y. Each segment can include a plurality of column slabs 2610.1-2610.C corresponding to some or all of the C columns of the set of records.

In some embodiments, the dataset 2505 can correspond to a given database table 2712. In some embodiments, the dataset 2505 can correspond to only portion of a given database table 2712 (e.g. the most recently received set of records of a stream of records received for the table over time), where other datasets 2505 are later processed to generate new segments as more records are received over time. In some embodiments, the dataset 2505 can correspond to multiple database tables. The dataset 2505 optionally includes non-relational records and/or any records/files/data that is received from/generated by a given data source multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24Q illustrates an example embodiment of a segment generator 2507 of database system 10. Some or all features and/or functionality of the database system 10 of FIG. 24Q can implement any embodiment of the database system 10 described herein. Some or all features and/or functionality of the segment generator 2507 of FIG. 24Q can implement the segment generator 2507 of FIG. 24P and/or any embodiment of the segment generator 2507 described herein.

The segment generator 2507 can implement a cluster key-based grouping module 2620 to group records of a dataset 2505 by a predetermined cluster key 2607, which can correspond to one or more columns. The cluster key can be received, accessed in memory, configured via user input, automatically selected based on an optimization, or otherwise determined. This grouping by cluster key can render generation of a plurality of record groups 2625.1-2625.X.

The segment generator 2507 can implement a columnar rotation module 2630 to generate a plurality of column formatted record data (e.g. column slabs 2610 to be included in respective segments 2424). Each record group 2625 can have a corresponding set of J column-formatted record data 2565.1-2565.J generated, for example, corresponding to J segments in a given segment group.

A metadata generator module 2640 can further generate parity data, index data, statistical data, and/or other metadata to be included in segments in conjunction with the column-formatted record data. A set of X segment groups corresponding to the X record groups can be generated and stored in database storage 2450. For example, each segment group includes J segments, where parity data of a proper subset of segments in the segment group can be utilized to rebuild column-formatted record data of other segments in the same segment group as discussed previously.

In some embodiments, the segment generator 2507 implements some or all features and/or functionality of the segment generator disclosed by: U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes: U.S. Utility application Ser. No. 16/985,957 entitled “PARALLELIZED SEGMENT GENERATION VIA KEY-BASED SUBDIVISION IN DATABASE SYSTEMS”, filed Aug. 5, 2020, which is hereby incorporated herein by reference in its entirety and made part of the present U.S. Utility Patent Application for all purposes; and/or U.S. Utility application Ser. No. 16/985,930, entitled “RECORD DEDUPLICATION IN DATABASE SYSTEMS”, filed Aug. 5, 2020, issued as U.S. Pat. No. 11,321,288 on May 3, 2022, which is hereby incorporated herein by reference in its entirety and made part of the present U.S. Utility Patent Application for all purposes. For example, the database system 10 implements some or all features and/or functionality of record processing and storage system of U.S. Utility application Ser. No. 16/985,723, U.S. Utility application Ser. No. 16/985,957, and/or U.S. Utility application Ser. No. 16/985,930.

FIG. 24R illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24R can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the column slabs of the segment, or other information denoting how the segment is configured. For example, different segments 2424 have different IO pipelines 2835 generated for a given query based on having different secondary indexing schemes, different statistical data/cardinality data for its values, different compression schemes applied for some of all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24S illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths. These elements can implement sourcing and/or filtering of rows based on query predicates 2822 applied to one or more columns, identified by corresponding column identifiers 3041 and corresponding filter parameters 3048. Some or all features and/or functionality of the IO pipeline 2835 and/or IO pipeline generator module 2834 of FIG. 24S can implement the IO pipeline 2835 and/or IO pipeline generator module 2834 of FIG. 24R, and/or any embodiment of IO pipeline 2835, of IO pipeline generator module 2834, or of any query execution via accessing segments described herein.

In some embodiments, the IO pipeline generator module 2834, IO pipeline 2835, IO operator execution module 2840, and/or any embodiment of IO pipeline generation and/or IO pipeline execution described herein, implements some or all features and/or functionality of the IO pipeline generator module 2834, IO pipeline 2835, IO operator execution module 2840, and/or pushing of filtering and/or other operations to the IO level as disclosed by: U.S. Utility application Ser. No. 17/303,437, entitled “QUERY EXECUTION UTILIZING PROBABILISTIC INDEXING” and filed May 28, 2021: U.S. Utility application Ser. No. 17/450,109, entitled “MISSING DATA-BASED INDEXING IN DATABASE SYSTEMS” and filed Oct. 6, 2021: U.S. Utility application Ser. No. 18/310,177, entitled “OPTIMIZING AN OPERATOR FLOW FOR PERFORMING AGGREGATION VIA A DATABASE SYSTEM” and filed May 1, 2023: U.S. Utility application Ser. No. 18/355,505, entitled “STRUCTURING GEOSPATIAL INDEX DATA FOR ACCESS DURING QUERY EXECUTION VIA A DATABASE SYSTEM” and filed Jul. 20, 2023; and/or U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES” and filed Oct. 12, 2023; all of which hereby incorporated herein by reference in its entirety and made part of the present U.S. Utility Patent Application for all purposes.

FIG. 24T presents an embodiment of a database system 10 that includes a plurality of storage clusters 2535. Storage clusters 2535.1-2535.Z of FIG. 24T can implement some or all features and/or functionality of storage clusters 35-1-35-Z described herein, and/or can implement some or all features and/or functionality of any embodiment of a storage cluster described herein. Some or all features and/or functionality of database system 10 of FIG. 24T can implement any embodiment of database system 10 described herein.

Each storage cluster 2535 can be implemented via a corresponding plurality of nodes 37. In some embodiments, a given node 37 of database system 10 is optionally included in exactly one storage cluster. In some embodiments, one or more nodes 37 of database system 10 are optionally included in no storage clusters (e.g. aren't configured to store segments). In some embodiments, one or more nodes 37 of database system 10 can be included in multiple storage clusters.

In some embodiments, some or all nodes 37 in a storage cluster 2535 participate at the IO level 2416 in query execution plans based on storing segments 2424 in corresponding memory drives 2425, and based on accessing these segments 2424 during query execution. This can include executing corresponding IO operators, for example, via executing an IO pipeline 2835 (and/or multiple IO pipelines 2835, where each IO pipeline is configured for each respective segment 2424). All segments in a given same segment group (e.g. a set of segments collectively storing parity data and/or replicated parts enabling any given segment in the segment group to be rebuilt/accessed as a virtual segment during query execution via access to some or all other segments in the same segment group as described previously) are optionally guaranteed to be stored in a same storage cluster 2535, where segment rebuilds and/or virtual segment use in query execution can thus be facilitated via communication between nodes in a given storage cluster 2535 accordingly, for example, in response to a node failing and/or a segment becoming unavailable.

Each storage cluster 2535 can further mediate cluster state data 3105 in accordance with a consensus protocol mediated via the plurality of nodes 37 of the given storage cluster. Cluster state data 3105 can implement any embodiment of state data and/or system metadata described herein. In some embodiments, cluster state data 3105 can indicate data ownership information indicating ownership of each segments stored by the cluster by exactly one node (e.g. as a physical segment or a virtual segment) to ensure queries are executed correctly via processing rows in each segment (e.g. of a given dataset against which the query is executed) exactly once.

Consensus protocol 3100 can be implemented via the raft consensus protocol and/or any other consensus protocol. Consensus protocol 3100 can be implemented be based on distributing a state machine across a plurality of nodes, ensuring that each node in the cluster agrees upon the same series of state transitions and/or ensuring that each node operates in accordance with the currently agreed upon state transition. Consensus protocol 3100 can implement any embodiment of consensus protocol described herein.

Coordination across different storage clusters 2535 can be minimal and/or non-existent, for example, based on each storage cluster coordinating state data and/or corresponding query execution separately. For example, state data 3105 across different storage clusters is optionally unrelated.

Each storage cluster's nodes 37 can perform various database tasks (e.g. participate in query execution) based on accessing/utilizing the state data 3105 of its given storage cluster, for example, without knowledge of state data of other storage clusters. This can include nodes syncing state data 3105 and/or otherwise utilizing the most recent version of state data 3105, for example, based on receiving updates from a leader node in the cluster, triggering a sync process in response to determining to perform a corresponding task requiring most recent state data, accessing/updating a locally stored copy of the state data, and/or otherwise determining updated state data.

In some embodiments, updating of state data (such as configuration data, system metadata, data shared via a consensus protocol, and/or any other state data described herein), for example, utilized by nodes to perform respective functionality over time, can be performed in conjunction with an event driven model. In some embodiments, such updating of state data over time can be performed in a same or similar fashion as updating of configuration data as disclosed by: U.S. Utility application Ser. No. 18/321,212, entitled COMMUNICATING UPDATES TO SYSTEM METADATA VIA A DATABASE SYSTEM, filed May 22, 2023; and/or U.S. Utility application Ser. No. 18/310,262, entitled “GENERATING A SEGMENT REBUILD PLAN VIA A NODE OF A DATABASE”, filed May 1, 2023; which are hereby incorporated herein by reference in their entirety and made part of the present U.S. Utility Patent Application for all purposes.

In some embodiments, system metadata can be generated and/or updated over time with different corresponding metadata sequence numbers (MSNs). For example, such generation/updating of metadata over time can be implemented via any features and/or functionality of the generation of data ownership information over time with corresponding OSNs as disclosed by U.S. Utility application Ser. No. 16/778,194, entitled “SERVICING CONCURRENT QUERIES VIA VIRTUAL SEGMENT RECOVERY”, filed Jan. 31, 2020, and issued as U.S. Pat. No. 11,061,910 on Jul. 13, 2021, which is hereby incorporated herein by reference in its entirety and made part of the present U.S. Utility Patent Application for all purposes. In some embodiments, the system metadata management system 2702 and/or a corresponding metadata system protocol can be implemented via a consensus protocols mediated via a plurality of nodes, for example, to update system metadata 2710, in a via any features and/or functionality of the execution of consensus protocols mediated via a plurality of nodes as disclosed by this U.S. Utility application Ser. No. 16/778,194. In some embodiments, each version of system metadata 2710 can assign nodes to different tasks and/or functionality via any features and/or functionality of assigning nodes to different segments for access in query execution in different versions of data ownership information as disclosed by this U.S. Utility application Ser. No. 16/778,194. In some embodiments, system metadata indicates a current version of data ownership information, where nodes utilize system metadata and corresponding system configuration data to determine their own ownership of segments for use in query execution accordingly, and/or to execute queries utilizing correct sets of segments accordingly, based on processing the denoted data ownership information as U.S. Utility application Ser. No. 16/778,194.

FIGS. 24U and 24V illustrate embodiments of a database system 10 that utilizes a dictionary structure to store compressed columns. Some or all features and/or functionality of the dictionary structure 5016 of FIGS. 24U and/or 24V can implement any compression scheme data and/or means of generating and/or accessing compressed columns described herein. Any other features and/or functionality of database system 10 of FIG. 24U and/or 24V can implement any other embodiment of database system 10 described herein.

In some embodiments, columns are compressed as compressed columns 5005 based on a globally maintained dictionary (e.g. dictionary structure 5016), for example, in conjunction with applying Global Dictionary Compression (GDC). Applying Global Dictionary Compression can include replaces variable length column values with fixed length integers on disk (e.g. in database storage 2450), where the globally maintained dictionary is stored elsewhere, for example, via different (e.g. slower/less efficient) memory resources of a different type/in a different location from the database storage 2450 that stores the compressed columns 5005 accessed during query execution.

The dictionary structure can store a plurality of fixed-length, compressed values 5013 (e.g. integers) each mapped to a single uncompressed value 5012 (e.g. variable-length values, such as strings). The mapping of compressed values 5013 to uncompressed values 5012 can be in accordance with a one-to-one mapping. The mapping of compressed values 5013 to uncompressed values 5012 can be based on utilizing the fixed-length values 5013 as keys of a corresponding map and/or dictionary data structure, and/or can be based on utilizing the uncompressed values 5012 as keys of a corresponding map and/or dictionary data structure.

A given uncompressed value 5012 that is included in many rows of one or more tables can be replaced (i.e. “compressed”) via a same corresponding compressed value 5013 mapped to this uncompressed value 5012 as the compressed value 5008 for these rows in compressed column 5005 in database storage. As new rows are received for storage over time, their column values for one or more compressed columns 5005 can be replaced via corresponding compressed values 5008 based on accessing the dictionary structure and determining whether the uncompressed value 5012 of this column is stored in the dictionary structure 5016. If yes, the compressed value 5013 mapped to the uncompressed value 5012 in this existing entry is stored as compressed value 5008 in the compressed column 5005 in the database storage 2450. If no, the dictionary structure 5016 can be updated to include a new entry that includes the uncompressed value 5012 and a new compressed value 5013 (e.g. different from all existing compressed values in the structure) generated for this uncompressed value 5012, where this new compressed value 5013 is stored as is applied as compressed value 5008 in the database storage 2450.

The dictionary structure 5016 can be stored in dictionary storage resources 2514, which can be different types of resources from and/or can be stored in a different location from the database storage 2450 storing the compressed columns for query execution. In some embodiments, the dictionary storage resources 2514 storing dictionary structure 5016 can be considered a portion/type of memory as of database storage 2450 that are accessed during query execution as necessary for decompressing column values. In some embodiments, the dictionary storage resources 2514 storing dictionary structure 5016 can be implemented as metadata storage resources, for example, implemented by a metadata consensus state mediated via a metadata storage cluster of nodes maintaining system metadata such as GDCs of the database system 10.

The dictionary structure 5016 can correspond to a given column 5005, where different columns optionally have their own dictionary structure 5016 build and maintained. Alternatively, a common dictionary structure 5016 can optionally be maintained for multiple columns of a same table/same dataset, and/or for multiple columns across different tables/different datasets. For example, a given uncompressed value 5012 appearing in different columns 5005 of the same or different table is compressed via the same fixed-length value 5013 as dictated by the dictionary structure 5016.

This dictionary structure 5016 can be globally maintained (e.g. across some or all nodes, indicating fixed length values mapped across one or more segments stored in conjunction with storing one or more relational database tables) and can be updated overtime (e.g. as more data is added with new variable length values requiring mapping to fixed length values). For example, the dictionary structure 5016 is maintained/stored in state data that is mediated/accessible by some or all nodes 37 of the database system 10 via the dictionary structure 5016 being included in any embodiment of state data described herein.

In some embodiments, dictionary compression via dictionary structure 5016 can implement the compression scheme utilized to generate (e.g. compress/decompress the values of) compressed columns 5005 of FIG. 24U based on implementing some or all features and/or functionality of the compression of data during ingress via a dictionary as disclosed by U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes.

In some embodiments, dictionary compression via dictionary structure 5016 can implement the compression scheme utilized to generate (e.g. compress/decompress the values of) compressed columns 5005 of FIG. 24U based on implementing some or all features and/or functionality of global dictionary compression as disclosed by U.S. Utility application Ser. No. 16/220,454, entitled “DATA SET COMPRESSION WITHIN A DATABASE SYSTEM”, filed Dec. 14, 2018, issued as U.S. Pat. No. 11,256,696 on Feb. 22, 2022, which is hereby incorporated herein by reference in its entirety and made part of the present U.S. Utility Patent Application for all purposes.

In some embodiments, dictionary compression via dictionary structure 5016 can be utilized in performing GDC join processes during query execution to enable recovery of uncompressed values during query execution, for example, based on implementing some or all features and/or functionality of GDC joins as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility Patent Application for all purposes.

FIG. 24U illustrates an embodiment of database system 10 where a compressed column filter conversion module 5010 accesses a dictionary structure 5016 to generate an updated filtering expression 5021 in conjunction with query execution.

The compressed column filter conversion module 5010 can generate updated filtering expression 5021 based on updating one or more literals 5011.1 from corresponding literals 5011.0 based on replacing uncompressed values 5012 with compressed values 5013 mapped to these compressed values based on accessing dictionary structure 5016 and determining which fixed-length compressed value 5013 is mapped to each given uncompressed value 5012. Such functionality can be implemented for one or more queries executed by database system 10 to reduce access to the dictionary structure during query execution in conjunction with performing one or more optimizations of the query operator execution flow to improve query performance.

FIG. 24V illustrates an embodiment of executing a join process 2530 that is implemented as a global dictionary compression (GDC) join. This can include applying a matching row determination module 2558 via access to a dictionary structure 5016,

In some embodiments, unlike hash maps generated during query execution for access in conjunction with executing other types of JOIN operations (e.g. as described in U.S. Utility application Ser. No. 18/266,525), the dictionary structure 5016 can optionally be accessed during GDC join processes based on being globally maintained, and thus being generated prior to execution of the corresponding query. In particular, the dictionary structure 5016 can be implemented in conjunction with compressing one or more columns, such as a variable length values stored in one or more variable length columns, by mapping these variable length, uncompressed values (e.g. strings, other large values of a given column) to corresponding fixed-length, compressed values 5013 (e.g. integers or other fixed length values).

For example, segments can store the fixed length values to improve storage efficiency and/or queries can access and process these fixed length values, where the uncompressed variable length values are only required via access to dictionary structure 5016 to emit an uncompressed value 5012 for a given fixed-length value 5013 of a given input row. This functionality can be achieved via performing a corresponding join as described herein, where the matching condition 2519 is implemented for a compressed column and indicates matching by the value of the compressed column, such as simply emitting the uncompressed value mapped to the compressed column as the right output value 2563 for a given input row, implemented as a left input row 2542 of a join operation.

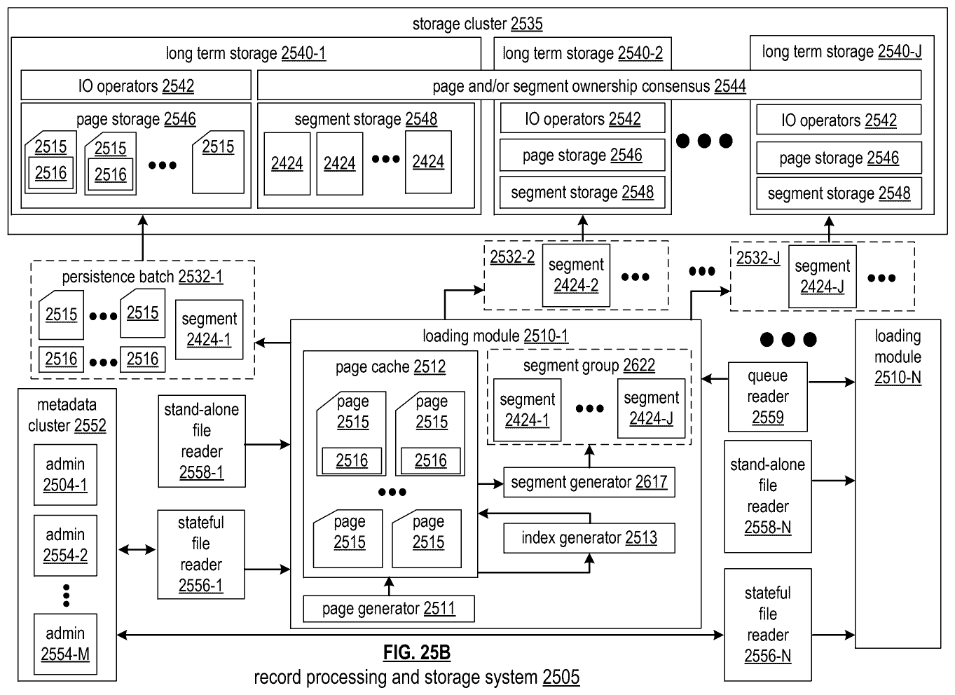

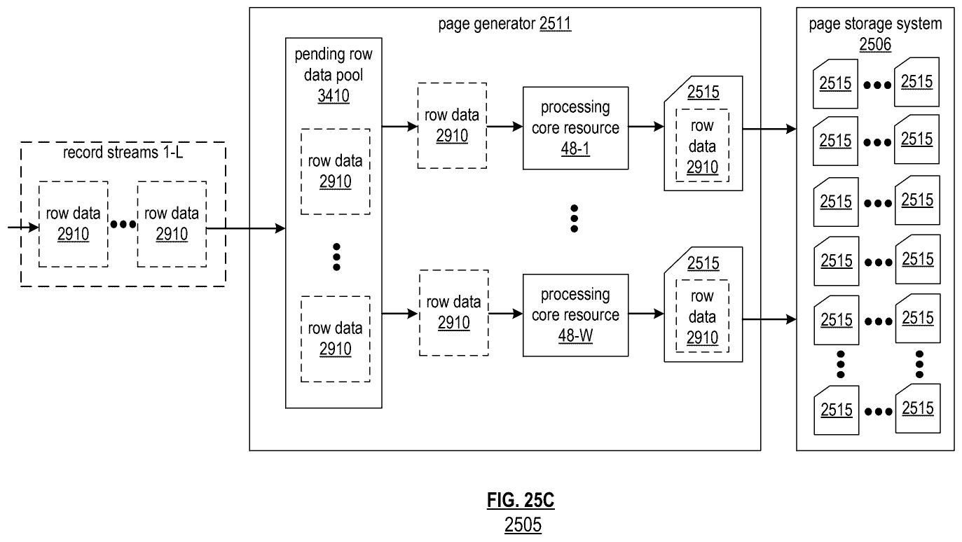

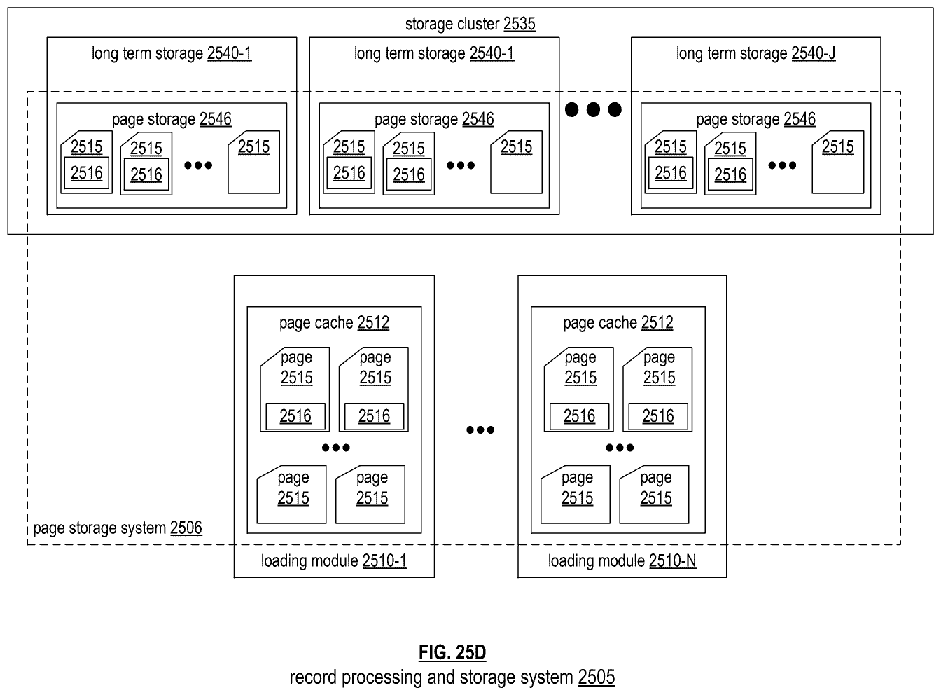

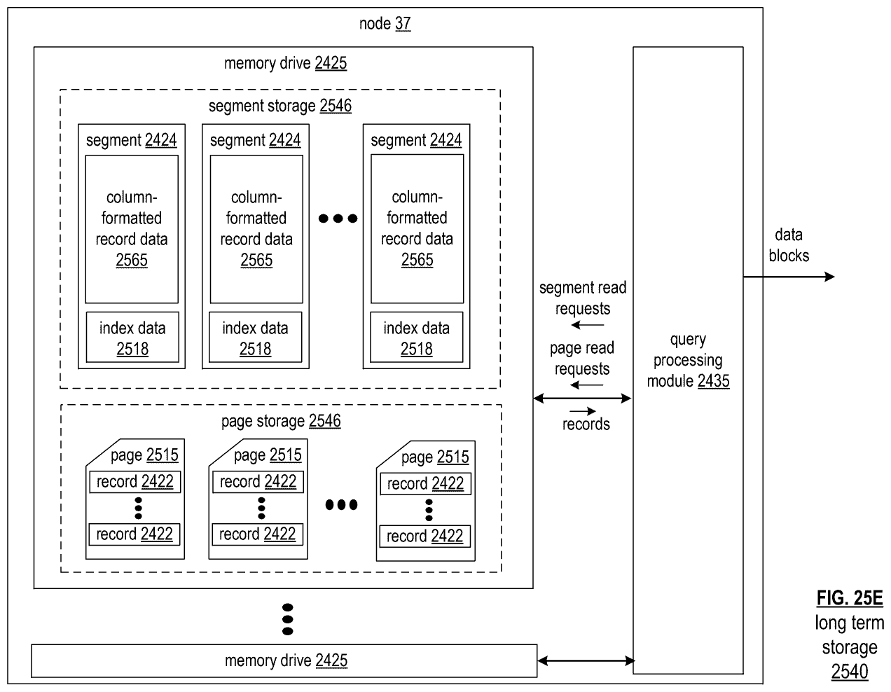

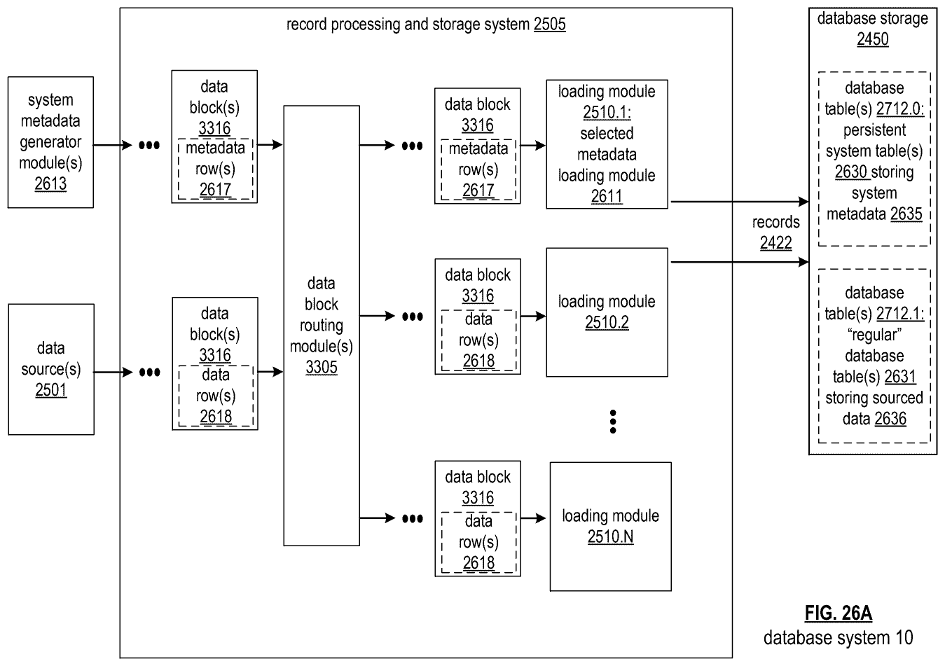

FIGS. 25A-25C illustrate embodiments of a database system 10 operable to execute queries indicating join expressions based on implementing corresponding join processes via one or more join operators. Some or all features and/or functionality of FIGS. 25A-25C can be utilized to implement the database system 10 of FIGS. 24A-24I when executing queries indicating join expressions. Some or all features and/or functionality of FIGS. 25A-25C can be utilized to implement any embodiment of the database system 10 described herein.

FIG. 25A illustrates an embodiment of a database system 10 that implements a record processing and storage system 2505. The record processing and storage system 2505 can be operable to generate and store the segments 2424 discussed previously by utilizing a segment generator 2617 to convert sets of row-formatted records 2422 into column-formatted record data 2565. These row-formatted records 2422 can correspond to rows of a database table with populated column values of the table, for example, where each record 2422 corresponds to a single row as illustrated in FIG. 15. For example, the segment generator 2617 can generate the segments 2424 in accordance with the process discussed in conjunction with FIGS. 15-23. The segments 2424 can be generated to include index data 2518, which can include a plurality of index sections such as the index sections 0-X illustrated in FIG. 23. The segments 2424 can optionally be generated to include other metadata, such as the manifest section and/or statistics section illustrated in FIG. 23.

The generated segments 2424 can be stored in a segment storage system 2508 for access in query executions. For example, the records 2422 can be extracted from generated segments 2424 in various query executions performed by via a query processing system 2502 of the database system 10, for example, as discussed in FIGS. 25A-25D. In particular, the segment storage system 2508 can be implemented by utilizing the memory drives 2425 of a plurality of IO level nodes 37 that are operable to store segments. As discussed previously, nodes 37 at the IO level 2416 can store segments 2424 in their memory drives 2425 as illustrated in FIG. 24C. These nodes can perform IO operations in accordance with query executions by reading rows from these segments 2424 and/or by recovering segments based on receiving segments from other nodes as illustrated in FIG. 24D. The records 2422 can be extracted from the column-formatted record data 2565 for these IO operations of query executions by utilizing the index data 2518 of the corresponding segment 2424.

To enhance the performance of query executions via access to segments 2424 to read records 2422 in this fashion, the sets of rows included in each segment are ideally clustered well. In the ideal case, rows sharing the same cluster key are stored together in the same segment or same group of segments. For example, rows having matching values of key columns(s) of FIG. 18 utilized to sort the rows into groups for conversion into segments are ideally stored in the same segments. As used herein, a cluster key can be implemented as any one or more columns, such as key columns(s) of FIG. 18, that are utilized to cluster records into segment groups for segment generation. As used herein, more favorable levels of clustering correspond to more rows with same or similar cluster keys being stored in the same segments, while less favorable levels of clustering correspond to less rows with same or similar cluster keys being stored in the same segments. More favorable levels of clustering can achieve more efficient query performance. In particular, query filtering parameters of a given query can specify particular sets of records with particular cluster keys be accessed, and if these records are stored together, fewer segments, memory drives, and/or nodes need to be accessed and/or utilized for the given query.

These favorable levels of clustering can be hard to achieve when relying upon the incoming ordering of records in record streams 1-L from a set of data sources 2501-1-2501-L. No assumptions can necessarily be made about the clustering, with respect to the cluster key, of rows presented by external sources as they are received in the data stream. For example, the cluster key value of a given row received at a first time t₁ gives no information about the cluster key value of a row received at a second time t₂ after t₁. It would therefore be unideal to frequently generate segments by performing a clustering process to group the most recently received records by cluster key. In particular, because records received within a given time frame from a particular data source may not be related and have many different cluster key values, the resulting record groups utilized to generate segments would render unfavorable levels of clustering.

To achieve more favorable levels of clustering, the record processing and storage system 2505 implements a page generator 2511 and a page storage system 2506 to store a plurality of pages 2515. The page generator 2511 is operable to generate pages 2515 from incoming records 2422 of record streams 1-L, for example, as is discussed in further detail in conjunction with FIG. 25C. Each page 2515 generated by the page generator 2511 can include a set of records, for example, in their original row format and/or in a data format as received from data sources 2501-1-2501-L. Once generated, the pages 2515 can be stored in a page storage system 2506, which can be implemented via memory drives and/or cache memory of one or more computing devices 18, such as some or all of the same or different nodes 37 storing segments 2424 as part of the segment storage system 2508.

This generation and storage of pages 2515 stored by can serve as temporary storage of the incoming records as they await conversion into segments 2424. Pages 2515 can be generated and stored over lengthy periods of time, such as hours or days. During this length time frame, pages 2515 can continue to be accumulated as one or more record streams of incoming records 1-L continue to supply additional records for storage by the database system.

The plurality of pages generated and stored over this period of time can be converted into segments, for example once a sufficient amount of records have been received and stored as pages, and/or once the page storage system 2506 runs out of memory resources to store any additional pages. It can be advantageous to accumulate and store as many records as possible in pages 2515 prior to conversion to achieve more favorable levels of clustering. In particular, performing a clustering process upon a greater numbers of records, such as the greatest number of records possible can achieve more favorable levels of clustering, For example, greater numbers of records with common cluster keys are expected to be included in the total set of pages 2515 of the page storage system 2506 when the page storage system 2506 accumulates pages over longer periods of time to include a greater number of pages. In other words. delaying the grouping of rows into segments as long as possible increases the chances of having sufficient numbers of records with same and/or similar cluster keys to group together in segments. Alternatively, the conversion of pages into segments can occur at any frequency, for example, where pages are converted into segments more frequently and/or in accordance with any schedule or determination in other embodiments of the record processing and storage system 2505.

This mechanism of improving clustering levels in segment generation by delaying the clustering process required for segment generation as long as possible can be further leveraged to reduce resource utilization of the record processing and storage system 2505. As the record processing and storage system 2505 is responsible for receiving records streams from data sources for storage, for example, in the scale of terabyte per second load rates, this process of generating pages from the record streams should therefore be as efficient as possible. The page generator 2511 can be further implemented to reduce resource consumption of the record processing and storage system 2505 in page generation and storage by minimizing the processing of, movement of, and/or access to records 2422 of pages 2515 once generated as they await conversion into segments.

To reduce the processing induced upon the record processing and storage system 2505 during this data ingress, sets of incoming records 2422 can be included in a corresponding page 2515 without performing any clustering or sorting. For example, as clustering assumptions cannot be made for incoming data, incoming rows can be placed into pages based on the order that they are received and/or based on any order that best conserves resources. In some embodiments, the entire clustering process is performed by the segment generator 2617 upon all stored pages all at once, where the page generator 2511 does not perform any stages of the clustering process.

In some embodiments, to further reduce the processing induced upon the record processing and storage system 2505 during this data ingress, incoming record data of data streams 1-L undergo minimal reformatting by the page generator 2511 in generating pages 2515. In some cases, the incoming data of record streams 1-L is not reformatted and is simply “placed” into a corresponding page 2515. For example, a set of records are included in given page in accordance with formatted row data received from data sources.

While delaying segment generation in this fashion improves clustering and further improves ingress efficiency, it can be unideal to wait for records to be processed into segments before they appear in query results, particularly because the most recent data may be of the most interest to end users requesting queries. The record processing and storage system 2505 can resolve this problem by being further operable to facilitate page reads in addition to segment reads in facilitating query executions.

As illustrated in FIG. 25A, a query processing system 2502 can implement a query execution plan generator module 2503 to generate query execution plan data based on a received query request. The query execution plan data can be relayed to nodes participating in the corresponding query execution plan 2405 indicated by the query execution plan data, for example, as discussed in conjunction with FIG. 24A. A query execution module 2504 can be implemented via a plurality of nodes participating in the query execution plan 2405, for example, where data blocks are propagated upwards from nodes at IO level 2416 to a root node at root level 2412 to generate a query resultant. The nodes at IO level 2416 can perform row reads to read records 2422 from segments 2424 as discussed previously and as illustrated in FIG. 24C. The nodes at IO level 2416 can further perform row reads to read records 2422 from pages 2515. For example, once records 2422 are durably stored by being stored in a page 2515, and/or by being duplicated and stored in multiple pages 2515, the record 2422 can be available to service queries, and will be accessed by nodes 37 at IO level 2416 in executing queries accordingly. This enables the availability of records 2422 for query executions more quickly, where the records need not be processed for storage in their final storage format as segments 2424 to be accessed in query requests. Execution of a given query can include utilizing a set of records stored in a combination of pages 2515 and segments 2424. An embodiment of an IO level node that stores and accesses both segments and pages is illustrated in FIG. 25E.

The record processing and storage system 2505 can be implemented utilizing the parallelized data input sub-system 11 and/or the parallelized ingress sub-system 24 of FIG. 4. The record processing and storage system 2505 can alternatively or additionally be implemented utilizing the parallelized data store, retrieve, and/or process sub-system 12 of FIG. 6. The record processing and storage system 2505 can alternatively or additionally be implemented by utilizing one or more computing devices 18 and/or by utilizing one or more nodes 37.

The record processing and storage system 2505 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the page generator 2511 and/or of the segment generator 2617 discussed herein. In some cases, one or more individual nodes 37 and/or one or more individual processing core resources 48 can be operable to perform some or all of the functionality of the record processing and storage system 2505, such as some or all of the functionality of the page generator 2511 and/or of the segment generator 2617, independently or in tandem by utilizing their own processing resources and/or memory resources.

The query processing system 2502 can be alternatively or additionally implemented utilizing the parallelized query and results sub-system 13 of FIG. 5. The query processing system 2502 can be alternatively or additionally implemented utilizing the parallelized data store, retrieve, and/or process sub-system 12 of FIG. 6. The query processing system 2502 can alternatively or additionally be implemented by utilizing one or more computing devices 18 and/or by utilizing one or more nodes 37.

The query processing system 2502 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the query execution plan generator module 2503 and/or of the query execution module 2504 discussed herein. In some cases, one or more individual nodes 37 and/or one or more individual processing core resources 48 can be operable to perform some or all of the functionality of the query processing system 2502, such as some or all of the functionality of query execution plan generator module 2503 and/or of the query execution module 2504, independently or in tandem by utilizing their own processing resources and/or memory resources.

In some embodiments, one or more nodes 37 of the database system 10 as discussed herein can be operable to perform multiple functionalities of the database system 10 illustrated in FIG. 25A. For example, a single node can be utilized to implement the page generator 2511, the page storage system 2506, the segment generator 2617, the segment storage system 2508, the query execution plan generator module, and/or the query execution module 2504 as a node 37 at one or more levels 2410 of a query execution plan 2405. In particular, the single node can utilize different processing core resources 48 to implement different functionalities in parallel, and/or can utilize the same processing core resources 48 to implement different functionalities at different times.

Some or all data sources 2501 can implemented utilizing at least one processor and at least one memory. Some or all data sources 2501 can be external from database system 10 and/or can be included as part of database system 10. For example, the at least one memory of a data source 2501 can store operational instructions that, when executed by the at least one processor of the data source 2501, cause the data source 2501 to perform some or all of the functionality of data sources 2501 described herein. In some cases, data sources 2501 can receive application data from the database system 10 for download, storage, and/or installation. Execution of the stored application data by processing modules of data sources 2501 can cause the data sources 2501 to execute some or all of the functionality of data sources 2501 discussed herein.

In some embodiments, system communication resources 14, external network(s) 17, local communication resources 25, wide area networks 22, and/or other communication resources of database system 10 can be utilized to facilitate any transfer of data by the record processing and storage system 2505. This can include, for example: transmission of record streams 1-L from data sources 2501 to the record processing and storage system 2505: transfer of pages 2515 to page storage system 2506 once generated by the page generator 2511: access to pages 2515 by the segment generator 2617: transfer of segments 2424 to the segment storage system 2508 once generated by the segment generator 2617: communication of query execution plan data to the query execution module 2504, such as the plurality of nodes 37 of the corresponding query execution plan 2405: reading of records by the query execution module 2504, such as IO level nodes 37, via access to pages 2515 stored page storage system 2506 and/or via access to segments 2424 stored segment storage system 2508: sending of data blocks generated by nodes 37 of the corresponding query execution plan 2405 to other nodes 37 in conjunction with their execution of the query; and/or any other accessing of data, communication of data, and/or transfer of data by record processing and storage system 2505 and/or within the record processing and storage system 2505 as discussed herein.

The record processing and storage system 2505 and/or the query processing system 2502 of FIG. 25A, and/or any other embodiment of record processing and storage system 2505 and/or the query processing system 2502 described herein, can be implemented at a massive scale, for example, by being implemented by a database system 10 that is operable to receive, store, and perform queries against a massive number of records of one or more datasets, such as millions, billions, and/or trillions of records stored as many Terabytes, Petabytes, and/or Exabytes of data as discussed previously. In particular, the record processing and storage system 2505 and/or the query processing system 2502 can each be implemented by a large number, such as hundreds, thousands, and/or millions of computing devices 18, nodes 37, and/or processing core resources 48 that perform independent processes in parallel, for example, with minimal or no coordination, to implement some or all of the features and/or functionality of the record processing and storage system 2505 and/or the query processing system 2502 at a massive scale.

Some or all functionality performed by the record processing and storage system 2505 and/or the query processing system 2502 as described herein cannot practically be performed by the human mind, particularly when the database system 10 is implemented to store and perform queries against records at a massive scale as discussed previously. In particular, the human mind is not equipped to perform record processing, record storage, and/or query execution for millions, billions, and/or trillions of records stored as many Terabytes, Petabytes, and/or Exabytes of data. Furthermore, the human mind is not equipped to distribute and perform record processing, record storage, and/or query execution as multiple independent processes, such as hundreds, thousands, and/or millions of independent processes, in parallel and/or within overlapping time spans.

Some or all features and/or functionality of FIG. 25A can be performed via at least one node 37 in conjunction with system metadata, applied across a plurality of nodes 37, for example, where at least one node 37 participates in some or all features and/or functionality of FIG. 25A based on receiving and storing the system metadata in local memory of the at least one node 37 as configuration data, and/or based on further accessing and/or executing this configuration data to implement some or all functionality of the record processing storage system and/or to implement some or all functionality of the query processing system as part of its database functionality accordingly. Performance of some or all features and/or functionality of FIG. 25A can optionally change and/or be updated over time, and/or a set of nodes participating in executing some or all features and/or functionality of FIG. 25A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25B illustrates an example embodiment of the record processing and storage system 2505 of FIG. 25A. Some or all of the features illustrated and discussed in conjunction with the record processing and storage system 2505 FIG. 25B can be utilized to implement the record processing and storage system 2505 and/or any other embodiment of the record processing and storage system 2505 described herein.

The record processing and storage system 2505 can include a plurality of loading modules 2501-1-2510-N. Each loading module 2510 can be implemented via its own processing and/or memory resources. For example, each loading module 2510 can be implemented via its own computing device 18, via its own node 37, and/or via its own processing core resource 48. The plurality of loading modules 2501-1-2510-N can be implemented to perform some or all of the functionality of the record processing and storage system 2505 in a parallelized fashion.

The record processing and storage system 2505 can include queue reader 2559, a plurality of stateful file readers 2556-1-2556-N, and/or stand-alone file readers 2558-1-2558-N. For example, the queue reader 2559, a plurality of stateful file readers 2556-1-2556-N, and/or stand-alone file readers 2558-1-2558-N are utilized to enable each loading modules 2510 to receive one or more of the record streams 1-L received from the data sources 2501-1-2501-L as illustrated in FIG. 25A. For example, each loading module 2510 receives a distinct subset of the entire set of records received by the record processing and storage system 2505 at a given time.

Each loading module 2510 can receive records 2422 in one or more record streams via its own stateful file reader 2556 and/or stand-alone file reader 2558. Each loading module 2510 can optionally receive records 2422 and/or otherwise communicate with a common queue reader 2559. Each stateful file reader 2556 can communicate with a metadata cluster 2552 that includes data supplied by and/or corresponding to a plurality of administrators 2554-1-2554-M. The metadata cluster 2552 can be implemented by utilizing the administrative processing sub-system 15 and/or the configuration sub-system 16. The queue reader 2559, each stateful file reader 2556, and/or each stand-alone file reader 2558 can be implemented utilizing the parallelized ingress sub-system 24 and/or the parallelized data input sub-system 11. The metadata cluster 2552, the queue reader 2559, each stateful file reader 2556, and/or each stand-alone file reader 2558 can be implemented utilizing at least one computing device 18 and/or at least one node 37. In cases where a given loading module 2510 is implemented via its own computing device 18 and/or node 37, the same computing device 18 and/or node 37 can optionally be utilized to implement the stateful file reader 2556, and/or each stand-alone file reader 2558 communicating with the given loading module 2510.

Each loading module 2510 can implement its own page generator 2511, its own index generator 2513, and/or its own segment generator 2617, for example, by utilizing its own processing and/or memory resources such as the processing and/or memory resources of a corresponding computing device 18. For example, the page generator 2511 of FIG. 25A can be implemented as a plurality of page generators 2511 of a corresponding plurality of loading modules 2510 as illustrated in FIG. 25B. Each page generator 2511 of FIG. 25B can process its own incoming records 2422 to generate its own corresponding pages 2515.

As pages 2515 are generated by the page generator 2511 of a loading module 2510, they can be stored in a page cache 2512. The page cache 2512 can be implemented utilizing memory resources of the loading module 2510, such as memory resources of the corresponding computing device 18. For example, the page cache 2512 of each loading module 2010-1-2010-N can individually or collectively implement some or all of the page storage system 2506 of FIG. 25A.

The segment generator 2617 of FIG. 25A can similarly be implemented as a plurality of segment generators 2617 of a corresponding plurality of loading modules 2510 as illustrated in FIG. 25B. Each segment generator 2617 of FIG. 25B can generate its own set of segments 2424-1-2424-J included in one or more segment groups 2622. The segment group 2622 can be implemented as the segment group of FIG. 23, for example, where J is equal to five or another number of segments configured to be included in a segment group. In particular, J can be based on the redundancy storage encoding scheme utilized to generate the set of segments and/or to generate the corresponding parity data 2426.

The segment generator 2617 of a loading module 2510 can access the page cache 2512 of the loading module 2510 to convert the pages 2515 previously generated by the page generator 2511 into segments. In some cases, each segment generator 2617 requires access to all pages 2515 generated by the segment generator 2617 since the last conversion process of pages into segments. The page cache 2512 can optionally store all pages generated by the page generator 2511 since the last conversion process, where the segment generator 2617 accesses all of these pages generated since the last conversion process to cluster records into groups and generate segments. For example, the page cache 2512 is implemented as a write-through cache to enable all previously generated pages since the last conversion process to be accessed by the segment generator 2617 once the conversion process commences.

In some cases, each loading module 2510 implements its segment generator 2617 upon only the set of pages 2515 that were generated by its own page generator 2511, accessible via its own page cache 2512. In such cases, the record grouping via clustering key to create segments with the same or similar cluster keys are separately performed by each segment generator 2617 independently without coordination, where this record grouping via clustering key is performed on N distinct sets of records stored in the N distinct sets of pages generated by the N distinct page generators 2511 of the N distinct loading modules 2510. In such cases, despite records never being shared between loading modules 2510 to further improve clustering, the level of clustering of the resulting segments generated independently by each loading module 2510 on its own data is sufficient, for example, due to the number of records in each loading module's 2510 set of pages 2515 for conversion being sufficiently large to attain favorable levels of clustering.

In such embodiments, each loading modules 2510 can independently initiate its own conversion process of pages 2515 into segments 2424 by waiting as long as possible based on its own resource utilization, such as memory availability of its page cache 2512. Different segment generators 2617 of the different loading modules 2510 can thus perform their own conversion of the corresponding set of pages 2515 into segments 2424 at different times, based on when each loading modules 2510 independently determines to initiate the conversion process, for example, based on each independently making the determination to generate segments. Thus, as discussed herein, the conversion process of pages into segments can correspond to a single loading module 2510 converting all of its pages 2515 generated by its own page generator 2511 since its own last the conversion process into segments 2424, where different loading modules 2510 can initiate and execute this conversion process at different times and/or with different frequency.

In other cases, it is ideal for even more favorable levels of clustering to be attained via sharing of all pages for conversion across all loading modules 2510. In such cases, a collective decision to initiate the conversion process can be made across some or all loading modules 2510, for example, based on resource utilization across all loading modules 2510. The conversion process can include sharing of and/or access to all pages 2515 generated via the process, where each segment generator 2617 accesses records in some or all pages 2515 generated by and/or stored by some or all other loading modules 2510 to perform the record grouping by cluster key. As the full set of records is utilized for this clustering instead of N distinct sets of records, the levels of clustering in resulting segments can be further improved in such embodiments. This improved level of clustering can offset the increased page movement and coordination required to facilitate page access across multiple loading modules 2510. As discussed herein, the conversion process of pages into segments can optionally correspond to multiple loading modules 2510 converting all of their collectively generated pages 2515 since their last conversion process into segments 2424 via sharing of their generated pages 2515.

An index generator 2513 can optionally be implemented by some or all loading modules 2510 to generate index data 2516 for some or all pages 2515 prior to their conversion into segments. The index data 2516 generated for a given page 2515 can be appended to the given page, can be stored as metadata of the given page 2515, and/or can otherwise be mapped to the given page 2515. The index data 2516 for a given page 2515 correspond to page metadata, for example, indexing records included in the corresponding page. As a particular example, the index data 2516 can include some or all of the data of index data 2518 generated for segments 2424 as discussed previously, such as index sections 0-x of FIG. 23. As another example, the index data 2516 can include indexing information utilized to determine the memory location of particular records and/or particular columns within the corresponding page 2515.

In some cases, the index data 2516 can be generated to enable corresponding pages 2515 to be processed by query IO operators utilized to read rows from pages, for example, in a same or similar fashion as index data 2518 is utilized to read rows from segments. In some cases, index probing operations can be utilized by and/or integrated within query IO operators to filter the set of rows returned in reading a page 2515 based on its index data 2516 and/or to filter the set of rows returned in reading a segment 2424 based on its index data 2518.

In some cases, index data 2516 is generated by index generator 2513 for all pages 2515, for example, as each page 2515 is generated, or at some point after each page 2515 is generated. In other cases, index data 2516 is only generated for some pages 2515, for example, where some pages do not have index data 2516 as illustrated in FIG. 25B. For example, some pages 2515 may never have corresponding index data 2516 generated prior to their conversion into segments. In some cases, index data 2516 is generated for a given page 2515 with its records are to be read in execution of a query by the query processing system 2502. For example, a node 37 at IO level 2416 can be implemented as a loading module 2510 and can utilize its index generator 2513 to generate index data 2516 for a particular page 2515 in response to having query execution plan data indicating that records 2422 be read the particular page from the page cache 2512 of the loading module in conjunction with execution of a query. The index data 2516 can be optionally stored temporarily for the life of the given query to facilitate reading of rows from the corresponding page for the given query only. The index data 2516 alternatively be stored as metadata of the page 2515 once generated, as illustrated in FIG. 25B. This enables the previously generated index data 2516 of a given page to be utilized in subsequent queries requiring reads from the given page.

As illustrated in FIG. 25B, each loading modules 2510 can generate and send pages 2515, corresponding index data 2516, and/or segments 2424 to long term storage 2540-1-2540-J of a particular storage cluster 2535. For example, system communication resources 14 can be utilized to facilitate sending of data from loading modules 2510 to storage cluster 2535 and/or to facilitate sending of data from storage cluster 2535 to loading modules 2510.

The storage cluster 2535 can be implemented by utilizing a storage cluster 35 of FIG. 6, where each long term storage 2540-1-2540-J is implemented by a corresponding computing device 18-1-18-J and/or by a corresponding node 37-1-37-J. In some cases, each storage cluster 35-1-35-z of FIG. 6 can receive pages 2515, corresponding index data 2516, and/or segments 2424 from its own set of loading modules 2501-1-2510-N, where the record processing and storage system 2505 of FIG. 25B can include z sets of loading modules 2501-1-2510-N that each generate pages 2515, segments 2524, and/or index data 2516 for storage in its own corresponding storage cluster 35.

The processing and/or memory resources utilized to implement each long term storage 2540 can be distinct from the processing and/or memory resources utilized to implement the loading modules 2510. Alternatively, some loading modules can optionally share processing and/or memory resources long term storage 2540, for example, where a same computing device 18 and/or a same node 37 implements a particular long term storage 2540 and also implements a particular loading modules 2510.

Each loading module 2510 can generate and send the segments 2424 to long term storage 2540-1-2540-J in a set of persistence batches 2532-1-2532-J sent to the set of long term storage 2540-1-2540-J as illustrated in FIG. 25B. For example, upon generating a segment group 2522 of J segments 2424, a loading module 2510 can send each of the J segments in the same segment group to a different one of the set of long term storage 2540-1-2540-J in the storage cluster 2535. For example, a particular long term storage 2540 can generate recovered segments as necessary for processing queries and/or for rebuilding missing segments due to drive failure as illustrated in FIG. 24D, where the value K of FIG. 24D is less than the value J and where the nodes 37 of FIG. 24D are utilized to implement the long term storage 2540-1-2540-J.

As illustrated in FIG. 25B, each persistence batch 2532-1-2532-J can optionally or additionally include pages 2515 and/or their corresponding index data 2516 generated via index generator 2513. Some or all pages 2515 that are generated via a loading module 2510's page generator 2511 can be sent to one or more long term storage 2540-1-2540-J. For example, a particular page 2515 can be included in some or all persistence batches 2532-1-2532-J sent to multiple ones of the set of long term storage 2540-1-2540-J for redundancy storage as replicated pages stored in multiple locations for the purpose of fault tolerance. Some or all pages 2515 can be sent to storage cluster 2535 for storage prior to being converted into segments 2424 via segment generator 2617. Some or all pages 2515 can be stored by storage cluster 2535 until corresponding segments 2424 are generated, where storage cluster 2535 facilitates deletion of these pages from storage in one or more long term storage 2540-1-2540-J once these pages are converted and/or have their records 2422 successfully stored by storage cluster 2535 in segments 2424.

In some cases, a loading module 2510 maintains storage of pages 2515 via page cache 2512, even if they are sent to storage cluster 2535 in persistence batches 2532. This can enable the segment generator 2617 to efficiently read pages 2515 during the conversion process via reads from this local page cache 2512. This can be ideal in minimizing page movement, as pages do not need to be retrieved from long term storage 2540 for conversion into segments by loading modules 2510 and can instead be locally accessed via maintained storage in page cache 2512. Alternatively, a loading module 2510 removes pages 2515 from storage via page cache 2512 once they are determined to be successfully stored in long term storage 2540. This can be ideal in reducing the memory resources required by loading module 2510 to store pages, as only pages that are not yet durably stored in long term storage 2540 need be stored in page cache 2512.

Each long term storage 2540 can include its own page storage 2546 that stores received pages 2515 generated by and received from one or more loading modules 2010-1-2010-N, implemented utilizing memory resources of the long term storage 2540. For example, the page storage 2546 of each long term storage 2540-1-2540-J can individually or collectively implement some or all of the page storage system 2506 of FIG. 25A. The page storage 2546 can optionally store index data 2516 mapped to and/or included as metadata of its pages 2515. Each long term storage 2540 can alternatively or additionally include its own segment storage 2548 that stores segments generated by and received from one or more loading modules 2010-1-2010-N. For example, the segment storage 2548 of each long term storage 2540-1-2540-J can individually or collectively implement some or all of the segment storage system 2508 of FIG. 25A.

The pages 2515 stored in page storage 2546 of long term storage 2540 and/or the segments 2424 stored in segment storage 2548 of long term storage 2540 can be accessed to facilitate execution of queries. As illustrated in FIG. 25B, each long term storage 2540-1-2540-J can perform IO operators 2542 to facilitate reads of records in pages 2515 stored in their page storage 2546 and/or to facilitate reads of records in segments 2424 stored in their segment storage 2548. For example, some or all long term storage 2540-1-2540-J can be implemented as nodes 37 at the IO level 2416 of one or more query execution plans 2405. In particular, the some or all long term storage 2540-1-2540-J can be utilized to implement the query processing system 2502 by facilitating reads to stored records via IO operators 2542 in conjunction with query executions.

Note that at a given time, a given page 2515 may be stored in the page cache 2512 of the loading module 2510 that generated the given page 2515, and may alternatively or additionally be stored in one or more long term storage 2540 of the storage cluster 2535 based on being sent to the in one or more long term storage 2540. Furthermore, at a given time, a given record may be stored in a particular page 2515 in a page cache 2512 of a loading module 2510, may be stored the particular page 2515 in page storage 2546 of one or more long term storage 2540, and/or may be stored in exactly one particular segment 2424 in segment storage 2548 of one long term storage 2540.

Because records can be stored in multiple locations of storage cluster 2535, the long term storage 2540 of storage cluster 2535 can be operable to collectively store page and/or segment ownership consensus 2544. This can be useful in dictating which long term storage 2540 is responsible for accessing each given record stored by the storage cluster 2535 via IO operators 2542 in conjunction with query execution. In particular, as a query resultant is only guaranteed to be correct if each required record is accessed exactly once, records reads to a particular record stored in multiple locations could render a query resultant as incorrect. The page and/or segment ownership consensus 2544 can include one or more versions of ownership data, for example, that is generated via execution of a consensus protocol mediated via the set of long term storage 2540-1-2540-J. The page and/or segment ownership consensus 2544 can dictate that every record is owned by exactly one long term storage 2540 via access to either a page 2515 storing the record or a segment 2424 storing the record, but not both. The page and/or segment ownership consensus 2544 can indicate, for each long term storage 2540 in the storage cluster 2535, whether some or all of its pages 2515 or some or all of its segments 2424 are to be accessed in query executions, where each long term storage 2540 only accesses the pages 2515 and segments 2424 indicated in page and/or segment ownership consensus 2544.

In such cases, all record access for query executions performed by query execution module 2504 via nodes 37 at IO level 2416 can optionally be performed via IO operators 2542 accessing page storage 2546 and/or segment storage 2548 of long term storage 2540, as this access can guarantee reading of records exactly once via the page and/or segment ownership consensus 2544. For example, the long term storage 2540 can be solely responsible for durably storing the records utilized in query executions. In such embodiments, the cached and/or temporary storage of pages and/or segments of loading modules 2510, such as pages 2515 in page caches 2512, are not read for query executions via accesses to storage resources of loading modules 2510.

Some or all features and/or functionality of FIG. 25B can be performed via at least one node 37 in conjunction with system metadata applied across a plurality of nodes 37, for example, where at least one node 37 participates in some or all features and/or functionality of FIG. 25B based on receiving and storing the system metadata in local memory of the at least one node 37 as configuration data and/or based on further accessing and/or executing this configuration data to implement some or all functionality of a loading module 2510, to implement some or all functionality of a file reader, and/or to implement some or all functionality of the storage cluster 2535 as part of its database functionality accordingly. Performance of some or all features and/or functionality of FIG. 25B can optionally change and/or be updated over time, and/or a set of nodes participating in executing some or all features and/or functionality of FIG. 25B can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25C illustrates an example embodiment of a page generator 2511. The page generator 2511 of FIG. 25C can be utilized to implement the page generator 2511 of FIG. 25A, can be utilized to implement each page generator 2511 of each loading module 2510 of FIG. 25B, and/or can be utilized to implement any embodiments of page generator 2511 described herein.

A single incoming record stream, or multiple incoming record streams 1-L, can include the incoming records 2422 as a stream of row data 2910. Each row data 2910 can be transmitted as an individual packet and/or a set of packets by the corresponding data source 2501 to include a single record 2422, such as a single row of a database table. Alternatively each row data 2910 can be transmitted by the corresponding data source 2501 as an individual packet and/or a set of packets to include a batched set of multiple records 2422, such as multiple rows of a database table. Row data 2910 received from the same or different data source over time can each include a same number of rows or a different number of rows, and can be sent in accordance with a particular format. Row data 2910 received from the same or different data source over time can include records with the same or different numbers of columns, with the same or different types and/or sizes of data populating its columns, and/or with the same or different row schemas. In some cases, row data 2910 is received in a stream over time for processing by a loading module 2510 via a stateful file reader 2556 and/or via a stand-alone file reader 2558.

Incoming rows can be stored in a pending row data pool 3410 while they await conversion into pages 2515. The pending row data pool 3410 can be implemented as an ordered queue or an unordered set. The pending row data pool 3410 can be implemented by utilizing storage resources of the record processing and storage system. For example, each loading module 2510 can have its own pending row data pool 3410. Alternatively, multiple loading modules 2510 can access the same pending row data pool 3410 that stores all incoming row data 2910, for example, by utilizing queue reader 2559.

The page generator 2511 can facilitate parallelized page generation via a plurality of processing core resources 48-1-48-W. For example, each loading module 2510 has its own plurality of processing core resources 48-1-48-W, where the processing core resources 48-1-48-W of a given loading module 2510 is implemented via the set of processing core resources 48 of one or more nodes 37 utilized to implement the given loading module 2510. As another example, the plurality of processing core resources 48-1-48-W are each implemented by a corresponding one of the set of each loading module 2501-1-2510-N, for example, where each loading module 2501-1-2510-N is implemented via its own processing core resources 48-1-48-W.

Over time, each processing core resource 48 can retrieve and/or can be assigned pending row data 2910 in the pending row data pool 3410. For example, when a given processing core resource 48 has finished another job, such as completed processing of another row data 2910, the processing core resource 48 can fetch a new row data 2910 for processing into a page 2515. For example, the processing core resource 48 retrieves a first ordered row data 2910 from a queue of the pending row data pool 3410, retrieves a highest priority row data 2910 from the pending row data pool 3410, retrieves an oldest row data 2910 from the pending row data pool 3410, and/or retrieves a random row data 2910 from the pending row data pool 3410. Once one processing core resource 48 retrieves and/or otherwise utilizes a particular row data 2910 for processing into a page, the particular row data 2910 is removed from the pending row data pool 3410 and/or is otherwise not available for processing by other processing core resources 48.

Each processing core resource 48 can generate pages 2515 from the row data received over time. As illustrated in FIG. 25C, the pages 2515 are depicted to include only one row data, such as a single row or multiple rows batched together in the row data 2910. For example, each page is generated directly from corresponding row data 2910. Alternatively, a page 2515 can include multiple row data 2910, for example, in sequence and/or concatenated in the page 2515. The page can include multiple row data 2910 from a single data source 2501 and/or can include multiple row data 2910 from multiple different data sources 2501. For example, the processing core resource 48 can retrieve one row data 2910 from the pending row data pool 3410 at a time, and can append each row data 2910 to a given page until the page 2515 is complete, where the processing core resource 48 appends subsequently retrieved row data 2910 to a new page. Alternatively, the processing core resource 48 can retrieve multiple row data 2910 at once, and can generate a corresponding page 2515 to include this set of multiple row data 2910.

Once a page 2515 is complete, the corresponding processing core resource 48 can facilitate storage of the page in page storage system 2506. This can include adding the page 2515 to the page cache 2512 of the corresponding loading module 2510. This can include facilitating sending of the page 2515 to one or more long term storage 2540 for storage in corresponding page storage 2546. Different processing core resources 48 can each facilitate storage of the page via common resources, or via designated resources specific to each processing core resources 48, of the page storage system 2506.

Some or all features and/or functionality of FIG. 25C can be performed via at least one node 37 in conjunction with system metadata applied across a plurality of nodes 37, for example, where at least one node 37 participates in some or all features and/or functionality of FIG. 25C based on receiving and storing the system metadata in local memory of the at least one node 37 as configuration data and/or based on further accessing and/or executing this configuration data to implement some or all functionality of a loading module 2510, to implement some or all functionality of page generator 2511 and/or page storage system 2506 as part of its database functionality accordingly. Performance of some or all features and/or functionality of FIG. 25C can optionally change and/or be updated over time, and/or a set of nodes participating in executing some or all features and/or functionality of FIG. 25C can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25D illustrates an example embodiment of the page storage system 2506. As used herein, the page storage system 2506 can include page cache 2512 of a single loading module 2510: can include page caches 2512 of some or all loading module 2501-1-2510-N: can include page storage 2546 of a single long term storage 2540 of a storage cluster 2535: can include page storage 2546 of some or all long term storage 2540-1-2540-J of a single storage cluster 2535; can include page storage 2546 of some or all long term storage 2540-1-2540-J of multiple different storage clusters, such as some or all storage clusters 35-1-35-z; and/or can include any other memory resources of database system 10 that are utilized to temporarily and/or durably store pages.

Some or all features and/or functionality of FIG. 25D can be performed via at least one node 37 in conjunction with system metadata applied across a plurality of nodes 37, for example, where at least one node 37 participates in some or all features and/or functionality of FIG. 25D based on receiving and storing the system metadata in local memory of the at least one node 37 as configuration data and/or based on further accessing and/or executing this configuration data to implement some or all functionality of a loading module 2510 and/or a given long term storage 2540 as part of its database functionality accordingly. Performance of some or all features and/or functionality of FIG. 25D can optionally change and/or be updated over time, and/or a set of nodes participating in executing some or all features and/or functionality of FIG. 25D can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25E illustrates an example embodiment of a node 37 utilized to implement a given long term storage 2540 of FIG. 25B. The node 37 of FIG. 25E can be utilized to implement the node 37 of FIG. 25B, FIG. 25C, 25D, some or all nodes 37 at the IO level 2416 of a query execution plan 2405 of FIG. 24A, and/or any other embodiments of node 37 described herein. As illustrated a given node 37 can have its own segment storage 2548 and/or its own page storage 2546 by utilizing one or more of its own memory drives 2425. Note that while the segment storage 2548 and page storage 2546 are segregated in the depiction of a memory drives 2425, any resources of a given memory drive or set of memory drives can be allocated for and/or otherwise utilized to store either pages 2515 or segments 2424. Optionally, some particular memory drives 2425 and/or particular memory locations within a particular memory drive can be designated for storage of pages 2515, while other particular memory drives 2425 and/or other particular memory locations within a particular memory drive can be designated for storage of segments 2424.

The node 37 can utilize its query processing module 2435 to access pages and/or records in conjunction with its role in a query execution plan 2405, for example, at the IO level 2416. For example, the query processing module 2435 generates and sends segment read requests to access records stored in segments of segment storage 2548, and/or generates and sends page read requests to access records stored in pages 2515 of page storage 2546. In some cases, in executing a given query, the node 37 reads some records from segments 2424 and reads other records from pages 2515, for example, based on assignment data indicated in the page and/or segment ownership consensus 2544. The query processing module 2435 can generate its data blocks to include the raw row data of the read records and/or can perform other query operators to generate its output data blocks as discussed previously. The data blocks can be sent to another node 37 in the query execution plan 2405 for processing as discussed previously, such as a parent node and/or a node in a shuffle node set within the same level 2410.

Some or all features and/or functionality of FIG. 25E can be performed a given node 37 in conjunction with system metadata applied across a plurality of nodes 37, for example, where the given node 37 performs some or all features and/or functionality of FIG. 25E based on receiving and storing the system metadata in local memory of the at least one node 37 as configuration data, and/or based on further accessing and/or executing this configuration data to implement some or all functionality of the given node 37 of FIG. 25E as part of its database functionality accordingly. Performance of some or all features and/or functionality of FIG. 25E can optionally change and/or be updated over time based on the system metadata applied across the plurality of nodes 37 being updated over time and/or based on nodes on updating their configuration data stored in local memory to reflect changes in the system metadata based on receiving data indicating these changes to the system metadata.

In some embodiments, some or all features and/or functionality of loading new data (e.g. as new pages and/or new segments), for example, via one or more loading modules 2510 and/or via record processing and storage system 2505 as described herein, implements some or all features and/or functionality of loading modules, record processing and storage system, and/or any loading of data for storage and access in query execution as disclosed by: U.S. Utility application Ser. No. 18/355,497, entitled “TRANSFER OF A SET OF SEGMENTS BETWEEN STORAGE CLUSTERS OF A DATABASE SYSTEM”, filed Jul. 20, 2023; and/or U.S. Utility application Ser. No. 18/308,954, entitled “QUERY EXECUTION DURING STORAGE FORMATTING UPDATES”, filed Apr. 28, 2023; which are hereby incorporated herein by reference in its entirety and made part of the present U.S. Utility Patent Application for all purposes.

In some embodiments, some or all features and/or functionality of loading new data described herein is based on implementing some or all features and/or functionality of loading tables, for example, generated via execution of CTAS queries, as disclosed by U.S. Utility application Ser. No. 18/313,548, entitled “LOADING QUERY RESULT SETS FOR STORAGE IN DATABASE SYSTEMS”, filed May 28, 2023: which are hereby incorporated herein by reference in its entirety and made part of the present U.S. Utility Patent Application for all purposes.

In some embodiments, some or all features and/or functionality of parallelized execution of tasks via a plurality of nodes, assigning different tasks to different nodes for in parallel, handling of node outages and facilitating reassignment of tasks, implementing a distributed task framework, and/or other handling of node outages and/or execution of tasks can be implemented via some or all features and/or functionality of assigning, executing, and/or reassigning tasks as disclosed by: U.S. Utility application Ser. No. 18/482,939, entitled “PERFORMING SHUTDOWN OF A NODE IN A DATABASE SYSTEM” filed Oct. 9, 2023, which is hereby incorporated herein by reference in its entirety and made part of the present U.S. Utility Patent Application for all purposes. In some embodiments, some or all tasks described herein are loading-based tasks performed in conjunction with loading data, for example, via loading modules 2510 via record processing and storage system 2505, where such tasks are optionally assigned to nodes 37 implemented as loading modules 2510.

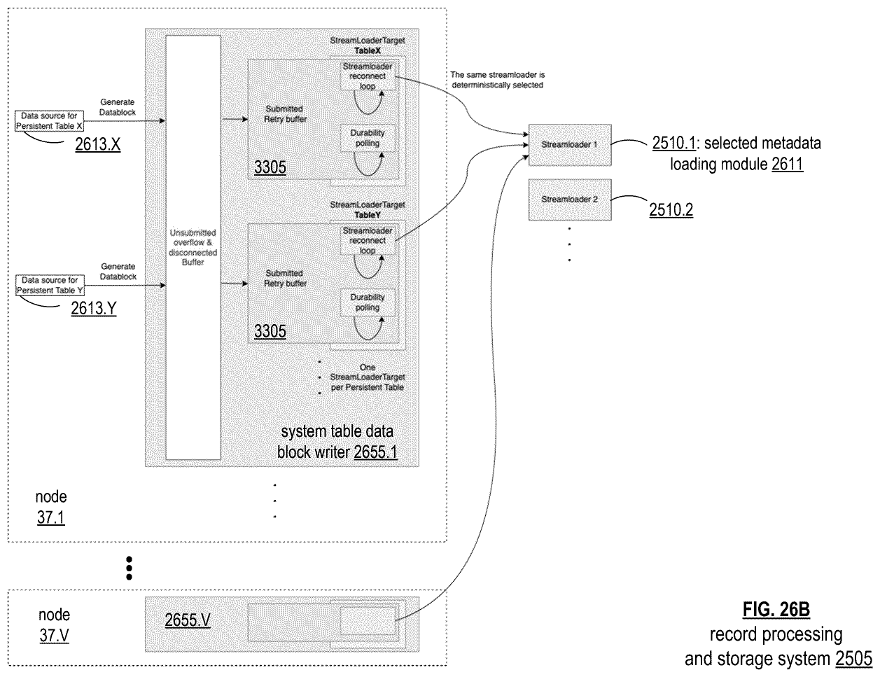

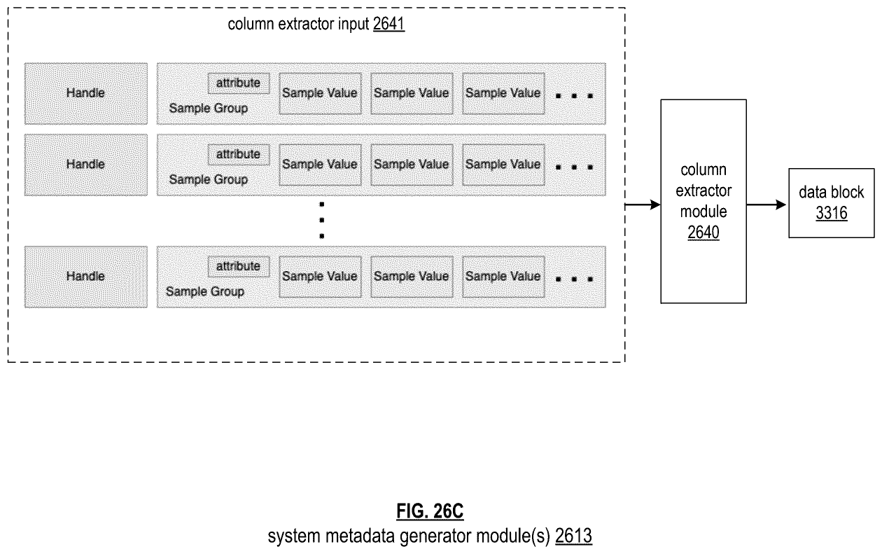

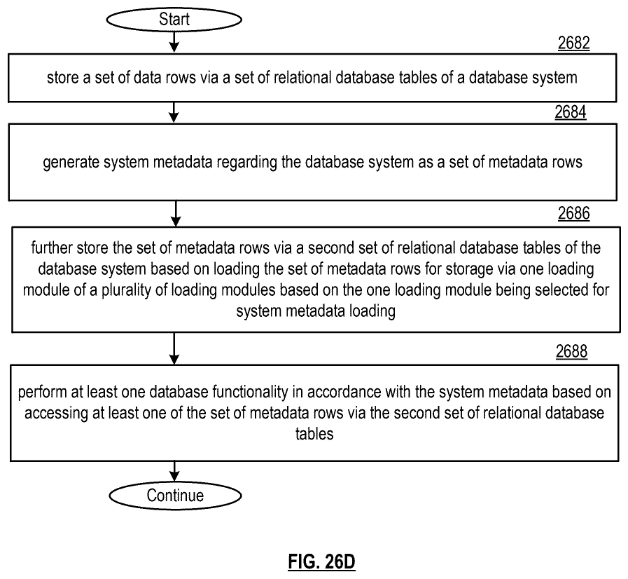

FIGS. 26A-26C present embodiments of a database system 10 that loads and stores metadata rows 2617 corresponding to system metadata 2635 in relational database tables 2712 implemented as persistent system tables 2630. Some or all features and/or functionality of FIGS. 26A-26C can implement any embodiment of maintaining system metadata described herein and/or can implement any embodiment of database system 10 described herein.

In some embodiments, large amounts of system-generated metadata need to be made accessible (e.g. by database system 10 and/or user entities). As the metadata can include many rows (e.g. billions of rows), it can be preferred that storage and/or access be scalable and/or durable (e.g. to survive node restarts).

FIGS. 26A-26C present embodiments of database system 10 where the database system 10 itself is utilized as backing storage for such metadata (e.g. any metadata generated in conjunction with performing functionality of database system 10, any metadata configuring functionality of database system 10, any system metadata described herein, and/or any other metadata). This can enable leveraging of capabilities of database system 10, such as scalability and durability of database system 10 in storing massive amounts of data (e.g. records 2422)-metadata can be stored in a same or similar fashion as other data via persistent system tables 2630, which can be implemented in a same or similar fashion as other (e.g. “regular”) database tables 2631 storing sourced data 2636, for example, via implementing some or all features and/or functionality of database tables 2712 described herein (e.g. metadata rows 2617 are stored as records 2422 in one or more database tables 2712.0 corresponding to persistent system tables 2630, where tables 2712.0 are distinct from other database tables 2712.1 storing data rows 2618 as records 2422). For example, persistent system tables 2630 can be automatically created via database system 10 and/or loading of metadata to persistent system tables 2630 can be performed automatically via loading modules 2510 of record storage processing storage system 2505. Persistent system tables 2630 can optionally be stored as segments 2424, for example, generated from pages 2515, in a same or similar fashion as segments 2424 being generated and stored to implement storage database table 2712 in database storage 2450 as described herein.

In some embodiments, loading of metadata can be performed in a same or similar fashion as Create Table as Select functionality of automatically loading query resultants into tables, for example, via implementing some or all features and/or functionality of U.S. Utility application Ser. No. 18/313,548. Such functionality can be leveraged to implement out-of-band loading, for example, via a stream loader target (e.g. “StreamLoaderTarget”). In some embodiments, persistent system table loading of data to persistent system tables 2630 is not associated with any specific query (e.g. such loading is performed over time as corresponding metadata is generated).

In some embodiments, the core target component implemented via execution of CTAS queries is similarly implemented to generate and load metadata (e.g. the “target” is an implementation of the SSID logic and/or retry loops). IN some embodiments, all queuing and/or retry interfaces provided by the “target” are encapsulated, and/or an easy-to-use interface to the rest of the system is provided. For example, a black-box component that allows a consumer to simply submit rows with one method call can be implemented to enable storage of and/or access to metadata rows 2617 of system metadata.

As illustrated in FIG. 26A, system metadata can be generated via one or more system metadata generator modules 2613 (e.g. implemented via database system 10 in conjunction with generating any metadata for storage/access) as metadata rows 2617 included in one or more data blocks 3316 (e.g. generated as a stream of data blocks 3316 over time). Such metadata generation can occur as data sources 2510 generate data blocks 3316 having data rows 2618 for storage (e.g. as “regular” record 2422 storing data for access in query execution that is not metadata). Some or all metadata generation can occur in tandem with generating/receiving/processing data rows 2618 (e.g. where the metadata is associated with incoming rows/processing of incoming rows/errors occurring in loading of incoming rows/etc.). Some or all metadata generation can be completely independent from the generation/receiving/processing of data rows 2618 for storage.

In some embodiments, all loading for all persistent system tables is directed to one loader at a time. This can improve loading efficiency based on minimize impact on the storage layer by minimizing the number of pages & generated, for example, based on the scale of the metadata being is small enough (e.g. relative to the loading of data rows 2618 of data sources 2501), where full parallelism (e.g. via multiple parallelized loading modules 2510) isn't necessary.

For example, as illustrated in FIG. 26A, one loading module 2510.1 of a plurality of loading modules 2510.1-2510.N can be implemented as a selected metadata loading module 2611 that loads all data blocks 3316 containing metadata rows 2617, where the remaining loading modules 2510.2-2510.N load data blocks 3316 containing data rows 2618. One or more data block routing modules 3305 can be implemented to route data blocks to loading modules 2510 accordingly based on routing all data blocks 3316 containing metadata rows 2617 to the selected metadata loading module 2611 and dispersing other load data blocks 3316 containing data rows 2618 across the other remaining loading modules 2510.2-2510.N.

In some embodiments, the selected metadata loading module 2611 can periodically rotate across loading modules (e.g. in response to configured conditions for changing loader being met, in accordance with a predefined schedule, in accordance with a round-robin assignment process over time, etc.) In some embodiments, loader outages can be handled gracefully, for example, where a new selected metadata loading module 2611.1 is assigned and data blocks 3316 containing metadata rows 2617 are reassigned/routed to the new selected metadata loading module 2611.1 in the case where an existing selected metadata loading module 2611.0 fails/restarts/undergoes an outage. Data blocks can be routed and/or loading module outages can be handled while guaranteeing that all rows (E.g. all metadata rows 2617 and all data rows 2618) are loaded exactly once based on via reassignment of data blocks and/or implementing of a corresponding distributed tasks framework, for example, via implementing some or all features and/or functionality of U.S. Utility application Ser. No. 18/313,548 and/or U.S. Utility application Ser. No. 18/482,939.

In some embodiments, table metadata is generated at compile time, and system metadata is updated over time as needed. In some embodiments, row-level permissions are managed, for example, depending on the system table, the user, and/or a logged-into database. This can be transparent to a corresponding user (e.g. handled via a built-in-view).

FIG. 26B illustrates an example embodiment of a plurality of nodes 37.1-37.V implementing system table data block writer 2655 (e.g. “system TableDataBlock Writer”). Some or all features and/or functionality of system table data block writer 2655 can implement data block routing modules 3305 to emit and/or route data blocks 3316.

System table data block writer 2655 of a given node can generate and/or route data blocks 3316 to loading modules 2510 responsible for loading corresponding tables accordingly. Multiple given tables (e.g. including table x and table y) can corresponding to persistent system tables 2630 for which loading module 2510 is responsible, for example, based on loading module 2510.1 implementing selected metadata loading module 2611. Data blocks for other tables can be routed to other loading modules (e.g. including loading module 2510.2) for loading. Different tables can have data blocks generated via different system metadata generator modules 2613, which can be processed via an unsubmitted overflow and disconnect buffer of writer 2655.

In some embodiments, data blocks containing rows to be loaded are constructed as needed before being passed to the system table data block writer 2655.

In some embodiments, any node 37 can run a system table data block writer, including nodes 37 implementing loading modules 2510.

In some embodiments, additional system table data block writers can be implemented on one node 37, for example, as long as the set of tables each one manages is disjoint.

FIG. 26C illustrates an embodiment of one or more system metadata generator modules 2613 that implement a column extractor module to generate a data block based on processing column extractor input 2641.

In some embodiments, all data blocks for a given table share the same schema. Construction of a given data block can be performed done using a compile-time transformation function, for example, implemented via column extractor module 2640 (e.g. “Schema Column Extractor”), which can takes some input and output a value per-column that can be packed into a data block. For each row of input, all columns can be traversed, and/or the output can be packed into one row of a data block. There can optionally be several schema column extractors defined that all output the same schema for a variety of different inputs types.

The input to the Schema Column Extractor is a nested datatype, (e.g. “schemaColExtractorInput_t”) that allows for “easy” data expression. In some embodiments, schemaColExtractorInput_t is implemented as a vector {HANDLE, vector {SAMPLE_GROUP}} where HANDLE is any object, where SAMPLE_GROUP is a vector_like_object{SAMPLE_VALUE}, and/or where vector_like_object is a vector with custom attribute fields describing the “group” where SAMPLE_VALUE is any object. In some embodiments, handle is implemented via a uuid data type, SampleGroup is implemented via a “plain” vector data type (e.g. having no attributes), and/or Sample Value is implemented via a protobufObject.

Consider an example schema column extractor defining how three columns col 1, col 2, and col 3 be generated:
Col 1: Return Handle as UUID
Col 2: Return protobufObject.attribute2( )
Col 3: Return protobufObject.attribute3( )

In some embodiments, deterministic selection of selected metadata loading module 2611 is performed. In particular, coordinated determination of which loading module 2510 should be targeted between multiple instances of a system table data block writer 2655 (e.g. on a single node and/or across nodes) which loading module 2510 should be targeted as selected metadata loading module 2611. It can be preferred that such coordination is performed without any network communication to minimize complexity.

Such network communication-free coordination of selection of selected metadata loading module 2611 can be performed via a deterministic scheme, for example, based on the current time (e.g. where the current time is the seed to a pseudo number generator).

Implementing this deterministic scheme can be implemented based on pigeonhole the system clock (e.g. seconds/milliseconds/microseconds have too much granularity, so a time value with a larger period that can be easily agreed upon across nodes that all have some small random execution delay is utilized). For example, the current time is determined by a given node as hours since some event (e.g. Epoch) and/or current Coordinated Universal Time (UTC) hour (e.g. some integer value [0-23]), for example, where it is assumed that all servers participating in a database system 10 storage cluster agree on the current UTC time.

Implementing this deterministic scheme can be further based on sorting the current set of loading modules 2510 (e.g. the N current loading modules that are active/participating in loading). In some embodiments, exact sort order doesn't matter, for example, where it just matters that the sort is deterministic across all nodes when given the same input.

Implementing this deterministic scheme can be further based on, using the pigeonhole'd time as a seed to a pseudo random number generator, shuffling the sorted list of streamloaders. Use of the same seed across system table data block writers 2655 can render selection of a same loading module 2510 as the selected metadata loading module 2611 (e.g. first selected in the sorted list via the seed).

In some embodiments, selected metadata loading module 2611 is rotated periodically, for example, to implement load sharing and/or render better load balancing. Such rotating can be handled based on the deterministic scheme being implemented further based on deciding when to switch to a new loading module, for example, via ensuring that all nodes agree on the pseudo random number seed, and thus the same loading module. This can be based on periodically (e.g. at a much smaller period than the pigeonhole'd system clock) polling, via each of the system table data block writers 2655, to see if the clock has rolled over to a new value. If yes, wait a short period & initiate switchover to next loading module 2510 (e.g. if loading module 2510 has changed based on deterministic shuffling)

In some embodiments, this scheme is implemented for a steady-state, non-error case. In some embodiments, while transient conditions may lead to temporary disagreement on the target streamloader is acceptable-while it can lead to less optimal segments, all data can be guaranteed to be loaded.

In some embodiments, failure handling is based on implementing Stream Source IDs (SSIDs) 3320, for example, via implementing some or all features and/or functionality of U.S. Utility application Ser. No. 18/313,548.

In some embodiments, implementing system table data block writers 2655 can be based on guaranteeing that: (1) Each node acquires a SSID (e.g. this SSID is unique on every restart, and/or this SSID is shared between all system table data block writers 2655 of the node); and/or (2) all system table data block writers 2655 on a node have a disjoint set of persistent system tables that they will write data to.

In some embodiments, if an indexer (e.g. loading module 2510) becomes temporarily unavailable or permanently errored, the data that it was responsible for can be redirected to a different indexer, chosen using round-robin from the available indexers, or from the unavailable indexers if none are available. The data can be resent to the new indexer under the same stream source ID, for example, in the same order as it was originally sent, enabling the indexer to perform deduplication correctly. In some embodiments, new data is not sent to the indexer while it is in an error state.

In some embodiments, if an unavailable indexer recovers, a new SSID is associated with that indexer (e.g. one SSID is always used). For example, when an original errored stream source could still be in the process of resending its blocks, assigning new blocks to that stream source in parallel to the retries would violate the guarantee of fixed ordering within a stream source. In some embodiments, to avoid out-of-order violations, all errored blocks are successfully retried before any new blocks are sent. In some embodiments, while blocks reassigned to this indexer from another failed indexer would use their original SSID, any newly enqueued ones use the newly generated one associated with the indexer.

In some embodiments, lots of small data blocks (e.g. only having one or two rows or other small number of rows) are sent to the system table data block writers 2655. In some embodiments, these smaller data blocks can be aggregated (e.g. by system table data block writer 2655) into larger data blocks, for example, to eliminate unnecessary network traffic and tracking overhead.

In some embodiments, an aggregation window buffer is implemented as a buffer on a short timeout with a maximum size. For example, whatever is satisfied first-size limit or timeout-can trigger aggregation & sending of a single data block generated from multiple smaller data block. Such functionality can optionally be implemented based on being straightforward to implement with minimal processing to implement the corresponding logic while reducing network traffic. These upsides can out-weight potential downsides, such as reducing time-to-queryability for low-rate data.

In some embodiments a hysteresis buffer is implemented. For example, a default case can include simply sending all data blocks through, without any aggregation. However, if a sufficient volume of data blocks are sent in a short period of time (e.g. as denoted via predefined threshold), buffering starts. At this point, implementation can resembles the aggregation window buffer. If data volume persists, buffering continues: otherwise, fallback to default case. Such functionality can optionally be implemented based on having upsides of reducing network traffic for heavy volumes of data.

In some embodiments, the system metadata is implemented based on expanding a system catalog to implement persistent system tables 2630 as a corresponding table type (e.g. of a plurality of table types that includes two or more table type, or optionally three or more table types). The schemas for the tables can be stored in a persistent system table store (e.g. “persistentSystemTableStore”) which follows a same format as a system table store (e.g. “systemTableStore” implemented for virtual system tables).

In some embodiments, the persistent system tables 2630 are optionally only accessible to the system admin. To make the data transparent in non-system databases, a built-in view can be implemented, for example, to enable querying from some underlying persistent table. For example, row-level filtering can be performed based on joining the persistent table with some other mechanism (e.g. virtual sys tables, current_database( ), etc.). The built-in view can be of a system catalogue type (e.g. “SYSTEM_CATALOG”), which can helps differentiate it from other types of schema views, such as helper and information schema views.

In some embodiments, persistent system tables 2630 tables live in an “md::system” system config acting as real tables (e.g. unlike virtual counterparts optionally implemented via database system 10) that can be queried, have stats, etc. In some embodiments, adding new tables or altering existing persistent system tables 2630 can optionally be done via implementing an upgrader. In some embodiments, an overarching upgrader exists to add new tables, for example, based on compares the current system with the list of schemas defined in a persistent system table store (E.g. “persistentSystemTableStore”). To alter existing tables, an ad-hoc “alteration upgrader” can be created for each change, for example, calling an internal handler (e.g. an “ALTER TABLE” handlers).

FIG. 26D illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 26D, for example, based on participating in execution of a query being executed by the database system 10. Some or all of the method of FIG. 26D can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 26D based on implementing a corresponding plurality of processing core resources 48.1-48.W. Some or all of the steps of FIG. 26D can optionally be performed by any other one or more processing modules of the database system 10. Some or all of the steps of FIG. 26D can be performed to implement some or all of the functionality of the database system 10 as described in conjunction with FIGS. 26A-26C, for example, by implementing some or all of the functionality of record processing and storage system 2505, data block routing modules 3305, loading modules 2510, system metadata generator modules 2613, selected metadata loading module 2611, metadata rows 2617, and/or persistent system tables 2630. Some or all steps of FIG. 26D can be performed by database system 10 in accordance with other embodiments of the database system 10 and/or nodes 37 discussed herein. Some or all of the steps of FIG. 26D can be performed in conjunction with performing some or all steps of any other method described herein.

Step 2682 includes storing a set of data rows via a set of relational database tables of a database system. Step 2684 includes generating system metadata regarding the database system as a set of metadata rows. Step 2686 includes further storing the set of metadata rows via a second set of relational database tables of the database system based on loading the set of metadata rows for storage via one loading module of a plurality of loading modules based on the one loading module being selected for system metadata loading. Step 2688 includes performing at least one database functionality in accordance with the system metadata based on accessing at least one of the set of metadata rows via the second set of relational database tables.

In various examples, performing the at least one database functionality includes at least one of: loading additional data to the database system for storage: executing at least one query against the set of relational database tables: performing a rebalancing process: performing at least one transfer of data from location to another; monitoring and/or communicating errors encountered via performance of at least one other database functionality: tracking OSNs and data ownership information: tracking visible tables; tracking node availability; and/or any other functionality performed via database system 10 described herein.

In various examples, the method further includes loading the set of data rows for storage via a set of other loading modules of the plurality of loading modules based on the other loading modules not being selected for system metadata loading.

In various examples, the set of metadata rows are loaded via the one loading module during a first temporal period. In various examples, the set of data rows are loaded via the set of other loading modules during a second temporal period. In various examples, the first temporal period overlaps with the second temporal period based on the plurality of loading module operating in parallel.

In various examples, a plurality of sets of metadata rows are stored over a time period that includes corresponding plurality of sequential time frames via a corresponding plurality of loading modules based on a turn-based selection of the one loading module selected for system data loading for each of the corresponding plurality of sequential time frames. In various examples, exactly one loading module is selected for system data loading at any time during the time period.

In various examples, the set of metadata rows are stored via a set of parallelized data writer modules communicating with the one loading module. In various examples, all of the set of parallelized data writer modules send corresponding ones of the set of metadata rows to the one loading module based on each determining the one loading module is selected for the system metadata loading.

In various examples, each of the set of parallelized data writer modules determine the one loading module is selected for the system metadata loading without coordination with other ones of the set of nodes based on the each of the set of parallelized data writer modules applying a same deterministic scheme to select the one loading module.

In various examples, the same deterministic scheme is applied to select the one loading module as a function of a current time based on utilizing the current time as a seed to a pseudo random number generator to shuffle a sorted list of loading modules.

In various examples, a plurality of sets of metadata rows are stored over a time period that includes corresponding plurality of sequential time frames via a corresponding plurality of loading modules based on a turn-based selection of the one loading module selected for system data loading for each of the corresponding plurality of sequential time frames. In various examples, the current time is utilized to identify the one loading module of the corresponding plurality of loading modules selected for system data loading for the each of the corresponding plurality of sequential time frames.

In various examples, a second set of metadata rows of the system metadata are stored based on: assigning the second set of metadata rows for storage via the one loading module of the plurality of loading modules based on the one loading module being selected for system metadata loading; and/or reassigning the second set of metadata rows for storage via one new loading module of the plurality of loading modules in accordance with a failure handling scheme based on the one loading module encountering a failure. In various examples, the second set of metadata rows are stored exactly once via the database system based on applying the failure handling scheme.

In various examples, a plurality of metadata table sources each generate data blocks that include ones of the set of metadata rows for a corresponding one of the second set of relational database tables in accordance with a schema for the corresponding one of the second set of relational database tables.

In various examples, each of the plurality of metadata table sources generates each data block to include a number of rows dictated by applying a buffering scheme based on: a predetermined maximum number of rows: a predetermined timeout; and/or a predetermined threshold maximum rate of data block generation.

In various examples, the method further includes enabling access to the system metadata by a system administrator entity via a corresponding build-in view for at least one of the second set of relational database tables.

In various example, the method further includes determining a query for execution against at least one of the set of relational database tables; and executing the query to generate a corresponding query resultant based on performance of the at least one database functionality in accordance with the system metadata.

In various examples, generating and storing the set of data rows is based on: generating and storing a set of pages. In various examples, in response to detecting that a page drain condition has been met, the method further includes determining a conversion page set as a proper subset of pages included in the set of pages based on a predetermined post-drain number of pages and/or performing a page conversion process upon pages included in the conversion page set to generate a set of segments from the pages included in the conversion page set. In various examples, the method further includes storing the set of segments via the database system.

In various examples, the set of data rows are stored in a set of segments. In various examples, the method further includes performing a segment group transfer process during a segment group transfer temporal period to transfer the set of segments from a first storage cluster to a second storage cluster. In various examples, performance of the segment group transfer process includes serialized performance of a plurality of steps in accordance with a query correctness guaranteeing strategy. In various examples, the method further includes, during a query execution temporal period overlapping with the segment group transfer temporal period, performing a query execution process to execute a query against the database system. In various examples, due to the serialized performance of the plurality of steps in accordance with the query correctness guaranteeing strategy, a query resultant generated via execution of the query is guaranteed to be correct based on the set of segments being accessed via exactly one storage cluster corresponding to either the first storage cluster or the second storage cluster.

In various examples, the set of data rows are stored via a plurality of storage buckets of the database system. In various examples, the method further includes performing a storage rebalancing process based on current storage distribution data for the plurality of storage buckets. In various examples, performing the storage rebalancing process is based on: identifying a first subset of the plurality of storage buckets as a plurality of source buckets based on each of the first subset of the plurality of storage buckets having corresponding storage utilization meeting source bucket criteria: identifying a second subset of the plurality of storage buckets as a plurality of target buckets based on each of the first subset of the plurality of storage buckets having corresponding storage utilization meeting target bucket criteria; and/or performing a plurality of data transfers. In various examples, performing each of the plurality of data transfers includes transferring storage of data included in one of plurality of source buckets to one of the plurality of target buckets.

In various examples, the set of data rows are included in a plurality of segments generated from the set of data rows. In various examples, the method further includes: based on generating the plurality of segments, populating a time bucket lookup map corresponding to the relational database table based on time values of the plurality of segments: determining a query for execution indicating time-based filtering parameters: identifying a time-based pre-filtered segment set of the plurality of segments based on accessing the time bucket lookup map based on the time-based filtering parameters; and/or executing the query based on accessing only segments of the plurality of segments included in an identified segment set determined based on identifying the time-based pre-filtered segment set.

In various examples, the set of data rows are included in a plurality of segments generated from the set of data rows. In various examples, the method further includes populating a multi-dimensional index structure. In various examples, the multi-dimensional index structure has a plurality of dimensions corresponding to a plurality of segment attribute types. In various examples, the method further includes: determining a query for execution: determining, based on the query, a required attribute value range for each of the plurality of segment attribute types: identifying an identified segment set based on accessing the multi-dimensional index structure determine ones of the plurality of segments having corresponding attributes for the each of the plurality of segment attribute types falling within the required attribute value range; and/or executing the query based on accessing only segments of the plurality of segments included in the identified segment set.

In various embodiments, any one of more of the various examples listed above are implemented in conjunction with performing some or all steps of FIG. 26D. In various embodiments, any set of the various examples listed above can be implemented in tandem, for example, in conjunction with performing some or all steps of FIG. 26D, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 26D described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 26D, for example, in conjunction with further implementing any one or more of the various examples described above.

In various embodiments, the operational instructions, when executed by the at least one processor, cause the database system to: store a set of data rows via a set of relational database tables of a database system: generate system metadata regarding the database system as a set of metadata rows; further store a set of metadata rows via a second set of relational database tables of the database system based on loading the set of metadata rows for storage via one loading module of a plurality of loading modules based on the one loading module being selected for system metadata loading; and/or perform at least one database functionality in accordance with the system metadata based on accessing at least one of the set of metadata rows via the second set of relational database tables.

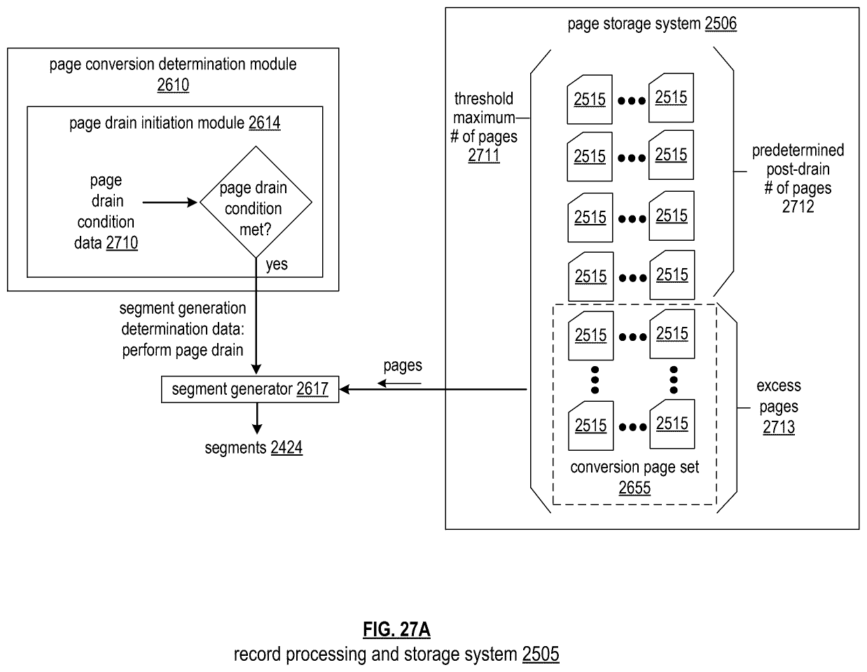

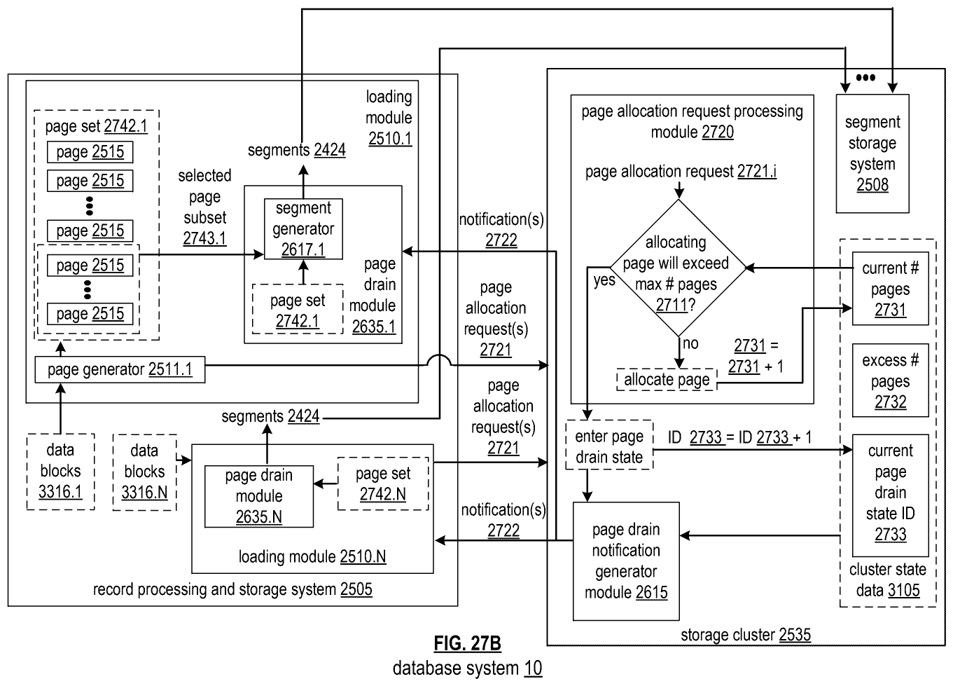

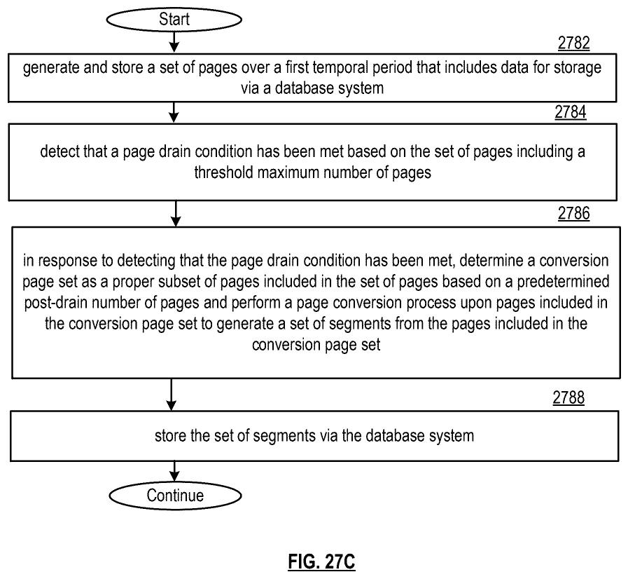

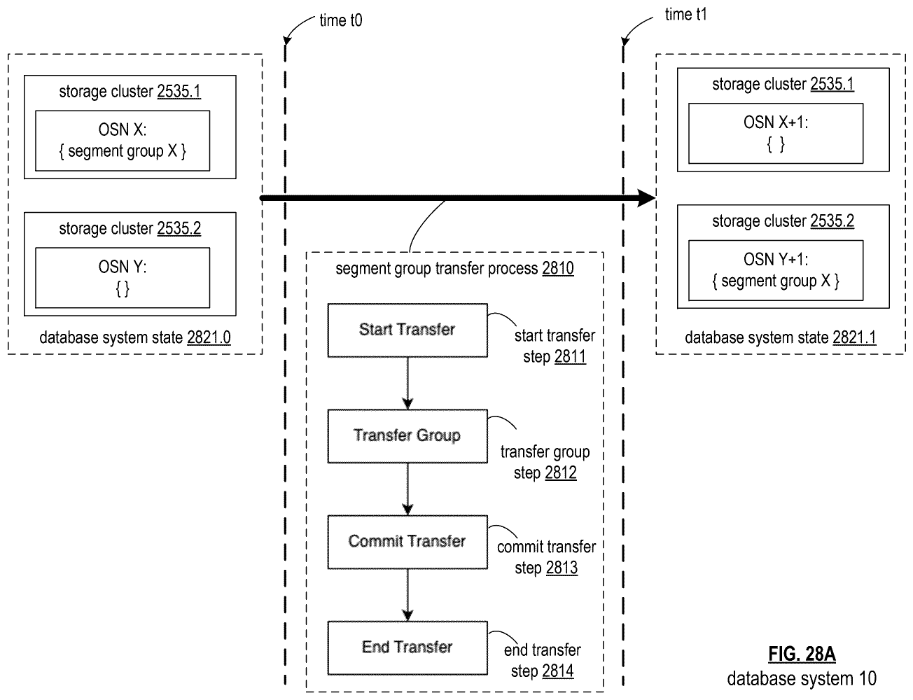

FIGS. 27A-27B illustrate embodiments of a database system 10 operable to perform a page drain to generate segments 2424 from pages 2515 when a page drain condition is met. Some or all features and/or functionality of FIGS. 27A-27B can implement any embodiment of record processing and storage system 2515, segment generator module 2617 and/or 2507, and/or any page conversion process to generate segments from a set of pages in a conversion page set 2655 described herein. Some or all features and/or functionality of FIGS. 27A-27B can implement any embodiment of database system 10 described herein.

In some embodiments, data loaded into database system 10 is grouped into pages 2515 which are later grouped into and persisted as segments 2424. Both page generation and segment generation can be performed by via a streamloader role (e.g. implemented via loading modules 2510 of data processing and storage system 2505).

In some embodiments, due to different requirements, page generation and segment generation have different throughput characteristics. For example, pages are generated soon after the data is input into the system, where the input rate can be highly variable.

Loading modules 2510 can be implemented to attempt to maximize the size of generated segments while still being able to fit them into memory. Segments 2424 can be generated when there are enough pages of a given time bucket, and/or when all pages of a bucket surpass an age limit (e.g. a “segment generation timeout”).

Both pages and segments can be committed to the storage cluster consensus state (e.g. mediated via a consensus protocol).

In some embodiments, if page generation outpaces segment generation over a long period of loading, various problematic circumstances can result, such as: (1) the consensus state can be overloaded with per-page metadata which slows the whole system down; and/or (2) streamloader memory that is taken up by pages cannot be used for segment generation, which can negatively impacts the size/quality of generated segments. These problems (1) and (2) can contribute to slowing down segment generation even more, which can lead to a vicious cycle of poor efficiency of segment generation.

FIGS. 27A-27B introduce functionality that mitigates occurrence of these problematic circumstances based on introducing a phase of “force-draining” pages into segments via performance of a force drain when a page drain condition is met (e.g. after hitting page-count peaks). This can include taking care to never force-drain too many pages, to avoid uncontrolled deterioration of segment quality. By using separate phases instead of constant adjustment, page and segment generation can be maintained to run at full steam most and/or all of the time.

In particular, this approach can be implemented to limit the effective page generation rate, for example, without seriously affecting segment generation throughput or segment quality, regardless of data input rate or variations in system configuration such as number and sizes of loading modules 2510 or storage clusters 2535. Hence, this approach can be optionally implemented without requiring site-specific configuration by a human expert in most and/or all cases, which can be useful in reducing human intervention required for data loading to database system 10.

As illustrated in FIG. 27A, a page conversion determination module 2610 can implement a page drain initiation module 2614 to generate segment generation determination data indicating a page drain be performed via segment generator 2617 upon a conversion page set 2655 of pages 2515 in page storage system 2506 when a page drain condition indicated by page drain condition data 2710 has been met (e.g. once the page storage system stores at least a threshold maximum number of pages 2711). When the page drain is indicated to be performed, segment generator 2617 can perform a corresponding page drain based on generating segments 2424 from a conversion page set 2655 corresponding to excess pages 2713 beyond a predetermined post-drain number of pages 2712.

The threshold maximum number of pages 2711 and/or predetermined post-drain number of pages 2712 can be configured via user input, can be automatically selected, can be fixed or dynamically can change over time, can be accessed via memory resources, can be received, can be indicated in state data and/or system metadata, and/or can otherwise be determined.

In some embodiments, the threshold maximum number of pages 2711 is indicated in storage cluster state data (e.g. implemented via a storage cluster state machine) as a conservative limit on the number of pages (e.g. a “high watermark”). The page drain condition data 2710 can indicate that, as soon as the threshold maximum number of pages 2711 would be exceeded by a page allocation request, the storage cluster starts rejecting such requests, until the page count goes below a predetermined post-drain number of pages 2712 (e.g. a “low watermark”).

As illustrated in FIG. 27B, such functionality of FIG. 27A can be based on communication between loading modules 2510 of record processing and storage system 2505 and storage cluster 2535. For example, the storage cluster 2535 stores pages 2515 in page sets 2742 generated via page generators 2511 of loading modules 2510 from data blocks 3316 sent to these loading modules 2510 for loading, and/or maintains information regarding pages and/or their ownership/other information in query execution in cluster state data 3105, which can implement some or all features and/or functionality of any state data and/or system metadata described herein (e.g. cluster state data 3105 is mediated in accordance with a consensus protocol via nodes 37 of the storage cluster 2535).

In some embodiments, as a given loading module 2510 begins generating a new page 2515 (e.g. to store rows included in one or more incoming data blocks 3316), it can send a corresponding page allocation request 2721 to the storage cluster 2535. A page allocation request processing module 2720 of the storage cluster 2535 can thus receive page allocation requests 2721 from loading modules 2510 over time as they receive new data blocks 3316 to be loaded into pages 2515 before segment generation. The page allocation request processing module 2720 can process a given incoming page allocation request 2721.i based on determining whether allocating the new page 2515 will render exceeding of the threshold maximum number of pages 2711 (e.g. corresponding to determining whether the page drain condition indicated in page drain condition data 2710 is met). This can be based on comparing a current number of pages 2731 to the threshold maximum number of pages 2711 (e.g. allocating the page will render exceeding the maximum number of pages 2711 when the current number of pages 2731 is already at the maximum number of pages 2711). The current number of pages can be indicated in cluster state data 3105 and/or can otherwise be determined via page allocation request processing module 2720 (e.g. based on tracking how many pages have been allocated that were not yet drained/converted into segments 2424).

If the threshold maximum number of pages 2711 will not be exceeded via allocating the page, the page allocation request 2721.i is accepted and the page is allocated, allowing the corresponding loading module 2510 that sent page allocation request 2721.i to generate the corresponding page 2515 in the allocated memory accordingly. The current number of pages 2731 can be updated to indicate addition of the newly allocated page.

If the threshold maximum number of pages 2711 will be exceeded via allocating the page, the page allocation request 2721.i is rejected and the page is not allocated. Furthermore, a page drain state corresponding to performing the page drain can be entered.

Entering the page drain state can include incrementing a current page drain state ID 2733 (e.g. a serial ID “pageCountPeakGeneration” included in the storage cluster state) maintained in cluster state data 3105 can be incremented, denoting entering of a new page drain process (e.g. a corresponding integer value is incremented every time the storage cluster starts rejecting page allocation requests). This can enable loading modules 2510 to drop redundant messages (e.g. ignore messages indicating a page drain state ID from a prior page drain state that was already completed).

Entering the page drain state can include implementing a page drain notification generator module 2615 to send page drain notifications 2722 to loading modules 2510. Based on receiving a page drain notification 2722, the loading modules 2510 can operate in accordance with entering the page drain state via implementing page drain modules 2635 to implement segment generator and generate segments 2424 from a corresponding page set 2742 for storage via segment storage system 2508 (e.g. memory drives of nodes 37 of the storage cluster 2535). For example, the page sets 2742.1-2742.N collectively constitute the excess pages 2713 implemented as conversion page set 2655. The page drain notifications 2722 can indicate the current page drain state ID 2733, communicating to loading modules which page drain process the notification refers to (e.g. enabling loading modules 2510 to identify and/or ignore “old” notifications from prior page drain states) and/or other information included in cluster state data 3105.

In some embodiments, the cluster state data 3105 can track an excess number of pages 2732 (e.g. the difference between the current number of pages 2731 and the predetermined post-drain number of pages 2712,), which can denote the number of pages still left in excess pages 2713 (e.g. pages still awaiting conversion into segments), where the current number of pages 2731 and excess pages 2713 are updated to reflect any page conversions (e.g. their values are decremented by the number of pages released in conjunction with generating segments from these pages via a segment generator 2617 of a loading module 2510).

The storage cluster can communicate to loading modules 2510 how many excess pages they need to drain. In some embodiments, it does not suffice to, based on a snapshot of the state, reject page allocations and compute the number of excess pages, because, due to the system's distributed nature, later snapshots created by concurrent page allocations might increase the page count yet again, possibly overshooting the high watermark. Additionally, in some embodiments, it also does not suffice to continually adjust the number of excess pages because that would skew the number of pages to drain in favor of faster loaders. Instead, optimistic concurrency control can be implemented to ensure that the high watermark is never exceeded. For example, the storage cluster state machine can be operable to fail instead of committing pages beyond the high watermark.

In some embodiments, this optimistic concurrency control can be implemented based on, as soon as a storage cluster starts rejecting page allocations, reporting the following information to loading modules 2510 (e.g. in notifications 2722): (1) the current number of pages 2731 (e.g. value of a “pageCount” variable corresponding to the current number of pages in the storage cluster): (2) the current page drain state ID 2733 (e.g. value of a “pageCountPeakGeneration” variable corresponding to the serial ID of the current “peak” corresponding to the current page drain state); and/or (3) the excess number of pages 2732 (e.g. the value of an “excessPages” variable corresponding to the number of remaining pages above the low watermark).

In some embodiments, this information can be communicated to loading modules via one or more channels (e.g. implemented via page drain notification generator module 2615), which can include: (1) sending this information (e.g. in corresponding notifications 2722) to loading modules 2510 whose page allocation requests are rejected receive the numbers immediately in the rejection response; and/or (2) sending this information (e.g. in corresponding notifications 2722) to idle loading modules in fixed intervals (e.g. via a heartbeat), for example, to make sure they participate in reducing page count (e.g. to trigger their entering of the page drain state via page drain module 2635). The storage cluster can continue to send this information (e.g. indicating updates to current number of pages 2731 and/or excess number of pages 2732) for as long as it rejects page allocations 2721 during the page drain state, for example, so package loss and/or node outages are tolerated. Additionally loading modules 2510 can be implemented to gracefully handle reports that no longer match the storage cluster state (e.g. based on the value of current page drain state ID 2733).

A given stream loader 2510 can process an incoming notification 2722 to decide whether to start or stop force-draining (e.g. to enter or exit a given page drain state implemented via its page drain module 2635) via implementing some or all of the following logic:

```
BEGIN {
  isDraining = false
}
needsDrain = excessPages > 0
if isDraining and not needsDrain:
  isDraining = false
else if not isDraining and needsDrain and pageCountPeakGeneration !=
seenGeneration:
  isDraining = true
seenGeneration = pageCountPeakGeneration
```

For example, needsDrain may be stale, and/or false positives around the time when the low watermark is reached can be a very real possibility. To protect against this, force-draining is optionally only initiated whenever a new peak was reached (e.g. once the threshold maximum number of pages 2711 is again exceeded to render entering of a new page drain state), as indicated by pageCountPeakGeneration (e.g. due the value of current page drain state ID being incremented accordingly when entering a new page drain state).

In some embodiments, when a loading module receives a notification 2722 and determines to enter/continue participation in the given page drain state, it can being to: (1) stop accepting new pages (e.g. presumably there are enough pages at this point); and/or force-drain pages into segments via page drain module 2635, for example, in spite of “normal” segment generation timeout and minimum segment size requirements that are generally required to initiate segment generation (e.g. in embodiments where the segment generator 2617 is implemented to wait as long as possible to generate segments from a large number of pages otherwise when a force-drain condition is not met and force draining is not triggered, for example, via implementing some of all features and/or functionality of delaying segment generation disclosed by U.S. Utility application Ser. No. 16/985,723).

In some embodiments, page count and/or size are highly dependent on the rate at which data is input, while segments are much less impacted. To address the problem of too much per-page metadata, force-draining can be initiated, on each cluster, to drain the number of pages above the low watermark. Each given loading module 2510 can compute how many/which of the pages it is responsible for draining itself (e.g. for conversion into pages via inclusion in its page set 2742). Different loading modules can have different sized page sets 2742 with different numbers of pages.

In some embodiments, for a given loading module 2510 “loader”, the number of pages to convert included in page set 2742 can be computed as pagesToConvert (loader)=ceil (ownedPages (loader)/pageCount*excessPages). For example, each loading module 2510 can be implemented to drain the share of pages that is proportional to the number of pages it owns (e.g. that it generated). At the tail end of the force-draining phase, this can throttle loading modules 2510 that have a faster relative page drain rate. Some throughput can be traded for segment quality.

In some embodiments, a given loading module 2510 continues its participation in the page drain process via force-draining pages until an exit page drain state condition is met, for example, based on determining one of: (1) It has completed draining its share of pages (e.g. the identified pages to convert in page set 2742, or (2) it hears from storage cluster via a success page/segment allocation response or heartbeat, that there are no more excess pages (E.g. the page drain notification generator module 2615 sends notifications 2722 indicating that the page drain state has ended to all loading modules 2510 once the current number of pages 2731 meets/falls below the predetermined post-drain number of pages 2712). Eventually, all loading modules 2510.1-2510.N will reach this state, for example, even if no page was drained outside the force-draining logic discussed above.

In some embodiments, the approach to performing a page drain process is based on the goal of back-propagating excessive pressure from the storage cluster to the loading modules 2510.1-2510.N, for example, erring on the side of doing so later (e.g. but before a catastrophic/extreme state of excess memory allocation to pages occurs) rather than as soon as, say, a “bad” trend would be identified (e.g. via a human expert would notice) to render a more simplistic implementation of logic for automated detection and response to cases where page allocation is excessive. In other embodiments, more complex solutions can be implemented to enable higher throughput, for example, where page drain condition data 2710 corresponds to more sophisticated conditions (e.g. generated/detected via machine learning and/or artificial intelligence techniques, and/or corresponding to more sophisticated conditions that a threshold maximum number of pages 2711).

FIG. 27C illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27C, for example, based on participating in execution of a query being executed by the database system 10. Some or all of the method of FIG. 27C can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 27C based on implementing a corresponding plurality of processing core resources 48.1-48.W. Some or all of the steps of FIG. 27C can optionally be performed by any other one or more processing modules of the database system 10. Some or all of the steps of FIG. 27C can be performed to implement some or all of the functionality of the database system 10 as described in conjunction with FIGS. 27A-27B, for example, by implementing some or all of the functionality of record processing and storage system 2505, page conversion determination module 2610, page drain initiation module 2614, page drain condition data 2710, segment generator 2617, page storage system 2506, page allocation request processing module 2720, page drain notification generator 2615, cluster state data 3105, and/or loading modules 2510. Some or all steps of FIG. 27C can be performed by database system 10 in accordance with other embodiments of the database system 10 and/or nodes 37 discussed herein. Some or all of the steps of FIG. 27C can be performed in conjunction with performing some or all steps of any other method described herein.

Step 2782 includes generating and storing a set of pages over a first temporal period that includes data for storage via a database system. Step 2784 includes detecting that a page drain condition has been met based on the set of pages including a threshold maximum number of pages. Step 2786 includes, in response to detecting that the page drain condition has been met, determining a conversion page set as a proper subset of pages included in the set of pages based on a predetermined post-drain number of pages; and/or performing a page conversion process upon pages included in the conversion page set to generate a set of segments from the pages included in the conversion page set. Step 2788 includes storing the set of segments via the database system.

In various examples, determining the conversion page set is based on computing an excess number of pages as a difference between a current number of pages in the set of pages and the predetermined post-drain number of pages for inclusion in the conversion page set. In various examples, a remaining set of pages still awaiting conversion into segments after performing the page conversion process upon the pages included in the conversion page set includes the predetermined post-drain number of pages.

In various examples, generating each page of the set of pages is based on determining that generation of the each page would not render meeting of the page drain condition. In various examples, the page drain condition is no longer met after performance of the page conversion process upon pages included in the conversion page set.

In various examples, generating the each page of the set of pages is based on allocating corresponding page memory for the each page via a corresponding page allocation request to a storage cluster. In various examples, a plurality of nodes of the storage cluster store the set of pages during the first temporal period and store the set of segments after the first temporal period. In various examples, the page drain condition has been met is based on determining that satisfying a page allocation request for a subsequent page to be generated next after generating the set of pages would render exceeding of the maximum threshold number of pages.

In various examples, the storage cluster rejects a plurality of page allocation requests during a page drain time frame corresponding to a page drain state after the page drain condition is detected and prior to completion of the page conversion process upon pages included in the conversion page set based on the page drain condition being met during the page drain time frame and/or based on the page drain time frame ending when the page drain condition is met.

In various examples, the set of pages are generated via a parallelized set of loading modules. In various examples, each of the plurality of page allocation requests are received from a corresponding loading module of the parallelized set of loading modules. In various examples, based on receiving page drain notification data from the storage cluster during the page drain time frame, each loading module of the parallelized set of loading modules: foregoes generation of additional pages during the page drain time frame and/or participates in the page conversion process without coordination with other ones of the parallelized set of loading modules.

In various examples, the storage cluster sends the page drain notification data to the corresponding loading module in response to receiving the each of the plurality of page allocation requests during the page drain time frame.

In various examples, page drain state data for the page drain time frame is mediated via the plurality of nodes of the storage cluster in accordance with a consensus protocol. In various examples, the page drain notification data is generated based on the page drain state data to indicate: a current number of pages stored by the storage cluster: a current page drain state identifier corresponding to the page drain state based on the current page drain state identifier being incremented in response initiating of the page drain time frame; and/or a remaining number of excess pages above the predetermined post-drain number of pages.

In various examples, the set of pages includes a plurality of per-loading module page sets. In various examples, the conversion page set includes a plurality of per-module page drain sets corresponding to the parallelized set of loading modules. In various examples, each loading module determines a corresponding set of pages to include in a corresponding per-module page drain set in response to receiving the page drain notification data, independently of other ones of the parallelized set of loading modules, to include a number of pages proportional to a total number of pages included in a corresponding per-loading module page set for the each loading module based on computing the number of pages for inclusion in the corresponding per-module page drain set as a function of the current number of pages and the remaining number of excess pages.

In various examples, prior to generation of the set of pages, a plurality of prior sets of pages are generated and converted into segments via a corresponding plurality of prior page conversion processes. In various examples, each of a subset of prior page conversion processes of the corresponding plurality of prior page conversion processes are performed during prior page drain time frames triggered based on corresponding prior detection of the page drain condition. In various examples, each of the subset of prior page conversion processes has a different current page drain state identifier based on incrementing the current page drain state identifier for each of the corresponding plurality of prior page conversion processes. In various examples, the each loading module of the parallelized set of loading modules initiates participation in the page conversion process based on determining the current page drain state identifier received in corresponding page drain notification data is different from a most-recently seen current page drain state identifier from prior corresponding page drain notification data sent in one of the corresponding plurality of prior page conversion processes.

In various examples, the set of pages are generated based on receiving the data and processing the data for storage during the first temporal period. In various examples, a remaining subset of pages awaiting conversion after the page conversion process corresponds to a set different between the set of pages and the proper subset of pages. In various examples, the page conversion process is triggered by any of a set of different conditions that includes the page drain condition and a maximized segment size-based segment generation condition. In various examples, the method further includes further generating a second set of pages over a second temporal period that includes second data for storage via the database system based on receiving the second data and processing the second data for storage during the second temporal period. In various examples, the method further includes, in response to detecting that the maximized segment size-based segment generation condition: determining a second conversion page set to include a union of the remaining subset of pages and the second set of pages; and/or performing the page conversion process upon pages included in the second conversion page set to generate a second set of segments from the pages included the second conversion page set. In various examples, the method further includes storing the second set of segments via the database system.

In various examples, the maximized segment size-based segment generation condition is based on: a segment generation timeout period and/or a minimum segment size. In various examples, the set of segments includes at least one segment falling below the minimum segment size based on the page conversion process being performed despite the maximized segment size-based segment generation condition not being met due to detecting that the page drain condition. In various examples, the set of segments includes at least one segment falling below the minimum segment size based on the page conversion process being performed despite the maximized segment size-based segment generation condition not being met due to detecting that the page drain condition. In various examples, the first temporal period is shorter than the segment generation timeout period based on the page conversion process being performed despite the maximized segment size-based segment generation condition not being met due to detecting that the page drain condition.

In various examples, the method further includes, during the second temporal period and prior to generating the second set of segments: determining a query for execution against a dataset that includes the data and the second data; and/or executing the query to generate a corresponding query resultant based on accessing at least one of the set of segments and/or at least one of the second set of pages.

In various examples, the method further includes generating system metadata regarding the database system as a set of metadata rows. In various examples, the method further includes further storing the set of metadata rows via a second set of relational database tables of the database system based on loading the set of metadata rows for storage via one loading module of a plurality of loading modules based on the one loading module being selected for system metadata loading.

In various examples, the method further includes performing a segment group transfer process during a segment group transfer temporal period to transfer the set of segments from a first storage cluster to a second storage cluster, where performance of the segment group transfer process includes serialized performance of a plurality of steps in accordance with a query correctness guaranteeing strategy; and/or during a query execution temporal period overlapping with the segment group transfer temporal period, performing a query execution process to execute a query against the database system. In various examples, due to the serialized performance of the plurality of steps in accordance with the query correctness guaranteeing strategy, a query resultant generated via execution of the query is guaranteed to be correct based on the set of segments being accessed via exactly one storage cluster corresponding to either the first storage cluster or the second storage cluster.

In various examples, the set of segments are stored via a plurality of storage buckets of the database system. In various examples, the method further includes performing a storage rebalancing process based on current storage distribution data for the plurality of storage buckets. In various examples, performing the storage rebalancing process is based on: identifying a first subset of the plurality of storage buckets as a plurality of source buckets based on each of the first subset of the plurality of storage buckets having corresponding storage utilization meeting source bucket criteria: identifying a second subset of the plurality of storage buckets as a plurality of target buckets based on each of the first subset of the plurality of storage buckets having corresponding storage utilization meeting target bucket criteria; and/or performing a plurality of data transfers. In various examples, performing each of the plurality of data transfers includes transferring storage of data included in one of plurality of source buckets to one of the plurality of target buckets.

In various examples, the set of segments are included in a plurality of segments stored by the database system. In various examples, the method further includes, based on generating the set of segments, populating a time bucket lookup map based on time values of the set of segments. In various examples, the method further includes: determining a query for execution indicating time-based filtering parameters: identifying a time-based pre-filtered segment set of the plurality of segments based on accessing the time bucket lookup map based on the time-based filtering parameters; and/or executing the query based on accessing only segments of the plurality of segments included in an identified segment set determined based on identifying the time-based pre-filtered segment set.

In various examples, the set of segments are included in a plurality of segments stored by the database system. In various examples, the method further includes populating a multi-dimensional index structure. In various examples, the multi-dimensional index structure has a plurality of dimensions corresponding to a plurality of segment attribute types. In various examples, the method further includes: determining a query for execution: determining, based on the query, a required attribute value range for each of the plurality of segment attribute types: identifying an identified segment set based on accessing the multi-dimensional index structure determine ones of the plurality of segments having corresponding attributes for the each of the plurality of segment attribute types falling within the required attribute value range; and/or executing the query based on accessing only segments of the plurality of segments included in the identified segment set.

In various embodiments, any one of more of the various examples listed above are implemented in conjunction with performing some or all steps of FIG. 27C. In various embodiments, any set of the various examples listed above can be implemented in tandem, for example, in conjunction with performing some or all steps of FIG. 27C, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27C described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27C, for example, in conjunction with further implementing any one or more of the various examples described above.

In various embodiments, the operational instructions, when executed by the at least one processor, cause the database system to: generate and/or store a set of pages over a first temporal period that includes data for storage via a database system; detecting that a page drain condition has been met based on the set of pages including a threshold maximum number of pages: in response to detecting that the page drain condition has been met, determine a conversion page set as a proper subset of pages included in the set of pages based on a predetermined post-drain number of pages and/or perform a page conversion process upon pages included in the conversion page set to generate a set of segments from the pages included in the conversion page set; and/or store the set of segments via the database system.

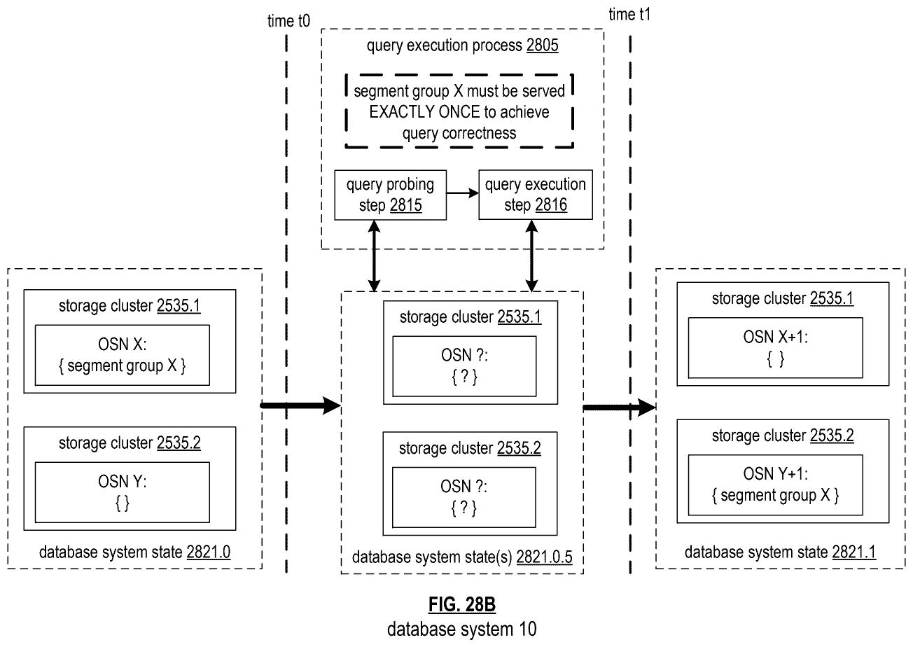

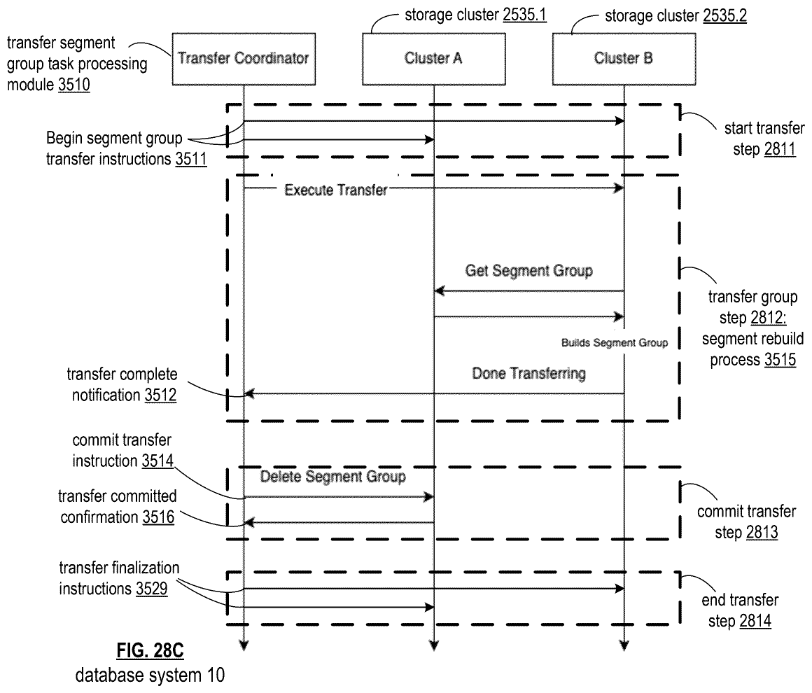

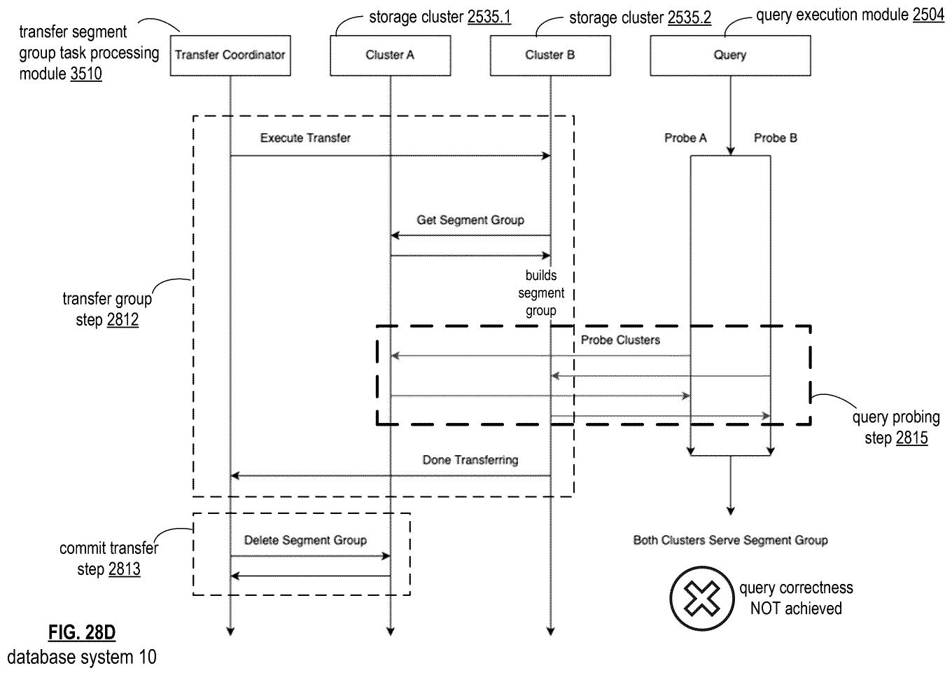

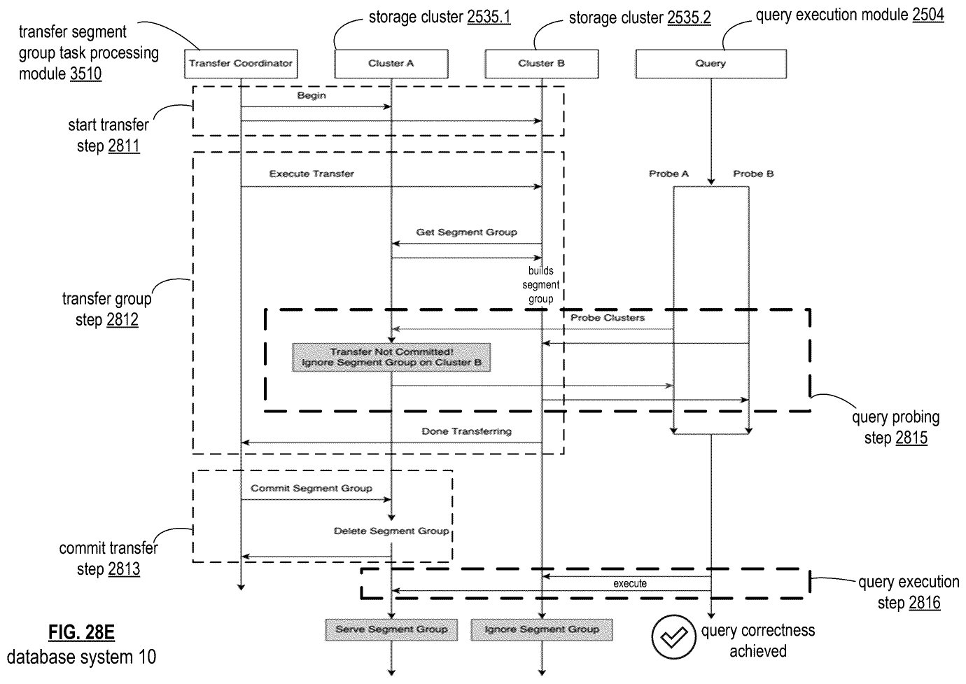

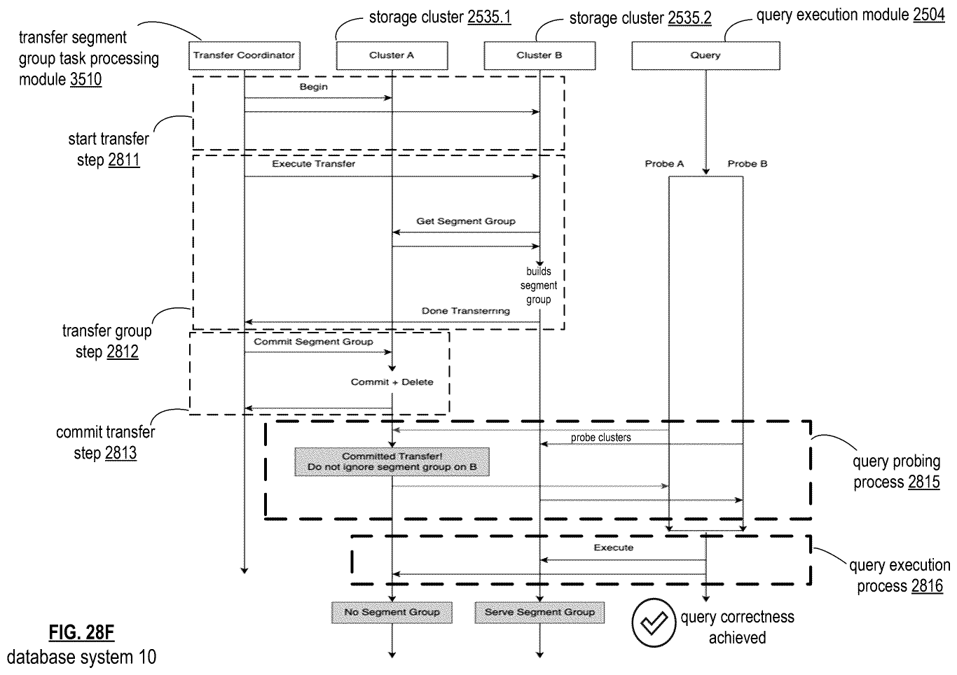

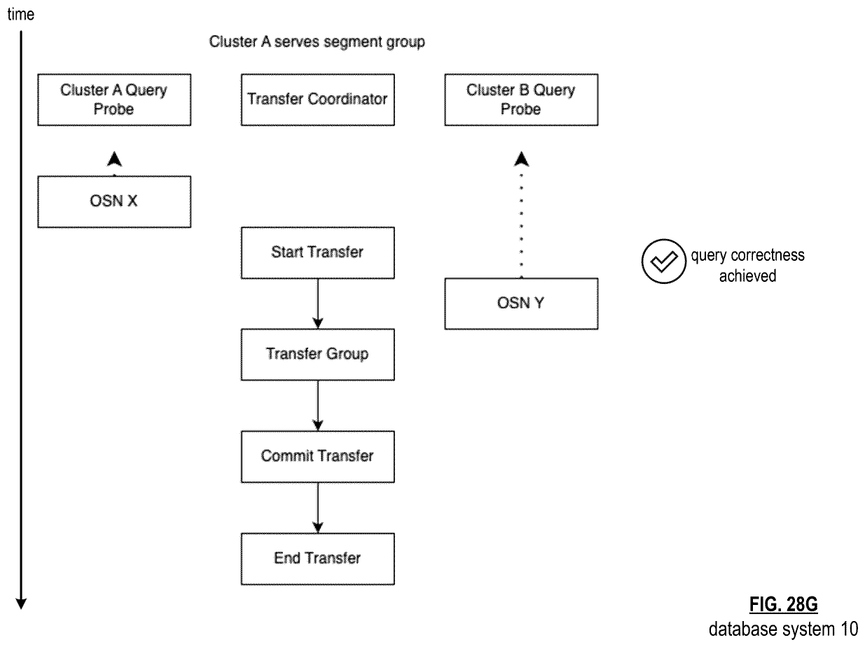

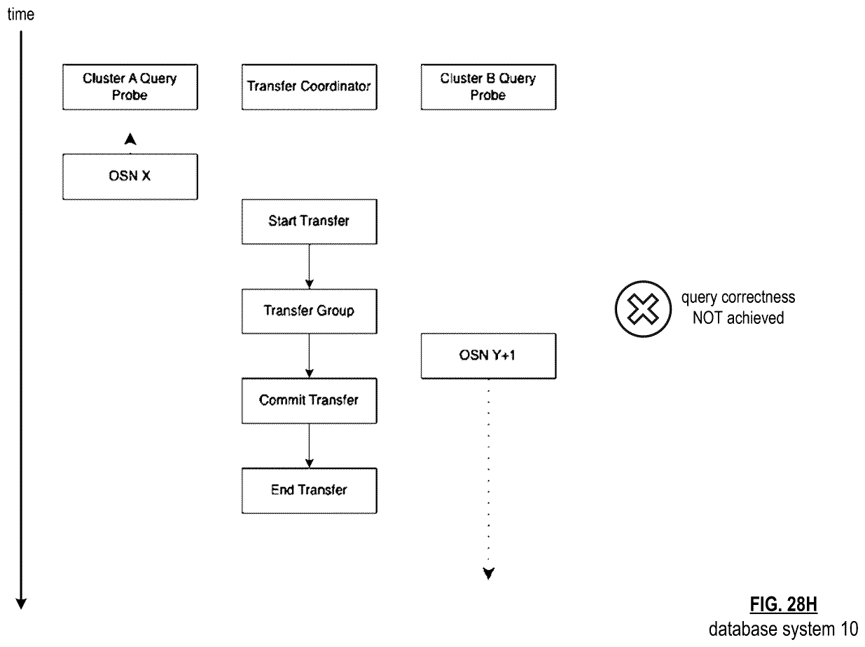

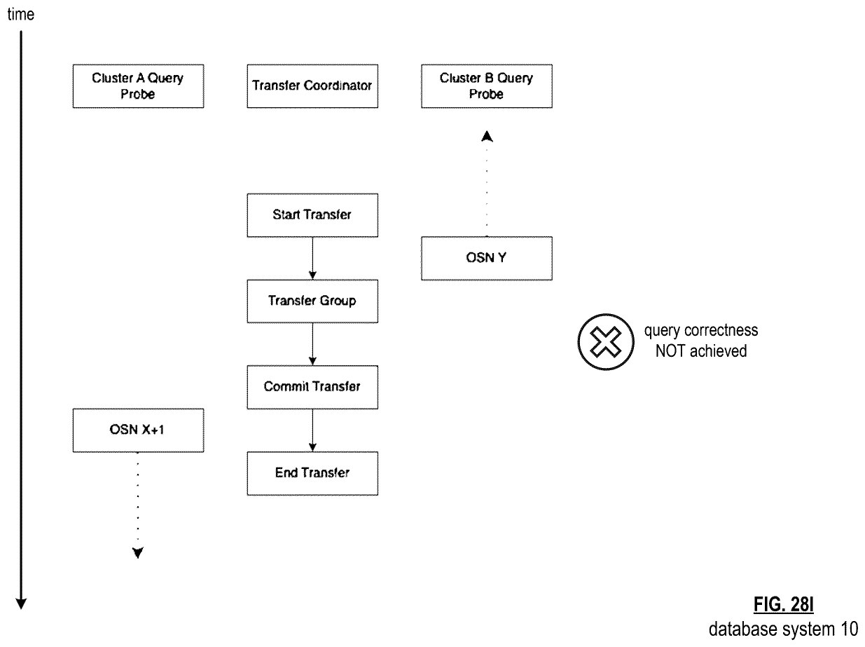

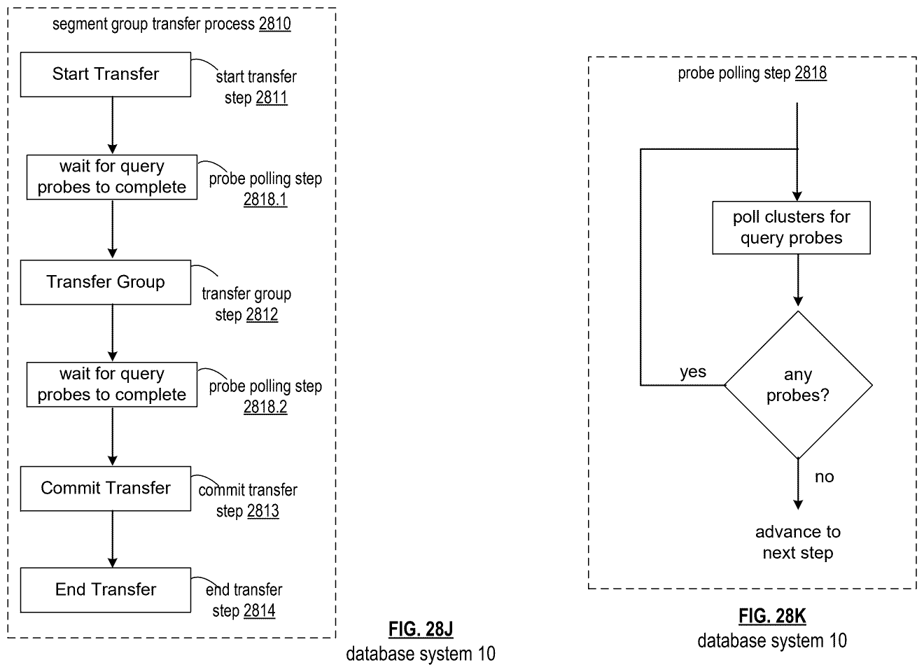

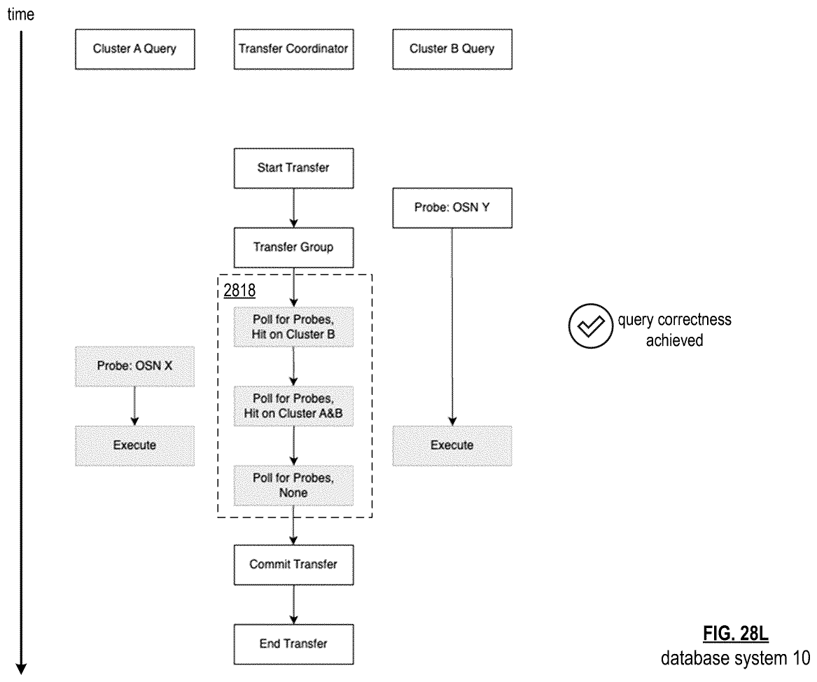

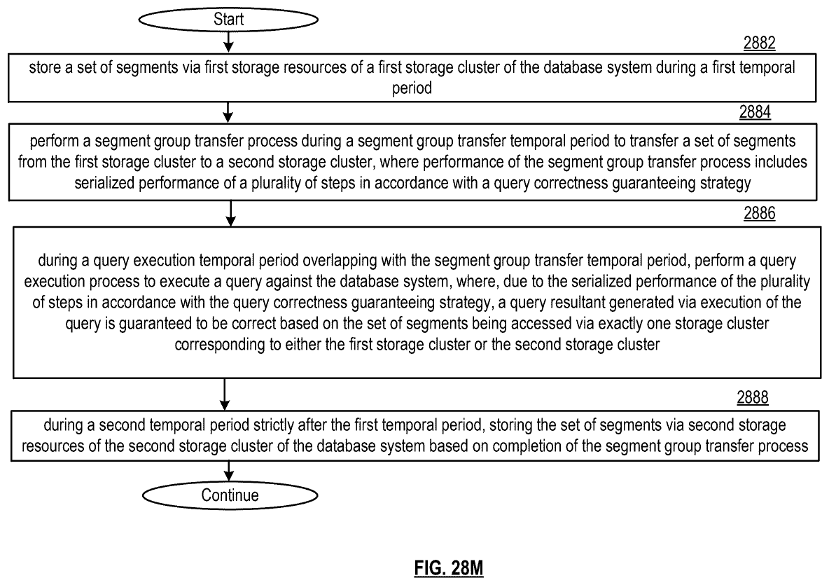

FIGS. 28A-28L illustrate embodiments of a database system 10 that performs a segment group transfer group process 2810 to transfer segments from one storage cluster 2535 to another, while enabling query execution to occur during the segment group transfer group process 2810 based on implementing a query correctness guaranteeing strategy. Some or all features and/or functionality of FIGS. 28A-28L can implement any embodiment of segment transfer, data transfer, and/or query execution via a hierarchical query execution plan 2405 implemented via one or more storage clusters 2535 described herein. Some or all features and/or functionality of FIGS. 28A-28L can implement any embodiment of database system 10 described herein.

Some or all features and/or functionality of the segment group transfer process 2810 of FIGS. 28A-28L can implement any features and/or functionality of transferring segments between storage clusters described in some or all features of U.S. Utility application Ser. No. 18/355,497.

In some embodiments, the database system 10 is operable to move segments from their via performing a segment group transfer group process 2810 based on copying the segment group from one location to another and delete original. A transfer segment group task processing module 2510 (e.g. a “transfer coordinator”) can be implemented to coordinate this copy and delete model. When moving segments within a single cluster, the consensus protocol facilitated via nodes of the cluster can be implemented to have all nodes agree at any time which nodes are responsible for segments (e.g. using OSNs). However, in embodiments where different storage clusters 2535 implement disjoint consensus clusters, where queries execute separately on each storage cluster, it the database system 10 can be configured to implement a query correctness guaranteeing strategy ensure exactly one cluster serves the segment group via implementing some or all features and/or functionality presented in FIGS. 28A-28L.

As illustrated in FIG. 28A, a segment group transfer process 2810 can be performed during a corresponding segment group transfer temporal period (e.g. between times t0 and t1) to facilitate transfer of a segment group X (e.g. that includes a group of segments 2424) from a first storage cluster 2535.1 to a second storage cluster 2535.2. The segment group transfer process 2810 can be performed via performance of a start transfer step 2811, a transfer group set 2812, a commit transfer step 2813, and an end transfer step 2814.

A given database system state 2821.0 prior to initiating the segment group transfer process 2810 at time to can be implemented via storage cluster 2535.1 being at a given OSN X (e.g. having most recent data ownership information with OSN X) and indicating inclusion of segment group X and storage cluster 2535.2 being at a given OSN Y (e.g. having most recent data ownership information with OSN Y) indicating no inclusion of segment group X. The first database system state 2821.0 thus denotes that nodes of storage cluster 2535.1 “own” segments of segment group X that are thus accessed and have rows reflected in processing queries via the storage cluster 2535.1, while nodes of storage cluster 2535.2 do not own any segments of segment group X and do not access/process their rows in executing queries. Thus, segment group X is processed exactly once in queries prior to time to (e.g. queries having OSN X for storage cluster 2535.1 and OSN Y for storage cluster 2535.2) via being processed only via storage cluster 2535.1.

An updated database system state 2821.1 after completing the segment group transfer process 2810 at time t1 can be implemented via storage cluster 2535.1 being at a given OSN X+1 (or some other OSN after OSN X) and indicating no inclusion of segment group X and storage cluster 2535.2 being at a given OSN Y+1 (or some other OSN after OSN Y) indicating inclusion of segment group X. The updated database system state 2821.1 thus denotes that nodes of storage cluster 2535.2 “own” segments of segment group X that are thus accessed and have rows reflected in processing queries via the storage cluster 2535.1, while nodes of storage cluster 2535.1 do not own any segments of segment group X and do not access/process their rows in executing queries. Thus, segment group X is processed exactly once in queries after time t1 (e.g. queries having OSN X+1 for storage cluster 2535.1 and OSN Y+1 for storage cluster 2535.2) via being processed only via storage cluster 2535.2.

As illustrated in FIG. 28B, one or more query execution processes 2805 (e.g. performed via query execution module 2504) can occur during the segment group transfer temporal period (e.g. between times t0 and t1) when the database system is at some intermediate database system state 2821.0.5, where it can be unclear which OSN is currently being utilized by a given one of the storage clusters 2535.1 and 2535.2 involved in the segment group transfer process 2810, and thus can be unclear whether each storage cluster should still be serving segment group X in the query execution process 2805. This lack of clarity can render segment group X accidentally not being served, or being served twice, which would render lack of query correctness.

For example, query execution process 2805 can be performed based on first performing a query probing step 2815 to determine which OSN be used could by each cluster 2535, and then a query execution step 2816 via access to the segments by each storage cluster as determined in the query probing step 2815. For example, performing query probing step 2815 can be based on a query probe being sent to each storage cluster before execution of the corresponding query in query execution step 2816, where the query probe is sent down to every node 37 to see who is available to participate in the query (e.g. in a corresponding query execution plan 2405), where there are multiple adjacent storage clusters at the leaf level of the query execution plan 2405 that includes at least storage cluster 2535.1 and 2535.2, where the query can then be executed in query execution step 2816 using the information from the probe, including information regarding which segment groups will be used in each cluster. In particular, the query probe can determine the state most recent OSN for each cluster and passes it back up (e.g. to a root node), where these OSNs are included in the plan header (E.g. are assigned to the query) and the plan is executed in accordance with these OSNs.

In cases where the query execution process 2805 is performed during the segment group transfer temporal period (e.g. between times t0 and t1) when the database system is at some intermediate database system state 2821.0.5, performing the query probing step 2815 can render determining of OSNs to be used could by cluster 2535.1 and/or cluster 2525.2 that are “outdated” by the time query execution step 2816 is performed based on progress having been made in the segment group transfer process 2810 during this timeframe.

The implementation of a query correctness guaranteeing strategy can ensure consistency in database system state 2821 across both the query probing step 2815 and query execution step 2816. For example, query correctness requires that execution of a query during the segment group transfer temporal period be performed via either: (1) using OSN X and OSN Y, where the segment group is accessed via cluster 2535.1 and not 2535.2; or (2) using OSN X+1 and OSN Y+1, where the segment group is accessed via cluster 2535.2 and not 2535.1. In particular, the implementing of query correctness guaranteeing strategy can be implemented to guarantee that one of these two cases will always occur, and that a query executed during the segment group transfer temporal period is guaranteed to not be performed via either: (3) using OSN X and OSN Y+1, where the segment group is accessed via cluster 2535.1 and also 2535.2; or (4) using OSN X+1 and OSN Y, where the segment group is accessed via neither cluster 2535.1 or 2535.2.

FIG. 28C illustrates an embodiment of performing segment group transfer process 2810 via a transfer segment group task processing module 3510.

In some embodiments, a transfer segment group task processing module 3510 is implemented to facilitate performance of segment group transfer process 2810 via: initializing the transfer on clusters via the start transfer step 2811: instructing the destination storage cluster 2535.2 to perform the transfer (e.g. via copying the segment group from source storage cluster 2535.1) via transfer step 2812 to ultimately completing storage of the segment group via the segment group becoming accessible in destination cluster 2535.2 via completion of transfer step 2812; committing the transfer via commit transfer step 2813 to render the segment group becoming inaccessible in the source cluster 2535.1 (e.g. via deleting the segment group from source cluster 2535.2 due to the transfer completing), and cleaning up on clusters via an end transfer step 2814.

Performance of the start transfer step 2811 can include sending of begin segment group transfer instructions 2511 by the transfer segment group task processing module 3510 (e.g. “transfer coordinator”) to storage cluster 2535.1 (e.g. “cluster A” and/or the “source cluster”) and 2535.2 (e.g. “cluster B” and/or the “destination cluster”).

Performance of the transfer group step 2812 can include execution of a segment rebuild process 3515 by storage cluster 2535.2 based on the transfer segment group task processing module 3510 instructing that storage cluster 2535.2 being executing the transfer, where storage cluster 2535.2 gets the segment group from storage cluster 2535.1 and performs the segment rebuild process to store the segment group, and sends a transfer complete notification 2512 to transfer segment group task processing module 3510 indicating transfer is complete.

Performance of the commit transfer step 2813 can include the transfer segment group task processing module 3510 instructing that storage cluster 2535.1 delete the segment group via a commit transfer instruction 3415 and receiving a transfer committed confirmation 3516 in response.

Performance of the end transfer step 2814 can include the transfer segment group task processing module 3510 sending transfer finalization instructions 3529 to storage cluster 2535.1 and storage cluster 2535.2, and the storage clusters 2535.1 and 2535.2 finalizing the transfer accordingly.

In some embodiments, a failure handling strategy is implemented during segment group transfer process 2810, for example, based on the transfer segment group task processing module 3510 being responsible for transfer of metadata on the source cluster 2535.1 and destination cluster 2535.2. Implementing the failure handling strategy can require that cleaning up on clusters via the end transfer step 2814 is performed even in failure cases: if the data has already been copied to the destination cluster, a rollback must be performed (e.g. to make segments available on the source cluster 2535.1 and not available on the destination cluster 2535.2).

The failure handling strategy can optionally be implemented via execution of a transfer segment group task (e.g. implemented via the distributed tasks framework), for example, based on being assigned to a node 37 in conjunction with implementing the transfer segment group task processing module 3510. For example, implementing the failure handling strategy can be based on, if the task owner of a transfer dies, the transfer must still be finished out (e.g. commit, rollback, and cleanup transfer on both source and destination clusters). Implementing the failure handling strategy can be based on the transfer segment group task being implemented as a distributed task, meaning it will be started over on a different task owner if the original die, where a task state contains whether or not the transfer committed and what the result was, and/or where, if the task is restarted after it was already committed, the task will just skip to finalizing the task.

In some embodiments, performance of these steps of segment group transfer process 2810 alone without additional consideration for when in this ordering of steps that a query probing step 2815 and query execution step 2816 of a query execution process 2805 does not guarantee that query correctness will be achieved.

For example, consider the example of FIG. 28D, where a query probing step 2815 is performed via a query execution module performing a query execution process 2405 to probe clusters during the building of segment group of segment rebuild process 3515 (e.g. between the copy and the deletion), where both clusters currently store the given segment group X and have current OSNs indicating the given segment group X (e.g. storage cluster 2535.1 is still at OSN X indicating ownership of the segment group due to not yet having been deleted, and storage cluster 2535.2 is at OSN Y+1 also indicating ownership of the segment group due to having been successfully copied). Query correctness is not achieved in this case.

FIGS. 28E and 28F illustrate examples where the deficiencies of FIG. 28D are corrected based on “helping” the query select which copy of the segment group to choose with information regarding/based on the status of the transfer. Implementing providing of this information in response to query probing during a segment group transfer process 2810 can optionally be configured in conjunction with implementing query correctness guaranteeing strategy.

For example, when the transfer has initiated and the query probe for cluster 2535.1 indicates OSN X (e.g. storage cluster 2535.1 still maintains a copy of the segment group), the probe can be implemented to indicate information to the query execution process regarding the transfer and instruct that the segment group be ignored on cluster 2535.2 even if the probe for cluster 2535.2 indicates OSN Y+1. Meanwhile, when the transfer has initiated and the query probe for cluster 2535.1 indicates OSN X+1 (e.g. storage cluster 2535.1 no longer maintains a copy of the segment group), the probe can be implemented to indicate information to the query execution process regarding the transfer and instruct that the segment group not be ignored on cluster 2535.2.

As illustrated in the example of FIG. 28E, the probe on cluster 2535.1 can be told about the transfer and its status so that the destination cluster 2535.2 can optionally ignore the copied segment group on cluster 2535.2 due to the probing occurring between the copying and deletion of the segment group, rendering use of the segment group via storage cluster 2535.1 only, which can render achieving of query correctness in this example case.

As illustrated in the example of FIG. 28F, the probe on cluster 2535.1 can be told that the transfer was committed due so that the destination cluster 2535.2 does not ignore the copied segment group on cluster 2535.2 due to the probing occurring after deletion of the segment group after copying, performed during conjunction with the commit transfer step 2813, which can also render achieving of query correctness in this example case.

The examples of FIGS. 28E and 28F assume that the query probing for each cluster 2535 occurs at relatively the same time (e.g. relative to the steps of the segment group transfer process 2810). However, this is not necessarily guaranteed, as query probing step 2815 can occur at different times/different rates (e.g. via propagation via separate groups of nodes 37 of the different clusters 2535 via corresponding query probing occurring independently per cluster). FIGS. 28G-28I illustrate further examples of how the time at which query probing step 2815 on each cluster occurs 2535.1 and 2535.2 relative to the steps of the segment group transfer process 2810 can influence whether query correctness is achieved.

As illustrated in the example of FIG. 28G, the cluster 2535.1 probe comes in before the transfer begins, and thus indicates OSN X (e.g. denoting serving of the segment group via cluster 2535.1). The cluster B probe comes in before the transfer begins or just after the transfer beings, but before transfer is complete and thus the cluster 2535.2 query probe indicates OSN Y (e.g. denoting not serving of the segment group via cluster 2535.2). Thus, query correctness is achieved in this case.

As illustrated in the example of FIG. 28H, the cluster 2535.1 probe comes in before the transfer begins and thus indicates OSN X. The cluster 2535.1 does not yet know about the transfer due to the transfer not yet being initiated, and cannot indicate the ignoring of the copied segment group on cluster 2535.2 of the query correctness guaranteeing strategy discussed in conjunction with FIGS. 28E and 28F. Meanwhile, cluster 2535.2 probe comes in after the transfer is complete and thus the cluster 2535.2 query probe indicates OSN Y+1. Thus, query correctness is not achieved in this case.

As illustrated in the example of FIG. 28I, the cluster 2535.2 probe comes in before the transfer completes (e.g. before the copy of the segment group exists on cluster 2535.2) and thus indicates OSN X. Meanwhile, cluster 2535.1 probe comes in after the transfer is committed (e.g. after the deletion of the segment group of cluster 2535.1) and thus the cluster 2535.1 query probe indicates OSN X+1). Thus, query correctness is not achieved in this case.

As illustrated in these examples, probing can render query correctness not being achieved if the probes span across: (1) the start transfer step 2811 (e.g. “initialization”) and transfer group step 2812, as illustrated in the example of FIG. 28H: or (2) the transfer group step 2812 and commit transfer step 2813, as illustrated in the example of FIG. 28I.

The query correctness guaranteeing strategy can be configured to account for these cases based on the segment group transfer process 2810 being implemented based on “waiting” for any ongoing query probes to complete before moving onto the next event. For example, query probes are “registered” (e.g. on “LTS” nodes, for example, corresponding to leaf nodes of the cluster), and starting of query execution “deregisters” the probes. A storage cluster action can returns which probes are registered currently. Thus, between start transfer step 2811 and transfer group step 2812, and again between transfer group step 2812 and commit transfer step 2813, the segment group transfer process 2810 can poll for any registered probes. If there are any, polling can continue, where the segment group transfer process 2810 proceeds to the next step only when the original probes finish.

Such an embodiment of segment group transfer process 2810 is illustrated in FIG. 28J, where a first query polling step 2818.1 is included between start transfer step 2811 and transfer group step 2812, and where a second query polling step 2818.2 is included between transfer group step 2812 and commit transfer step 2813. Performing the query polling step 2818 can be implemented to wait for query probes to complete.

FIG. 28K illustrates an embodiment of probe polling step 2818, which can implement the first query polling step 2818.1 and/or the second query polling step 2818.2 of FIG. 28J. Clusters are polled for any active polls. If any probes are found (e.g. are still registered and not yet deregistered), this polling continues (e.g. at predetermined intervals). If no probes are found (e.g. all probes have been deregistered), the probe polling step completes and the segment group transfer process 2810 advances to the next step.

FIG. 28L illustrates an example where query correctness is achieved based on the performance of probe polling step 2818, for example, to rectify the deficiency illustrated in the example of FIG. 28I. The probe polling step 2818.2 between transfer group step 2812 and commit transfer step 2813 is performed in this case based on polling for probes until no hits (e.g. no registered probed) on either cluster. This renders probing completing on cluster A with OSN X due to waiting for probing to complete before committing the transfer, rendering query correctness.

FIG. 28M illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 28M, for example, based on participating in execution of a query being executed by the database system 10. Some or all of the method of FIG. 28M can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 28M based on implementing a corresponding plurality of processing core resources 48.1-48.W. Some or all of the steps of FIG. 28M can optionally be performed by any other one or more processing modules of the database system 10. Some or all of the steps of FIG. 28M can be performed to implement some or all of the functionality of the database system 10 as described in conjunction with FIGS. 28A-28L, for example, by implementing some or all of the functionality of segment group transfer process 2810, storage cluster 2535.1, storage cluster 2535.2, query execution process 2805, query execution module 2504, transfer segment group task processing module 3510, and/or probe polling step 2818. Some or all steps of FIG. 28M can be performed by database system 10 in accordance with other embodiments of the database system 10 and/or nodes 37 discussed herein. Some or all of the steps of FIG. 28M can be performed in conjunction with performing some or all steps of any other method described herein.

Step 2882 includes storing a set of segments via first storage resources of a first storage cluster of the database system during a first temporal period. Step 2884 includes performing a segment group transfer process during a segment group transfer temporal period to transfer a set of segments from the first storage cluster to a second storage cluster. In various examples, performance of the segment group transfer process includes serialized performance of a plurality of steps in accordance with a query correctness guaranteeing strategy. Step 2886 includes, during a query execution temporal period overlapping with the segment group transfer temporal period, performing a query execution process to execute a query against the database system. In various examples, due to the serialized performance of the plurality of steps in accordance with the query correctness guaranteeing strategy, a query resultant generated via execution of the query is guaranteed to be correct based on the set of segments being accessed via exactly one storage cluster of: the first storage cluster or the second storage cluster. Step 2888 includes, during a second temporal period strictly after the first temporal period, storing the set of segments via second storage resources of the second storage cluster of the database system based on completion of the segment group transfer process.

In various examples, the query execution temporal period overlaps with the segment group transfer temporal period based on execution of the query initiating after performance of at least one first one of the plurality of steps and prior to performance of at least one second one of the plurality of steps.

In various examples, the plurality of steps includes: a start transfer step: a transfer group step performed after the start transfer step: a commit transfer step performed after the transfer group step; and/or an end transfer step performed after the commit transfer step.

In various examples, performing the query execution process includes performing a query probing step to send a plurality of query probes to the first storage cluster and the second storage cluster. In various examples, the exactly one storage cluster is identified for accessing the set of segments based on performance of the query probing step. In various examples, performing the query execution process includes performing a query execution step after the query probing step. In various examples, the set of segments are accessed via the exactly one storage cluster during the query execution step.

In various examples, the plurality of steps includes at least one probe polling step. In various examples, performance of the at least one probe polling step includes, after completing a prior step of the plurality of steps, waiting for any query probes of the query probing step to complete prior to advancing to a next step of the plurality of steps.

In various examples, performing the query probing step includes registering each of the plurality of query probes. In various examples, performing the query execution step includes deregistering each of the plurality of query probes. In various examples, performing the query probing step is initiated during one of the plurality of steps prior to a probe polling step of the at least one probe polling step. In various examples, performing the at least one probe polling step includes: at a first time, identifying a set of registered query probes of the plurality of query probes based on all having being registered during the query probing step prior to the first time and further based on all not yet being deregistered at the first time; and/or advancing to the next step, at a second time after the first time, in response to determining that all of the set of query probes are deregistered at the second time based on all having been deregistered prior to the second time via the query execution step.

In various examples, the plurality of steps includes: a start transfer step: a first probe polling step after the start transfer step: a transfer group step, where the transfer group step is initiated only after waiting for any query probes identified after the start transfer step to complete based on performing the first probe polling step: a second probe polling step after the transfer group step; and/or a commit transfer step after the second probe polling step, where the commit transfer step is initiated only after waiting for any query probes identified after the transfer group step to complete based on performing the second probe polling step.

In various examples, first data ownership information for the first storage cluster indicates a first data ownership state for the first storage cluster and a second data ownership state for the first storage cluster.

In various examples, the first data ownership state for the first storage cluster corresponds to a first state of the first storage cluster prior to performance of the segment group transfer process. In various examples, the first data ownership state of the second storage cluster is identified via a first data ownership sequence number for the first storage cluster. In various examples, the first data ownership state for the first storage cluster indicates a first set of owned segments for servicing queries having the first data ownership sequence number for the first storage cluster that includes the set of segments.

In various examples, the second data ownership state for the first storage cluster is more recent than the first data ownership state for the first storage cluster. In various examples, the second data ownership state for the first storage cluster corresponds to a second state of the second storage cluster after completion of the performance of the segment group transfer process. In various examples, the second data ownership state of the second storage cluster is identified via a second data ownership sequence number for the first storage cluster. In various examples, the second data ownership state for the first storage cluster indicates a second set of owned segments for servicing queries having the second data ownership sequence number for the first storage cluster that does not include the set of segments.

In various examples, second data ownership information for the second storage cluster indicates a first data ownership state for the second storage cluster and a second data ownership state for the second storage cluster.

In various examples, the first data ownership state for the second storage cluster corresponds to a first state of the second storage cluster prior to performance of the segment group transfer process. In various examples, the first data ownership state of the second storage cluster is identified via a first data ownership sequence number for the second storage cluster. In various examples, the first data ownership state for the second storage cluster indicates a first set of owned segments for servicing queries having the first data ownership sequence number for the second storage cluster that does not include the set of segments.

In various examples, the second data ownership state for the second storage cluster is more recent than the first data ownership state for the second storage cluster. In various examples, the second data ownership state for the second storage cluster corresponds to a second state of the second storage cluster after completion of the performance of the segment group transfer process. In various examples, the second data ownership state of the second storage cluster is identified via a second data ownership sequence number for the second storage cluster. In various examples, the second data ownership state for the second storage cluster indicates a second set of owned segments for servicing queries having the second data ownership sequence number for the second storage cluster that includes the set of segments.

In various examples, performing the query execution process includes determining which data ownership state be applied for each storage cluster in executing the query based on assigning a corresponding data ownership number for the each storage cluster to the query. In various examples, the query resultant generated via execution of the query is guaranteed to be correct based on the query correctness guaranteeing strategy guaranteeing that either situation (1) or (2) occurs: (1) the first data ownership state for the first storage cluster and the first data ownership state for the second storage cluster are both applied, where the query is assigned both the first data ownership sequence number for the first storage cluster and the first data ownership sequence number for the second storage cluster; or (2) the second data ownership state for the first storage cluster and the second data ownership state for the second storage cluster are both applied, where the query is assigned both the second data ownership sequence number for the first storage cluster and the second data ownership sequence number for the second storage cluster.

In various examples, the query resultant generated via execution of the query is guaranteed to be correct based on the query correctness guaranteeing strategy guaranteeing that the first data ownership state for the first storage cluster and the second data ownership state for the second storage cluster are not both applied, where the query is guaranteed to not be assigned both the first data ownership sequence number for the first storage cluster and the second data ownership sequence number for the second storage cluster. In various examples, the query resultant generated via execution of the query is guaranteed to be correct based on the query correctness guaranteeing strategy further guaranteeing that the second data ownership state for the first storage cluster and the first data ownership state for the second storage cluster are not both applied, where the query is guaranteed to not be assigned both the second data ownership sequence number for the first storage cluster and the first data ownership sequence number for the second storage cluster.

In various examples, performing the query execution process includes performing a query probing step to identify which data ownership state be applied for each storage cluster in executing the query and assigning the corresponding data ownership number for the each storage cluster to the query. In various examples, performing the query execution step after the query probing step based on applying, in accessing the each storage cluster, the data ownership state identified via the corresponding data ownership number for the each storage cluster to the query.

In various examples, the first storage resources of the first storage cluster are implemented via a first plurality of nodes. In various examples, the first data ownership information is mediated via the first plurality of nodes in accordance with a consensus protocol. In various examples, the second storage resources of the second storage cluster are implemented via a second plurality of nodes. In various examples, the second data ownership information is mediated via the second plurality of nodes in accordance with the consensus protocol. In various examples, the query is executed via a plurality of query execution nodes in accordance with a hierarchical query execution plan. In various examples, the plurality of query execution nodes includes at least some of the first plurality of nodes and at least some of the second plurality of nodes. In various examples, performing the query probing step includes: sending a first query probes to all of the first plurality of nodes identify which ownership sequence number be assigned to the query for the first storage cluster and be applied by all nodes of the first plurality of nodes in executing the query; and/or sending a second query probe to all of the second plurality of nodes identify which ownership sequence number be assigned to the query for the second storage cluster and be applied by all nodes of the second plurality of nodes in executing the query.

In various examples, the query correctness guaranteeing strategy is based on a applying a failure handling strategy. In various examples, the plurality of steps includes a cleanup step. In various examples, a transfer failure occurs during the segment group transfer process. In various examples, the cleanup step is performed despite the transfer failure occurring, in accordance with applying the failure handling strategy, based on performing a corresponding rollback step based on the transfer failure occurring.

In various examples, applying the failure handling strategy includes executing the segment group transfer process as a corresponding distributed task in accordance with a distributed task framework. In various examples, the segment group transfer process is coordinated via a first node of a plurality of nodes of the database system in conjunction with executing a corresponding segment group transfer task implemented as the corresponding distributed task based on the corresponding segment group transfer task being assigned to the first node. In various examples, the transfer failure occurs based on the first node failing. In various examples, executing the segment group transfer process as the corresponding distributed task in accordance with the distributed task framework includes, in response to the first node failing, reassigning the corresponding segment group transfer task to a second node of the plurality of nodes. In various examples, the second node successfully completes execution of the corresponding segment group transfer task. In various examples, the second storage resources of the second storage cluster store the set of segments during the second temporal period based on successful completion of execution of the corresponding segment group transfer task via the second node.

In various examples, the plurality of steps includes a commit transfer step after at least one first one of the plurality of steps and prior to at least one second one of the plurality of steps. In various examples, execution of the corresponding segment group transfer task by the second node includes determining whether the commit transfer step was completed by the first node prior to the transfer failure occurring. In various examples, execution of the corresponding segment group transfer task by the second node includes performing all of the plurality of steps when the commit transfer step is determined to have not been completed by the first node prior to the transfer failure occurring; and/or performing only the at least one second one of the plurality of steps when the commit transfer step is determined to have been completed by the first node prior to the transfer failure occurring.

In various examples, the method further includes generating system metadata regarding the database system as a set of metadata rows; and/or further storing the set of metadata rows via a second set of relational database tables of the database system based on loading the set of metadata rows for storage via one loading module of a plurality of loading modules based on the one loading module being selected for system metadata loading.

In various examples, the method further includes generating and storing a set of pages: in response to detecting that a page drain condition has been met, determining a conversion page set as a proper subset of pages included in the set of pages based on a predetermined post-drain number of pages and/or performing a page conversion process upon pages included in the conversion page set to generate a plurality of segments from the pages included in the conversion page set. In various examples, the set of segments includes at least some of the plurality of segments.

In various examples, the set of segments are stored via a plurality of storage buckets of the database system. In various examples, the method further includes performing a storage rebalancing process based on current storage distribution data for the plurality of storage buckets. In various examples, performing the storage rebalancing process is based on: identifying a first subset of the plurality of storage buckets as a plurality of source buckets based on each of the first subset of the plurality of storage buckets having corresponding storage utilization meeting source bucket criteria: identifying a second subset of the plurality of storage buckets as a plurality of target buckets based on each of the first subset of the plurality of storage buckets having corresponding storage utilization meeting target bucket criteria; and/or performing a plurality of data transfers. In various examples, performing each of the plurality of data transfers includes transferring storage of data included in one of plurality of source buckets to one of the plurality of target buckets.

In various examples, the set of segments are included in a plurality of segments stored by the database system. In various examples, the method further includes, based on generating the set of segments, populating a time bucket lookup map based on time values of the set of segments. In various examples, executing the query is based on: identifying a time-based pre-filtered segment set of the plurality of segments based on accessing the time bucket lookup map based on time-based filtering parameters of the query; and/or executing the query based on accessing only segments of the plurality of segments included in an identified segment set determined based on identifying the time-based pre-filtered segment set.

In various examples, the set of segments are included in a plurality of segments stored by the database system. In various examples, the method further includes populating a multi-dimensional index structure. In various examples, the multi-dimensional index structure has a plurality of dimensions corresponding to a plurality of segment attribute types. In various examples, executing the query is based on: determining, based on the query, a required attribute value range for each of the plurality of segment attribute types: identifying an identified segment set based on accessing the multi-dimensional index structure determine ones of the plurality of segments having corresponding attributes for the each of the plurality of segment attribute types falling within the required attribute value range; and/or executing the query based on accessing only segments of the plurality of segments included in the identified segment set.

In various embodiments, any one of more of the various examples listed above are implemented in conjunction with performing some or all steps of FIG. 28M. In various embodiments, any set of the various examples listed above can be implemented in tandem, for example, in conjunction with performing some or all steps of FIG. 28M, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 28M described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 28M, for example, in conjunction with further implementing any one or more of the various examples described above.

In various embodiments, the operational instructions, when executed by the at least one processor, cause the database system to: store a set of segments via first storage resources of a first storage cluster during a first temporal period: perform a segment group transfer process during a segment group transfer temporal period to transfer a set of segments from the first storage cluster to a second storage cluster, where performance of the segment group transfer process includes serialized performance of a plurality of steps in accordance with a query correctness guaranteeing strategy: during a query execution temporal period overlapping with the segment group transfer temporal period, perform a query execution process to execute a query. In various examples, due to the serialized performance of the plurality of steps in accordance with the query correctness guaranteeing strategy, a query resultant generated via execution of the query is guaranteed to be correct based on the set of segments being accessed via exactly one storage cluster of: the first storage cluster or the second storage cluster; and/or during a second temporal period strictly after the first temporal period, store the set of segments via second storage resources of the second storage cluster based on completion of the segment group transfer process.

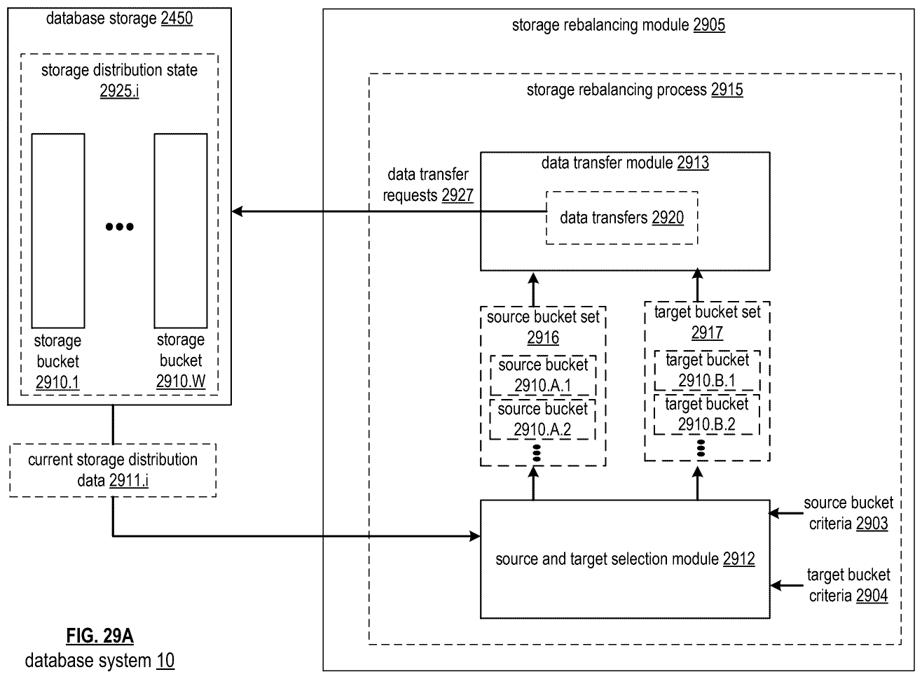

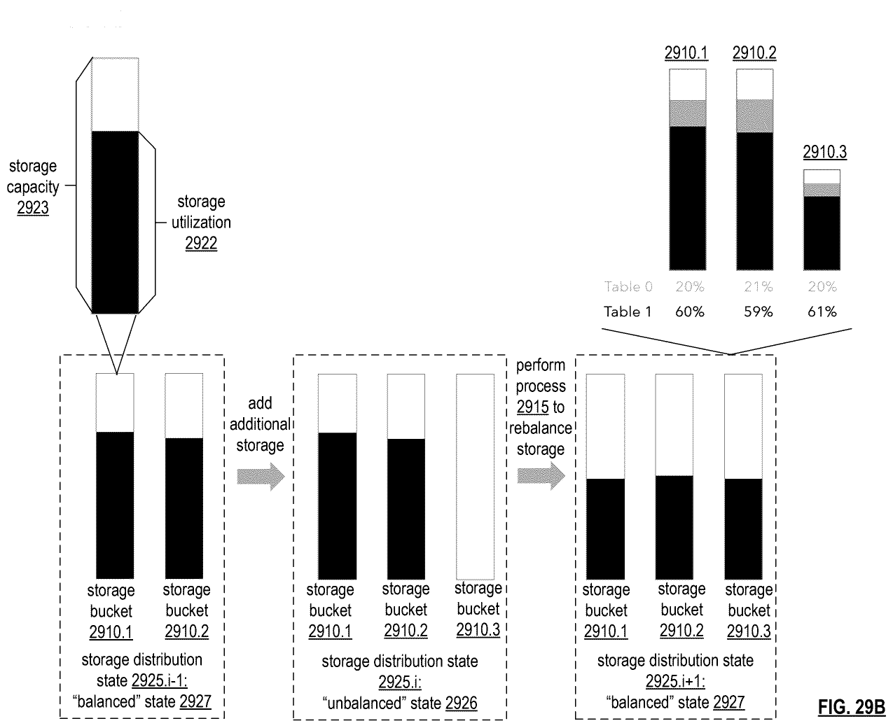

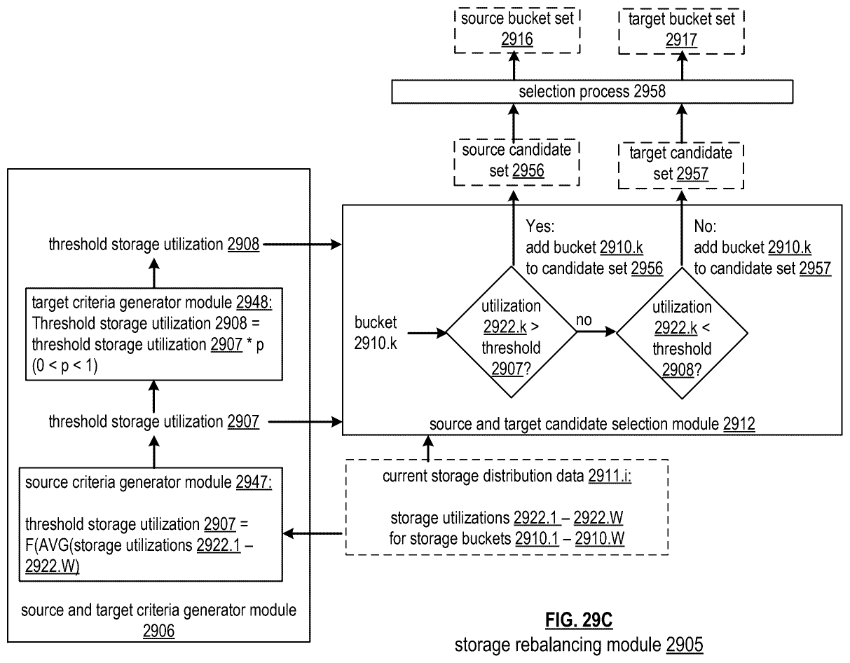

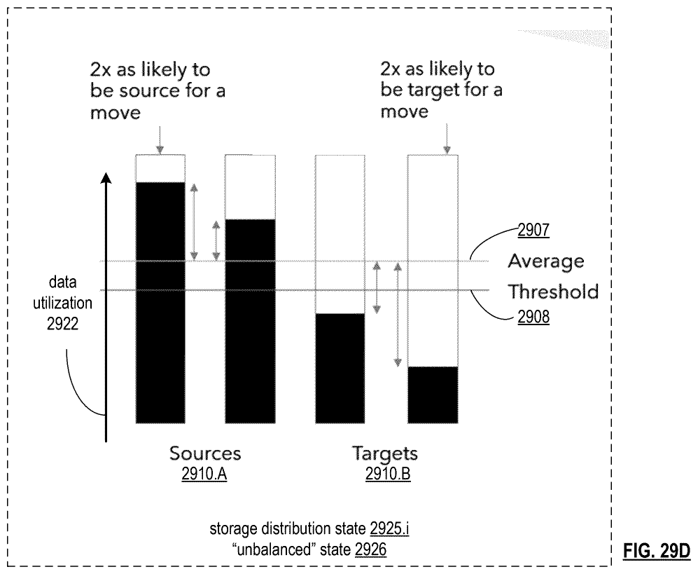

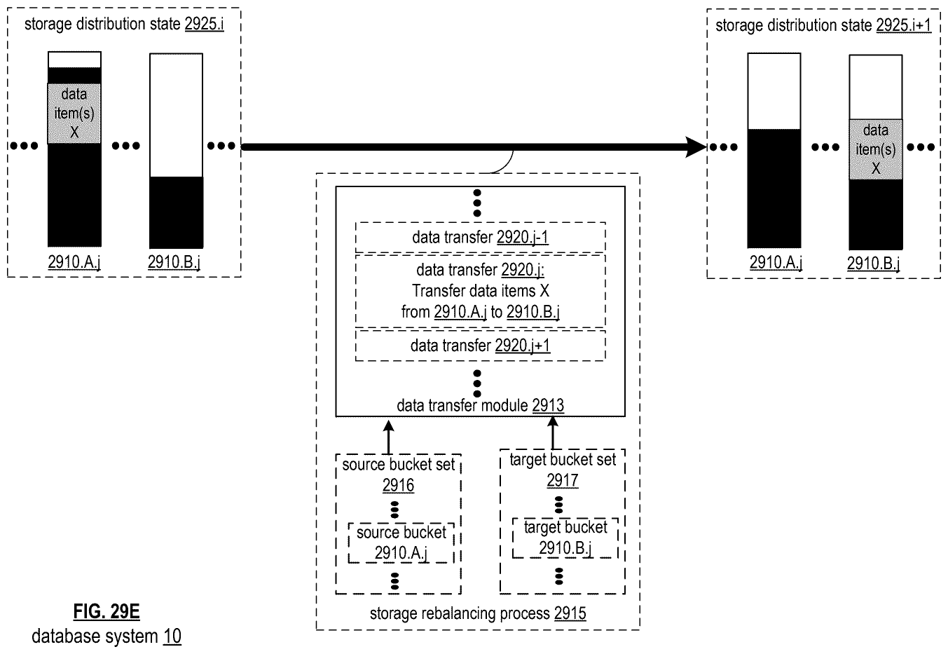

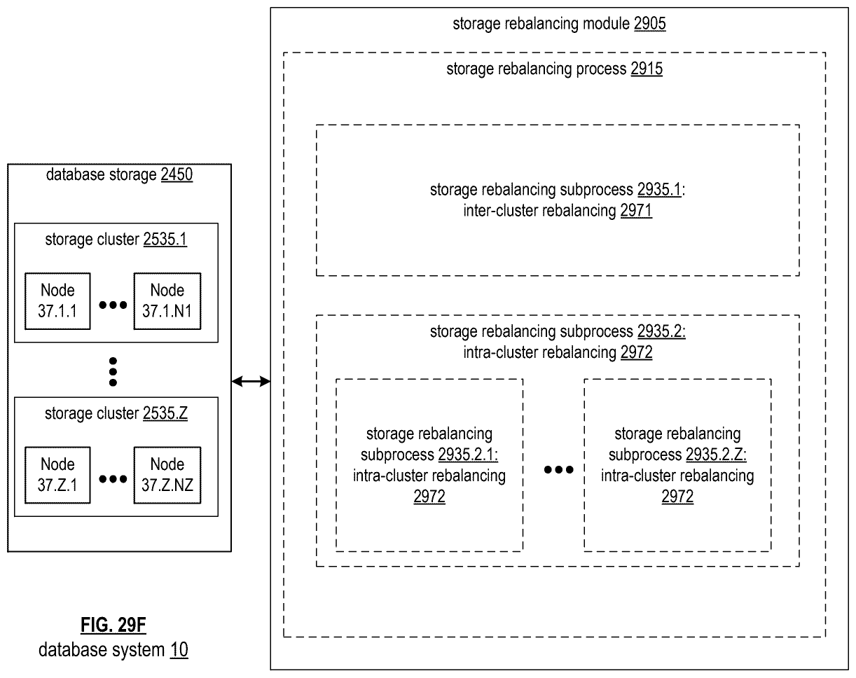

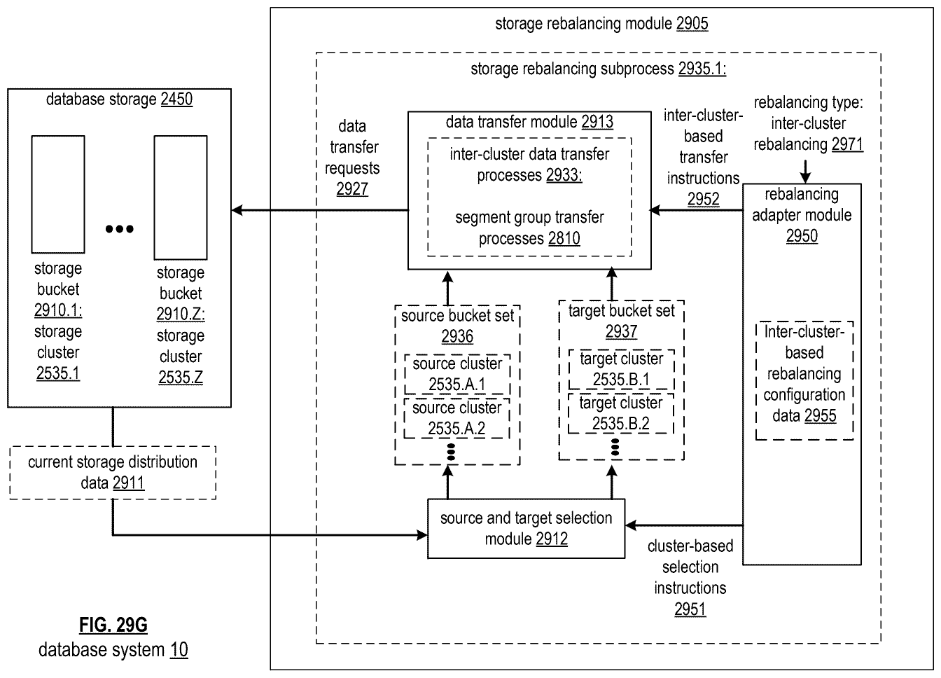

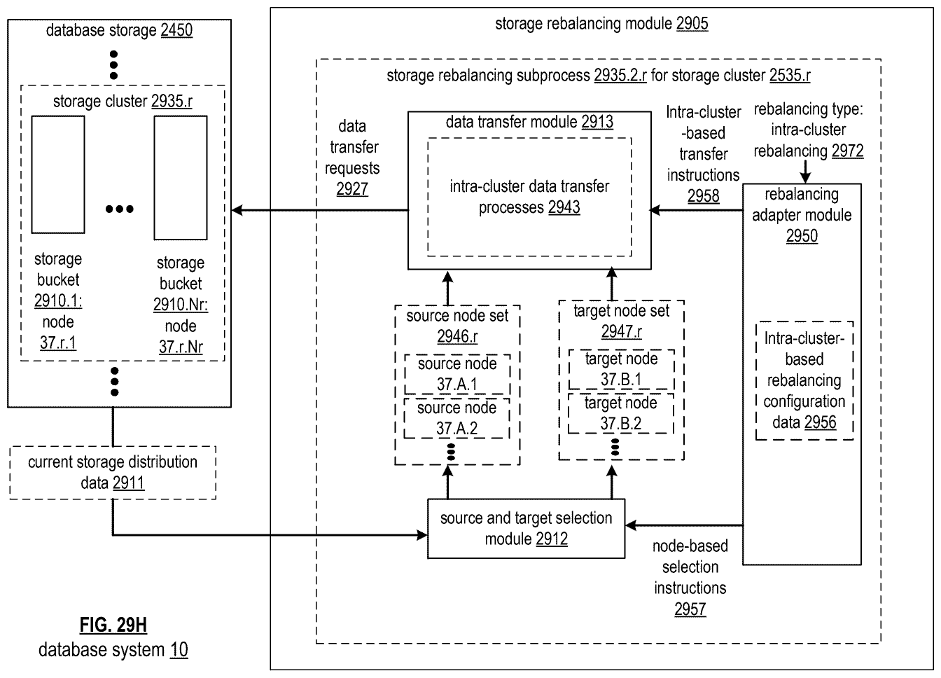

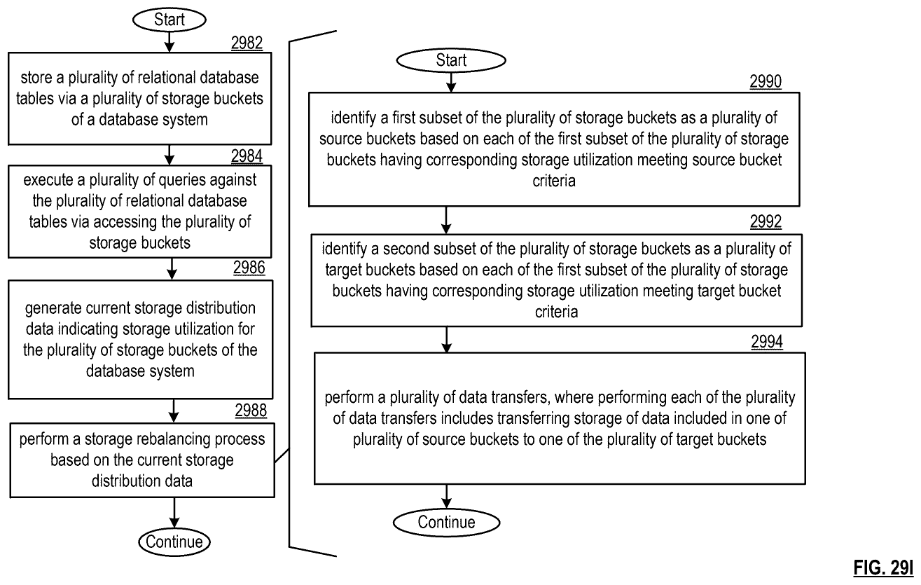

FIGS. 29A-29H present embodiments of a database system 10 operable to perform a storage rebalancing process 2915 via a storage rebalancing module to rebalance distribution of data (e.g. segments 2424) across storage buckets (e.g. across nodes 37 and/or storage clusters 2535) implementing database storage 2450. Some or all features and/or functionality of FIGS. 29A-29H can implement the segment group transfer process 2810 and/or any moving of segments/data described herein. Some or all features and/or functionality of FIGS. 29A-29H can implement any embodiment of database system 10 described herein.

As illustrated in FIG. 29A, a rebalancing module 2905 can implement a storage rebalancing module 2905 to perform a storage rebalancing process 2915 based on current storage distribution data 2911.i for a current storage distribution state 2925.i of a plurality of storage buckets 2910.1-2910.W of database storage 2450 (e.g. based on the current storage distribution state 2925.i being an unbalanced state requiring rebalancing). A storage and target selection module can identify a source bucket set 2916 of storage buckets 2910.A of the set of storage buckets 2910.1-2910.W (e.g. that includes at least a first source bucket 2910.A.1 and a second source bucket 2910.A.2) and a target bucket set 2917 (e.g. that includes at least a first target bucket 2910.B.1 and a second target bucket 2910.B.2). For example, the source bucket set 2916 is identified based on selecting some or all storage buckets 2910.1-2910.W meeting source bucket criteria 2903 (e.g. based on information in current storage distribution data 2911.i regarding these buckets 2910) and/or the target bucket set 2917 is identified based on selecting some or all storage buckets 2910.1-2910.W meeting target bucket criteria 2904. The source bucket set 2916 and target bucket set 2917 can be mutually exclusive (e.g. no bucket 2910 is included in both source bucket set 2916 and target bucket set 2917).

A data transfer module 2920 can facilitate performance of a plurality of data transfers 2920 to transfer data from source buckets 2910.A of source bucket set 2916 to target buckets 2910.B of target bucket set 2917. A given data transfer 2920 can correspond to transfer of some amount of data from a given source bucket 2910.A to a given target bucket 2910.B. For example, each storage buckets 2910.A of source bucket set 2916 is involved in exactly one (or optionally more than one) data transfer process 2920 and/or each storage buckets 2910.B of target bucket set 2917 is involved in exactly one (or optionally more than one) data transfer process 2920. Alternatively, the buckets 2910.A in source bucket set 2916 correspond to candidate source buckets and/or the buckets 2910.B in target bucket set 2917 correspond to candidate target buckets, and data transfers are performed until a data transfer completion condition is met (e.g. a balanced state is achieved in database storage 2450 due to the data transfers 2920 performed thus far based on the current storage distribution data 2911 being updated to indicate this balanced state, where additional data transfers 2920 upon additional candidate source and target buckets are not required to render successful completion of the storage rebalancing process) to end the storage rebalancing process, where some candidate source buckets 2910.A and/or some candidate target buckets 2910.B are optionally not involved in data transfers due to the storage rebalancing process ending prior to data transfers being performed.

A given data transfer 2920 can be performed via a corresponding data transfer request 2927 and/or other facilitation of a corresponding data transfer process between these buckets in database storage 2450. The storage distribution state 2925.i can change (e.g. becomes a new storage distribution state 2925.i+1) as a result of the storage rebalancing process completing (e.g. all of its data transfers 2920 being performed and/or the data transfer completion condition being met by the updated storage distribution state 2925.i+1).

In some embodiments, the source and target selection module 2912 and/or data transfer module 2913 is applied per table 2712, where current storage distribution data 2911.i indicates storage utilization of storage buckets per table to render balancing of each table. For example, a given storage bucket 2910 is selected as a source bucket for one table 2712.1, but is not selected as a source bucket or target bucket for another table 2712.2. As another example, a given storage bucket 2910 is selected as a target bucket for one table 2712.1, but is not selected as a source bucket or target bucket for another table 2712.2. As another example, a given storage bucket 2910 is selected as a source bucket for one table 2712.1, and is selected as a target bucket for another table 2712.2.

FIG. 29B illustrates an example of the storage distribution state 2925 changing over time. Some or all features and/or functionality of storage buckets 2910, storage distribution states 2925, and storage rebalancing process 2915 of FIG. 29B can implementing the storage buckets 2910, storage distribution states 2925, and storage rebalancing process 2915 of FIG. 29A and/or any embodiments of storage buckets 2910, storage distribution states 2925, and storage rebalancing process 2915 described herein.

In some embodiments, as new data is loaded to database system 10, it is loaded into a balanced state 2927 (e.g. if all conditions remained the same, no rebalancing would be required as a balanced state is achieved from the onset). However, as customers accumulate more data, database system 10 can be expanded with more storage (e.g. via adding nodes 37 and/or clusters 2535), rendering an unbalanced state 2926. A storage rebalancing process 2915 can be performed (e.g. periodically and/or in response to new storage being added) to put the state back into a balanced state 2927 and/or to otherwise maintain balance over time. This can be based on achieving the goal of spend the same amount of time per query on each node when queries are executed against the data-a balanced state can help achieve this.

In some embodiments, storage rebalancing process 2915 can be implemented in conjunction with maintaining database system 10 requirements of scalability (e.g. via being performed in conjunction with distributed tasks of a distributed tasks framework) and/or query correctness (e.g. via implementing functionality of transfer segment group process 2810 to implement a query correctness guaranteeing strategy).

In some embodiments, balanced state 2927 can be considered achieved when, ultimately, a query takes the same amount of time on each node (e.g. on average). In some embodiments, quantity of data divided by capacity is a reasonable measure of this. Thus, a balanced state 2927 can be achieved based on, for each given table 2712, for each node 37 across database system 10 storing data (e.g. segments 2424) of this given table 2712, the total storage relative to storage capacity is roughly equal (e.g. based on storage capacity being a good relative approximation of compute power).

As illustrated in FIG. 29B, a first storage distribution state 2925.i−1 (e.g. that includes at least storage bucket 2910.1 and 2910.2) corresponds to a balanced state 2927, for example, based on all storage buckets having relatively equal storage utilization 2922 relative to storage capacity 2923. After additional storage is added (e.g. at least storage bucket 2910.3 is added), the system enters a new storage distribution state 2925.i corresponding to an unbalanced state 2926, for example, based on storage buckets no longer having relatively equal storage utilization 2922 relative to storage capacity 2923 (e.g. based on new storage buckets not yet storing data due to being newly added). After the storage rebalancing process 2915 is performed, the system enters storage distribution state 2925.i+1 again corresponding to balanced state 2927, for example, based on all storage buckets again having relatively equal storage utilization 2922 relative to storage capacity 2923.

Different storage buckets can have different actual capacity (e.g. as illustrated in FIG. 29B, storage buckets 2910.1 and 2910.2 have a same capacity and bucket 2910.3 has a smaller capacity). The storage utilization 2922 can be measured as a proportion of actual capacity 2923 of the corresponding bucket 2910 that is utilized.

Furthermore, different tables can contribute to different amounts of utilization within a storage bucket. Performing the storage rebalancing process 2915 can be based on making each table relatively equal across buckets 37 responsible for storing these tables. For example, as illustrated in FIG. 29B, the balanced state 2927 is achieved based on table 0 having relatively equal utilization across buckets 2910.1, 2910.2, and 2910.3, and also table 1 having relatively equal utilization across buckets 2910.1, 2910.2, and 2910.3, despite table 1 collectively contributing to much higher utilization per bucket than table 0.

FIG. 29C illustrates an embodiment of storage rebalancing module 2905 that implements a source and target criteria generator module 2906, a source and target candidate selection module 2912, and/or a selection process 2958. Some or all features and/or functionality of storage rebalancing module 2905 can implement the storage rebalancing module 2905 of FIG. 29A and/or any embodiment of storage rebalancing module 2905 and/or storage rebalancing process 2915 described herein.

In some embodiments, the storage rebalancing module identifies source bucket set 2917 and target bucket set 2917 based on a first threshold storage utilization 2907 and a second threshold storage utilization 2908. For example, the source bucket criteria 2903 is based on the first threshold storage utilization 2907 (e.g. only storage buckets 2910 exceeding the first threshold storage utilization 2907 are included in source bucket set 2916), and/or the target bucket criteria 2904 is based on the second threshold storage utilization 2908 (e.g. only storage buckets 2910 falling below the second threshold storage utilization 2908 are included in target bucket set 2917).

The first threshold storage utilization 2907 and a second threshold storage utilization 2908 are selected for the given rebalancing process 2915 as a function of current storage distribution data 2911.i. For example, the current storage distribution data 2911.i indicates a plurality of storage utilizations 2922.1-2922.W for storage buckets 2910.1-2910.W (e.g. storage utilization 2922 is indicated as a proportion of total storage capacity 2923 rather than absolute amount of storage used, for example, based on different storage buckets 2910 having different actual storage capacities 2923).

In some embodiments, the first threshold storage utilization 2907 is generated via a source criteria generator module 2947. The first threshold storage utilization 2907 can be computed as a function F of the average storage utilization across storage utilizations 2922.1-2922.W). As a particular example, the first threshold storage utilization 2907 is selected as the average storage utilization across storage utilizations 2922.1-2922.W.

In some embodiments, the second threshold storage utilization 2908 is generated via a target criteria generator module 2948. The second threshold storage utilization 2908 can be computed as a function of the first threshold storage utilization 2907. For example, the second threshold storage utilization 2908 can be computed as a predetermined proportion p of the first threshold storage utilization 2907. As a particular example, the second threshold storage utilization 2908 can be computed as 0.8 times the first threshold storage utilization 2907 (e.g. p=0.8).

For example, in some embodiments, for every table 2712, across multiple cycles, the buckets are identified and categorized as “source” or “target”. In some embodiments, the goal is for the total storage used in a bucket divided by its capacity to be greater than 0.8 times the average (or some of other proportion p of the average between 0 and 1 and optionally different from 0.8). In some embodiments, anything with a ratio less than 0.8 times the average is a target, anything above the average is a source. Items in each source bucket can be determined, and some number of items from the source buckets can be chosen (e.g. proportional to how much extra data they have), and corresponding move requests can be submitted.

The source and target candidate selection module 2912 can generate a source candidate set 2956 and a target candidate set 2957. This can include evaluating a given bucket 2910.k of the storage buckets 2910.1-2910.W to determine whether it be included in the source candidate set 2956 or target candidate set 2957 (or neither). Determining the source candidate set 2956 can include identifying ones of the buckets 2910 meeting source bucket criteria 2903 (e.g. exceeding the first threshold storage utilization 2907, and/or optionally being greater than or equal to first threshold storage utilization 2907) for inclusion in source candidate set 2956. Determining the target candidate set 2957 can include identifying ones of the buckets 2910 meeting target bucket criteria 2904 (e.g. falling below the second threshold storage utilization 2908, and/or optionally being less than or equal to second threshold storage utilization 2908) for inclusion in target candidate set 2957.

A selection process 2958 can be performed to select source buckets 2910.A and target buckets 2910.B to be involved in data transfers 2920 as sources and targets of a given data transfer 2920 accordingly. In some embodiments, all candidate source buckets in source candidate set 2956 are included in source bucket set 2916. In some embodiments, less than all candidate source buckets in source candidate set 2956 are included in source bucket set 2916. In some embodiments, all candidate target buckets in target candidate set 2957 are included in target bucket set 2917. In some embodiments, less than all candidate target buckets in target candidate set 2957 are included in target bucket set 2917.

For example, the items to be moved are selected at random, where items from sources with more data above average are more likely to be chosen, and/or where target buckets with less data below average are more likely to be chosen. This principle is illustrated in FIG. 29D: storage buckets 2910 with storage utilization 2922 above the threshold 2907 (e.g. above the computed average utilization) are source buckets 2910.A (e.g. candidate sources in the source candidate set 2956), and storage buckets 2910 with storage utilization 2922 below the threshold 2908 (e.g. below the computed threshold as 0.8 times the average utilization) are target buckets 2910.B (e.g. candidate sources in the target candidate set 2956).

As illustrated in FIG. 29D, a first source bucket 2910.A. 1 that exceeds the threshold 2907 by more than a second source bucket 2910.A.2 is more likely to be selected via selection process 2958 as a source for a data transfer 2920. The probability of selection (e.g. via a weighted, random selection process) can be proportional to the amount by which the threshold 2907 is exceeded (e.g. the first source bucket 2910.A.1 exceeds the threshold 2907 by twice as much as the second source bucket 2910.A.2, and is thus two times more likely to be selected via selection process 2958).

Similarly, as illustrated in FIG. 29D, a first target bucket 2910.B.1 that falls the threshold 2907 by more than a second target bucket 2910.B.2 is more likely to be selected via selection process 2958 as a target for a data transfer 2920. The probability of selection (e.g. via a weighted, random selection process) can be proportional to the amount under which the threshold 2907 falls (e.g. the first target bucket 2910.B.1 falls below the threshold 2907 by twice as much as the second target bucket 2910.B.2, and is thus two times more likely to be selected via selection process 2958).

In some embodiments of implementing selection process 2958, batch size is updated lazily every cycle such that the system processes towards a balanced state quickly, but not so quickly to render “overshooting” of the balanced state. For example, if in any given cycle, the system haven't gotten some configured percentage (e.g. 20%) closer to our balanced state, the batch size is multiplied by a configurable amount greater than 1 (e.g. by 1.5), while adhering to a configured maximum batch size (e.g. 10,000). As a particular example, a 10% approach-rate and batch size multiplier of 2 can be utilized for progressing to some or all next cycles.

In some embodiments, the entire state of storage (e.g. current storage distribution data 2911) is not checked every cycle (e.g. as this could be timely/inefficient). In some embodiments, selection process 2958 is implemented such that it is not running on cached values for too long, for example, because the state of storage will change after a while with loading going on too. To adapt for these conditions, cached values can be utilized until we get a configurable percentage (e.g. 50%) of the way to a completely balanced state (e.g. corresponding to reaching, on average, 0.8 percent of the average across buckets 2910, for example, based on needing target buckets to reach only 0.8 of average).

FIG. 29E illustrates an example embodiment of implementing data transfer module to perform a plurality of data transfers 2920, where a given data transfer 2920.j includes to transfer data items X (e.g. of a given table) from a given source bucket 2910.A.j to a given target bucket 2910.B.j. Thus, transitioning to the storage distribution state 2925.i to storage distribution state 2925.i+1 includes data items X being moved from source bucket 2910.A.j to target bucket 2910.B.j. Additional data items can optionally be transferred for additional tables similarly.

FIG. 29F illustrates an embodiment of storage rebalancing module operable 2905 to perform storage rebalancing process 2915 via performing a first storage rebalancing process 2935.1 corresponding to inter-cluster rebalancing 2971 across a plurality of storage clusters 2535.1-2535.Z, and/or performing a second storage rebalancing subprocess 2935 corresponding to intra-cluster rebalancing 2972 via a plurality of storage plurality subprocesses 2935.2.1-2935.2.Z to perform intra-cluster rebalancing for each of the plurality of storage clusters 2535.1-2535.Z. Some or all features and/or functionality of the storage rebalancing module operable 2905 and/or perform storage rebalancing process 2915 can implement the storage rebalancing module operable 2905 and/or perform storage rebalancing process 2915 of FIG. 29A and/or any embodiment of the storage rebalancing module operable 2905 and/or perform storage rebalancing process 2915 described herein.

In some embodiments, inter-cluster rebalancing 2971 is performed as part of storage rebalancing process 2915 to render balance of data across clusters 2535 via moving entire segment groups between clusters 2535. For example, performing inter-cluster rebalancing 2971 of first storage rebalancing subprocess 2935.1, the storage buckets 2910.1-2910.W correspond to storage clusters 2535.1-2535.Z, where one or more data transfers 2920 are performed as a corresponding segment group transfer process 2810 to transfer a given segment group from a source storage cluster 2535.A to a target storage cluster 2535.B.

In some embodiments, intra-cluster rebalancing 2972 is performed as part of storage rebalancing process 2915 to render balance of data across nodes 37 via moving individual segments 2424 between nodes 37 (e.g. while moving multiple segments with the same segment group ID into a single node to ensure redundant storage/data recovery rendered via storage of different segments in a same segment group across multiple different nodes 37 is achieved). For example, performing a given intra-cluster rebalancing 2972 of a given storage rebalancing subprocess 2935.2.r for a given storage cluster 2535.r, the storage buckets 2910.1-2910.W correspond to nodes 37.r.1-37.r.Nr included in the given storage cluster 2535.r, where one or more data transfers 2920 are performed as a corresponding segment transfer (e.g. mediated within the cluster via the consensus protocol) of a given segment from a source node 37.A to a target node 37.B.

In some embodiments, all of the subprocesses 2935.2.1-2935.2.Z are performed in accordance with a first order value, and the subprocess 2935.1 is performed in accordance with a second order value, denoting that all intra-cluster rebalancing be performed first, and the inter-cluster rebalancing only be performed after all intra-cluster rebalancing is complete.

FIGS. 29G and 29H illustrate a storage balancing module 2905 implementing inter-cluster rebalancing 2971 and intra-cluster rebalancing 2972, respectively, via implementing a rebalancing adapter module 2950 to render performance of the appropriate rebalancing type. This can enable both inter-cluster rebalancing 2971 and intra-cluster rebalancing 2972 being performed essentially identically via implementing the functionality of storage rebalancing process 2915 upon its respective data buckets 2910 via implementing some or all features and/or functionality of FIGS. 29A-29F, while accounting for rules and/or configuration of the corresponding type of transferring specific to the rebalancing type (e.g. whether it is performing inter-cluster rebalancing 2971 and intra-cluster rebalancing 2972). Some or all features and/or functionality of storage balancing module 2905 of FIG. 29G and/or 29H can implement the storage balancing module 2905 of FIG. 29A and/or any embodiment of storage balancing module 2905 described herein.

As illustrated in FIG. 29G, storage rebalancing subprocess 2935.1 is performed based on current storage distribution data 2911 for storage buckets 2910.1-2910.Z corresponding to storage clusters 2535.1-2535.Z based on implementing rebalancing adapter module 2950 to implement inter-cluster-based rebalancing configuration data 2955 corresponding to inter-cluster rebalancing 2971 to: implement the source and target selection module 2912 to implement cluster-based selection instructions 2951 in identifying source bucket set 2936 to include a set of source clusters 2535.A and target bucket set 2936 to include as set of target clusters 2935.B; and/or to implement data transfer module 2913 to implement inter-cluster-based transfer instructions 2952 to perform inter-cluster data transfer processes 2933 as segment group transfer processes 2810.

As illustrated in FIG. 29H, a given storage rebalancing subprocess 2935.2.r is performed based on current storage distribution data 2911 for storage buckets 2910.1-2910.Nr corresponding to nodes 2535.r.1-2535.r.Nr based on implementing rebalancing adapter module 2950 to implement intra-cluster-based rebalancing configuration data 2956 corresponding to intra-cluster rebalancing 2972 to: implement the source and target selection module 2912 to implement node-based selection instructions 2957 in identifying source bucket set 2936 to include a set of source nodes 37.A and target bucket set 2936 as a set of target nodes 37.B; and/or to implement data transfer module 2913 to implement intra-cluster-based transfer instructions 2958 to perform intra-cluster data transfer processes 2943.

In some embodiments, the rebalancing adapter module 2950 adapts inter-cluster-based rebalancing configuration data 2955 differently from intra-cluster-based rebalancing configuration data 2956, in implementing inter-cluster rebalancing 2971 vs implementing intra-cluster rebalancing 2972, respectfully, based on adapting each of a plurality of adapter concepts for inter-cluster rebalancing 2971 vs intra-cluster rebalancing 2972. For example, for an adapter concept corresponding to getting/identifying buckets 2910, the inter-cluster-based rebalancing configuration data 2955 indicates this corresponds to getting/identifying all clusters 2535, while intra-cluster-based rebalancing configuration data 2956 indicates this corresponds to getting/identifying all nodes 37 in the given cluster. As another example, for an adapter concept corresponding to getting/identifying items within a requested (e.g. source) bucket 2910 (e.g. for transfer to another bucket), the inter-cluster-based rebalancing configuration data 2955 indicates this corresponds to getting/identifying segment groups in the requested cluster, while intra-cluster-based rebalancing configuration data 2956 indicates this corresponds to getting/identifying segments in the requested node. As another example, for an adapter concept corresponding to choosing N items to be moved from bucket A to bucket B, the inter-cluster-based rebalancing configuration data 2955 indicates this corresponds to choosing any N segment groups in cluster A to be moved to cluster B (e.g. without restriction), while intra-cluster-based rebalancing configuration data 2956 indicates this corresponds to choosing N segments in node A to be moved to node B that don't have segment group IDs matching any group IDs of segments already in B (e.g. based on the restriction that multiple segments in the same segment group cannot be stored on the same node 37). As another example, for an adapter concept corresponding to submitting/executing the transfer of the N items, the inter-cluster-based rebalancing configuration data 2955 indicates this corresponds to executing multiple instances of transfer segment group (e.g. for each of the N segment groups), while intra-cluster-based rebalancing configuration data 2956 indicates this corresponds to sending a move segment request to the corresponding cluster (e.g. a different request for each of the N segments and/or a single indicating all N segments).

In some embodiments, the storage rebalancing process 2915 can be implemented via one or more rebalance tasks implemented via the distributed tasks framework. For example, intra-cluster rebalance subprocess 2935.2.r can be run on the cluster it is balancing (e.g. via nodes 37 of this cluster), while intra-cluster rebalance subprocess 2935.1 can be run anywhere (e.g. via any nodes on any cluster). A corresponding task structure can include a rebalance root (e.g. with no task owner) having a plurality of children (e.g. each owned by a corresponding node 37), where each child runs a corresponding subtask. For example, the plurality of children include Z+1 children, where the first Z children 1-Z each implement a corresponding intra-cluster rebalance subprocess 2935.2 on a corresponding cluster (e.g. in accordance with an order 0), and where child Z+1 runs the inter-cluster rebalance subprocess 2935.1 anywhere (e.g. in accordance with an order 1, denoting the intra-cluster rebalances all be performed first to finish before running inter-cluster rebalance so there isn't conflict in trying to move the same data).

In some embodiments, inter-cluster rebalance performs transfer segment group process via multiple transfer coordinators (e.g. multiple transfer segment group task processing modules 3510). In some embodiments, if the task dies while transfers are executing, it can be important to determine what was executing upon the task re-executing on a different task owner. In some embodiments, this can be achieved based on, before “submitting” the transfers, storing it in the task state: after the submissions are complete: removing it from the task state; and/or if the task is started on a task owner and there exist leftover transfers in the state, re-execute those transfers to guarantee at least that they are cleaned up on the storage clusters.

FIG. 29I illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 29I, for example, based on participating in execution of a query being executed by the database system 10. Some or all of the method of FIG. 29I can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 29I based on implementing a corresponding plurality of processing core resources 48.1-48.W. Some or all of the steps of FIG. 29I can optionally be performed by any other one or more processing modules of the database system 10. Some or all of the steps of FIG. 29I can be performed to implement some or all of the functionality of the database system 10 as described in conjunction with FIGS. 29A-29I, for example, by implementing some or all of the functionality of storage rebalancing process 2915, storage rebalancing module 2905, storage buckets 2910, database storage 2910, data transfer 2913, data transfers 2920, source and target selection module 2912, source and target criteria generator module 2906, source and target candidate selection module 2912, selection process 2958, inter-cluster rebalancing 2971, intra-cluster rebalancing 2972, and/or rebalancing adaptor module 2950. Some or all steps of FIG. 29I can be performed by database system 10 in accordance with other embodiments of the database system 10 and/or nodes 37 discussed herein. Some or all of the steps of FIG. 29I can be performed in conjunction with performing some or all steps of any other method described herein.

Step 2982 includes storing a plurality of relational database tables via a plurality of storage buckets of a database system. Step 2984 includes executing a plurality of queries against the plurality of relational database tables via accessing the plurality of storage buckets. Step 2986 includes generating current storage distribution data indicating storage utilization for the plurality of storage buckets of the database system. Step 2988 includes performing a storage rebalancing process based on the current storage distribution data.

Performing step 2988 can include performing 2990, 2992, and/or 2994. Step 2990 includes identifying a first subset of the plurality of storage buckets as a plurality of source buckets based on each of the first subset of the plurality of storage buckets having corresponding storage utilization meeting source bucket criteria. Step 2992 includes identifying a second subset of the plurality of storage buckets as a plurality of target buckets based on each of the first subset of the plurality of storage buckets having corresponding storage utilization meeting target bucket criteria. Step 2996 includes performing a plurality of data transfers. In various examples, performing each of the plurality of data transfers includes transferring storage of data included in one of plurality of source buckets to one of the plurality of target buckets.

In various examples, a first subset of the plurality of queries are executed against the plurality of relational database tables via accessing the plurality of storage buckets prior to performing the storage rebalancing process, and/or a second subset of the plurality of queries are executed against the plurality of relational database tables via accessing the plurality of storage buckets after performing the storage rebalancing process.

In various examples, performing the storage rebalancing process includes performing a first storage rebalancing subprocess corresponding to rebalancing of first storage buckets of the database system having a first storage type based on: identifying a first subset of the first storage buckets of the database system having the first storage type as a first corresponding plurality of source buckets based on each of the first subset of the first storage buckets of the database system meeting the source bucket criteria; identifying a second subset of the first storage buckets of the database system having the first storage type as a first corresponding plurality of target buckets based on each of the second subset of the first storage buckets of the database system meeting the target bucket criteria; and/or performing a first plurality of data transfers. In various examples, performing each of the first plurality of data transfers includes transferring storage of data included in one of the first corresponding plurality of source buckets to one of the first corresponding plurality of target buckets via a first type of data transfer process corresponding to the first storage type.

In various examples, performing the storage rebalancing process further includes performing a second storage rebalancing subprocess corresponding to rebalancing of second storage buckets of the database system having a second storage type based on: identifying a first subset of the second storage buckets of the database system having the second storage type as a second corresponding plurality of source buckets based on each of the first subset of the second storage buckets of the database system meeting the source bucket criteria; identifying a second subset of the second storage buckets of the database system having the second storage type as a second corresponding plurality of target buckets based on each of the second subset of the second storage buckets of the database system meeting the target bucket criteria; and/or performing a second plurality of data transfers, In various examples, performing each of the second plurality of data transfers includes transferring storage of data included in one of the second corresponding plurality of source buckets to one of the second corresponding plurality of target buckets via a second type of data transfer process corresponding to the second storage type.

In various examples, performing the plurality of data transfers includes implementing an adapter module to perform each of the first plurality of data transfers in accordance with the first type of data transfer process and to further perform each of the second plurality of data transfers in accordance with the second type of data transfer process.

In various examples, the source bucket criteria is applicable to both the first storage type and the second storage type. In various examples, the target bucket criteria is applicable to both the first storage type and the second storage type.

In various examples, each first storage bucket of the first storage buckets having the first storage type includes a corresponding subset of the second storage buckets having the second storage type based on the first storage buckets and the second storage buckets being configured in accordance with a hierarchical storage structuring of the first storage type and the second storage type. In various examples, performing the storage rebalancing process includes performing a plurality of second storage rebalancing subprocesses based on, for the each first storage bucket of the first storage buckets, performing a corresponding second storage rebalancing subprocesses of the plurality of second storage rebalancing subprocesses to rebalance corresponding second storage buckets included within the each first storage bucket.

In various examples, the plurality of relational database tables are stored via a plurality of segments of a plurality of segments groups across a plurality of nodes of a plurality of storage clusters of the database system. In various examples, each storage cluster of the plurality of storage clusters includes a corresponding plurality of nodes that collectively store a corresponding plurality of segment groups that each include a corresponding plurality of segments each stored via a corresponding node of the corresponding plurality of nodes. In various examples, the first storage buckets correspond to the plurality of storage clusters. In various examples, the second storage buckets correspond to the plurality of nodes. In various examples, the first type of data transfer process corresponds to an inter-cluster data transfer process. In various examples, the second type of data transfer process corresponds to an intra-cluster data transfer process.

In various examples, performing the storage rebalancing process includes performing the first storage rebalancing subprocess to rebalance storage of segment groups across the plurality of storage clusters of the database system based on: identifying a plurality of source storage clusters as a first subset of the plurality of storage clusters based on each of the first subset of the plurality of storage clusters meeting the source bucket criteria: identifying a plurality of target storage clusters as a second subset of the plurality of storage clusters based on each of the second subset of the plurality of storage clusters meeting the target bucket criteria; and/or performing the first plurality of data transfers. In various examples, performing each of the first plurality of data transfers includes performing a corresponding inter-cluster data transfer process via transferring storage of at least one segment group included in one of the plurality of source storage clusters to one of the plurality of target storage clusters via transferring all segments included in the at least one segment group from a corresponding first plurality of nodes of the one of the plurality of source storage clusters to a corresponding second plurality of nodes of the one of the plurality of target storage clusters.

In various examples, performing the storage rebalancing process further includes performing a plurality of second storage rebalancing subprocesses based on, for each storage cluster of the plurality of storage clusters, performing a corresponding second storage rebalancing subprocess of the plurality of second storage rebalancing subprocesses to rebalance storage of segments across the corresponding plurality of nodes of the each storage cluster based on: identifying a plurality of source nodes as a first subset of the corresponding plurality of nodes based on each of the first subset of the corresponding plurality of nodes meeting the source bucket criteria: identifying a plurality of target nodes as a second subset of the corresponding plurality of nodes based on each of the second subset of the corresponding plurality of nodes meeting the target bucket criteria; and/or performing the second plurality of data transfers. In various examples, performing each of the second plurality of data transfers includes performing a corresponding intra-cluster data transfer process via transferring storage of at least one segment group included in one of the plurality of source nodes to one of the plurality of target nodes.

In various examples, performing each of the first plurality of data transfers includes selecting a subset of segment groups stored by the one of the plurality of source storage clusters for transfer to the one of the plurality of target storage clusters without applying any segment group selection restrictions. In various examples, performing each of the second plurality of data transfers includes selecting a subset of segments stored by the one of the plurality of source nodes for transfer to the one of the plurality of target storage clusters based on applying a segment selection restriction based on selecting segments stored by the one of the plurality of source nodes for inclusion in the subset of segments based on having segment group identifiers different from all segment group identifiers of other segments already stored by the one of the plurality of target nodes.

In various examples, performing each of the first plurality of data transfers includes performing a corresponding segment group transfer process via serialized performance of a plurality of steps in accordance with a query correctness guaranteeing strategy. In various examples, a first one of the plurality of queries is executed during performance of at least one corresponding segment group transfer process. In various examples, due to the serialized performance of the plurality of steps in accordance with the query correctness guaranteeing strategy, a query resultant generated via execution of the query is guaranteed to be correct based on each segment group of the plurality of segment groups being accessed via exactly one storage cluster of the plurality of storage clusters.

In various examples, the source bucket criteria indicates a first threshold storage utilization. In various examples, the plurality of source buckets are identified based on each having a corresponding storage utilization exceeding the first threshold storage utilization. In various examples, the target bucket criteria indicates a second threshold storage utilization. In various examples, the plurality of source buckets are identified based on each having a corresponding storage utilization falling below the second threshold storage utilization. In various examples, the second threshold storage utilization is strictly less than the first threshold storage utilization.

In various examples, different ones of the plurality of storage buckets have different total storage capacities. In various examples, storage utilization of a given bucket of the plurality of storage buckets corresponds to a proportion of total storage capacity of the given bucket that is utilized based on storing corresponding data. In various examples, the first threshold storage utilization corresponds to a first threshold proportion of total storage capacity that is utilized. In various examples, the second threshold storage utilization corresponds to a second threshold proportion of total storage capacity that is utilized.

In various examples, the method further includes computing an average storage utilization for the plurality of storage buckets of the database system based on the current storage distribution data: selecting the first threshold storage utilization as a function of the average storage utilization; and/or selecting the second threshold storage utilization as a predetermined proportion of the first threshold storage utilization.

In various examples, the predetermined proportion is 0.8 and/or is based on the value 0.8. In various examples, the predetermined proportion corresponds to/is based on another value.

In various examples, the first threshold data is set as the average storage utilization.

In various examples, the storage rebalancing process is further based on selecting the plurality of source buckets as a proper subset of a plurality of source bucket candidates all having a corresponding storage utilization exceeding the first threshold storage utilization based on selecting the plurality of source buckets from the plurality of source bucket candidates in accordance with a randomized selection process applying weighing as an increasing function of deviation of corresponding storage utilization from the first threshold storage utilization.

In various examples, the storage rebalancing process is further based on selecting, for each source bucket of the plurality of source buckets, an amount of data to transfer out of the each source bucket as an increasing function of the deviation of the corresponding storage utilization from the first threshold storage utilization.

In various examples, the storage rebalancing process is further based on selecting the plurality of target buckets as a proper subset of a plurality of target bucket candidates all having a corresponding storage utilization falling below the second threshold storage utilization based on selecting the plurality of target buckets from the plurality of target bucket candidates in accordance with the randomized selection process applying weighing as an increasing function of deviation of corresponding storage utilization from the second threshold storage utilization.

In various examples, the storage rebalancing process is further based on selecting, for each target bucket of the plurality of target buckets, an amount of data to transfer into the each target bucket as an increasing function of the deviation of the corresponding storage utilization from the first threshold storage utilization.

In various examples, performing the plurality of data transfers is based on performing a plurality of sets of data transfers over a plurality of cycles. In various examples, each set of data transfers is performed in accordance with a selected batch size for a corresponding one of the plurality of cycles. In various examples, the selected batch size is updated for a subsequent one of the plurality of cycles based on: a configured batch size approach rate: a configured batch size multiplier: comparing a rebalancing progress measured from after performing a previous one of the plurality of cycles to after performing the corresponding one of the plurality of cycles to a threshold minimum percentage of progress; and/or adhering to a configured threshold maximum batch size.

In various examples, the plurality of data transfers are performed as a corresponding plurality of distributed tasks for execution in accordance with a distributed task framework. In various examples, performing the plurality of data transfers includes re-executing one of the corresponding plurality of distributed tasks a newly assigned node of a plurality of nodes based on a previously assigned node of the plurality of nodes failing while executing the executing the one of the corresponding plurality of distributed tasks.

In various examples, the method further includes: generating system metadata regarding the database system as a set of metadata rows; and/or further storing the set of metadata rows via a second set of relational database tables of the database system based on loading the set of metadata rows for storage via one loading module of a plurality of loading modules based on the one loading module being selected for system metadata loading.

In various examples, storing the plurality of relational database tables is based on: generating and storing a set of pages; and/or in response to detecting that a page drain condition has been met, determining a conversion page set as a proper subset of pages included in the set of pages based on a predetermined post-drain number of pages and/or performing a page conversion process upon pages included in the conversion page set to generate a set of segments from the pages included in the conversion page set. In various examples, the set of segments includes a plurality of rows of at least one of the plurality of relational database tables.

In various examples, the plurality of storage buckets include a plurality of segments stored by the database system. In various examples, the method further includes, based on generating the plurality of segments, populating a time bucket lookup map corresponding to the relational database table based on time values of the plurality of segments. In various examples, the method further includes: determining a query for execution indicating time-based filtering parameters: identifying a time-based pre-filtered segment set of the plurality of segments based on accessing the time bucket lookup map based on the time-based filtering parameters; and/or executing the query based on accessing only segments of the plurality of segments included in an identified segment set determined based on identifying the time-based pre-filtered segment set.

In various examples, the plurality of storage buckets include a plurality of segments stored by the database system. In various examples, the method further includes populating a multi-dimensional index structure. In various examples, the multi-dimensional index structure has a plurality of dimensions corresponding to a plurality of segment attribute types. In various examples, the method further includes: determining a query for execution: determining, based on the query, a required attribute value range for each of the plurality of segment attribute types: identifying an identified segment set based on accessing the multi-dimensional index structure determine ones of the plurality of segments having corresponding attributes for the each of the plurality of segment attribute types falling within the required attribute value range; and/or executing the query based on accessing only segments of the plurality of segments included in the identified segment set.

In various embodiments, any one of more of the various examples listed above are implemented in conjunction with performing some or all steps of FIG. 29I. In various embodiments, any set of the various examples listed above can be implemented in tandem, for example, in conjunction with performing some or all steps of FIG. 29I, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 29I described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 29I, for example, in conjunction with further implementing any one or more of the various examples described above.

In various embodiments, the operational instructions, when executed by the at least one processor, cause the database system to: store a plurality of relational database tables via a plurality of storage buckets of a database system: execute a plurality of queries against the plurality of relational database tables via accessing the plurality of storage buckets: generate current storage distribution data indicating storage utilization for the plurality of storage buckets of the database system; and/or perform a storage rebalancing process based on the current storage distribution data. In various embodiments, performing the storage rebalancing process is based on: identifying a first subset of the plurality of storage buckets as a plurality of source buckets based on each of the first subset of the plurality of storage buckets having corresponding storage utilization meeting source bucket criteria; identifying a second subset of the plurality of storage buckets as a plurality of target buckets based on each of the first subset of the plurality of storage buckets having corresponding storage utilization meeting target bucket criteria; and/or performing a plurality of data transfers. In various embodiments, performing each of the plurality of data transfers includes transferring storage of data included in one of plurality of source buckets to one of the plurality of target buckets.

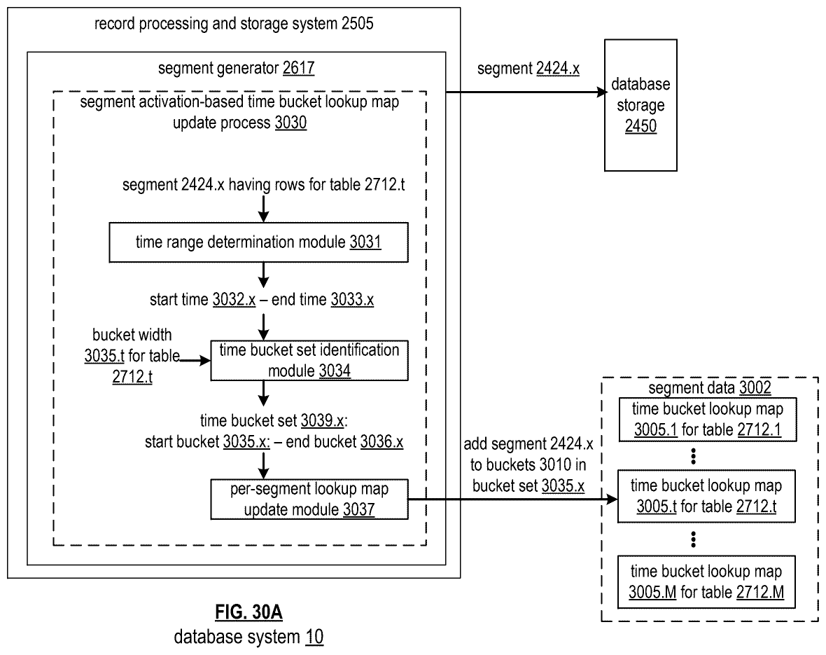

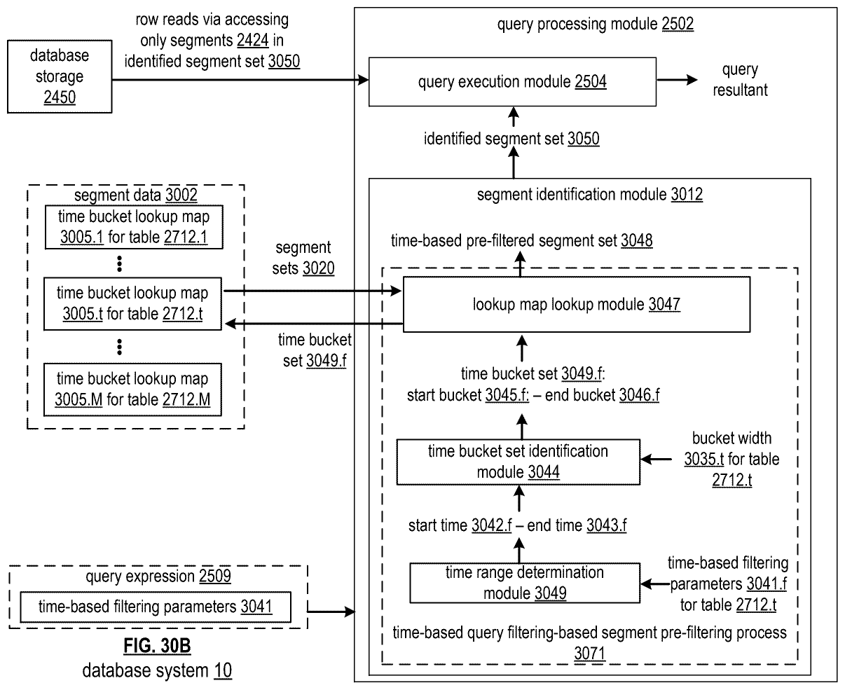

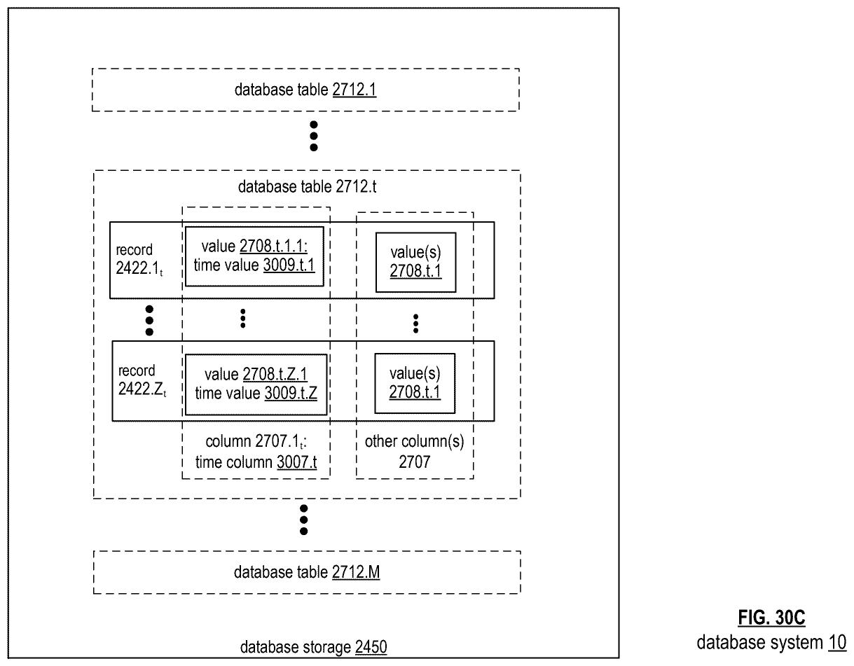

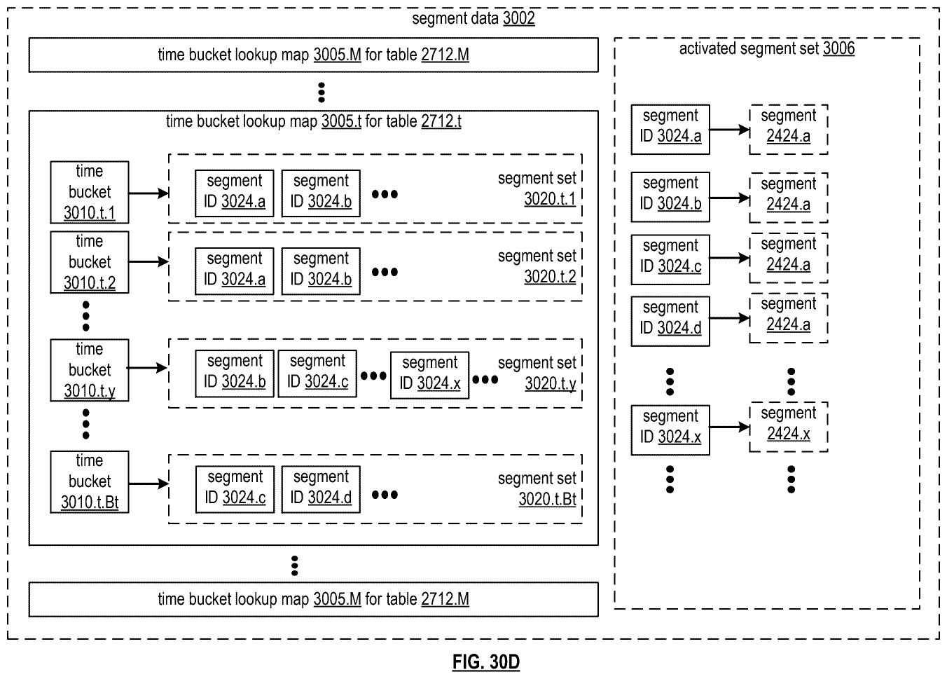

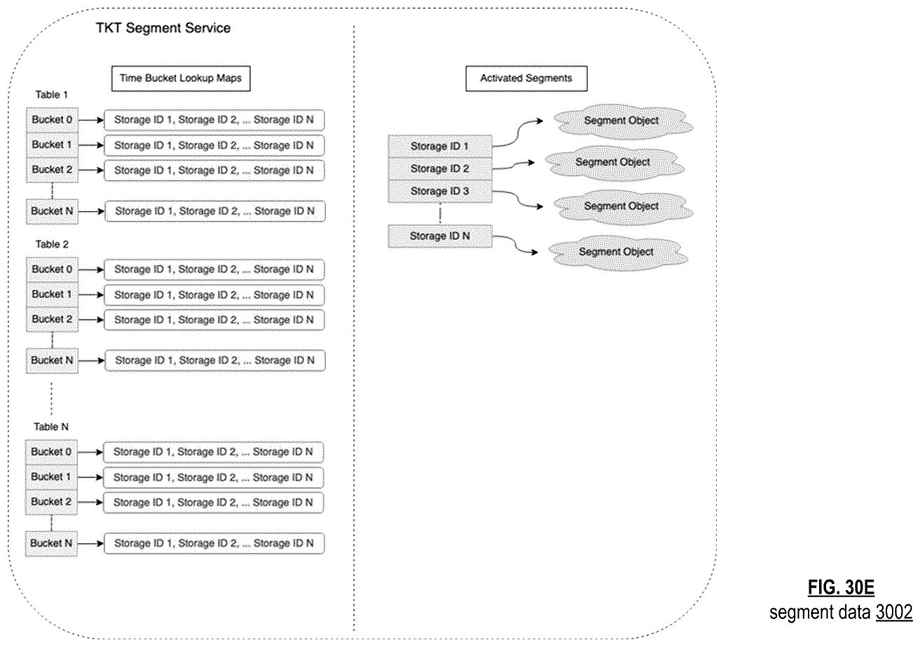

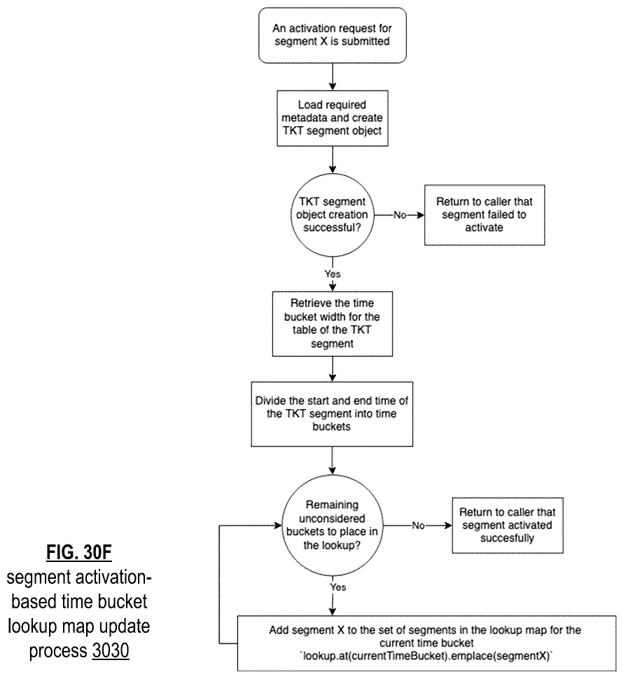

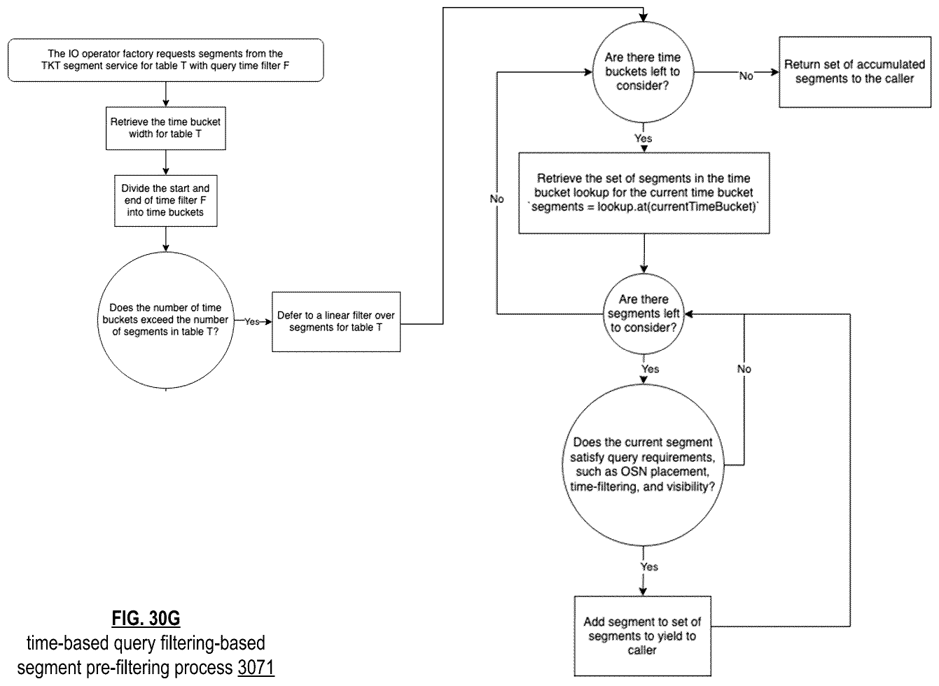

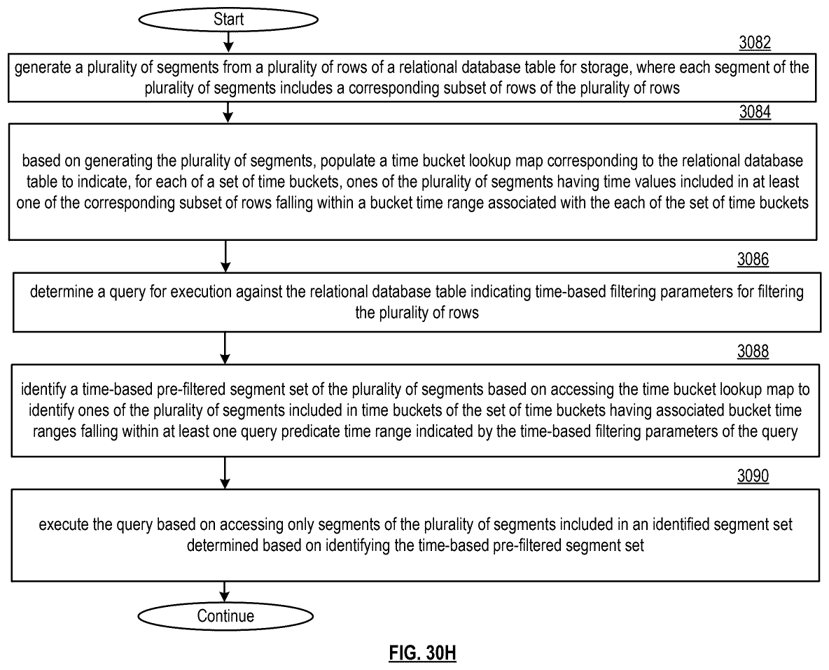

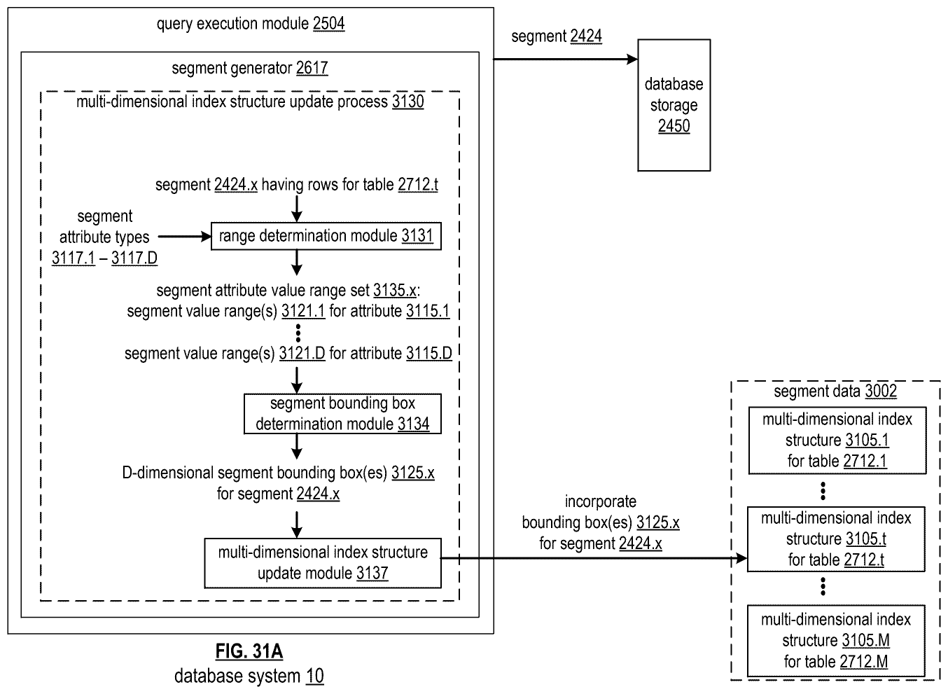

FIGS. 30A-30G present embodiments of a database system 10 operable to utilize at least one time bucket lookup map 3005 for at least one database table 2712 to pre-filter segments required for access in query execution based on time-based filtering parameters 3041 of a corresponding query. Some or all features and/or functionality of FIGS. 30A-30G can implement any embodiment of database system 10 described herein.

In some embodiments, database system 10 is configured to efficiently query time series data: data where each row has an associated numerical time column. In some embodiments, many queries (e.g. a majority of queries) of database system 10 will filter on data that falls within a specified time range.

This attribute can be leveraged to improve performance. For example, when segments 2424 (e.g. TKT segments) are activated and registered with a node (e.g in data ownership information), their time period (e.g. minimum and maximum value of a time column within the contained rows) can be determined (e.g. cached in-memory).

In some embodiments, this information is used (e.g. within an IO operator factory, for example, implemented via generation and/or execution of a corresponding IO pipeline for a corresponding query) to filter segments out of a query that fall outside of the user's specified time-filters. This can be implemented based on performing some or all of the following logic:

```
def operatorFactory_t::getSegmentsForQuery(tableId, osn, timeFilters):
  segments = m_segmentService->getSegments(tableId, osn)
  for segment in segments:
    if segment->timePeriod( ) does not intersect any filter in timeFilters:
      discard segment
  return segments
```

In some embodiments, a getSegments( ) function (e.g. within a TKT segment service) also performs filtering. For example, a linear pass can be performed over all required segments for the specified table: segments that should not be exposed to the query are excluded. This can include segments that fall outside the specified OSN of the query or have hidden visibility, amongst other conditions.

The benefit of pre-execution segment filtering is inapplicable segments can be identified and rejected before spending IO or VM compute resources on them (e.g. these segments are not accessed in performing query operators 2520 due to being pre-filtered).

In some embodiments, such pre-execution segment filtering can require two linear passes over segments to fully filter them for the query—the first pass rejects segments which are hidden or fall outside the query's target OSN, and the second pass performs time-filtering on the segments. For nodes with dense amounts of storage there could be millions of segments to consider. Furthermore, in query workloads with strict runtime requirements the costs of considering every required segment during filtering could be detrimental.

FIGS. 30A-30G present embodiments where such pre-execution segment filtering is implemented via improved efficiency, which can improve the technology of database systems by improving speed and/or processing efficiency of query execution.

In some embodiments, to address the performance implications of performing linear passes, the time filtering step can be incorporated based on implementing time bucket lookup maps 3005 for some or all tables 2712 of database system 10. For example, the time filtering step can be incorporated into the TKT segment service itself. In some embodiments, data structures can be implemented (e.g. within the TKT segment service) to efficiently time-filter segments by using a lookup map of time bucket to a set of applicable segments (e.g. implemented as time bucket lookup maps 3005). This can enable the database system 10 to perform pre-filtering based on only considering segments which fall within the time range of the query and completely bypassing those that fall outside the query's time range. This can result in far fewer iterations than a linear pass over all of the segments, for example, depending upon the total number of time buckets that are spanned by the query's time range.

FIG. 30A illustrates an embodiment of a record processing and storage system 2505 operable to generate and/or update segment data 3002 that includes time bucket lookup maps 3005.1-3005.M for a plurality of tables 2712.1-2712.M based on performing a segment activation-based time bucket lookup map update process 3030 for a given segment 2424.x (e.g. via a segment generator 2617 in conjunction with storing the given segment 2424.x in database storage 2450). For example, database storage 2450 implements storage of the plurality of tables 2712.1-2712.M via a plurality of segments 2424 each storing records 2422 for one of the plurality of tables 2712.

Performing segment activation-based time bucket lookup map update process 3030 can include, for a given segment 2424.x having rows for a given table 2712.t, implementing a time range determination module 3031 to identify a segment time range for rows in the segment, for example, based on identifying start time 3032.x (e.g. minimum time across all rows of the segment) and an end time 3033.x (e.g. maximum time across all rows of the segment) defining this time range.

Performing segment activation-based time bucket lookup map update process 3030 can further include implementing a time bucket set identification module 3034 to determine a time bucket set 3039.x of time buckers in a corresponding time bucket lookup map 3005 with which the segment's time range overlaps. This can be based on utilizing known bucket width 3035 for the given table 2712.t, for example, corresponding to a time range of each bucket of time bucket lookup map 3005.t to identify a start bucket 3035.x and end bucket 3035.x.

A per-bucket lookup map update module 3037 can be implemented to add (e.g. emplace) the segment 2424.x to buckets 3010 of the time bucket lookup map 3005.t included within the bucket set 3039.x.

FIG. 30B illustrates an embodiment of a query processing module 2502 that implements a segment identification module 3012 that performs a time-based query filtering-based segment pre-filtering process 3071 to generate an identified segment set 3050 indicating one of the set of segments to be accessed in query execution via query execution module 2504 via row reads to segments 2424 (e.g. in implementing IO pipeline) to access only segments included in identified segment set 3050, based on filtering out segments with time ranges not overlapping with any one or more time ranges indicated in time-based filtering parameters 3041 of a corresponding query expression 2509 indicating a query for execution.

Performing the time-based query filtering-based segment pre-filtering process 3071 can include implementing a time range determination module 3049 to process the time-based filtering parameters 3041.f for a given table 2712.t included in the time-based filtering parameters 3041 of the query expression 2509 to determine a corresponding query time frame, for example, based on determining a start time 3042.f and/or corresponding end time 3043.f defining this time frame.

A time bucket set identification module 3044 can be implemented to identify a time bucket set 3049.f for the given time frame, for example, based on identifying a corresponding start bucket 3045.f and end bucket 3046.f. Identifying the time bucket set 3049.f for the given time frame can be based on applying the bucket width 3035.t for the given table 2712.t.

A lookup map lookup module 3047 can be implemented to access the time bucket lookup map 3005.t for the given table 2712.t to access segment sets 3020 mapped to time buckets in the time bucket set 3049 to identify a time-based pre-filtered segment set 3048 (e.g. only segments included in segment sets mapped to the time buckets in the time bucket set 3049). Segment identification module 3012 can determine identified segment set 3050 from this time-based pre-filtered segment set 3048 (e.g. as the time-based pre-filtered segment set 3048, or as a subset of the time-based pre-filtered segment set 3048 based on further filtering the time-based pre-filtered segment set 3048 based on other parameters, such as OSN and/or visibility of the segments).

In some embodiments, the time-based filtering parameters 3041 indicate time-based filtering parameters for multiple different tables, and/or indicate multiple time ranges for a same table. Each corresponding time range can be processed to identify a corresponding time bucket set for the given table to which the corresponding time range applies, where the time-based pre-filtered segment set 3048 corresponds to a union of segments identified for all time bucket sets for all query time ranges indicated by the time-based filtering parameters 3041 for the query expression 2509.

FIG. 30C illustrates an embodiment of database system 10 where one or more tables 2712.1-2712.M of database storage 2450 include a column 2707 implemented as a time column 3007. Some or all features and/or functionality of tables 2712 of FIG. 30C can implement any embodiment of table 2712 described herein.

As illustrated in FIG. 30C, a given table 2712.t can include a time column 3007.t storing time values 3009 for each record 2422 in the table 2424. A given segment 2424.x (e.g. storing some subset of the records 2422 of this table 2712.t) can have its time range defined based on the range of time values 3009 of its record (e.g. start time 3032.x and end time 3033.x correspond to the minimum time value 3009 and maximum time value 3009 across records 2422 of the segment 2424). Given time-based filtering parameters 3041.f for the table 2712.t can indicate filtering parameters for the given query based on indicating query predicates for filtering on the time column 3007 of the table 2712.t.

In some embodiments, the segment data 3002 is implemented as system metadata and/or state data, for example, mediated via a corresponding plurality of nodes (e.g. of a corresponding storage cluster having the activated set of segments in its most recent data ownership information having a most recent OSN).

In some embodiments, the segment data 3002 is implemented/stored via a given node 37 (e.g. a node storing the segment and/or assigned to own the segment in data ownership information). In such embodiments, the segment activation-based time bucket lookup map update process 3030 is optionally performed by the given node in conjunction with storing/activating the segment 2424, where different nodes store their own segment data 3002 for their own segments. In some embodiments, the time-based query filtering-based segment pre-filtering process 3071 is performed separately (e.g. in parallel without coordination) via each node executing the query to determine its own set of segments 2424 for access in its own execution of the query (e.g. via its participation at the IO level of a query execution plan and/or via its own implementation of IO pipeline).

FIG. 30D illustrates an embodiment of segment data 3002. Some or all features and/or functionality of segment data 3002 of FIG. 30D can implement segment data of FIG. 30A and/or 30B, and/or any embodiment of segment data described herein.

Each time bucket lookup map 3005 can include a corresponding plurality of time buckets 3010.1-3010.B. Each time bucket 3010 can be mapped to a corresponding segment set 3020, which can indicate a plurality of corresponding segments 2424. For example, the corresponding segment set 3020 indicated segment identifiers 3024 of the corresponding segments 2424, mapped to the corresponding segments 2424 in an activated segment set 3006 (e.g. indicating its corresponding memory location and/or otherwise denoting the corresponding segment 2424).

Each segment set 3020 can indicate segment identifiers 3024 for all segments having time ranges overlapping with a time span for the corresponding time bucket 3010 (e.g. all segments having at least one time value 3009 of time column 3007 of the given table 2712 falling within a corresponding time span dictated by the time bucket 3010).

Each time bucket 3010 of a given time bucket lookup map 3005 can span a same amount of time, for example, as dictated by the bucket width 3035 for the given table 2712. Time buckets 3010 of a given time bucket lookup map 3005 can correspond to contiguous, disjoint time windows collectively spanning a full span of time for the corresponding table 2712 (e.g. that includes all time values 3009 of the time column 3007 for all rows in the table 2712). For example, the time buckets are ordered (e.g. 3010.t.1 is a first time span followed by a second time span 3010.t.2, and so on, where time bucket 3010.t.Bt spans a final time span). Alternatively, time buckets 3010 are not necessarily contiguous, for example, based on some spans of time not being reflected in any segments 2424 (e.g. the table includes not rows for this time span), where such time spans are optionally skipped.

As illustrated in FIG. 30D, some segments can optionally be identified in multiple segment sets 3020, for example, based on having time ranges spanning multiple time buckets 3010. In some embodiments, a given segment included in multiple segment sets 3020 will be included in a contiguous set of time buckets in the ordering, based on its respective segment time range. Different time buckets can include different numbers of segments.

In this example, segment 2424.x has its corresponding segment identifier 3024.x included in at least time bucket 3010.t.y (e.g. included in a span of time buckets 3010.t.y−k1-3010.t.y+k2 that all identify segment 2424.x in their segment sets 3020, where k1 and k2 are positive integers). For example, the time bucket set 3039.x for segment 2424 includes time bucket 3010.t.y, and segment 2424.x was identified in this segment set 3020.y accordingly via per-segment lookup map update module 3037.

In some embodiments, each table database system 10 can have an associated time bucket width. The time bucket width can optionally prescribes the span of time that can be included within a single TKT segment. This time bucket width can optionally dictate the bucket width 3035 for the corresponding time bucket lookup map. In such embodiments, each segment 2424 is optionally included in exactly one time bucket 3010 based on all adhering to the bucket width 3035.

A value of the time column can be converted into a numerical time bucket index based on dividing this time column value by the time bucket width. The value of the time bucket width for a table can be based on the interval of time that one is likely to query against as well as characteristics of the data load. The value of the time bucket width can be user configured (e.g. via user associated with the corresponding table, such as an administrator of a corresponding data source 2501).

A time bucket lookup map 3005 (e.g. within the TKT segment service) can be implemented as a mapping of {timeBucket->set (storageId)}, where there exists an entry in the map for each individual time bucket that is included within one or more segments in the table. The storage IDs within the lookup's inner sets can optionally be trivially resolved to actual segment objects via an existing lookup map of {storageId->segmentObject}.

In some embodiments, there exists a time bucket lookup map for each known table within the TKT segment service. If segments are allowed to span multiple time buckets, the same segment may appear in multiple buckets within the lookup map.

FIG. 30E illustrates an example embodiment of segment data 3002 implemented via TKT segment service. Some or all features and/or functionality of the segment data 3002 of FIG. 30E can implement segment data 3002 of FIG. 30D any embodiment of segment data 3002 described herein.

FIG. 30F illustrates an example logic flow implemented in performing segment activation-based time bucket lookup map update process 3030. For example, when a segment 2424 is requested for activation (e.g. within the TKT segment service), the segment 2424 is emplaced into time bucket lookup map 3005 for the respective table (e.g. upon successful TKT object creation) via implementing some or all logic of FIG. 30F.Some or all features and/or functionality of FIG. 30F can implement the segment activation-based time bucket lookup map update process 3030 of FIG. 30A and/or any embodiment of generating/updating a time bucket lookup map 3005.

In some embodiments, when segments 2424 are removed (E.g. deactivated via the TKT segment service), the process for removing them from the time bucket lookup map can largely follows the same procedure as activation, albeit with the emplace operation replaced by an erase from the lookup map instead.

FIG. 30G illustrates an example logic flow implemented in performing time-based query filtering-based segment pre-filtering process 3071. Some or all features and/or functionality of FIG. 30G can implement the time-based query filtering-based segment pre-filtering process 3071 of FIG. 30B and/or any embodiment of accessing a time bucket lookup map 3005 to pre-filter segments 2424 from consideration in query execution.

For example, the IO operator factory does not perform its own time-filtering, and it instead passes in the disjunction of query time-filters into the TKT segment service directly, where the time bucket lookup map is utilized to minimize the number of TKT segments that will be considered. For simplicity, the following diagram assumes only a single time-filter is given, but it can be trivially extended to support multiple time-filters by repeating steps on a per-filter basis.

In some embodiments, the time bucket lookup map is not always consulted. For example, consider a case where the specified query time range spans a very large number of time buckets: far more buckets than segments in the table. Iterating over each bucket and looking it up in the map could result in more total iterations than just performing a linear pass over the segments within the table. Thus, before consulting the time bucket lookup map, the number of buckets spanned by the query time filter can be compared to the number of segments in the table. If the number of buckets is within a specified threshold of the total segments (e.g. where the specified threshold is configured via user input or otherwise predetermined), the TKT segment service can then defer to a linear pass over the segments.

FIG. 30H illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 30H, for example, based on participating in execution of a query being executed by the database system 10. Some or all of the method of FIG. 30H can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 30A based on implementing a corresponding plurality of processing core resources 48.1-48.W. Some or all of the steps of FIG. 30H can optionally be performed by any other one or more processing modules of the database system 10. Some or all of the steps of FIG. 30H can be performed to implement some or all of the functionality of the database system 10 as described in conjunction with FIGS. 30A-30G, for example, by implementing some or all of the functionality of record processing and storage system 2505, segment generator 2617, segment activation-based time bucket lookup map update process 3030, segment data 3002, time bucket lookup map 3005, segment identification module 3012, query processing module 2502, query execution module 2504, time-based filtering parameters 3041, time-based query filter-based segment pre-filtering process 3071, time buckets 3010, and/or segment sets 3020. Some or all steps of FIG. 30H can be performed by database system 10 in accordance with other embodiments of the database system 10 and/or nodes 37 discussed herein. Some or all of the steps of FIG. 30H can be performed in conjunction with performing some or all steps of any other method described herein.

Step 3082 includes generating a plurality of segments from a plurality of rows of a relational database table for storage. In various examples, each segment of the plurality of segments includes a corresponding subset of rows of the plurality of rows. Step 3084 includes, based on generating the plurality of segments, populating a time bucket lookup map corresponding to the relational database table to indicate, for each of a set of time buckets, ones of the plurality of segments having time values included in at least one of the corresponding subset of rows falling within a bucket time range associated with the each of the set of time buckets. Step 3086 includes determining a query for execution against the relational database table indicating time-based filtering parameters for filtering the plurality of rows. Step 3088 includes identifying a time-based pre-filtered segment set of the plurality of segments based on accessing the time bucket lookup map to identify ones of the plurality of segments included in time buckets of the set of time buckets having associated bucket time ranges falling within at least one query predicate time range indicated by the time-based filtering parameters of the query. Step 3090 includes executing the query based on accessing only segments of the plurality of segments included in an identified segment set determined based on identifying the time-based pre-filtered segment set.

In various examples, the method further includes generating a plurality of pluralities of segments for a plurality of relational database tables. In various examples, each plurality of segments of the plurality of pluralities of segments corresponds to one of the plurality of relational database tables. In various examples, the plurality of pluralities of segments includes the plurality of segments. In various examples, the plurality of relational database tables includes the relational database table.

In various examples, the method further includes populating a plurality of time bucket lookup maps. In various examples, each time bucket lookup map of the plurality of time bucket lookup maps is associated with a corresponding one of the plurality of relational database tables and is populated based on a corresponding plurality of segments for the corresponding one of the plurality of relational database tables. In various examples, the plurality of time bucket lookup maps includes the time bucket lookup map.

In various examples, the method further includes determining a plurality of queries for execution that each indicate corresponding time-based filtering parameters. In various examples, the plurality of queries includes the query.

In various examples, the method further includes, for each query of the plurality of queries: identifying a corresponding time-based pre-filtered segment set of at least one plurality of segments for at least one relational database table indicated in the each query based on accessing at least one corresponding time bucket lookup map to identify ones of the at least one plurality of segments included in time buckets of the at least one corresponding time bucket lookup map having associated bucket time ranges falling within at least one query predicate time range indicated by the time-based filtering parameters of the query; and/or executing the each query based on accessing only corresponding segments included in a corresponding identified segment set determined based on identifying the corresponding time-based pre-filtered segment set.

In various examples, the set of time buckets of the time bucket lookup map all have an associated bucket time range of a first bucket width. In various examples, another time bucket lookup map of the plurality of time bucket lookup maps for another relational database table of the plurality of relational database tables has a second set of time buckets all having a second associated bucket time range of a second bucket width. In various examples, the first bucket width is different from the second bucket width.

In various examples, the first bucket width is different from the second bucket width based on the first bucket width being configured differently from the second bucket width via user input: the relational database table having a different distribution of time values from the another relational database table; and/or queries executed against the relational database table having different time-based filtering parameter trends from other queries executed against the another relational database table.

In various examples, the identified segment set is generated based on including only ones of the plurality of segments included in the time-based pre-filtered segment set that satisfy a set of additional criteria for use in the query that includes an ownership sequence number requirement, where the identified segment set is generated based on including only ones of the plurality of segments included in the time-based pre-filtered segment set that are further included in an activated set of segments in data ownership information having an ownership sequence number matching an ownership sequence number assigned to the query; and/or a visibility requirement, where the identified segment set is generated based on including only ones of the plurality of segments included in the time-based pre-filtered segment set that are further included in a visible set of segments.

In various examples, segment data is included in state data mediated via a plurality of nodes in accordance with a consensus protocol. In various examples, each of the plurality of segments is stored via a corresponding one of the plurality of nodes. In various examples, the segment data indicates the time bucket lookup map; the data ownership information; and/or the set of visible segments.

In various examples, the plurality of rows of the relational database table each include a corresponding time value of a time column of the relational database table. In various examples, identifying ones of the set of time buckets to which each segment of the plurality of segments should be mapped is based on identifying the ones of the set of time buckets having an associated bucket time range that includes the corresponding time value for the time column of at least one of the corresponding subset of rows of the each segment.

In various examples, populating the time bucket lookup map corresponding to the relational database table is based on updating the time bucket lookup map for each segment in the set of segments based on: identifying a segment time range encompassing time values of the corresponding subset of rows of the each segment: identifying a segment time bucket subset of the set of time buckets based on the segment time range; and/or for each time bucket included in the segment time bucket subset, including a segment identifier for the each segment in a set of segment identifiers mapped to the each time bucket in the time bucket lookup map.

In various examples, the set of time buckets have a corresponding ordering based on a time-based ordering of a set of sequential, contiguous time frames corresponding to the set of time buckets. In various examples, identifying the segment time range is based on identifying a corresponding segment start time and a corresponding segment end time. In various examples, identifying the segment time bucket subset for the each segment is based on: identifying a segment start bucket for the each segment based on having a first corresponding index in the corresponding ordering computed based on dividing the corresponding segment start time by a bucket width for the time bucket lookup map; and/or identifying a segment end bucket for the each segment based on having a second corresponding index in the corresponding ordering computed based on dividing the corresponding segment end time by the bucket width for the time bucket lookup map. In various examples, the segment time bucket subset for the each segment is identified as an ordered subset of the set of time buckets in accordance with the corresponding ordering, staring from the segment start bucket and ending with the segment end bucket.

In various examples, populating the time bucket lookup map corresponding to the relational database table is further based on determining to update the time bucket lookup map for the each segment based on: an activation request for the each segment being submitted: the each segment being created and metadata for the each segment being loaded in response to the activation request for the each segment being submitted; and/or determining creation of the each segment was successful. In various examples, the method further includes storing the plurality of segments based on activating the plurality of segments, determining to deactivate a segment of the plurality of segments, and/or, based on determining to deactivate the segment, removing the segment from storage and/or updating the time bucket lookup map to remove indication of the segment based on: identifying a corresponding segment time range encompassing time values of the corresponding subset of rows of the segment: identifying a corresponding segment time bucket subset of the set of time buckets based on the corresponding segment time range; and/or for each corresponding time bucket included in the segment time bucket subset, removing a corresponding segment identifier for the segment from the set of segment identifiers mapped to the each corresponding time bucket in the time bucket lookup map.

In various examples, identifying the time-based pre-filtered segment set of the plurality of segments is based on, for each query predicate time range indicated by the time-based filtering parameters: identifying a query predicate time bucket subset of the set of time buckets based on each query predicate time range; and/or for each time bucket included in the query predicate time bucket subset, determining a set segment identifiers mapped to the each time bucket in the time bucket lookup map.

In various examples, the set of time buckets have a corresponding ordering based on a time-based ordering of a set of sequential, contiguous time frames corresponding to the set of time buckets. In various example, identifying the each query predicate time range is based on identifying a corresponding query predicate start time and a corresponding query predicate end time. In various examples, identifying the query predicate time bucket set for the each query predicate time range is based on: identifying a query predicate start bucket for the each query predicate time range based on having a first corresponding index in the corresponding ordering computed based on dividing the corresponding query predicate start time by a bucket width for the time bucket lookup map; and/or identifying a segment end bucket for the each query predicate time range based on having a second corresponding index in the corresponding ordering computed based on dividing the corresponding query predicate end time by the bucket width for the time bucket lookup map. In various examples, the query predicate time bucket subset for the each query predicate time range is identified as an ordered subset of the set of time buckets in accordance with the corresponding ordering, staring from the query predicate start bucket and ending with the query predicate end bucket.

In various examples, all of the set of time buckets of the time bucket lookup map have a bucket width associated with the time bucket lookup map. In various examples, the method further includes: determining a number of time buckets included in the each query predicate time range based on applying the bucket width: determining whether the number of time buckets included in the each query predicate time range is less than a total number of time buckets included in the set of time buckets; and/or setting the query predicate time bucket subset as all of the set of time buckets based on the number of time buckets included in the each query predicate time range is greater than or equal to the total number of time buckets included in the set of time buckets.

In various examples, the method further includes: determining whether to access the time bucket lookup map for the query based on determining whether time bucket utilization criteria is met for the query as a function of: a first number of buckets included in the query predicate time bucket subset for the query; and/or a number of segments included in the plurality of segments.

In various examples, the time bucket utilization criteria is determined to be met for the query based on the first number of buckets being less than the number of segments included in the plurality of segments. In various examples, the time-based pre-filtered segment set is identified for use in determining the identified segment set for access in executing the query based on determining the time bucket utilization criteria is met for the query.

In various examples, the method further includes determining a second query for execution against the relational database table indicating second time-based filtering parameters for filtering the plurality of rows and/or determining whether to access the time bucket lookup map for the second query based on determining whether the time bucket utilization criteria is met for the query as a function of: a second number of buckets included in a query predicate time bucket subset determined for the second query; and/or the number of segments included in the plurality of segments. In various examples, the time bucket utilization criteria is determined to be unmet for the second query based on the first number of buckets being greater than the number of segments included in the plurality of segments. In various examples, no time-based pre-filtered segment set is identified for use in determining a second identified segment set for access in executing the second query based on determining the time bucket utilization criteria is unmet for the second query. In various examples, the second identified segment set is determined for access in executing the second query without accessing the time bucket lookup map based on determining the time bucket utilization criteria is unmet for the query.

In various examples, the method further includes generating system metadata regarding as a set of metadata rows; and/or further storing the set of metadata rows via a second set of relational database tables based on loading the set of metadata rows for storage via one loading module of a plurality of loading modules based on the one loading module being selected for system metadata loading.

In various examples, generating a set of segments included in the plurality of segments is based on: generating and storing a set of pages; and/or, in response to detecting that a page drain condition has been met, determining a conversion page set as a proper subset of pages included in a set of pages based on a predetermined post-drain number of pages and/or performing a page conversion process upon pages included in the conversion page set to generate a plurality of segments from the pages included in the conversion page set. In various examples, the set of segments includes at least some of the plurality of segments.

In various examples, the method further includes performing a segment group transfer process during a segment group transfer temporal period to transfer a set of segments included in the plurality of segments from a first storage cluster to a second storage cluster. In various examples, performance of the segment group transfer process includes serialized performance of a plurality of steps in accordance with a query correctness guaranteeing strategy. In various examples, the method further includes, during a query execution temporal period overlapping with the segment group transfer temporal period, performing a query execution process to execute a query. In various examples, due to the serialized performance of the plurality of steps in accordance with the query correctness guaranteeing strategy, a query resultant generated via execution of the query is guaranteed to be correct based on the set of segments being accessed via exactly one storage cluster of: the first storage cluster or the second storage cluster.

In various examples, the plurality of segments are stored via a plurality of storage buckets. In various examples, the method further includes performing a storage rebalancing process based on current storage distribution data for the plurality of storage buckets. In various examples, performing the storage rebalancing process is based on: identifying a first subset of the plurality of storage buckets as a plurality of source buckets based on each of the first subset of the plurality of storage buckets having corresponding storage utilization meeting source bucket criteria: identifying a second subset of the plurality of storage buckets as a plurality of target buckets based on each of the first subset of the plurality of storage buckets having corresponding storage utilization meeting target bucket criteria; and/or performing a plurality of data transfers. In various examples, performing each of the plurality of data transfers includes transferring storage of data included in one of plurality of source buckets to one of the plurality of target buckets.

In various examples, the time bucket lookup map is implemented via a multi-dimensional index structure. In various examples, the multi-dimensional index structure has a plurality of dimensions corresponding to a plurality of segment attribute types that includes a time-based dimension. In various examples, a required attribute value range is determined for each of the plurality of segment attribute types based on the query. In various examples, the required attribute value range of the time-based dimension is determined based on the time-based filtering parameters. In various examples, identifying the identified segment set is based on accessing the multi-dimensional index structure to determine ones of the plurality of segments having corresponding attributes for the each of the plurality of segment attribute types falling within the required attribute value range.

In various embodiments, any one of more of the various examples listed above are implemented in conjunction with performing some or all steps of FIG. 30H. In various embodiments, any set of the various examples listed above can be implemented in tandem, for example, in conjunction with performing some or all steps of FIG. 30H, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 30H described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 30H, for example, in conjunction with further implementing any one or more of the various examples described above.

In various embodiments, the operational instructions, when executed by the at least one processor, cause the database system to: generate a plurality of segments from a plurality of rows of a relational database table for storage, where each segment of the plurality of segments includes a corresponding subset of rows of the plurality of rows: based on generating the plurality of segments, populate a time bucket lookup map corresponding to the relational database table to indicate, for each of a set of time buckets, ones of the plurality of segments having time values included in at least one of the corresponding subset of rows falling within a bucket time range associated with the each of the set of time buckets; determine a query for execution against the relational database table indicating time-based filtering parameters for filtering the plurality of rows: identify a time-based pre-filtered segment set of the plurality of segments based on accessing the time bucket lookup map to identify ones of the plurality of segments included in time buckets of the set of time buckets having associated bucket time ranges falling within at least one query predicate time range indicated by the time-based filtering parameters of the query; and/or execute the query based on accessing only segments of the plurality of segments included in an identified segment set determined based on identifying the time-based pre-filtered segment set.

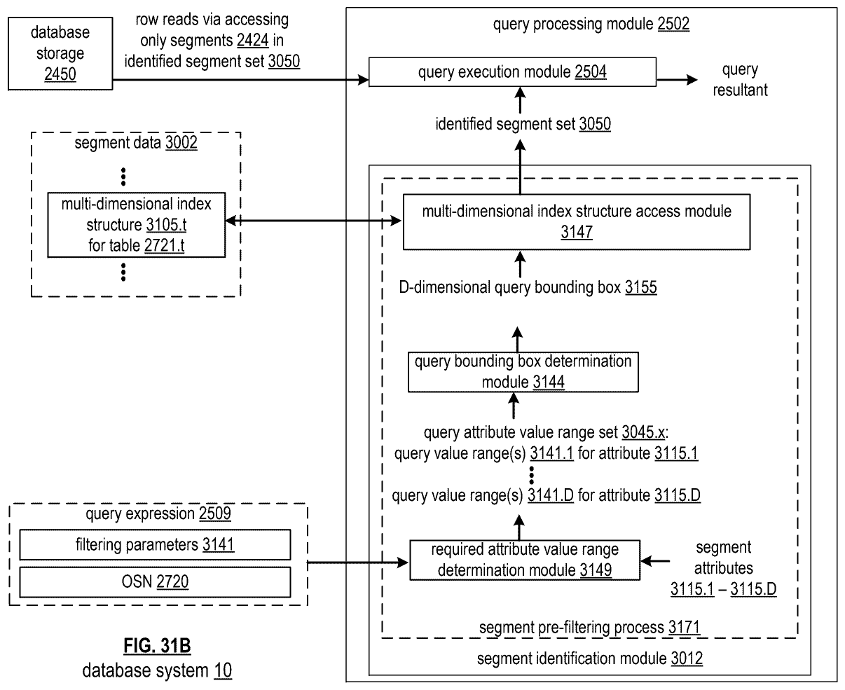

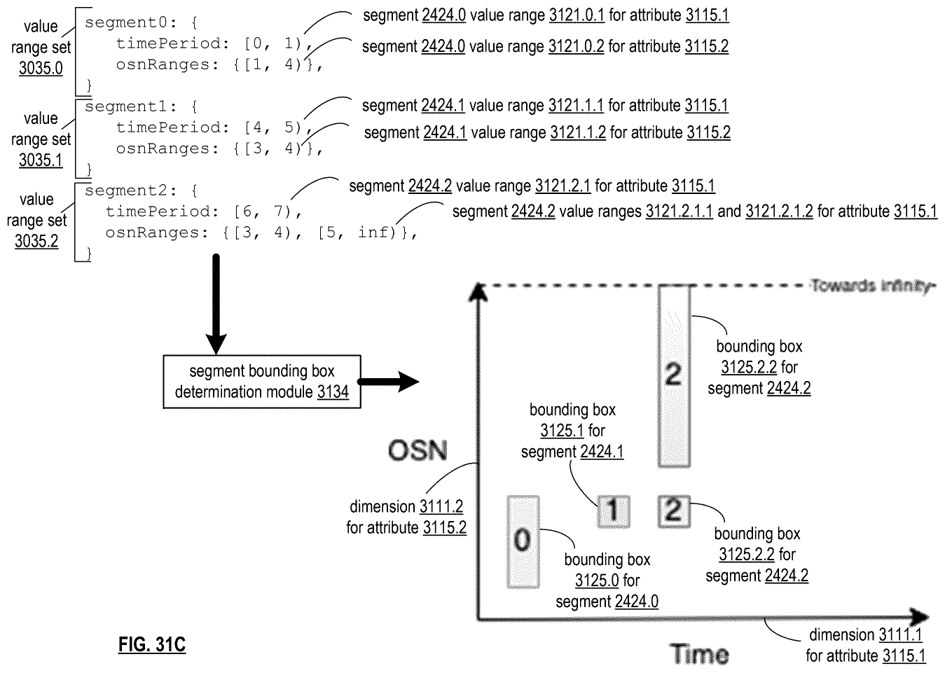

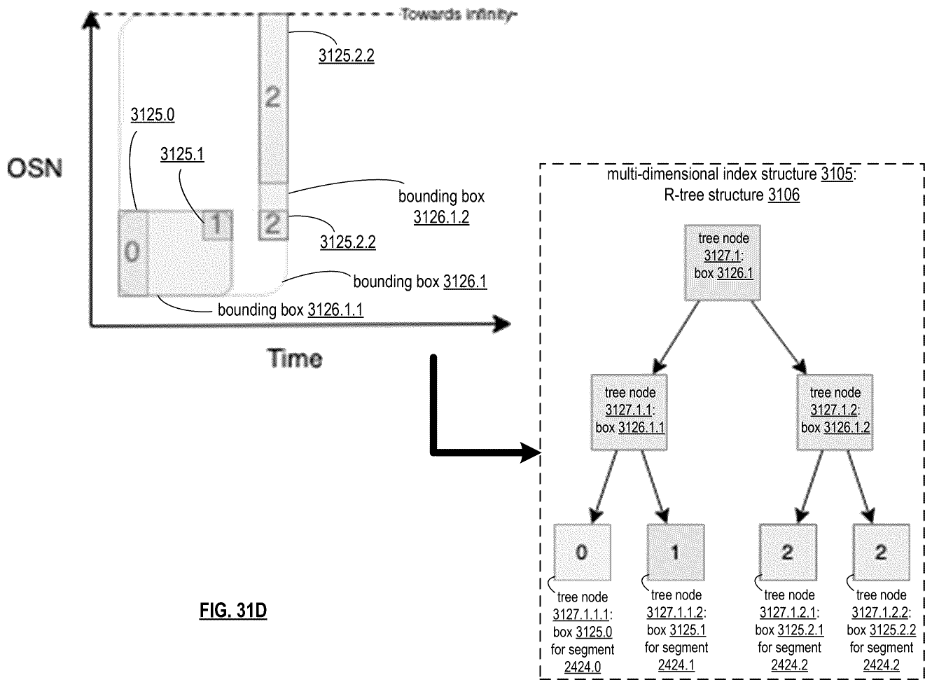

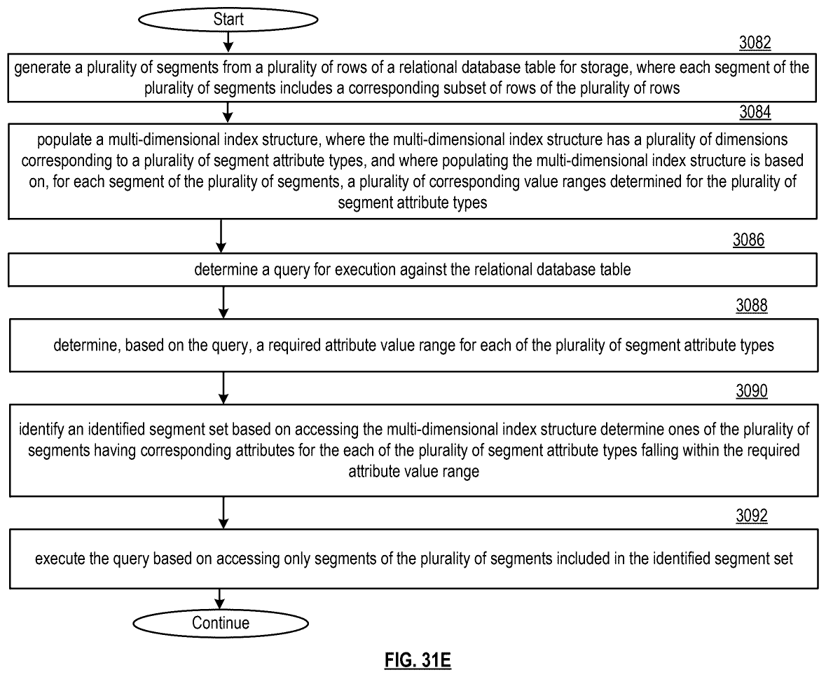

FIGS. 31A-31D present embodiments of a database system 10 operable to utilize at least one multi-dimensional index structure 3105 for at least one database table 2712 to pre-filter segments required for access in query execution based on time-based filtering parameters 3041 of a corresponding query. Some or all features and/or functionality of FIGS. 31A-31D can implement any embodiment of database system 10 described herein.

In some embodiments, the embodiments of FIGS. 30A-30G can result in far fewer iterations to filter out segments for a query than unconditionally considering every required segment for a table. However, some or all features and/or functionality of FIGS. 30A-30G can come with a few downsides in some cases, for example, based on: the number of iterations being proportional to the width of the query's time-filters, which can be problematic if the time bucket width is narrow and the total span of time being filtered against is large: the possibility of iterating on time buckets which fall outside the total time extents of the data of the table, which can be wasteful work that doesn't perform any meaningful filtering (in some embodiments, this can be mitigated based on trimming query time-filter against cached time extents within the time bucket lookup; and/or, for every segment within a considered time bucket in the time bucket lookup map, a linear pass is still performed, for example, to determine visibility based on OSN and other attributes.

FIGS. 31A-31D present embodiments where these issues are mitigated based on implementing a multi-dimensional index structure 3105 (e.g. implemented via one or more R-tree data structures) to index activated segments on numerical values (and/or otherwise orderable values for columns with datatypes having a defined ordering scheme that can be utilized to define ranges and/or compare values via inequality expressions) such as min/max time column, OSN placement, and/or the min/max of a subset of a table's other numeric/orderable columns if desired.

In some embodiments, the multi-dimensional index structure 3105 implements time bucket lookup map 3005 (e.g. time bucket lookup map 3005 is implemented via a portion of multi-dimensional index structure 3105 corresponding to a time-based dimension of a plurality of dimensions of multi-dimensional index structure 3105). In some embodiments, the multi-dimensional index structure 3105 is implemented in addition to the time bucket lookup map 3005 (e.g. the time bucket lookup map 3005 is accessed for some queries and/or the multi-dimensional index structure 3105 is accessed for others: both the multi-dimensional index structure 3105 and the time bucket lookup map 3005 are accessed for some queries: etc.). In some embodiments, the multi-dimensional index structure 3105 is implemented instead of the time bucket lookup map 3005.

FIG. 31A illustrates an embodiment of a record processing and storage system 2505 operable to generate and/or update segment data 3002 that includes multi-dimensional index structures 3105.1-3105.M for a plurality of tables 2712.1-2712.M based on performing a multi-dimensional index structure update process 3130 for a given segment 2424.x (e.g. via a segment generator 2617 in conjunction with storing the given segment 2424.x in database storage 2450 and/or activation of the given segment in the TKT segment service). For example, database storage 2450 implements storage of the plurality of tables 2712.1-2712.M via a plurality of segments 2424 each storing records 2422 for one of the plurality of tables 2712.

Performing a multi-dimensional index structure update process 3010 can include, for a given segment 2424.x having rows for a given table 2712.t, implementing a range determination module 3131 to identify a segment attribute value range set 3135.x that include one or more segment value ranges 3121 for each segment attribute 3115 of a set of segment attributes 3115.1-3115.D. For example, the number of attributes D in the set of segment attributes 3115.1-3115.D corresponds to a number of dimensions implemented via the multi-dimensional index structure 3105, where D is an integer value greater than or equal to two. Each segment value range 3121 can be defined via a corresponding start value and end value.

In some embodiments, one of the set of segment attributes 3115 corresponds to a time attribute, for example, where the segment value range 3121 for the time attribute is determined as the segment time range dictated by the start time 3032.x (e.g. minimum time across all rows of the segment) and an end time 3033.x (e.g. maximum time across all rows of the segment, for example, for time values 3009 of the time column 3007) defining this time range.

In some embodiments, one of the set of segment attributes 3115 corresponds to an OSN attributed, where the segment value range 3121 for the OSN attribute denotes a range of OSNs (e.g. corresponding integer values denoting corresponding OSNs) for corresponding data ownership information indicating the corresponding segment is activated (e.g. in a corresponding storage cluster mediating/storing the segment data 3002), for example, in activated segment set 3006.

In some embodiments, one or more of the set of segment attributes 3115 correspond to one or more columns attributes of the table 2712, where the segment value range 3121 for each of these column attributes is determined as range of values for the corresponding column in rows of the segment 2424. The columns attributes can include a time-based attribute corresponding to the column and can optionally further include additional column attributes corresponding to additional columns of the table 2712.

The set of segment attributes 3115 can optionally include other segment attributes corresponding to segment visibility and/or corresponding to other factors utilized to pre-filter segments in query execution.

Performing multi-dimensional index structure update process 3010 can further include implementing a segment bounding box determination module 3134 to determine one or more D-dimensional segment bounding boxes 3125.x for the segment 2424.x. Each of the D-dimensions can be defined via the corresponding segment value range 3121 of a corresponding attribute 3115. In the case where the segment has multiple non-contiguous segment value ranges 3121 for a given attribute 3115, the segment can optionally have include multiple corresponding bounding boxes 3125 determined, where multiple different bounding boxes are each defined via a corresponding one of the non-contiguous segment value ranges 3121 of the given dimension.

A multi-dimensional index structure update module 3137 can indicate the segment 2424.x in the multidimensional index structure 3105.t for the given table 2712.t via incorporation of the one or more bounding boxes 3125.x determined for the segment 2424.x. This can optionally include adding the segment to a corresponding R-tree structure based on the bounding boxes 3125.

FIG. 31B illustrates an embodiment of a query processing module 2502 that implements a segment identification module 3012 that performs a segment pre-filtering process to generate an identified segment set 3050 indicating one of the set of segments to be accessed in query execution via query execution module 2504 via row reads to segments 2424 (e.g. in implementing IO pipeline) to access only segments included in identified segment set 3050, based on filtering out segments with segment value ranges not overlapping with any one or more corresponding query value ranges for the query.

Performing the segment pre-filtering process 3171 can include implementing a required attribute value range determination module 3149 to determine a query value range 3141 for each of the D segment attributes 3115, denoting the required range for the corresponding query based on the corresponding query.

For example, the query has corresponding filtering parameters 3141 (e.g. that optionally include time-based filtering parameters 3041 and/or other filtering parameters applied to other columns of the table), where one or more of the query value ranges 3141 is determined based on the filtering parameters 3141 (e.g. for a time-based attribute 3115 based on time-based filtering parameters 3041 and/or for one or more column attributes 3115 based on filtering parameters applied to corresponding columns).

Alternatively or in addition, the query is assigned a corresponding OSN defining which segments be accessed via a corresponding storage cluster (e.g. as dictated by corresponding ownership sequence information), where one the query value ranges 3141 indicates the OSN (e.g. as a single value rather than a range) for an OSN attribute 3115.

A query bounding box determination module 3114 can determine a D-dimensional query bounding box 3115 for the query. Each of the D-dimensions can be defined via the corresponding query value range 3141 of a corresponding attribute 3115. In the case where the query has multiple non-contiguous query value ranges 3141 for a given attribute 3115, the query can optionally have include multiple corresponding bounding boxes 3155 determined, where multiple different bounding boxes are each defined via a corresponding one of the non-contiguous segment value ranges 3141 of the given dimension.

A multi-dimensional index structure access module 3147 can be implemented to access the multi-dimensional index structure 3105.t for the given table 2712.t to determine the identified segment set 3050. For example, the identified segment set 3050 includes only segments 2424 having segment bounding boxes 3125 intersecting with query bounding box 3155 in D-dimensional space.

In some embodiments, multi-dimensional index structure 3105 is implemented based on stored objects being grouped together to form bounding-boxes in higher-order levels (e.g. in accordance with an R-tree based structuring). This can allow large swathes of children to be ruled out when performing checks against the bounding-boxes of intermediary nodes in the tree during traversal.

In some embodiments, the segment data 3002 is implemented/stored via a given node 37 (e.g. a node storing the segment and/or assigned to own the segment in data ownership information). In such embodiments, the multi-dimensional index structure update process 3130 is optionally performed by the given node in conjunction with storing/activating the segment 2424, where different nodes store their own segment data 3002 for their own segments. In some embodiments, the segment pre-filtering process 3171 is performed separately (e.g. in parallel without coordination) via each node executing the query to determine its own set of segments 2424 for access in its own execution of the query (e.g. via its participation at the IO level of a query execution plan and/or via its own implementation of IO pipeline).

FIGS. 31C and 31D illustrate examples of determination and grouping of segment bounding boxes 3125.

For simplicity, assume the D-dimensional indexing is performed only a segment's OSN placements and time extents (e.g. where D equals two in conjunction with implementing multi-dimensional index structure 3105 as a two-dimensional index structure). Similar principles can be employed for higher dimensions D.

In this examples, the segments can have bounding boxes 3125 existing within a two-dimensional coordinate system where the first dimension is OSN and the second dimension is time. For example, segments do not exist in this two-dimensional space as singular points, as segments have both a range of OSNs in which they are placed as well as min and max time values. Thus, segments 2424 can be represented as axis-aligned boxes. For example, there exists a box in this space for each OSN range in which a segment is placed.

Consider the example of FIG. 31C, where a node

Suppose 3 segments are present (e.g. one a corresponding node 37), each with the following information:
segment0: {
   timePeriod: [0, 1),
   osnRanges: {[1, 4)},
}
segment1: {
   timePeriod: [4, 5),
   osnRanges: {[3, 4)},
}
segment2: {
   timePeriod: [6, 7),
   osnRanges: {[3, 4), [5, inf)},
}

FIG. 31C indicates how bounding boxes 3015 determined for these segments (e.g. via segment bounding box determination module 3134) are arranged in two-dimensional space.

FIG. 31D illustrates a possible r-tree configuration around these segments via implementation of multi-dimensional index structure 3105 via an R-tree structure 3106. In this example, assume each tree node 3127 of the r-tree can have at-most 2 children (e.g. effectively a binary r-tree), having these values are chosen purely for simplicity for purposes of example, based on nesting of segment bounding boxes within corresponding higher-order bounding boxes 3126 dictating the tree nodes 3127.

In some embodiments, requests for segments (e.g. from the TKT segment service) can still provide a target OSN along with a range of time to filter against. Given an input OSN of O and a target time range of [S, E), we can a query bounding box 3145 utilized as input for a corresponding query can be as follows:

```
{
  osnRange: [O, O + 1),
  timePeriod: [S, E)
}
```

R-tree structure 3106 can be utilized to find all segments which intersect the input bounding box. For example, this access is based on, starting from the root node, checking for intersections against the bounding-boxes of children nodes to decide which children need to be iterated on. In the end, the storage IDs tracked within the leaf-level of the r-tree can be mapped to segment objects (e.g. in the same or similar fashion as the time bucket lookup map implementation of FIGS. 30A-30G).

In some embodiments, there are a few cases where the multi-dimensional index structure implementation of FIGS. 31A-31D could out-perform the lookup map implementation of FIGS. 30A-30G: (1) If the input time-period is very large and intersects few if any segments (e.g. with the lookup map approach, O(time_filter_span_in_buckets) iterations are performed, whereas assuming the time period intersects no segments, only a single check against the root bounding-box would be required, where O( ) is in accordance with big-O notation); and/or (2) If there are many segments which have the same time period but different OSN placements (e.g. with the lookup map solution, if every segment is in the same time period, it would be worst case O(num_segments) iterations, whereas the R-tree solution would provide a logarithmic runtime if the tree was balanced and the bounding boxes were constructed with minimal overlap.

In some embodiments, while the given example of FIGS. 31C and 31D utilizes only OSN and time period to define a two-dimensional space, additional dimensions can be utilized (e.g. D can be greater than or equal to 3 in some embodiments). For example, some dimensions correspond to other arbitrary numeric/orderable columns, where their minimum and maximum value are optionally stored within the headers of TKT segments. The two-dimensional space can be extended to higher dimensions to incorporate any desired numeric columns. In some cases, the utility of this can largely depend on the spans of these columns within various segments. In some embodiments, loading modules 2510 can be configured to prioritize grouping together rows with similar values into pages and therefore into segments for numeric columns that one would want to filter against.

In some embodiments, the R-tree structure 3106 is modified when segments have OSN placements modified, are deactivated, and when additional segments are activated. In some embodiments, the R-trees are dynamically updated within the TKT segment service. In some embodiments, a forest of multiple R-trees are implemented based on time-range or other qualities to bound the size of the stored R-trees.

In some embodiments, segment attributes can have trends as segments are generated over time. For example, the time ranges of incoming segments 2424 over time tend to march continually towards the future: OSNs are monotonically increasing over time; and/or most segments have and end OSN of infinity, unless scheduled for deletion (e.g. the range for the corresponding attribute is unbounded on the upper end), and/or finite OSNs don't tend to last long until they are reaped. Such trends can be leveraged in configuring multi-dimensional index structures 3105.

For example, in some embodiments, instead of implementing “true” dynamic R-trees, an ever expanding forest of R-trees is implemented via multi-dimensional index structure 3105 for a given table (e.g. new segments have similar time-ranges, so each forest is generally increasing in time).

As another example, in some embodiments, because OSN placements always have a fixed start period and usually span towards infinity. In accounting for this trend, trend, segments can be represented as lines rather than boxes (e.g. optionally still two dimensional but unbounded in the OSN dimension towards infinity), whose placement in space is based on their start OSN (e.g. the “top” of the segment boxes do not need to be updated with finite OSNs). In some embodiments, R-tree filtering is performed by time ranges and potential OSN matches, based on the starting OSN, where this unbounded embodiments optionally applies a post filter. This could be expensive if many segments are involved in the query.

In some embodiments, the R-tree structure 3106 implements some or all features and/or functionality of R-tree structuring and/or corresponding generation and/or access disclosed by: U.S. Utility application Ser. No. 18/355,505, entitled “STRUCTURING GEOSPATIAL INDEX DATA FOR ACCESS DURING QUERY EXECUTION VIA A DATABASE SYSTEM”, filed Jul. 20, 2023, which is hereby incorporated herein by reference in its entirety and made part of the present U.S. Utility Patent Application for all purposes; and/or U.S. Utility application Ser. No. 18/468,122, entitled “APPLYING RANGE-BASED FILTERING DURING QUERY EXECUTION BASED ON UTILIZING AN INVERTED INDEX STRUCTURE”, filed Sep. 15, 2023, which is hereby incorporated herein by reference in its entirety and made part of the present U.S. Utility Patent Application for all purposes.

FIG. 31E illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 31E, for example, based on participating in execution of a query being executed by the database system 10. Some or all of the method of FIG. 31E can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 31E based on implementing a corresponding plurality of processing core resources 48.1-48.W. Some or all of the steps of FIG. 31E can optionally be performed by any other one or more processing modules of the database system 10. Some or all of the steps of FIG. 31E can be performed to implement some or all of the functionality of the database system 10 as described in conjunction with FIGS. 31A-31D, for example, by implementing some or all of the functionality of record processing and storage system 2505, segment generator 2617, multi-dimensional index structure update process 3130, segment data 3002, multi-dimensional index structure 3105, segment identification module 3012, segment pre-filtering process 3171, query processing module 2502, query execution module 2504, filtering parameters 3141, segment bounding box determination module 3134, and/or R-tree structure 3106. Some or all steps of FIG. 31E can be performed by database system 10 in accordance with other embodiments of the database system 10 and/or nodes 37 discussed herein. Some or all of the steps of FIG. 31E can be performed in conjunction with performing some or all steps of any other method described herein.

Step 3182 includes generating a plurality of segments from a plurality of rows of a relational database table for storage. In various examples, each segment of the plurality of segments includes a corresponding subset of rows of the plurality of rows. Step 3184 includes populating a multi-dimensional index structure. In various examples, the multi-dimensional index structure has a plurality of dimensions corresponding to a plurality of segment attribute types. In various examples, populating the multi-dimensional index structure is based on, for each segment of the plurality of segments, a plurality of corresponding value ranges determined for the plurality of segment attribute types. Step 3186 includes determining a query for execution against the relational database table. Step 3188 includes, determining, based on the query, a required attribute value range for each of the plurality of segment attribute types. Step 3190 includes identifying an identified segment set based on accessing the multi-dimensional index structure determine ones of the plurality of segments having corresponding attributes for the each of the plurality of segment attribute types falling within the required attribute value range. Step 3192 includes executing the query based on accessing only segments of the plurality of segments included in the identified segment set.

In various examples, the plurality of segment attribute types includes an ownership sequence number range attribute type and/or a time value range attribute type. In various examples, the plurality of dimensions of the multi-dimensional index structure includes a first dimension corresponding to the ownership sequence number range attribute type and/or a second dimension corresponding to the time value range attribute type.

In various examples, the plurality of rows of the relational database table each have a corresponding set of values for a plurality of columns of the relational database table. In various examples, the plurality of columns includes a set of orderable columns having corresponding data types that can be ordered in accordance with a corresponding ordering scheme. In various examples, the set of segment attribute types includes at least two column value-based attribute types corresponding to at least two corresponding orderable columns of the set of orderable columns. In various examples, the plurality of dimensions of the multi-dimensional index structure includes at least two dimensions corresponding to the at least two column value-based attribute types.

In various examples, the at least two corresponding orderable columns includes a time column having time values in the relational database table and/or at least one numeric column numeric values in the relational database table. In various examples, the query indicates filtering the plurality of rows based on a set of filtering parameters. In various examples, the required attribute value range for each of at least one of the at least two corresponding orderable columns is based on at least one corresponding query predicate of the set of filtering parameters indicating filtering by values of the each of the at least one of the at least two corresponding orderable columns via at least one corresponding range of values.

In various examples, the plurality of segment attribute types includes an ownership sequence number attribute type. In various examples, populating the multi-dimensional index structure is based on, for the each segment of the plurality of segments: determining a corresponding ownership sequence number range for the each segment indicating a subset of a plurality of sequence numbers corresponding to a subset of a plurality of data ownership information in which the each segment is indicated for access in query execution; and/or mapping the corresponding ownership sequence number range to the each segment. In various examples, determining the required attribute value range for each of the plurality of segment attribute types is based on determining an ownership sequence number assigned to the each query. In various examples, the identified segment set includes only ones of the plurality of segments having the ownership sequence number assigned to the each query.

In various examples, the multi-dimensional index structure includes a plurality of multi-dimensional bounding boxes each defined via a corresponding value range for each of the plurality of segment attribute types and encompassing at least one multi-dimensional segment bounding box of a plurality of multi-dimensional segment bounding boxes each defined based on a segment attribute value range for each of the plurality of segment attribute types determined for a corresponding segment. In various examples, identifying the identified segment set is based on: determining a multi-dimensional query bounding box for the query defined based on the required attribute value range for each of the plurality of segment attribute types determined for the query; and/or identifying ones of the plurality of multi-dimensional bounding boxes for the query intersecting with the multi-dimensional query bounding box to identify the identified segment set to include segments having ones of the plurality of multi-dimensional segment bounding boxes intersecting with the multi-dimensional query bounding box.

In various examples, the plurality of multi-dimensional bounding boxes of the multi-dimensional index structure includes a plurality of higher-level multi-dimensional bounding boxes and the plurality of multi-dimensional segment bounding boxes. In various examples, each of the plurality of higher-level multi-dimensional bounding boxes encompass multiple other ones of the plurality of multi-dimensional bounding boxes. In various examples, populating the multi-dimensional index structure includes: determining the multi-dimensional segment bounding box for the each segment of the plurality of segments defined based on the plurality of corresponding value ranges determined for the plurality of segment attribute types for the each segment; and/or determining each of the plurality of higher-level multi-dimensional bounding boxes based on grouping multiple multi-dimensional bounding boxes for inclusion within the each of the plurality of higher-level multi-dimensional bounding boxes.

In various examples, the multi-dimensional index structure includes a plurality of hierarchical levels in accordance with a tree-based structure having a plurality of tree nodes. In various examples, leaf level nodes of a leaf level of the plurality of hierarchical levels indicate the plurality of segments. In various examples, each higher-level node of a plurality of higher-level nodes at higher levels of the plurality of the hierarchical levels corresponds to a corresponding higher-level multi-dimensional bounding boxes of the plurality of multi-dimensional bounding boxes that fully encompass multi-bounding boxes of all child nodes of the each higher-level node. In various examples, identifying the subset of the plurality of multi-dimensional bounding boxes for the query is based on propagating down the tree-based structure to only child nodes of ones of the plurality of higher-level nodes intersecting with the multi-dimensional query bounding box determined for the query. In various examples, the identified segment set is identified as segments indicated by only the leaf level nodes that are descendants of at least one of the subset of the plurality of multi-dimensional bounding boxes in the tree-based structure.

In various examples, the multi-dimensional index structure is implemented via at least one R-tree index structure.

In various examples, the multi-dimensional index structure is implemented via a forest of multiple R-trees. In various examples, new R-trees are added to a forest of R-trees to indicate newer segments of the plurality of segments. In various examples, a first R-tree of the forest of multiple R-trees is bounded by a first range for at least one at least one of the plurality of segment attribute types. In various examples, a second R-tree of the forest of multiple R-trees is bounded by a second range for the at least one of the plurality of segment attribute types. In various examples, the second range is higher than the first range based on the second R-tree being newer than the first R-tree and further based on a segment attribute trend associated with the at least one of the plurality of segment attribute types dictating that newer ones of the plurality of segments have higher values for the at least one of the plurality of segment attribute types than older ones of the plurality of segments.

In various examples, a first subset of the plurality of corresponding value ranges for the each segment are defined via a corresponding minimum value. In various examples, a subset of the plurality of corresponding value ranges for at least one the plurality of segments are defined via only corresponding minimum value based on having an unbounded maximum value for corresponding ones of the plurality of segment attribute types.

In various examples, the plurality of dimensions of the multi-dimensional index structure includes at least three dimensions corresponding to at least three segment attribute types.

In various examples, the method further includes: generating system metadata regarding as a set of metadata rows; and/or further storing the set of metadata rows via a second set of relational database tables based on loading the set of metadata rows for storage via one loading module of a plurality of loading modules based on the one loading module being selected for system metadata loading.

In various examples, generating a set of segments included in the plurality of segments is based on: generating and storing a set of pages: in response to detecting that a page drain condition has been met, determining a conversion page set as a proper subset of pages included in the set of pages based on a predetermined post-drain number of pages: performing a page conversion process upon pages included in the conversion page set to generate a set of segments from the pages included in the conversion page set; and/or storing the set of segments.

In various examples, the method further includes performing a segment group transfer process during a segment group transfer temporal period to transfer a set of segments of the plurality of segments from a first storage cluster to a second storage cluster. In various examples, performance of the segment group transfer process includes serialized performance of a plurality of steps in accordance with a query correctness guaranteeing strategy. In various examples, the method further includes, during a query execution temporal period overlapping with the segment group transfer temporal period, performing a query execution process to execute a query. In various examples, due to the serialized performance of the plurality of steps in accordance with the query correctness guaranteeing strategy, a query resultant generated via execution of the query is guaranteed to be correct based on the set of segments being accessed via exactly one storage cluster of: the first storage cluster or the second storage cluster.

In various examples, the plurality of segments are stored via a plurality of storage buckets. In various examples, the method further includes: performing a storage rebalancing process based on current storage distribution data for the plurality of storage buckets. In various examples, performing the storage rebalancing process is based on: identifying a first subset of the plurality of storage buckets as a plurality of source buckets based on each of the first subset of the plurality of storage buckets having corresponding storage utilization meeting source bucket criteria: identifying a second subset of the plurality of storage buckets as a plurality of target buckets based on each of the first subset of the plurality of storage buckets having corresponding storage utilization meeting target bucket criteria; and/or performing a plurality of data transfers. In various examples, performing each of the plurality of data transfers includes transferring storage of data included in one of plurality of source buckets to one of the plurality of target buckets.

In various examples, the multi-dimensional index structure is populated based on time values of the plurality of segments. In various examples, the query indicates time-based filtering parameters. In various examples, the identified segment set is determined based on accessing the multi-dimensional index structure based on the time-based filtering parameters.

In various embodiments, any one of more of the various examples listed above are implemented in conjunction with performing some or all steps of FIG. 31E. In various embodiments, any set of the various examples listed above can be implemented in tandem, for example, in conjunction with performing some or all steps of FIG. 31E, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 31E described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 31E, for example, in conjunction with further implementing any one or more of the various examples described above.

In various embodiments, the operational instructions, when executed by the at least one processor, cause the database system to: generate a plurality of segments from a plurality of rows of a relational database table for storage, where each segment of the plurality of segments includes a corresponding subset of rows of the plurality of rows: populate a multi-dimensional index structure, where the multi-dimensional index structure has a plurality of dimensions corresponding to a plurality of segment attribute types, and/or where populating the multi-dimensional index structure is based on, for each segment of the plurality of segments, a plurality of corresponding value ranges determined for the plurality of segment attribute types: determine a query for execution against the relational database table: determine, based on the query, a required attribute value range for each of the plurality of segment attribute types: identify an identified segment set based on accessing the multi-dimensional index structure determine ones of the plurality of segments having corresponding attributes for the each of the plurality of segment attribute types falling within the required attribute value range; and/or execute the query based on accessing only segments of the plurality of segments included in the identified segment set.

As used herein, an “AND operator” can correspond to any operator implementing logical conjunction. As used herein, an “OR operator” can correspond to any operator implementing logical disjunction.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not (A) matches not (B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage: (b) a wired or wireless medium for the transportation of data as a signal within a computing device from one element of the computing device to another element of the computing device for temporary storage or persistent storage: (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event--without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions-even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution comprising:
storing a plurality of relational database tables via a plurality of storage buckets of a database system:
executing a plurality of queries against the plurality of relational database tables via accessing the plurality of storage buckets:
generating current storage distribution data indicating storage utilization for the plurality of storage buckets of the database system; and
performing a storage rebalancing process based on the current storage distribution data, wherein performing the storage rebalancing process is based on:
identifying a first subset of the plurality of storage buckets as a plurality of source buckets based on each of the first subset of the plurality of storage buckets having corresponding storage utilization meeting source bucket criteria:
identifying a second subset of the plurality of storage buckets as a plurality of target buckets based on each of the first subset of the plurality of storage buckets having corresponding storage utilization meeting target bucket criteria; and
performing a plurality of data transfers, wherein performing each of the plurality of data transfers includes transferring storage of data included in one of plurality of source buckets to one of the plurality of target buckets.

2. The method of claim 1,
wherein performing the storage rebalancing process includes:
performing a first storage rebalancing subprocess corresponding to rebalancing of first storage buckets of the database system having a first storage type based on:
identifying a first subset of the first storage buckets of the database system having the first storage type as a first corresponding plurality of source buckets based on each of the first subset of the first storage buckets of the database system meeting the source bucket criteria:
identifying a second subset of the first storage buckets of the database system having the first storage type as a first corresponding plurality of target buckets based on each of the second subset of the first storage buckets of the database system meeting the target bucket criteria; and
performing a first plurality of data transfers, wherein performing each of the first plurality of data transfers includes transferring storage of data included in one of the first corresponding plurality of source buckets to one of the first corresponding plurality of target buckets via a first type of data transfer process corresponding to the first storage type; and
performing a second storage rebalancing subprocess corresponding to rebalancing of second storage buckets of the database system having a second storage type based on:
identifying a first subset of the second storage buckets of the database system having the second storage type as a second corresponding plurality of source buckets based on each of the first subset of the second storage buckets of the database system meeting the source bucket criteria;
identifying a second subset of the second storage buckets of the database system having the second storage type as a second corresponding plurality of target buckets based on each of the second subset of the second storage buckets of the database system meeting the target bucket criteria; and
performing a second plurality of data transfers, wherein performing each of the second plurality of data transfers includes transferring storage of data included in one of the second corresponding plurality of source buckets to one of the second corresponding plurality of target buckets via a second type of data transfer process corresponding to the second storage type.

3. The method of claim 2, wherein performing the plurality of data transfers includes implementing an adapter module to perform each of the first plurality of data transfers in accordance with the first type of data transfer process and to further perform each of the second plurality of data transfers in accordance with the second type of data transfer process.

4. The method of claim 2, wherein the source bucket criteria is applicable to both the first storage type and the second storage type, and wherein the target bucket criteria is applicable to both the first storage type and the second storage type.

5. The method of claim 2, wherein each first storage bucket of the first storage buckets having the first storage type includes a corresponding subset of the second storage buckets having the second storage type based on the first storage buckets and the second storage buckets being configured in accordance with a hierarchical storage structuring of the first storage type and the second storage type, and wherein performing the storage rebalancing process includes performing a plurality of second storage rebalancing subprocesses based on, for the each first storage bucket of the first storage buckets, performing a corresponding second storage rebalancing subprocesses of the plurality of second storage rebalancing subprocesses to rebalance corresponding second storage buckets included within the each first storage bucket.

6. The method of claim 2, wherein the plurality of relational database tables are stored via a plurality of segments of a plurality of segments groups across a plurality of nodes of a plurality of storage clusters of the database system, wherein each storage cluster of the plurality of storage clusters includes a corresponding plurality of nodes that collectively store a corresponding plurality of segment groups that each include a corresponding plurality of segments each stored via a corresponding node of the corresponding plurality of nodes, wherein the first storage buckets correspond to the plurality of storage clusters, wherein the second storage buckets correspond to the plurality of nodes, wherein the first type of data transfer process corresponds to an inter-cluster data transfer process, and wherein the second type of data transfer process corresponds to an intra-cluster data transfer process:
wherein performing the storage rebalancing process includes:
performing the first storage rebalancing subprocess to rebalance storage of segment groups across the plurality of storage clusters of the database system based on:
identifying a plurality of source storage clusters as a first subset of the plurality of storage clusters based on each of the first subset of the plurality of storage clusters meeting the source bucket criteria:
identifying a plurality of target storage clusters as a second subset of the plurality of storage clusters based on each of the second subset of the plurality of storage clusters meeting the target bucket criteria; and
performing the first plurality of data transfers, wherein performing each of the first plurality of data transfers includes performing a corresponding inter-cluster data transfer process via transferring storage of at least one segment group included in one of the plurality of source storage clusters to one of the plurality of target storage clusters via transferring all segments included in the at least one segment group from a corresponding first plurality of nodes of the one of the plurality of source storage clusters to a corresponding second plurality of nodes of the one of the plurality of target storage clusters; and
performing a plurality of second storage rebalancing subprocesses based on, for each storage cluster of the plurality of storage clusters, performing a corresponding second storage rebalancing subprocess of the plurality of second storage rebalancing subprocesses to rebalance storage of segments across the corresponding plurality of nodes of the each storage cluster based on:
identifying a plurality of source nodes as a first subset of the corresponding plurality of nodes based on each of the first subset of the corresponding plurality of nodes meeting the source bucket criteria:
identifying a plurality of target nodes as a second subset of the corresponding plurality of nodes based on each of the second subset of the corresponding plurality of nodes meeting the target bucket criteria; and
performing the second plurality of data transfers, wherein performing each of the second plurality of data transfers includes performing a corresponding intra-cluster data transfer process via transferring storage of at least one segment group included in one of the plurality of source nodes to one of the plurality of target nodes.

7. The method of claim 6,
wherein performing each of the first plurality of data transfers includes selecting a subset of segment groups stored by the one of the plurality of source storage clusters for transfer to the one of the plurality of target storage clusters without applying any segment group selection restrictions:
wherein performing each of the second plurality of data transfers includes selecting a subset of segments stored by the one of the plurality of source nodes for transfer to the one of the plurality of target storage clusters based on applying a segment selection restriction based on selecting segments stored by the one of the plurality of source nodes for inclusion in the subset of segments based on having segment group identifiers different from all segment group identifiers of other segments already stored by the one of the plurality of target nodes.

8. The method of claim 6, wherein performing each of the first plurality of data transfers includes performing a corresponding segment group transfer process via serialized performance of a plurality of steps in accordance with a query correctness guaranteeing strategy,
wherein a first one of the plurality of queries is executed during performance of at least one corresponding segment group transfer process, and wherein, due to the serialized performance of the plurality of steps in accordance with the query correctness guaranteeing strategy, a query resultant generated via execution of the query is guaranteed to be correct based on each segment group of the plurality of segment groups being accessed via exactly one storage cluster of the plurality of storage clusters.

9. The method of claim 1,
wherein the source bucket criteria indicates a first threshold storage utilization, wherein the plurality of source buckets are identified based on each having a corresponding storage utilization exceeding the first threshold storage utilization:
wherein the target bucket criteria indicates a second threshold storage utilization, wherein the plurality of source buckets are identified based on each having a corresponding storage utilization falling below the second threshold storage utilization:
wherein the second threshold storage utilization is strictly less than the first threshold storage utilization.

10. The method of claim 9, wherein different ones of the plurality of storage buckets have different total storage capacities, wherein storage utilization of a given bucket of the plurality of storage buckets corresponds to a proportion of total storage capacity of the given bucket that is utilized based on storing corresponding data, wherein the first threshold storage utilization corresponds to a first threshold proportion of total storage capacity that is utilized, and wherein the second threshold storage utilization corresponds to a second threshold proportion of total storage capacity that is utilized.

11. The method of claim 9, further comprising:
computing an average storage utilization for the plurality of storage buckets of the database system based on the current storage distribution data;
selecting the first threshold storage utilization as a function of the average storage utilization; and
selecting the second threshold storage utilization as a predetermined proportion of the first threshold storage utilization.

12. The method of claim 9, wherein performing the storage rebalancing process is further based on at least one of:
selecting the plurality of source buckets as a proper subset of a plurality of source bucket candidates all having a corresponding storage utilization exceeding the first threshold storage utilization based on selecting the plurality of source buckets from the plurality of source bucket candidates in accordance with a randomized selection process applying weighing as an increasing function of deviation of corresponding storage utilization from the first threshold storage utilization:
selecting, for each source bucket of the plurality of source buckets, an amount of data to transfer out of the each source bucket as an increasing function of the deviation of the corresponding storage utilization from the first threshold storage utilization:
selecting the plurality of target buckets as a proper subset of a plurality of target bucket candidates all having a corresponding storage utilization falling below the second threshold storage utilization based on selecting the plurality of target buckets from the plurality of target bucket candidates in accordance with the randomized selection process applying weighing as an increasing function of deviation of corresponding storage utilization from the second threshold storage utilization; or
selecting, for each target bucket of the plurality of target buckets, an amount of data to transfer into the each target bucket as an increasing function of the deviation of the corresponding storage utilization from the first threshold storage utilization.

13. The method of claim 1, wherein performing the plurality of data transfers is based on performing a plurality of sets of data transfers over a plurality of cycles, wherein each set of data transfers is performed in accordance with a selected batch size for a corresponding one of the plurality of cycles, and wherein the selected batch size is updated for a subsequent one of the plurality of cycles based on at least one of:
a configured batch size approach rate:
a configured batch size multiplier:
comparing a rebalancing progress measured from after performing a previous one of the plurality of cycles to after performing the corresponding one of the plurality of cycles to a threshold minimum percentage of progress; or
adhering to a configured threshold maximum batch size.

14. The method of claim 1, wherein the plurality of data transfers are performed as a corresponding plurality of distributed tasks for execution in accordance with a distributed task framework, and wherein performing the plurality of data transfers includes:
re-executing one of the corresponding plurality of distributed tasks a newly assigned node of a plurality of nodes based on a previously assigned node of the plurality of nodes failing while executing the executing the one of the corresponding plurality of distributed tasks.

15. The method of claim 1, further comprising:
generating system metadata regarding the database system as a set of metadata rows; and
further storing the set of metadata rows via a second set of relational database tables of the database system based on loading the set of metadata rows for storage via one loading module of a plurality of loading modules based on the one loading module being selected for system metadata loading.

16. The method of claim 1, wherein storing the plurality of relational database tables is based on:
generating and storing a set of pages:
in response to detecting that a page drain condition has been met:
determining a conversion page set as a proper subset of pages included in the set of pages based on a predetermined post-drain number of pages; and
performing a page conversion process upon pages included in the conversion page set to generate a set of segments from the pages included in the conversion page set, wherein the set of segments includes a plurality of rows of at least one of the plurality of relational database tables.

17. The method of claim 1, wherein the plurality of storage buckets include a plurality of segments stored by the database system, further comprising:
based on generating the plurality of segments, populating a time bucket lookup map corresponding to the relational database table based on time values of the plurality of segments:
determining a query for execution indicating time-based filtering parameters:
identifying a time-based pre-filtered segment set of the plurality of segments based on accessing the time bucket lookup map based on the time-based filtering parameters; and
executing the query based on accessing only segments of the plurality of segments included in an identified segment set determined based on identifying the time-based pre-filtered segment set.

18. The method of claim 1, wherein the plurality of storage buckets include a plurality of segments stored by the database system, further comprising:
populating a multi-dimensional index structure, wherein the multi-dimensional index structure has a plurality of dimensions corresponding to a plurality of segment attribute types:
determining a query for execution:
determining, based on the query, a required attribute value range for each of the plurality of segment attribute types:
identifying an identified segment set based on accessing the multi-dimensional index structure determine ones of the plurality of segments having corresponding attributes for the each of the plurality of segment attribute types falling within the required attribute value range; and
executing the query based on accessing only segments of the plurality of segments included in the identified segment set.

19. A database system includes:
at least one processor; and
at least one memory storing operational instructions that, when executed by the at least one processor, causes the database system to:
store a plurality of relational database tables via a plurality of storage buckets of the database system:
execute a plurality of queries against the plurality of relational database tables via accessing the plurality of storage buckets:
generate current storage distribution data indicating storage utilization for the plurality of storage buckets of the database system; and
perform a storage rebalancing process based on the current storage distribution data, wherein performing the storage rebalancing process is based on:
identifying a first subset of the plurality of storage buckets as a plurality of source buckets based on each of the first subset of the plurality of storage buckets having corresponding storage utilization meeting source bucket criteria;
identifying a second subset of the plurality of storage buckets as a plurality of target buckets based on each of the first subset of the plurality of storage buckets having corresponding storage utilization meeting target bucket criteria; and
performing a plurality of data transfers, wherein performing each of the plurality of data transfers includes transferring storage of data included in one of plurality of source buckets to one of the plurality of target buckets.

20. A non-transitory computer readable storage medium comprises:
at least one memory section that stores operational instructions that, when executed by at least one processing module that includes a processor and a memory, causes the at least one processing module to:
store a plurality of relational database tables via a plurality of storage buckets of a database system;
execute a plurality of queries against the plurality of relational database tables via accessing the plurality of storage buckets;
generate current storage distribution data indicating storage utilization for the plurality of storage buckets of the database system; and
perform a storage rebalancing process based on the current storage distribution data, wherein performing the storage rebalancing process is based on:
identifying a first subset of the plurality of storage buckets as a plurality of source buckets based on each of the first subset of the plurality of storage buckets having corresponding storage utilization meeting source bucket criteria;
identifying a second subset of the plurality of storage buckets as a plurality of target buckets based on each of the first subset of the plurality of storage buckets having corresponding storage utilization meeting target bucket criteria; and
performing a plurality of data transfers, wherein performing each of the plurality of data transfers includes transferring storage of data included in one of plurality of source buckets to one of the plurality of target buckets.
